(19) United States
(12) Patent Application Publication
(10) Pub. No.: US 2010/0137136 A1
(43) Pub. Date: Jun. 3, 2010

(54) HERBICIDE/SAFENER COMBINATION

(75) Inventors: Christopher Hugh ROSINGER, Hofheim (DE); Erwin Hacker, Hochheim (DE); Hartmut Ahrens, Egelsbach (DE); Hansjörg Dietrich, Liederbach am Taunus (DE); Frank Ziemer, Kriftel (DE)

Correspondence Address: Baker Donelson Bearman, Caldwell & Berkowitz, PC, 555 Eleventh Street, NW, Sixth Floor, Washington, DC, 20004, US

(73) Assignee: BAYER CROPSCIENCE AG, Monheim (DE)

(21) Appl. No.: 12/625,925

(22) Filed: Nov. 25, 2009

(30) Foreign Application Priority Data
Nov. 29, 2008 (EP) 08020781.4

(51) Int. Cl. A01N 25/32; A01P 13/00

(52) U.S. Cl. 504/105; 504/106; 504/107; 504/112; 504/110

(57) ABSTRACT

A composition comprising
(A) one or more compounds of the formula (I), their N-oxides or their salts,

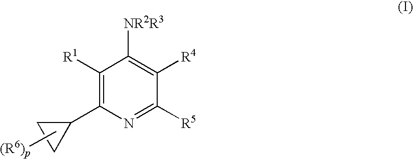

in which the individual indices and definitions have the meaning defined in the description
   and
(B) one or more safeners
   is described.

The present invention relates to agrochemically effective herbicide/safener combinations, to processes for their preparation, and to their use for controlling harmful plants.

It is known from various documents that certain pyridine derivatives have herbicidal properties. For example, WO 2003/011853, WO 2006/062979 and WO 2007/082098 describe pyridine derivatives which control a broad spectrum of weeds.

However, the active ingredients described in WO 2003/011853 are structurally different from those described in the compositions according to the invention; this is because they have an aryl or heteroaryl substituent in the 6-position of the pyridine. WO 2007/082098 also discloses structurally different pyridine derivatives, namely likewise 6-aryl-substituted compounds.

Although WO 2006/062979 discloses the pyridine derivatives used in the composition according to the invention, the use of safeners in combination with these is only described generically. It is not disclosed which safeners are suitable for the compounds, neither is any biological data shown which demonstrates an actual safener effect.

The active ingredients in the compositions according to the invention are, when applied without safeners, in part not fully compatible with a number of important crop plants, such as, for example, various cereal species, corn or rice. Consequently, in some crops, they cannot be used in a manner which ensures the desired broad herbicidal activity against harmful plants.

It is therefore an object of the present invention to find herbicidal compositions in which the selectivity of the aforementioned herbicides in respect of important crop plants is increased. Surprisingly, this object is achieved by the herbicide/safener combination according to the invention.

Accordingly, the present invention provides a composition comprising
(A) one or more compounds of the formula (I), their N-oxides or their salts,

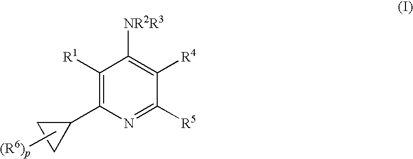

in which
R¹ is hydrogen, fluorine or chlorine;
R² is hydrogen, C₁-C₄-alkyl optionally substituted by one to two radicals R⁷, C₂-C₄-alkenyl optionally substituted by one to two radicals R⁸, C₂-C₄-alkynyl optionally substituted by one to two radicals R⁹, C(═O)R¹⁰, nitro, OR¹¹, SO₂R¹², NR¹³R¹⁴ or N═CR¹⁵R¹⁶;
R³ is hydrogen, C₁-C₄-alkyl optionally substituted by one to two radicals R¹⁷ or C(═O)R¹⁰; or
R² and R³ together are —(CH₂)₄—, —(CH₂)₅—, —CH₂CH═CHCH₂— or —(CH₂)₂O(CH₂)₂—, where each of these four last-mentioned radicals is optionally substituted by one to two radicals R¹⁸; or
R² and R³ together are ═C(R¹⁹)NR²⁰R²¹ or ═C(R²²)OR²³;
R⁴ is halogen;
R⁵ is COOH or a herbicide-active derivative of COOH;
R⁶ independently of the others is halogen, C₁-C₆-alkyl, C₁-C₆-haloalkyl, C₂-C₆-alkenyl, C₂-C₆-haloalkenyl, C₁-C₃-alkoxy, C₁-C₂-haloalkoxy, C₁-C₃-alkylthio or C₁-C₂-haloalkylthio;
R⁷, R⁸ and R⁹ in each case independently of one another are halogen, C₁-C₃-alkoxy, C₁-C₃-haloalkoxy, C₁-C₃-alkylthio, C₁-C₃-haloalkylthio, amino, C₁-C₃-alkylamino, C₂-C₄-dialkylamino or C₂-C₄-alkoxycarbonyl;
R¹⁰ independently of the others is hydrogen, C₁-C₁₄-alkyl, C₁-C₃-haloalkyl, C₁-C₄-alkoxy, phenyl, phenoxy or benzyloxy;
R¹¹ is hydrogen, C₁-C₄-alkyl, C₁-C₃-haloalkyl or CHR²⁴C(O)OR²⁵;
R¹² is C₁-C₄-alkyl or C₁-C₃-haloalkyl;
R¹³ is hydrogen, C₁-C₄-alkyl or C(═O)R²⁶;
R¹⁴ is hydrogen or C₁-C₄-alkyl;
R¹⁵ is hydrogen, C₁-C₄-alkyl or phenyl optionally substituted by one to three radicals R²⁷;
R¹⁶ is hydrogen or C₁-C₄-alkyl; or
R¹⁵ and R¹⁶ together are —(CH₂)₄— or —(CH₂)₅—;
R¹⁷ independently of one another are halogen, C₁-C₃-alkoxy, C₁-C₃-haloalkoxy, C₁-C₃-alkylthio, C₁-C₃-haloalkylthio, amino, C₁-C₃-alkylamino, C₂-C₄-dialkylamino or C₂-C₄-alkoxycarbonyl;
R¹⁸ independently of one another are halogen, C₁-C₃-alkyl, C₁-C₃-alkoxy, C₁-C₃-haloalkoxy, C₁-C₃-alkylthio, C₁-C₃-haloalkylthio, amino, C₁-C₃-alkylamino, C₂-C₄-dialkylamino or C₂-C₄-alkoxycarbonyl;
R¹⁹ is hydrogen or C₁-C₄-alkyl;
R²⁰ and R²¹ independently of one another are hydrogen or C₁-C₄-alkyl; or
R²⁰ and R²¹ together are —(CH₂)₄—, —(CH₂)₅—, —CH₂CH═CHCH₂— or —(CH₂)₂O(CH₂)₂—;
R²² is hydrogen or C₁-C₄-alkyl;
R²³ is C₁-C₄-alkyl;
R²⁴ is hydrogen, C₁-C₄-alkyl or C₁-C₄-alkoxy;
R²⁵ is hydrogen, C₁-C₄-alkyl or benzyl;
R²⁶ is hydrogen, C₁-C₁₄-alkyl, C₁-C₃-haloalkyl, C₁-C₄-alkoxy, phenyl, phenoxy or benzyloxy;
R²⁷ independently of the others is methyl, chloro or methoxy;
p is 0, 1, 2, 3, 4 or 5;
and
(B) one or more safeners.

The herbicide/safener combinations according to the invention can comprise additional further components, for example crop protection composition active ingredients of a different type and/or formulation auxiliaries and/or additives customary in crop protection, or can be used together with these.

The herbicides (A) and the safeners (B) can be applied in a known manner, for example together (for example as a coformulation or as a tank mix) or else at different times (splitting), for example to the plants, plant parts, plant seeds or the area on which the plants grow. It is possible, for example, to apply the individual active ingredients or the herbicide/safener combination in several portions (sequential application), for example pre-emergence applications, followed by post-emergence applications or early post-emergence applications, followed by medium or late post-emergence applications. Preference is given here to the joint or almost simultaneous application of the active ingredients of the combination in question. It is also possible to use the individual active ingredients or the herbicide/safener combination for treating seed material.

### Compound of the Formula (I)

The specified formula (I) encompasses all stereoisomers and mixtures thereof, in particular also racemic mixtures, and—if enantiomers are possible—both enantiomers and in particular the particular biologically effective enantiomer.

It is assumed that the compounds of the formula (I) in which R⁵ is CO₂H are the compounds which bind to an active site of a plant enzyme or receptor in order to achieve a herbicidal effect. Other compounds of the formula (I) in which the substituent R⁵ is a group which can be converted into a carboxylic acid function (i.e. CO₂H) within the plants or the environment permit similar herbicidal effects and are likewise encompassed within the context of the present invention as herbicidally active derivatives.

Consequently, within the context of the present invention, a herbicidally active derivative is understood in particular as meaning salts, esters, carboxamides, acyl hydrazides, imidates, thioimidates, amidines, acyl halides, acyl cyanides, acid anhydrides, ethers, acetals, orthoesters, carboxaldehydes, oximes, hydrazones, thio acids, thio esters, dithiol esters, nitriles and any other desired carboxylic acid derivative which does not cancel the herbicidal effect of the compound of the formula (I) and provides the carboxylic acid function in plants and/or in the soil for example through hydrolysis, oxidation, reduction or another type of metabolism. Here, the carboxylic acid function may be present in dissociated form or non-dissociated form, depending on the pH.

The salts of the compounds of the formula (I) suitable in the field of crop protection are salts which are obtained by bringing them into contact with acids or bases or are obtained by ion exchange, meaning that the derived salts have adequate solubility in water for the bioavailability and thus the herbicidal effectiveness.

The compounds of the formula (I) can also form salts through adduct formation of a suitable inorganic or organic acid, such as, for example, HCl, HBr, H₂SO₄, H₃PO₄, or HNO₃, but also oxalic acid, acetic acid, butyric acid, fumaric acid, lactic acid, malonic acid, propionic acid, salicylic acid, tartaric acid, pentanoic acids or sulfonic acids, such as para-toluenesulfonic acid, onto a basic group, such as, for example, amino or alkylamino. Suitable substituents which are present in deprotonated form, such as, for example, sulfonic acids or carboxylic acids, can form internal salts with groups that for their part are protonatable, such as amino groups. Salts can likewise be formed by, in the case of suitable substituents, such as, for example, sulfonic acids or carboxylic acids, replacing the hydrogen by a cation suitable for agriculture. These salts are, for example, metal salts, in particular alkali metal salts or alkaline earth metal salts, in particular sodium and potassium salts, salts with organic amines, for example of dimethylamine, diethanolamine or triethanolamine, ammonium salts, in particular quaternary ammonium salts with cations of the formula [NRR′R″R′″]⁺, in which R to R′″, in each case independently of one another, are an organic radical, in particular alkyl, aryl, aralkyl or alkylaryl, or sulfonium salts, for example trimethylsulfonium salts.

Also of particular suitability are ester and thio ester derivates of the carboxylic acid function of R⁵. Ester groups result from the condensation of a carboxylic acid function (CO₂H) with an alcohol (i.e. R^{AL}OH), in which R^{AL} is a radical derived from the alcohol; a large number of processes is known for preparing such esters. Analogous thio ester groups of the formula C(O)SR^{AL} can be obtained as the condensation product of a carboxylic acid function with a thio alcohol (mercaptan) of the formula R^{AL}SH; a large number of processes are likewise known for preparing such thio esters. In the herbicidal application, the corresponding ester or thio ester compounds of the general formula (I) are lightly hydrolyzed, for example by the presence of hydrolytically effective enzymes, as a result of which the corresponding carboxylic acid function is obtained again.

If the radical R^{AL} has more than one OH or SH function, the radical can be condensed with more than one pyridine ring system of the formula (I).

Examples of ester and thio ester compounds of the formula (I) are based in particular on the ester or thio ester formation with methanol, ethanol, butanol, 2-butoxyethanol, 2-ethylhexanol, isopropanol, 2-methylpropanol (isobutanol), octanol isomers (isoctanol) and ethanethiol, in order in each case to form methyl, ethyl, butyl, 2-butoxyethyl, 2-ethylhexyl, isopropyl, 2-methylpropyl, isoctyl and ethylthio esters. Particular preference is given to the methyl and ethyl esters.

Preferred embodiments of the present invention are described below:

in a first embodiment, the present invention includes compounds of the formula (I) in which
R⁵ is CO₂R²⁹, CH₂OR³⁰, CH(OR³¹)(OR³²), CHO, C(═NOR³³)H, C(═NNR³⁴R³⁵)H, C(═O)N(R³⁶)R³⁷, C(═S)OR³⁸, C(═O)SR³⁹, C(═S)SR⁴⁰ or C(═NR⁴¹)YR⁴²;
R²⁹ is H, —CH[—C(O)O(CH₂)ₘ—], —N═C(R⁴³)R⁴⁴; or a radical which is selected from the group consisting of C₁-C₁₄-alkyl, C₃-C₁₂-cycloalkyl, C₄-C₁₂-alkylcycloalkyl, C₄-C₁₂-cycloalkylalkyl, C₂-C₁₄-alkenyl, C₂-C₁₄-alkynyl and phenyl, where each radical may be optionally substituted by 1 to 3 radicals R⁴⁵; or
R²⁹ is a divalent radical which joins the carboxylate function CO₂R²⁹ of in each case two pyridine ring systems of the formula (I), and the divalent radical is selected from the group consisting of —CH₂—, —(CH₂)₂—, —(CH₂)₃— and —CH(CH₃)CH₂—;
R³⁰ is hydrogen, C₁-C₁₀-alkyl, which may be optionally substituted by 1 to 3 radicals R⁴⁶, or is benzyl;
R³¹ and R³² independently of one another are C₁-C₄-alkyl or C₁-C₃-haloalkyl; or
R³¹ and R³² together are —CH₂CH₂—, —CH₂CH(CH₃)— or —(CH₂)₃—;
R³³ is hydrogen, C₁-C₄-alkyl, C₁-C₄-haloalkyl or benzyl;
R³⁴ is hydrogen, C₁-C₄-alkyl, C₁-C₄-haloalkyl, C₂-C₄-alkylcarbonyl, C₂-C₄-alkoxycarbonyl or benzyl;
R³⁵ is hydrogen, C₁-C₄-alkyl or C₁-C₄-haloalkyl;
R³⁶ is hydrogen, C₁-C₄-alkyl, hydroxy, C₁-C₄-alkoxy or S(O)₂R⁴⁷;
R³⁷ is hydrogen or C₁-C₄-alkyl;
R³⁸, R³⁹ and R⁴⁰ are hydrogen or a radical which is selected from the group consisting of C₁-C₁₄-alkyl, C₃-C₁₂-cycloalkyl, C₄-C₁₂-alkylcycloalkyl, C₄-C₁₂-cycloalkylalkyl, C₂-C₁₄-alkenyl and C₂-C₁₄-alkynyl, where each radical may be optionally substituted by 1 to 3 radicals R⁴⁵;
Y is O, S or NR⁴⁸;
R⁴¹ is hydrogen, C₁-C₃-alkyl, C₁-C₃-haloalkyl, C₂-C₄-alkoxyalkyl, OH or C₁-C₃-alkoxy;
R⁴² is C₁-C₃-alkyl, C₁-C₃-haloalkyl or C₂-C₄-alkoxyalkyl; or
R⁴¹ and R⁴² together form —(CH₂)₂—, —CH₂CH(CH₃)— or —(CH₂)₃—;
R⁴³ and R⁴⁴ independently of one another are C₁-C₄-alkyl;
each R⁴⁵ independently of the others is selected from the group consisting of halogen, cyano, hydroxycarbonyl, C₂-C₄-alkoxycarbonyl, hydroxy, C₁-C₄-alkoxy, C₁-C₄-haloalkoxy, C₁-C₄-alkylthio, C₁-C₄-haloalkylthio, amino, C₁-C₄-alkylamino, C₂-C₄-dialkylamino, —CH[O(CH₂)ₙ] and phenyl, which may be optionally substituted by 1 to 3 radicals R⁴⁹; or
two radicals R⁴⁵ together form —OC(O)O— or —O(C(R⁵⁰)(R⁵⁰))₁₋₂O—; or
two radicals R⁴⁵ are taken together as an oxygen atom in order to form a carbonyl radical with the carbon atom to which they are bonded;
each R⁴⁶ independently of the others is selected from the group consisting of halogen, C₁-C₄-alkoxy, C₁-C₄-haloalkoxy, C₁-C₄-alkylthio, C₁-C₄-haloalkylthio, amino, C₁-C₄-alkylamino or C₂-C₄-dialkylamino; or
two radicals R⁴⁶ are taken together as an oxygen atom in order to form a carbonyl radical with the carbon atom to which they are bonded;
R⁴⁷ is C₁-C₄-alkyl, C₁-C₃-haloalkyl or NR⁵¹R⁵²;
R⁴⁸ is H, C₁-C₃-alkyl, C₁-C₃-haloalkyl or C₂-C₄-alkoxyalkyl;
each R⁴⁹ independently of the others is selected from the group consisting of halogen, C₁-C₄-alkyl, C₁-C₃-haloalkyl, hydroxy, C₁-C₄-alkoxy, C₁-C₃-haloalkoxy, C₁-C₃-alkylthio, C₁-C₃-haloalkylthio, amino, C₁-C₃-alkylamino, C₂-C₄-dialkylamino and nitro;
each R⁵⁰ independently of the others is selected from the group consisting of hydrogen and C₁-C₄-alkyl;
R⁵¹ and R⁵² independently of the others is selected from the group consisting of hydrogen or C₁-C₄-alkyl;
m is an integer from 2 to 3; and
n is an integer from 1 to 4.
   In a second embodiment, the present invention includes compounds of the formula (I) in which
R⁵ is CO₂R²⁹, CH₂OR³⁰ or CHO.
   In a third embodiment, the present invention includes compounds of the formula (I) in which
R⁵ is CO₂R²⁹ or CHO.
   In a fourth embodiment, the present invention includes compounds of the formula (I) in which
R⁵ is CO₂R²⁹.
   In a fifth embodiment, the present invention includes compounds of the formula (I) in which
R²⁹ is selected from the group consisting of hydrogen, C₁-C₈-alkyl or C₁-alkyl which is substituted by phenyl, where the phenyl radical may be optionally substituted by 1 to 3 radicals R⁴⁵.
   In a sixth embodiment, the present invention includes compounds of the formula (I) in which
R²⁹ is selected from the group consisting of hydrogen, C₁-C₄-alkyl or C₁-alkyl which is substituted by phenyl, where the phenyl radical may be optionally substituted by 1 to 3 radicals R⁴⁵.
   In a seventh embodiment, the present invention includes compounds of the formula (I) in which
R²⁹ is selected from the group consisting of hydrogen, C₁-C₄-alkyl or benzyl.
   In an eighth embodiment, the present invention includes compounds of the formula (I) in which
R³⁶ is selected from the group consisting of hydrogen, C₁-C₄-alkyl, hydroxy or C₁-C₄-alkoxy.
   In a ninth embodiment, the present invention includes compounds of the formula (I) in which
R⁴¹ is selected from the group consisting of hydrogen, C₁-C₃-alkyl, C₁-C₃-haloalkyl or C₂-C₄-alkoxyalkyl.
   In a tenth embodiment, the present invention includes compounds of the formula (I) in which
R⁵ is selected from the group consisting of COOH, an agrochemically compatible salt, an ester derivative and a thio ester derivative thereof.
   In an eleventh embodiment, the present invention includes compounds of the formula (I) in which
R⁵ is selected from the group consisting of COOH, an agrochemically compatible salt and an ester derivative thereof.
   In a twelfth embodiment, the present invention includes compounds of the formula (I) in which
p is an integer from 0 to 2.
   In a thirteenth embodiment, the present invention includes compounds of the formula (I) in which
p is an integer from 0 to 1.
   In a fourteenth embodiment, the present invention includes compounds of the formula (I) in which
p is 0.
   In a fifteenth embodiment, the present invention includes compounds of the formula (I) in which
R¹ is hydrogen or F.
   In a sixteenth embodiment, the present invention includes compounds of the formula (I) in which
R¹ is F or Cl.
   In a seventeenth embodiment, the present invention includes compounds of the formula (I) in which
R¹ is H.
   In an eighteenth embodiment, the present invention includes compounds of the formula (I) in which
R¹ is F.
   In a nineteenth embodiment, the present invention includes compounds of the formula (I) in which
R¹ is Cl.
   In a twentieth embodiment, the present invention includes compounds of the formula (I) in which
R² is H, C(O)R¹⁰ or C₁-C₄-alkyl, which may be optionally substituted by R⁷;
R³ is H or C₁-C₂-alkyl; or
R² and R³ together form ═C(R¹⁹)N(R²⁰)R²¹.
   In a twenty first embodiment, the present invention includes compounds of the formula (I) in which
R² is H, CH₃ or C(O)R¹⁰;
R³ is H or CH₃; or
R² and R³ together form ═C(R¹⁹)N(R²⁰)R²¹.
   In a twenty second embodiment, the present invention includes compounds of the formula (I) in which
R² is H, C(O)CH₃ or C₁-C₄-alkyl, which may be optionally substituted by R⁷; and
R³ is H or C₁-C₂-alkyl.
   In a twenty third embodiment, the present invention includes compounds of the formula (I) in which
R² and R³ independently of one another are hydrogen or methyl.
   In a twenty fourth embodiment, the present invention includes compounds of the formula (I) in which
R² and R³ are hydrogen.
   In a twenty fifth embodiment, the present invention includes compounds of the formula (I) in which
R⁴ is Br or Cl.
   In a twenty sixth embodiment, the present invention includes compounds of the formula (I) in which
R⁴ is Cl.
   In a twenty seventh embodiment, the present invention includes compounds of the formula (I) in which
each R⁶ independently of the others is halogen, C₁-C₂-alkyl or C₁-C₂-haloalkyl.
   In a twenty eighth embodiment, the present invention includes compounds of the formula (I) in which
R⁷ is halogen, methoxy, fluoromethoxy, methylthio, fluoromethylthio, amino, methylamino, dimethylamino or methoxycarbonyl.
   In a twenty ninth embodiment, the present invention includes compounds of the formula (I) in which
R¹⁰ is hydrogen or C₁-C₃-alkyl.
   In a thirtieth embodiment, the present invention includes compounds of the formula (I) in which
R¹⁰ is hydrogen or CH₃.
   In a thirty first embodiment, the present invention includes compounds of the formula (I) in which
R¹⁰ is CH₃.
   In a thirty second embodiment, the present invention includes compounds of the formula (I) in which
R¹⁹ is hydrogen or C₁-C₂-alkyl.
   In a thirty third embodiment, the present invention includes compounds of the formula (I) in which
R³² is hydrogen or CH₃.
   In a thirty fourth embodiment, the present invention includes compounds of the formula (I) in which
R²⁰ and R²¹ independently of one another are hydrogen or C₁-C₂-alkyl.
   In a thirty fifth embodiment, the present invention includes compounds of the formula (I) in which
R²⁰ and R²¹ independently of one another are hydrogen or CH₃.

Included in the compositions of the described embodiments are N-oxides and agrochemically compatible salts thereof. Combinations of embodiments 1 to 35 are shown by
(A) the embodiment A in which compounds of the formula (I) are comprised in which
   R⁵ is CO₂R²⁹, CH₂OR³⁰, CH(OR³¹)(OR³²), CHO, C(═NOR³³)H, C(═NNR³⁴R³⁵)H, C(═O)N(R³⁶)R³⁷, C(═S)OR³⁸, C(═O)SR³⁹, C(═S)SR⁴⁰ or C(═NR⁴¹)YR⁴²;
   R²⁹ is hydrogen, —CH[C(O)O(CH₂)ₘ], —N═C(R⁴³)R⁴⁴ or a radical which is selected from the group consisting of C₁-C₁₄-alkyl, C₃-C₁₂-cycloalkyl, C₄-C₁₂-alkylcycloalkyl, C₄-C₁₂-cycloalkylalkyl, C₂-C₁₄-alkenyl, C₂-C₁₄-alkynyl and phenyl, where each radical may be optionally substituted by 1 to 3 radicals R⁴⁵; or
   R²⁹ is a divalent radical which joins the carboxylate function CO₂R²⁹ of two pyridine ring systems of the formula (I), and the divalent radical is selected from the group consisting of —CH₂—, —(CH₂)₂—, —(CH₂)₃— and —CH(CH₃)CH₂—;
   R³⁰ is hydrogen; C₁-C₁₀-alkyl, which may be optionally substituted by 1 to 3 radicals R⁴⁶; or is benzyl;
   R³¹ and R³² independently of one another are C₁-C₄-alkyl or C₁-C₃-haloalkyl; or
   R³¹ and R³² together are —CH₂CH₂—, —CH₂CH(CH₃)— or —(CH₂)₃—;
   R³³ is hydrogen, C₁-C₄-alkyl, C₁-C₄-haloalkyl or benzyl;
   R³⁴ is hydrogen, C₁-C₄-alkyl, C₁-C₄-haloalkyl, C₂-C₄-alkylcarbonyl, C₂-C₄-alkoxycarbonyl or benzyl;
   R³⁵ is hydrogen, C₁-C₄-alkyl or C₁-C₄-haloalkyl;
   R³⁶ is hydrogen, C₁-C₄-alkyl, hydroxy, C₁-C₄-alkoxy or S(O)₂R⁴⁷;
   R³⁷ is hydrogen or C₁-C₄-alkyl;
   R³⁸, R³⁹ and R⁴⁰ are hydrogen or a radical which is selected from the group consisting of C₁-C₁₄-alkyl, C₃-C₁₂-cycloalkyl, C₄-C₁₂-alkylcycloalkyl, C₄-C₁₂-cycloalkylalkyl, C₂-C₁₄-alkenyl and C₂-C₁₄-alkynyl, where each radical may be optionally substituted by 1 to 3 radicals R⁴⁵;
   Y is O, S or NR⁴⁸;
   R⁴¹ is hydrogen, C₁-C₃-alkyl, C₁-C₃-haloalkyl, C₂-C₄-alkoxyalkyl, OH or C₁-C₃-alkoxy;
   R⁴² is C₁-C₃-alkyl, C₁-C₃-haloalkyl or C₂-C₄-alkoxyalkyl; or
   R⁴¹ and R⁴² together form —(CH₂)₂—, —CH₂CH(CH₃)— or —(CH₂)₃—;
   R⁴³ and R⁴⁴ independently of one another are C₁-C₄-alkyl;
   each R⁴⁵ independently of the others is selected from the group consisting of halogen, cyano, hydroxycarbonyl, C₂-C₄-alkoxycarbonyl, hydroxy, C₁-C₄-alkoxy, C₁-C₄-haloalkoxy, C₁-C₄-alkylthio, C₁-C₄-haloalkylthio, amino, C₁-C₄-alkylamino, C₂-C₄-dialkylamino, —CH[—O(CH₂)ₙ—] and phenyl, which may be optionally substituted by 1 to 3 radicals R⁴⁹; or
   two R⁴⁵ together form —OC(O)O— or —O(C(R⁵⁰)(R⁵⁰))₁₋₂O—; or
   two R⁴⁵ form an oxygen atom in order to form a carbonyl radical with the carbon atom to which they are bonded;
   each R⁴⁶ independently of the others is selected from the group consisting of halogen, C₁-C₄-alkoxy, C₁-C₄-haloalkoxy, C₁-C₄-alkylthio, C₁-C₄-haloalkylthio, amino, C₁-C₄-alkylamino and C₂-C₄-dialkylamino; or
   two R⁴⁶ form an oxygen atom in order to form a carbonyl radical with the carbon atom to which they are bonded;
   R⁴⁷ is C₁-C₄-alkyl, C₁-C₃-haloalkyl or NR⁵¹R⁵²;
   R⁴⁸ is hydrogen, C₁-C₃-alkyl, C₁-C₃-haloalkyl or C₂-C₄-alkoxyalkyl;
   each R⁴⁹ independently of the others is selected from the group consisting of halogen, C₁-C₄-alkyl, C₁-C₃-haloalkyl, hydroxy, C₁-C₄-alkoxy, C₁-C₃-haloalkoxy, C₁-C₃-alkylthio, C₁-C₃-haloalkylthio, amino, C₁-C₃-alkylamino, C₂-C₄-dialkylamino and nitro;
   each R⁵⁰ independently of the others is selected from the group consisting of hydrogen and C₁-C₄-alkyl;
   R⁵¹ and R⁵² independently of one another are hydrogen or C₁-C₄-alkyl;
   m is an integer from 2 to 3; and
   n is an integer from 1 to 4;
(B) the embodiment B in which compounds of the formula (I) are comprised in which
   R² is hydrogen, CH₃ or C(O)R¹⁰;
   R³ is hydrogen or CH₃; or
   R² and R³ together form ═C(R¹⁹)N(R²⁰)R²¹; and
   R¹⁰, R¹⁹, R²⁰ and R²¹ in each case independently of one another are hydrogen or CH₃;
(C) the embodiment C in which compounds of the formula (I) are comprised in which
   R⁵ is CO₂R²⁹; and
   R² and R³ are hydrogen;
(D) the embodiment D in which compounds of the formula (I) are comprised in which
   R²⁹ is hydrogen, C₁-C₄-alkyl or benzyl.

Specific embodiments include compounds of the formula (I) selected from the group consisting of
methyl 4-amino-3,5-dichloro-6-cyclopropyl-2-pyridinecarboxylate (compound I-22 in table A.1);
4-amino-3,5-dichloro-6-cyclopropyl-2-pyridinecarboxylic acid (compound I-21 in table A.1);
methyl 4-amino-3-chloro-6-cyclopropyl-2-pyridinecarboxylate (compound I-2 in table A.1);
4-amino-3-chloro-6-cyclopropyl-2-pyridinecarboxylic acid (compound I-1 in table A.1);
methyl 4-amino-3-chloro-6-cyclopropyl-5-fluoro-2-pyridinecarboxylate (compound I-12 in table A.1); and
4-amino-3-chloro-6-cyclopropyl-5-fluoro-2-pyridinecarboxylic acid (compound I-11 in table A.1).

In particular, the compounds of the formula (I) can also include N-oxides.

Corresponding pyridine N-oxides are accessible via an oxidation of the corresponding pyridines. Suitable oxidation methods are described, for example, in Houben-Weyl, Methoden der organischen Chemie [Methods in organic chemistry], expanded and subsequent volumes to the 4th edition, volume E 7b, p. 565 f.

Unless specifically defined otherwise, the following definitions apply in general for the radicals of the formula (I).

In formula (I), the radicals alkyl, alkoxyalkyl, hydroxyalkyl and alkoxyalkoxyalkyl may in each case be straight-chain or branched.

Within the context of the present invention, the term “alkyl” is understood in particular as meaning the radicals methyl; ethyl; n-propyl; isopropyl; n-butyl; sec-butyl; tert-butyl; or the various isomers of pentyl or hexyl.

Within the context of the present invention, the term “alkoxyalkyl” is understood as meaning alkyl provided with an alkoxy substituent. Examples of the radical “alkoxyalkyl” include CH₃OCH₂, CH₃OCH₂CH₂, CH₃CH₂OCH₂, CH₃CH₂CH₂CH₂OCH₂, CH₃CH₂OCH₂CH₂, CH₃CH₂CH₂CH₂OCH₂CH₂ or CH₃CH₂CH₂CH₂OCH₂CHMe.

Within the context of the present invention, the term “alkoxyalkoxy” is understood as meaning alkoxy provided with an alkoxy substituent.

Within the context of the present invention, the term “alkoxyalkoxyalkyl” is understood as meaning a radical in which an alkoxyalkoxy substituent is bonded to an alkyl radical.

Examples of “alkoxyalkoxyalkyl” include CH₃OCH₂OCH₂, CH₃OCH₂OCH₂CH₂, CH₃CH₂OCH₃OCH₂ and CH₃OCH₃CH₂OCH₂CH₂.

Within the context of the present invention, the term “hydroxyalkyl” is understood as meaning alkyl provided with a hydroxy substituent. Examples of “hydroxyalkyl” include HOCH₂CH₂, HOCH₂CH₂CH₂ and HOCH₂CH₂CH₂CH₂.

For radicals with carbon atoms, preference is in principle given to those having 1 to 6 carbon atoms, preferably 1 to 4 carbon atoms, in particular 1 or 2 carbon atoms.

The present invention also provides mixtures comprising stereoisomers which are encompassed by formula (I) or by the formulae of component B (safener). Such compounds of the formula (I) or of the formulae of component B (safener) comprise, for example, one or more asymmetrically substituted carbon atoms or sulfoxides. The possible stereoisomers defined by their specific spatial form, such as enantiomers and diastereomers, are all encompassed by the formula (I) or by the formulae of component B (safener) and can be obtained by customary methods from mixtures of the stereoisomers or else be prepared by stereoselective reactions in combination with the use of stereochemically pure starting substances or auxiliaries.

Examples of compounds used as herbicide (A) are specified in tables A below, in which the following abbreviations are used:

Me is methyl,
Et is ethyl and
i-Pr is isopropyl.

TABLE A.1
specific examples of the compounds of the formula (I)

| | |
|---|---|
| | (I) |
| 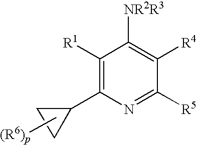 | |

| Compound | R¹ | R² | R³ | R⁴ | R⁵ | R⁶ | p |
|---|---|---|---|---|---|---|---|
| I-1 | H | H | H | Cl | COOH | — | 0 |
| I-2 | H | H | H | Cl | COOMe | — | 0 |
| I-3 | H | H | H | Cl | COOEt | — | 0 |
| I-4 | H | H | H | Cl | COO-n-C₈H₁₇ | — | 0 |
| I-5 | H | H | H | Cl | CH₂OH | — | 0 |
| I-6 | H | H | H | Cl | CHO | — | 0 |
| I-7 | H | H | H | Cl | C(═NOH)H | — | 0 |
| I-8 | H | H | H | Cl | C(═O)NHMe | — | 0 |
| I-9 | H | H | H | Cl | C(O)O⁻H₃N⁺i-Pr | — | 0 |
| I-10 | H | H | H | Cl | C(O)O⁻Li⁺ | — | 0 |
| I-11 | F | H | H | Cl | COOH | — | 0 |
| I-12 | F | H | H | Cl | COOMe | — | 0 |
| I-13 | F | H | H | Cl | COOEt | — | 0 |
| I-14 | F | H | H | Cl | COO-n-C₈H₁₇ | — | 0 |
| I-15 | F | H | H | Cl | CH₂OH | — | 0 |
| I-16 | F | H | H | Cl | CHO | — | 0 |
| I-17 | F | H | H | Cl | C(═NOH)H | — | 0 |
| I-18 | F | H | H | Cl | C(═O)NHMe | — | 0 |
| I-19 | F | H | H | Cl | C(O)O⁻H₃N⁺i-Pr | — | 0 |
| I-20 | F | H | H | Cl | C(O)O⁻Li⁺ | — | 0 |
| I-21 | Cl | H | H | Cl | COOH | — | 0 |
| I-22 | Cl | H | H | Cl | COOMe | — | 0 |
| I-23 | Cl | H | H | Cl | COOEt | — | 0 |
| I-24 | Cl | H | H | Cl | COO-n-C₈H₁₇ | — | 0 |
| I-25 | Cl | H | H | Cl | CH₂OH | — | 0 |
| I-26 | Cl | H | H | Cl | CHO | — | 0 |
| I-27 | Cl | H | H | Cl | C(═NOH)H | — | 0 |
| I-28 | Cl | H | H | Cl | C(═O)NHMe | — | 0 |
| I-29 | Cl | H | H | Cl | C(O)O⁻H₃N⁺i-Pr | — | 0 |
| I-30 | Cl | H | H | Cl | C(O)O⁻Li⁺ | — | 0 |
| I-31 | H | H | H | Br | COOH | — | 0 |
| I-32 | H | H | H | Br | COOMe | — | 0 |
| I-33 | H | H | H | Br | COOEt | — | 0 |
| I-34 | H | H | H | Br | COO-n-C₈H₁₇ | — | 0 |
| I-35 | H | H | H | Br | CH₂OH | — | 0 |
| I-36 | H | H | H | Br | CHO | — | 0 |
| I-37 | H | H | H | Br | C(═NOH)H | — | 0 |
| I-38 | H | H | H | Br | C(═O)NHMe | — | 0 |
| I-39 | H | H | H | Br | C(O)O⁻H₃N⁺i-Pr | — | 0 |
| I-40 | H | H | H | Br | C(O)O⁻Li⁺ | — | 0 |
| I-41 | F | H | H | Br | COOH | — | 0 |
| I-42 | F | H | H | Br | COOMe | — | 0 |
| I-43 | F | H | H | Br | COOEt | — | 0 |
| I-44 | F | H | H | Br | COO-n-C₈H₁₇ | — | 0 |
| I-45 | F | H | H | Br | CH₂OH | — | 0 |
| I-46 | F | H | H | Br | CHO | — | 0 |
| I-47 | F | H | H | Br | C(═NOH)H | — | 0 |
| I-48 | F | H | H | Br | C(═O)NHMe | — | 0 |
| I-49 | F | H | H | Br | C(O)O⁻H₃N⁺i-Pr | — | 0 |
| I-50 | F | H | H | Br | C(O)O⁻Li⁺ | — | 0 |
| I-51 | Cl | H | H | Br | COOH | — | 0 |
| I-52 | Cl | H | H | Br | COOMe | — | 0 |
| I-53 | Cl | H | H | Br | COOEt | — | 0 |
| I-54 | Cl | H | H | Br | COO-n-C₈H₁₇ | — | 0 |
| I-55 | Cl | H | H | Br | CH₂OH | — | 0 |
| I-56 | Cl | H | H | Br | CHO | — | 0 |
| I-57 | Cl | H | H | Br | C(═NOH)H | — | 0 |
| I-58 | Cl | H | H | Br | C(═O)NHMe | — | 0 |
| I-59 | Cl | H | H | Br | C(O)O⁻H₃N⁺i-Pr | — | 0 |
| I-60 | Cl | H | H | Br | C(O)O⁻Li⁺ | — | 0 |
| I-61 | H | H | H | F | COOH | — | 0 |
| I-62 | H | H | H | F | COOMe | — | 0 |
| I-63 | H | H | H | F | COOEt | — | 0 |
| I-64 | H | H | H | F | COO-n-C₈H₁₇ | — | 0 |
| I-65 | H | H | H | F | CH₂OH | — | 0 |
| I-66 | H | H | H | F | CHO | — | 0 |
| I-67 | H | H | H | F | C(═NOH)H | — | 0 |
| I-68 | H | H | H | F | C(═O)NHMe | — | 0 |
| I-69 | H | H | H | F | C(O)O⁻H₃N⁺i-Pr | — | 0 |
| I-70 | H | H | H | F | C(O)O⁻Li⁺ | — | 0 |
| I-71 | F | H | H | F | COOH | — | 0 |
| I-72 | F | H | H | F | COOMe | — | 0 |
| I-73 | F | H | H | F | COOEt | — | 0 |
| I-74 | F | H | H | F | COO-n-C₈H₁₇ | — | 0 |
| I-75 | F | H | H | F | CH₂OH | — | 0 |
| I-76 | F | H | H | F | CHO | — | 0 |
| I-77 | F | H | H | F | C(═NOH)H | — | 0 |
| I-78 | F | H | H | F | C(═O)NHMe | — | 0 |
| I-79 | F | H | H | F | C(O)O⁻H₃N⁺i-Pr | — | 0 |
| I-80 | F | H | H | F | C(O)O⁻Li⁺ | — | 0 |
| I-81 | Cl | H | H | F | COOH | — | 0 |
| I-82 | Cl | H | H | F | COOMe | — | 0 |
| I-83 | Cl | H | H | F | COOEt | — | 0 |
| I-84 | Cl | H | H | F | COO-n-C₈H₁₇ | — | 0 |
| I-85 | Cl | H | H | F | CH₂OH | — | 0 |
| I-86 | Cl | H | H | F | CHO | — | 0 |
| I-87 | Cl | H | H | F | C(═NOH)H | — | 0 |
| I-88 | Cl | H | H | F | C(═O)NHMe | — | 0 |
| I-89 | Cl | H | H | F | C(O)O⁻H₃N⁺i-Pr | — | 0 |
| I-90 | Cl | H | H | F | C(O)O⁻Li⁺ | — | 0 |
| I-91 | H | H | H | I | COOH | — | 0 |
| I-92 | H | H | H | I | COOMe | — | 0 |
| I-93 | H | H | H | I | COOEt | — | 0 |
| I-94 | H | H | H | I | COO-n-C₈H₁₇ | — | 0 |
| I-95 | H | H | H | I | CH₂OH | — | 0 |
| I-96 | H | H | H | I | CHO | — | 0 |
| I-97 | H | H | H | I | C(═NOH)H | — | 0 |
| I-98 | H | H | H | I | C(═O)NHMe | — | 0 |
| I-99 | H | H | H | I | C(O)O⁻H₃N⁺i-Pr | — | 0 |
| I-100 | H | H | H | I | C(O)O⁻Li⁺ | — | 0 |
| I-101 | F | H | H | I | COOH | — | 0 |
| I-102 | F | H | H | I | COOMe | — | 0 |
| I-103 | F | H | H | I | COOEt | — | 0 |
| I-104 | F | H | H | I | COO-n-C₈H₁₇ | — | 0 |
| I-105 | F | H | H | I | CH₂OH | — | 0 |
| I-106 | F | H | H | I | CHO | — | 0 |
| I-107 | F | H | H | I | C(═NOH)H | — | 0 |
| I-108 | F | H | H | I | C(═O)NHMe | — | 0 |
| I-109 | F | H | H | I | C(O)O⁻H₃N⁺i-Pr | — | 0 |
| I-110 | F | H | H | I | C(O)O⁻Li⁺ | — | 0 |
| I-111 | Cl | H | H | I | COOH | — | 0 |
| I-112 | Cl | H | H | I | COOMe | — | 0 |
| I-113 | Cl | H | H | I | COOEt | — | 0 |
| I-114 | Cl | H | H | I | COO-n-C₈H₁₇ | — | 0 |
| I-115 | Cl | H | H | I | CH₂OH | — | 0 |
| I-116 | Cl | H | H | I | CHO | — | 0 |
| I-117 | Cl | H | H | I | C(═NOH)H | — | 0 |
| I-118 | Cl | H | H | I | C(═O)NHMe | — | 0 |
| I-119 | Cl | H | H | I | C(O)O⁻H₃N⁺i-Pr | — | 0 |
| I-120 | Cl | H | H | I | C(O)O⁻Li⁺ | — | 0 |

TABLE A.2
specific examples of the compounds of the formula (I)

| | |
|---|---|
| | (I) |
| 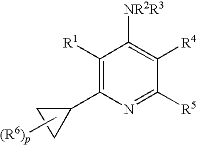 | |

| Compound | R¹ | R² | R³ | R⁴ | R⁵ | R⁶ | p |
|---|---|---|---|---|---|---|---|
| I-121 | H | H | H | Cl | COOMe | 2-Cl | 1 |
| I-122 | H | H | H | Cl | COOMe | 2,2-Cl | 2 |
| I-123 | H | H | H | Cl | COOMe | 2-F | 1 |
| I-124 | H | H | H | Cl | COOMe | 2,2-F | 2 |
| I-125 | H | H | H | Cl | COOMe | 1-Me | 1 |
| I-126 | H | H | H | Cl | COOMe | 2-Me | 1 |
| I-127 | H | H | H | Cl | COOMe | 2,2-Me | 2 |
| I-128 | F | H | H | Cl | COOMe | 2-Cl | 1 |
| I-129 | F | H | H | Cl | COOMe | 2,2-Cl | 2 |
| I-130 | F | H | H | Cl | COOMe | 2-F | 1 |
| I-131 | F | H | H | Cl | COOMe | 2,2-F | 2 |
| I-132 | F | H | H | Cl | COOMe | 1-Me | 1 |
| I-133 | F | H | H | Cl | COOMe | 2-Me | 1 |
| I-134 | F | H | H | Cl | COOMe | 2,2-Me | 2 |
| I-135 | Cl | H | H | Cl | COOMe | 2-Cl | 1 |
| I-136 | Cl | H | H | Cl | COOMe | 2,2-Cl | 2 |
| I-137 | Cl | H | H | Cl | COOMe | 2-F | 1 |
| I-138 | Cl | H | H | Cl | COOMe | 2,2-F | 2 |
| I-139 | Cl | H | H | Cl | COOMe | 1-Me | 1 |
| I-140 | Cl | H | H | Cl | COOMe | 2-Me | 1 |
| I-141 | Cl | H | H | Cl | COOMe | 2,2-Me | 2 |
| I-142 | H | H | H | Br | COOMe | 2-Cl | 1 |
| I-143 | H | H | H | Br | COOMe | 2,2-Cl | 2 |
| I-144 | H | H | H | Br | COOMe | 2-F | 1 |
| I-145 | H | H | H | Br | COOMe | 2,2-F | 2 |
| I-146 | H | H | H | Br | COOMe | 1-Me | 1 |
| I-147 | H | H | H | Br | COOMe | 2-Me | 1 |
| I-148 | H | H | H | Br | COOMe | 2,2-Me | 2 |
| I-149 | F | H | H | Br | COOMe | 2-Cl | 1 |
| I-150 | F | H | H | Br | COOMe | 2,2-Cl | 2 |
| I-151 | F | H | H | Br | COOMe | 2-F | 1 |
| I-152 | F | H | H | Br | COOMe | 2,2-F | 2 |
| I-153 | F | H | H | Br | COOMe | 1-Me | 1 |
| I-154 | F | H | H | Br | COOMe | 2-Me | 1 |
| I-155 | F | H | H | Br | COOMe | 2,2-Me | 2 |
| I-156 | Cl | H | H | Br | COOMe | 2-Cl | 1 |
| I-157 | Cl | H | H | Br | COOMe | 2,2-Cl | 2 |
| I-158 | Cl | H | H | Br | COOMe | 2-F | 1 |
| I-159 | Cl | H | H | Br | COOMe | 2,2-F | 2 |
| I-160 | Cl | H | H | Br | COOMe | 1-Me | 1 |
| I-161 | Cl | H | H | Br | COOMe | 2-Me | 1 |
| I-162 | Cl | H | H | Br | COOMe | 2,2-Me | 2 |
| I-163 | H | H | H | F | COOMe | 2-Cl | 1 |
| I-164 | H | H | H | F | COOMe | 2,2-Cl | 2 |
| I-165 | H | H | H | F | COOMe | 2-F | 1 |
| I-166 | H | H | H | F | COOMe | 2,2-F | 2 |
| I-167 | H | H | H | F | COOMe | 1-Me | 1 |
| I-168 | H | H | H | F | COOMe | 2-Me | 1 |
| I-169 | H | H | H | F | COOMe | 2,2-Me | 2 |
| I-170 | F | H | H | F | COOMe | 2-Cl | 1 |
| I-171 | F | H | H | F | COOMe | 2,2-Cl | 2 |
| I-172 | F | H | H | F | COOMe | 2-F | 1 |
| I-173 | F | H | H | F | COOMe | 2,2-F | 2 |
| I-174 | F | H | H | F | COOMe | 1-Me | 1 |
| I-175 | F | H | H | F | COOMe | 2-Me | 1 |
| I-176 | F | H | H | F | COOMe | 2,2-Me | 2 |
| I-177 | Cl | H | H | F | COOMe | 2-Cl | 1 |
| I-178 | Cl | H | H | F | COOMe | 2,2-Cl | 2 |
| I-179 | Cl | H | H | F | COOMe | 2-F | 1 |
| I-180 | Cl | H | H | F | COOMe | 2,2-F | 2 |
| I-181 | Cl | H | H | F | COOMe | 1-Me | 1 |
| I-182 | Cl | H | H | F | COOMe | 2-Me | 1 |
| I-183 | Cl | H | H | F | COOMe | 2,2-Me | 2 |
| I-184 | H | H | H | I | COOMe | 2-Cl | 1 |
| I-185 | H | H | H | I | COOMe | 2,2-Cl | 2 |
| I-186 | H | H | H | I | COOMe | 2-F | 1 |
| I-187 | H | H | H | I | COOMe | 2,2-F | 2 |
| I-188 | H | H | H | I | COOMe | 1-Me | 1 |
| I-189 | H | H | H | I | COOMe | 2-Me | 1 |
| I-190 | H | H | H | I | COOMe | 2,2-Me | 2 |
| I-191 | F | H | H | I | COOMe | 2-Cl | 1 |
| I-192 | F | H | H | I | COOMe | 2,2-Cl | 2 |
| I-193 | F | H | H | I | COOMe | 2-F | 1 |
| I-194 | F | H | H | I | COOMe | 2,2-F | 2 |
| I-195 | F | H | H | I | COOMe | 1-Me | 1 |
| I-196 | F | H | H | I | COOMe | 2-Me | 1 |
| I-197 | F | H | H | I | COOMe | 2,2-Me | 2 |
| I-198 | Cl | H | H | I | COOMe | 2-Cl | 1 |
| I-199 | Cl | H | H | I | COOMe | 2,2-Cl | 2 |
| I-200 | Cl | H | H | I | COOMe | 2-F | 1 |
| I-201 | Cl | H | H | I | COOMe | 2,2-F | 2 |
| I-202 | Cl | H | H | I | COOMe | 1-Me | 1 |
| I-203 | Cl | H | H | I | COOMe | 2-Me | 1 |
| I-204 | Cl | H | H | I | COOMe | 2,2-Me | 2 |

TABLE A.3
specific examples of the compounds of the formula (I)

| | |
|---|---|
| | (I) |
| 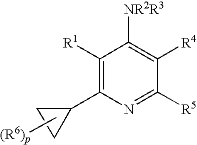 | |

| Compound | R¹ | R² | R³ | R⁴ | R⁵ | R⁶ | p |
|---|---|---|---|---|---|---|---|
| I-205 | H | Me | H | Cl | COOMe | — | 0 |
| I-206 | H | Me | Me | Cl | COOMe | — | 0 |
| I-207 | H | C(═O)Me | H | Cl | COOMe | — | 0 |
| I-208 | H | ═CHN(Me)₂ | | Cl | COOMe | — | 0 |
| I-209 | H | ═CHOMe | | Cl | COOMe | — | 0 |
| I-210 | F | Me | H | Cl | COOMe | — | 0 |
| I-211 | F | Me | Me | Cl | COOMe | — | 0 |
| I-212 | F | C(═O)Me | H | Cl | COOMe | — | 0 |
| I-213 | F | ═CHN(Me)₂ | | Cl | COOMe | — | 0 |
| I-214 | F | ═CHOMe | | Cl | COOMe | — | 0 |
| I-215 | Cl | Me | H | Cl | COOMe | — | 0 |
| I-216 | Cl | Me | Me | Cl | COOMe | — | 0 |
| I-217 | Cl | C(═O)Me | H | Cl | COOMe | — | 0 |
| I-218 | Cl | ═CHN(Me)₂ | | Cl | COOMe | — | 0 |
| I-219 | Cl | ═CHOMe | | Cl | COOMe | — | 0 |
| I-220 | H | Me | H | Br | COOMe | — | 0 |
| I-221 | H | Me | Me | Br | COOMe | — | 0 |
| I-222 | H | C(═O)Me | H | Br | COOMe | — | 0 |
| I-223 | H | ═CHN(Me)₂ | | Br | COOMe | — | 0 |
| I-224 | H | ═CHOMe | | Br | COOMe | — | 0 |
| I-225 | F | Me | H | Br | COOMe | — | 0 |
| I-226 | F | Me | Me | Br | COOMe | — | 0 |
| I-227 | F | C(═O)Me | H | Br | COOMe | — | 0 |
| I-228 | F | ═CHN(Me)₂ | | Br | COOMe | — | 0 |
| I-229 | F | ═CHOMe | | Br | COOMe | — | 0 |
| I-230 | Cl | Me | H | Br | COOMe | — | 0 |
| I-231 | Cl | Me | Me | Br | COOMe | — | 0 |
| I-232 | Cl | C(═O)Me | H | Br | COOMe | — | 0 |
| I-233 | Cl | ═CHN(Me)₂ | | Br | COOMe | — | 0 |
| I-234 | Cl | ═CHOMe | | Br | COOMe | — | 0 |
| I-235 | H | Me | H | F | COOMe | — | 0 |
| I-236 | H | Me | Me | F | COOMe | — | 0 |
| I-237 | H | C(═O)Me | H | F | COOMe | — | 0 |
| I-238 | H | ═CHN(Me)₂ | | F | COOMe | — | 0 |
| I-239 | H | ═CHOMe | | F | COOMe | — | 0 |
| I-240 | F | Me | H | F | COOMe | — | 0 |
| I-241 | F | Me | Me | F | COOMe | — | 0 |
| I-242 | F | C(═O)Me | H | F | COOMe | — | 0 |
| I-243 | F | ═CHN(Me)₂ | | F | COOMe | — | 0 |
| I-244 | F | ═CHOMe | | F | COOMe | — | 0 |
| I-245 | Cl | Me | H | F | COOMe | — | 0 |
| I-246 | Cl | Me | Me | F | COOMe | — | 0 |
| I-247 | Cl | C(═O)Me | H | F | COOMe | — | 0 |
| I-248 | Cl | ═CHN(Me)₂ | | F | COOMe | — | 0 |
| I-249 | Cl | ═CHOMe | | F | COOMe | — | 0 |
| I-250 | H | Me | H | I | COOMe | — | 0 |
| I-251 | H | Me | Me | I | COOMe | — | 0 |
| I-252 | H | C(═O)Me | H | I | COOMe | — | 0 |
| I-253 | H | ═CHN(Me)₂ | | I | COOMe | — | 0 |
| I-254 | H | ═CHOMe | | I | COOMe | — | 0 |
| I-255 | F | Me | H | I | COOMe | — | 0 |
| I-256 | F | Me | Me | I | COOMe | — | 0 |
| I-257 | F | C(═O)Me | H | I | COOMe | — | 0 |
| I-258 | F | ═CHN(Me)₂ | | I | COOMe | — | 0 |
| I-259 | F | ═CHOMe | | I | COOMe | — | 0 |
| I-260 | Cl | Me | H | I | COOMe | — | 0 |
| I-261 | Cl | Me | Me | I | COOMe | — | 0 |
| I-262 | Cl | C(═O)Me | H | I | COOMe | — | 0 |

| | | | | | | |
|---|---|---|---|---|---|---|
| I-263 | Cl | ═CHN(Me)₂ | I | COOMe | — | 0 |
| I-264 | Cl | ═CHOMe | I | COOMe | — | 0 |

The application rate of the herbicides of the formula (I) can vary within a wide range with the external conditions such as temperature, humidity, the type of herbicide used, for example between 0.001 g and 2000 g of a.i./ha (a.i./ha means hereinbelow “active substance per hectare”=based on 100% pure active ingredient).

In the case of applications at application rates of from 0.01 g to 1000 g of a.i./ha of the herbicides (A) of the formula (I), in the pre-emergence and post-emergence method, a relatively broad spectrum of harmful plants is controlled, e.g. annual and perennial monocotyledonous or dicotyledonous weeds and also of undesired crop plants. For the combinations according to the invention, the application rates are generally lower, e.g. in the range from 0.1 g to 800 g of a.i./ha, preferably 1 g to 500 g of a.i./ha, particularly preferably 10 g to 400 g of a.i./ha.

The herbicides of the formula (I) are suitable for controlling harmful plants, e.g. in plant crops, for example in economically important arable crops, e.g. monocotyledonous arable crops such as cereals (e.g. wheat, barley, rye, oats), rice, corn, millet, or dicotyledonous arable crops such as sugar beet, rapeseed, cotton, sunflowers and leguminous plants, for example of the genera Glycine (for example Glycine max. (soybean), such as non-transgenic Glycine max. (e.g. conventional cultivars such as STS cultivars) or transgenic Glycine max. (e.g. RR-soybean or LL-soybean) and hybrids thereof), Phaseolus, Pisum, Vicia and Arachis, or vegetable crops from various botanical groups, such as potato, leek, cabbage, carrot, tomato, onion, and also permanent crops and plantation crops such as pip and stone fruit, berry fruit, grapevine, Hevea, bananas, sugar cane, coffee, tea, citrus fruits, nut plantations, lawns, palm crops and forest plantations. For the application of the herbicide/safener combinations (A)+(B) according to the invention, these crops are likewise preferred, particular preference being given to the use in cereals (e.g. wheat, barley, rye, oats), rice, corn, millet, sugar beet, sugar cane, sunflowers, rapeseed and cotton. The herbicide/safener combinations (A)+(B) can also be used in tolerant and nontolerant mutant crops and tolerant and nontolerant transgenic crops, preferably of corn, rice, cereals, rapeseed and soybean, e.g. those which are resistant to imidazolinone herbicides, atrazine, glufosinate or glyphosate.

The compounds of the formula (I) are known from WO 2006/062979 A and can be obtained by the processes described therein.

### Safener (B):

The safeners present as component (B) are understood as meaning compounds which are suitable for reducing phytotoxic effects of crop protection composition active ingredients such as herbicides on crop plants.

Within the context of the present invention, the compounds of the formula (I) are combined with the following safener compounds:

S1) compounds from the group of heterocyclic carboxylic acid derivatives:
S1^{a}) compounds of the dichlorophenylpyrazoline-3-carboxylic acid type (S1^{a}), preferably compounds such as 1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr-diethyl”), and related compounds, as described in WO-A-91/07874;
S1^{b}) derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds, as described in EP-A-333 131 and EP-A-269 806;
S1^{c}) derivates of 1,5-diphenylpyrazole-3-carboxylic acid (S1^{c}), preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S1-6) and related compounds, as described, for example, in EP-A-268554;
S1^{d}) compounds of the triazolecarboxylic acid type (S1^{d}), preferably compounds such as fenchlorazole(-ethyl), i.e. ethyl 1-(2,4-dichloro-phenyl)-5-trichloromethyl-(1H)-1,2,4-triazole-3-carboxylate (S1-7), and related compounds, as described in EP-A-174 562 and EP-A-346 620;
S1^{e}) compounds of the 5-benzyl- or 5-phenyl-2-isoxazoline-3-carboxylic acid type, or of the 5,5-diphenyl-2-isoxazoline-3-carboxylic acid type (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds, as described in WO-A-91/08202, or 5,5-diphenyl-2-isoxazoline-carboxylic acid (S1-10) or ethyl 5,5-diphenyl-2-isoxazoline-carboxylate (S1-11) (“isoxadifen-ethyl”) or n-propyl 5,5-diphenyl-2-isoxazoline-carboxylate (S1-12) or of the ethyl 5-(4-fluorophenyl)-5-phenyl-2-isoxazoline-3-carboxylate type (S1-13), as described in the patent application WO-A-95/07897.
S2) Compounds from the group of the 8-quinolinyloxy derivates (S2):
S2^{a}) compounds of the 8-quinolinoxyacetic acid type (S2^{a}), preferably 1-methylhexyl(5-chloro-8-quinolinoxy)acetate (“cloquintocet-mexyl”) (S2-1), 1,3-dimethyl-but-1-yl(5-chloro-8-quinolinoxy)acetate (S2-2), 4-allyloxy butyl(5-chloro-8-quinolinoxy)acetate (S2-3), 1-allyloxyprop-2-yl(5-chloro-8-quinolinoxy)acetate (S2-4), ethyl(5-chloro-8-quinolinoxy)acetate (S2-5), methyl(5-chloro-8-quinolinoxy)acetate (S2-6), allyl(5-chloro-8-quinolinoxy)acetate (S2-7), 2-(2-propylideneiminoxy)-1-ethyl(5-chloro-8-quinolinoxy)acetate (S2-8), 2-oxo-prop-1-yl(5-chloro-8-quinolinoxy)acetate (S2-9) and related compounds, as described in EP-A-86 750, EP-A-94 349 and EP-A-191 736 or EP-A-0 492 366, and also (5-chloro-8-quinolinoxy)acetic acid (S2-10), its hydrates and salts, for example its lithium, sodium, potassium, calcium, magnesium, aluminum, iron, ammonium, quaternary ammonium, sulfonium or phosphonium salts, as described in WO-A-2002/34048;
S2^{b}) compounds of the (5-chloro-8-quinolinoxy)malonic acid type (S2^{b}), preferably compounds such as diethyl(5-chloro-8-quinolinoxy)malonate, diallyl(5-chloro-8-quinolinoxy)malonate, methyl ethyl(5-chloro-8-quinolinoxy)malonate and related compounds, as described in EP-A-0 582 198.
S3) Active ingredients of the dichloroacetamide type (S3), which are often used as pre-emergence safeners (soil-acting safeners), such as, for example,
   “dichlormid” (N,N-diallyl-2,2-dichloroacetamide) (S3-1),
   “R-29148” (3-dichloroacetyl-2,2,5-trimethyl-1,3-oxazolidine) from Stauffer (S3-2),
   “R-28725” (3-dichloroacetyl-2,2-dimethyl-1,3-oxazolidine) from Stauffer (S3-3),
   “benoxacor” (4-dichloroacetyl-3,4-dihydro-3-methyl-2H-1,4-benzoxazine) (S3-4),
   “PPG-1292” (N-allyl-N-[(1,3-dioxolan-2-yl)methyl]dichloroacetamide) from PPG Industries (S3-5),
   “DKA-24” (N-allyl-N-[(allylaminocarbonyl)methyl]dichloroacetamide) from Sagro-Chem (S3-6),
   “AD-67” or “MON 4660” (3-dichloroacetyl-1-oxa-3-azaspiro[4,5]decane) from Nitrokemia or Monsanto (S3-7),
   “TI-35” (1-dichloroacetylazepane) from TRI-Chemical RT (S3-8),
   “diclonon” (dicyclonone) (synonym: “BAS145138” or “LAB145138”) (RS)-1-dichloroacetyl-3,3,8a-trimethylperhydropyrrolo[1,2-a]pyrimidin-6-one from BASF (S3-9),
   “furilazole” or “MON 13900” ((RS)-3-dichloroacetyl-5-(2-furyl)-2,2-dimethyloxazolidine) (S3-10), and also its (R)-isomer (S3-11).
S4) Compounds from the class of acylsulfonamides (S4):
S4^{a}) N-acylsulfonamides of the formula (S4^{a}) and salts thereof, as described in WO-A-97/45016,

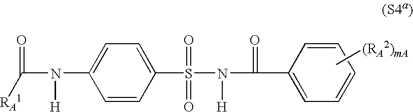

in which
R_{A}¹ is (C₁-C₆)alkyl, (C₃-C₆)cycloalkyl, where the 2 last-mentioned radicals are substituted by v_{A} substituents from the group consisting of halogen, (C₁-C₄)alkoxy, (C₁-C₆)haloalkoxy and (C₁-C₄)alkylthio and, in the case of cyclic radicals, also by (C₁-C₄)alkyl and (C₁-C₄)haloalkyl;
R_{A}² is halogen, (C₁-C₄)alkyl, (C₁-C₄)alkoxy, CF₃;
m_{A} is 1 or 2;
v_{A} is 0, 1, 2 or 3;
S4^{b}) compounds of the 4-(benzoylsulfamoyl)benzamide type of the formula (S4^{b}) and salts thereof, as described in WO-A-99/16744,

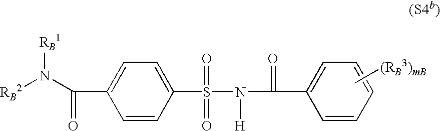

in which
R_{B}¹, R_{B}² independently of one another are hydrogen, (C₁-C₆)alkyl, (C₃-C₆)cycloalkyl, (C₃-C₆)alkenyl, (C₃-C₆)alkynyl,
R_{B}³ is halogen, (C₁-C₄)alkyl, (C₁-C₄)haloalkyl or (C₁-C₄)alkoxy and
m_{B} is 1 or 2,
e.g. those in which
R_{B}¹=cyclopropyl, R_{B}²=hydrogen and (R_{B}³)=2-OMe (S4-1, “cyprosulfamide”),
R_{B}¹=cyclopropyl, R_{B}²=hydrogen and (R_{B}³)=5-Cl-2-OMe (S4-2),
R_{B}¹=ethyl, R_{B}²=hydrogen and (R_{B}³)=2-OMe (S4-3),
R_{B}¹=isopropyl, R_{B}²=hydrogen and (R_{B}³)=5-Cl-2-OMe (S4-4) and
R_{B}¹=isopropyl, R_{B}²=hydrogen and (R_{B}³)=2-OMe (S4-5).
S4^{c}) Compounds from the benzoylsulfamoylphenylurea class of the formula (S4^{c}), as described in EP-A-365484

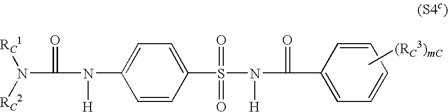

in which
R_{C}¹, R_{C}² independently of one another are hydrogen, (C₁-C₈)alkyl, (C₃-C₈)cycloalkyl, (C₃-C₆)alkenyl, (C₃-C₆)alkynyl,
R_{C}³ is halogen, (C₁-C₄)alkyl, (C₁-C₄)alkoxy, CF₃
m_{C} is 1 or 2;
for example
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea.
S5) Active ingredients from the class of hydroxyaromatics and the aromatic-aliphatic carboxylic acid derivatives (S5), e.g. ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicylic acid, 2-hydroxycinnamic acid, 2,4-dichlorocinnamic acid, as described in WO-A-2004/084631, WO-A-2005/015994, WO-A-2005/016001.
S6) Active ingredients from the class of 1,2-dihydroquinoxalin-2-ones (S6), e.g. 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydro-quinoxalin-2-one hydrochloride, 1-(2-methylsulfonylaminoethyl)-3-(2-thienyl)-1,2-dihydroquinoxalin-2-one, as described in WO-A-2005/112630.
S7) Compounds from the class of diphenylmethoxyacetic acid derivatives (S7), e.g. methyl diphenylmethoxyacetate (CAS Reg. No. 41858-19-9) (S7-1), ethyl diphenylmethoxyacetate or diphenylmethoxyacetic acid, as described in WO-A-98/38856.
S8) Compounds of the formula (S8), as described in WO-A-98/27049

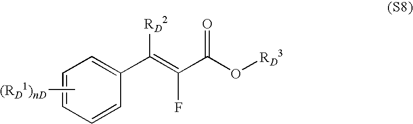

in which the symbols and the indices have the following meanings:
R_{D}¹ is halogen, (C₁-C₄)alkyl, (C₁-C₄)haloalkyl, (C₁-C₄)alkoxy, (C₁-C₄)haloalkoxy,
R_{D}² is hydrogen or (C₁-C₄)alkyl
R_{D}³ is hydrogen, (C₁-C₈)alkyl, (C₂-C₄)alkenyl, (C₂-C₄)alkynyl, or aryl, where each of the aforementioned C-containing radicals is unsubstituted or substituted by one or more, preferably up to three, identical or different radicals from the group consisting of halogen and alkoxy; or salts thereof
n_{D} is an integer from 0 to 2.
S9) Active ingredients from the class of 3-(5-tetrazolylcarbonyl)-2-quinolones (S9), e.g. 1,2-dihydro-4-hydroxy-1-ethyl-3-(5-tetrazolylcarbonyl)-2-quinolone (CAS Reg No.: 219479-18-2), 1,2-dihydro-4-hydroxy-1-methyl-3-(5-tetrazolyl-carbonyl)-2-quinolone (CAS Reg. No. 95855-00-8), as described in WO-A-1999/000020.
S10) Compounds of the formulae (S10^{a}) or (S10^{b}) as described in WO-A-2007/023719 and WO-A-2007/023764

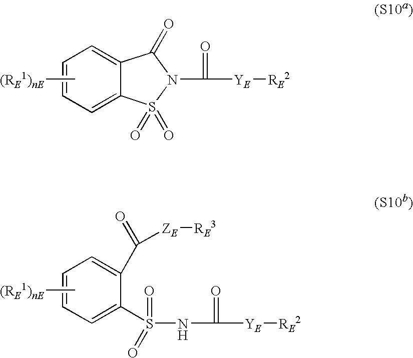

in which
R_{E}¹ is halogen, (C₁-C₄)alkyl, methoxy, nitro, cyano, CF₃, OCF₃
Y_{E}, Z_{E} independently of one another are O or S,
n_{E} is an integer from 0 to 4,
R_{E}² is (C₁-C₁₆)alkyl, (C₂-C₆)alkenyl, (C₃-C₆)cycloalkyl, aryl; benzyl, halobenzyl,
R_{E}³ is hydrogen or (C₁-C₆)alkyl.
S11) Active ingredients of the oxyimino compound type (S11), which are known as seed dressings, such as, for example,
   “oxabetrinil” ((Z)-1,3-dioxolan-2-ylmethoxyimino(phenyl)acetonitrile) (S11-1), which is known as seed dressing safener for millet against metolachlor damage,
   “fluxofenim” (1-(4-chlorophenyl)-2,2,2-trifluoro-1-ethanone O-(1,3-dioxolan-2-ylmethyl)oxim) (S11-2), which is known as seed dressing safener for millet against metolachlor damage, and
   “cyometrinil” or “CGA-43089” ((Z)-cyanomethoxyimino(phenyl)acetonitrile) (S11-3), which is known as seed dressing safener for millet against metolachlor damage.
S12) Active ingredients from the class of isothiochromanones (S12), such as, for example, methyl[(3-oxo-1H-2-benzothiopyran-4(3H)-ylidene)methoxy]acetate (CAS Reg. No. 205121-04-6) (S12-1) and related compounds from WO-A-1998/13361.
S13) One or more compounds from group (S13):
   “naphthalic anhydride” (1,8-naphthalenedicarboxylic anhydride) (S13-1), which is known as seed dressing safener for corn against thiocarbamate herbicide damage,
   “fenclorim” (4,6-dichloro-2-phenylpyrimidine) (S13-2), which is known as safener for pretilachlor in sown rice,
   “flurazole” (benzyl 2-chloro-4-trifluoromethyl-1,3-thiazole-5-carboxylate) (S13-3), which is known as seed dressing safener for millet against alachlor and metolachlor damage,
   “CL 304415” (CAS Reg. No. 31541-57-8) (4-carboxy-3,4-dihydro-2H-1-benzopyran-4-acetic acid) (S13-4) from American Cyanamid, which is known as safener for corn against imidazolinone damage,
   “MG 191” (CAS Reg. No. 96420-72-3) (2-dichloromethyl-2-methyl-1,3-dioxolane) (S13-5) from Nitrokemia, which is known as safener for corn,
   “MG-838” (CAS Reg. No. 133993-74-5) (2-propenyl 1-oxa-4-azaspiro[4.5]decane-4-carbodithioate) (S13-6) from Nitrokemia
   “disulfoton” (O,O-diethyl S-2-ethylthioethyl phosphorodithioate) (S13-7),
   “dietholate” (O,O-diethyl O-phenylphosphorothioate) (S13-8),
   “mephenate” (4-chlorophenyl methylcarbamate) (S13-9).
S14) Active ingredients which, besides a herbicidal effect against harmful plants, also have a safener effect on crop plants such as rice, such as, for example,
   “dimepiperate” or “MY-93” (S-1-methyl-1-phenylethyl piperidine-1-carbothioate), which is known as safener for rice against molinate herbicide damage,
   “daimuron” or “SK 23” (1-(1-methyl-1-phenylethyl)-3-p-tolylurea), which is known as safener for rice against imazosulfuron herbicide damage (S14-1),
   “cumyluron”=“JC-940” (3-(2-chlorophenyl methyl)-1-(1-methyl-1-phenylethyl)urea, see JP-A-60087254) which is known as safener for rice against some herbicide damage,
   “methoxyphenone” or “NK 049” (3,3′-dimethyl-4-methoxybenzophenone), which is known as safener for rice against some herbicide damage,
   “CSB” (1-bromo-4-(chloromethylsulfonyl)benzene) from Kumiai (CAS Reg. No. 54091-06-4), which is known as safener against some herbicide damage in rice.

The cited documents contain detailed information relating to preparation processes and starting materials and name preferred compounds. Reference is expressly made to these documents; they form part of this description by way of citation.

Examples of preferred combinations of herbicidal active ingredients (A) and safeners (B) are shown in the table below:

(I-1)+(S1-1); (I-1)+(S1-2); (I-1)+(S1-3); (I-1)+(S1-4); (I-1)+(S1-5); (I-1)+(S1-6); (I-1)+(S1-7); (I-1)+(S1-8); (I-1)+(S1-9); (I-1)+(S1-10); (I-1)+(S1-11); (I-1)+(S1-12); (I-1)+(S1-13); (I-1)+(S2-1); (I-1)+(S2-2); (I-1)+(S2-3); (I-1)+(S2-4); (I-1)+(S2-5); (I-1)+(S2-6); (I-1)+(S2-7); (I-1)+(S2-8); (I-1)+(S2-9); (I-1)+(S2-10); (I-1)+(S3-1); (I-1)+(S3-2); (I-1)+(S3-3); (I-1)+(S3-4); (I-1)+(S3-5); (I-1)+(S3-6); (I-1)+(S3-7); (I-1)+(S3-8); (I-1)+(S3-9); (I-1)+(S3-10); (I-1)+(S3-11); (I-1)+(S4-1); (I-1)+(S4-2); (I-1)+(S4-3); (I-1)+(S4-4); (I-1)+(S4-5); (I-1)+(S7-1); (I-1)+(S11-1); (I-1)+(S11-2); (I-1)+(S11-3); (I-1)+(S12-1); (I-1)+(S13-1); (I-1)+(S13-2); (I-1)+(S13-3); (I-1)+(S13-4): (I-1)+(S13-5); (I-1)+(S13-6); (I-1)+(S13-7); (I-1)+(S13-8); (I-1)+(S13-9); (I-1)+(S14-1)
(I-2)+(S1-1); (I-2)+(S1-2); (I-2)+(S1-3); (I-2)+(S1-4); (I-2)+(S1-5); (I-2)+(S1-6); (I-2)+(S1-7); (I-2)+(S1-8); (I-2)+(S1-9); (I-2)+(S1-10); (I-2)+(S1-11); (I-2)+(S1-12); (I-2)+(S1-13); (I-2)+(S2-1); (I-2)+(S2-2); (I-2)+(S2-3); (I-2)+(S2-4); (I-2)+(S2-5); (I-2)+(S2-6); (I-2)+(S2-7); (I-2)+(S2-8); (I-2)+(S2-9); (I-2)+(S2-10); (I-2)+(S3-1); (I-2)+(S3-2); (I-2)+(S3-3); (I-2)+(S3-4); (I-2)+(S3-5); (I-2)+(S3-6); (I-2)+(S3-7); (I-2)+(S3-8); (I-2)+(S3-9); (I-2)+(S3-10); (I-2)+(S3-11); (I-2)+(S4-1); (I-2)+(S4-2); (I-2)+(S4-3); (I-2)+(S4-4); (I-2)+(S4-5); (I-2)+(S7-1); (I-2)+(S11-1); (I-2)+(S11-2); (I-2)+(S11-3); (I-2)+(S12-1); (I-2)+(S13-1); (I-2)+(S13-2); (I-2)+(S13-3); (I-2)+(S13-4): (I-2)+(S13-5); (I-2)+(S13-6); (I-2)+(S13-7); (I-2)+(S13-8); (I-2)+(S13-9); (I-2)+(S14-1)
(I-3)+(S1-1); (I-3)+(S1-2); (I-3)+(S1-3); (I-3)+(S1-4); (I-3)+(S1-5); (I-3)+(S1-6); (I-3)+(S1-7); (I-3)+(S1-8); (I-3)+(S1-9); (I-3)+(S1-10); (I-3)+(S1-11); (I-3)+(S1-12); (I-3)+(S1-13); (I-3)+(S2-1); (I-3)+(S2-2); (I-3)+(S2-3); (I-3)+(S2-4); (I-3)+(S2-5); (I-3)+(S2-6); (I-3)+(S2-7); (I-3)+(S2-8); (I-3)+(S2-9); (I-3)+(S2-10); (I-3)+(S3-1); (I-3)+(S3-2); (I-3)+(S3-3); (I-3)+(S3-4); (I-3)+(S3-5); (I-3)+(S3-6); (I-3)+(S3-7); (I-3)+(S3-8); (I-3)+(S3-9); (I-3)+(S3-10); (I-3)+(S3-11); (I-3)+(S4-1); (I-3)+(S4-2); (I-3)+(S4-3); (I-3)+(S4-4); (I-3)+(S4-5); (I-3)+(S7-1); (I-3)+(S11-1); (I-3)+(S11-2); (I-3)+(S11-3); (I-3)+(S12-1); (I-3)+(S13-1); (I-3)+(S13-2); (I-3)+(S13-3); (I-3)+(S13-4): (I-3)+(S13-5); (I-3)+(S13-6); (I-3)+(S13-7); (I-3)+(S13-8); (I-3)+(S13-9); (I-3)+(S14-1)
(I-4)+(S1-1); (I-4)+(S1-2); (I-4)+(S1-3); (I-4)+(S1-4); (I-4)+(S1-5); (I-4)+(S1-6); (I-4)+(S1-7); (I-4)+(S1-8); (I-4)+(S1-9); (I-4)+(S1-10); (I-4)+(S1-11); (I-4)+(S1-12); (I-4)+(S1-13); (I-4)+(S2-1); (I-4)+(S2-2); (I-4)+(S2-3); (I-4)+(S2-4); (I-4)+(S2-5); (I-4)+(S2-6); (I-4)+(S2-7); (I-4)+(S2-8); (I-4)+(S2-9); (I-4)+(S2-10); (I-4)+(S3-1); (I-4)+(S3-2); (I-4)+(S3-3); (I-4)+(S3-4); (I-4)+(S3-5); (I-4)+(S3-6); (I-4)+(S3-7); (I-4)+(S3-8); (I-4)+(S3-9); (I-4)+(S3-10); (I-4)+(S3-11); (I-4)+(S4-1); (I-4)+(S4-2); (I-4)+(S4-3); (I-4)+(S4-4); (I-4)+(S4-5); (I-4)+(S7-1); (I-4)+(S11-1); (I-4)+(S11-2); (I-4)+(S11-3); (I-4)+(S12-1); (I-4)+(S13-1); (I-4)+(S13-2); (I-4)+(S13-3); (I-4)+(S13-4): (I-4)+(S13-5); (I-4)+(S13-6); (I-4)+(S13-7); (I-4)+(S13-8); (I-4)+(S13-9); (I-4)+(S14-1)
(I-5)+(S1-1); (I-5)+(S1-2); (I-5)+(S1-3); (I-5)+(S1-4); (I-5)+(S1-5); (I-5)+(S1-6); (I-5)+(S1-7); (I-5)+(S1-8); (I-5)+(S1-9); (I-5)+(S1-10); (I-5)+(S1-11); (I-5)+(S1-12); (I-5)+(S1-13); (I-5)+(S2-1); (I-5)+(S2-2); (I-5)+(S2-3); (I-5)+(S2-4); (I-5)+(S2-5); (I-5)+(S2-6); (I-5)+(S2-7); (I-5)+(S2-8); (I-5)+(S2-9); (I-5)+(S2-10); (I-5)+(S3-1); (I-5)+(S3-2); (I-5)+(S3-3); (I-5)+(S3-4); (I-5)+(S3-5); (I-5)+(S3-6); (I-5)+(S3-7); (I-5)+(S3-8); (I-5)+(S3-9); (I-5)+(S3-10); (I-5)+(S3-11); (I-5)+(S4-1); (I-5)+(S4-2); (I-5)+(S4-3); (I-5)+(S4-4); (I-5)+(S4-5); (I-5)+(S7-1); (I-5)+(S11-1); (I-5)+(S11-2); (I-5)+(S11-3); (I-5)+(S12-1); (I-5)+(S13-1); (I-5)+(S13-2); (I-5)+(S13-3); (I-5)+(S13-4): (I-5)+(S13-5); (I-5)+(S13-6); (I-5)+(S13-7); (I-5)+(S13-8); (I-5)+(S13-9); (I-5)+(S14-1)
(I-6)+(S1-1); (I-6)+(S1-2); (I-6)+(S1-3); (I-6)+(S1-4); (I-6)+(S1-5); (I-6)+(S1-6); (I-6)+(S1-7); (I-6)+(S1-8); (I-6)+(S1-9); (I-6)+(S1-10); (I-6)+(S1-11); (I-6)+(S1-12); (I-6)+(S1-13); (I-6)+(S2-1); (I-6)+(S2-2); (I-6)+(S2-3); (I-6)+(S2-4); (I-6)+(S2-5); (I-6)+(S2-6); (I-6)+(S2-7); (I-6)+(S2-8); (I-6)+(S2-9); (I-6)+(S2-10); (I-6)+(S3-1); (I-6)+(S3-2); (I-6)+(S3-3); (I-6)+(S3-4); (I-6)+(S3-5); (I-6)+(S3-6); (I-6)+(S3-7); (I-6)+(S3-8); (I-6)+(S3-9); (I-6)+(S3-10); (I-6)+(S3-11); (I-6)+(S4-1); (I-6)+(S4-2); (I-6)+(S4-3); (I-6)+(S4-4); (I-6)+(S4-5); (I-6)+(S7-1); (I-6)+(S11-1); (I-6)+(S11-2); (I-6)+(S11-3); (I-6)+(S12-1); (I-6)+(S13-1); (I-6)+(S13-2); (I-6)+(S13-3); (I-6)+(S13-4): (I-6)+(S13-5); (I-6)+(S13-6); (I-6)+(S13-7); (I-6)+(S13-8); (I-6)+(S13-9); (I-6)+(S14-1)
(I-7)+(S1-1); (I-7)+(S1-2); (I-7)+(S1-3); (I-7)+(S1-4); (I-7)+(S1-5); (I-7)+(S1-6); (I-7)+(S1-7); (I-7)+(S1-8); (I-7)+(S1-9); (I-7)+(S1-10); (I-7)+(S1-11); (I-7)+(S1-12); (I-7)+(S1-13); (I-7)+(S2-1); (I-7)+(S2-2); (I-7)+(S2-3); (I-7)+(S2-4); (I-7)+(S2-5); (I-7)+(S2-6); (I-7)+(S2-7); (I-7)+(S2-8); (I-7)+(S2-9); (I-7)+(S2-10); (I-7)+(S3-1); (I-7)+(S3-2); (I-7)+(S3-3); (I-7)+(S3-4); (I-7)+(S3-5); (I-7)+(S3-6); (I-7)+(S3-7); (I-7)+(S3-8); (I-7)+(S3-9); (I-7)+(S3-10); (I-7)+(S3-11); (I-7)+(S4-1); (I-7)+(S4-2); (I-7)+(S4-3); (I-7)+(S4-4); (I-7)+(S4-5); (I-7)+(S7-1); (I-7)+(S11-1); (I-7)+(S11-2); (I-7)+(S11-3); (I-7)+(S12-1); (I-7)+(S13-1); (I-7)+(S13-2); (I-7)+(S13-3); (I-7)+(S13-4): (I-7)+(S13-5); (I-7)+(S13-6); (I-7)+(S13-7); (I-7)+(S13-8); (I-7)+(S13-9); (I-7)+(S14-1)
(I-8)+(S1-1); (I-8)+(S1-2); (I-8)+(S1-3); (I-8)+(S1-4); (I-8)+(S1-5); (I-8)+(S1-6); (I-8)+(S1-7); (I-8)+(S1-8); (I-8)+(S1-9); (I-8)+(S1-10); (I-8)+(S1-11); (I-8)+(S1-12); (I-8)+(S1-13); (I-8)+(S2-1); (I-8)+(S2-2); (I-8)+(S2-3); (I-8)+(S2-4); (I-8)+(S2-5); (I-8)+(S2-6); (I-8)+(S2-7); (I-8)+(S2-8); (I-8)+(S2-9); (I-8)+(S2-10); (I-8)+(S3-1); (I-8)+(S3-2); (I-8)+(S3-3); (I-8)+(S3-4); (I-8)+(S3-5); (I-8)+(S3-6); (I-8)+(S3-7); (I-8)+(S3-8); (I-8)+(S3-9); (I-8)+(S3-10); (I-8)+(S3-11); (I-8)+(S4-1); (I-8)+(S4-2); (I-8)+(S4-3); (I-8)+(S4-4); (I-8)+(S4-5); (I-8)+(S7-1); (I-8)+(S11-1); (I-8)+(S11-2); (I-8)+(S11-3); (I-8)+(S12-1); (I-8)+(S13-1); (I-8)+(S13-2); (I-8)+(S13-3); (I-8)+(S13-4): (I-8)+(S13-5); (I-8)+(S13-6); (I-8)+(S13-7); (I-8)+(S13-8); (I-8)+(S13-9); (I-8)+(S14-1)
(I-9)+(S1-1); (I-9)+(S1-2); (I-9)+(S1-3); (I-9)+(S1-4); (I-9)+(S1-5); (I-9)+(S1-6); (I-9)+(S1-7); (I-9)+(S1-8); (I-9)+(S1-9); (I-9)+(S1-10); (I-9)+(S1-11); (I-9)+(S1-12); (I-9)+(S1-13); (I-9)+(S2-1); (I-9)+(S2-2); (I-9)+(S2-3); (I-9)+(S2-4); (I-9)+(S2-5); (I-9)+(S2-6); (I-9)+(S2-7); (I-9)+(S2-8); (I-9)+(S2-9); (I-9)+(S2-10); (I-9)+(S3-1); (I-9)+(S3-2); (I-9)+(S3-3); (I-9)+(S3-4); (I-9)+(S3-5); (I-9)+(S3-6); (I-9)+(S3-7); (I-9)+(S3-8); (I-9)+(S3-9); (I-9)+(S3-10); (I-9)+(S3-11); (I-9)+(S4-1); (I-9)+(S4-2); (I-9)+(S4-3); (I-9)+(S4-4); (I-9)+(S4-5); (I-9)+(S7-1); (I-9)+(S11-1); (I-9)+(S11-2); (I-9)+(S11-3); (I-9)+(S12-1); (I-9)+(S13-1); (I-9)+(S13-2); (I-9)+(S13-3); (I-9)+(S13-4): (I-9)+(S13-5); (I-9)+(S13-6); (I-9)+(S13-7); (I-9)+(S13-8); (I-9)+(S13-9); (I-9)+(S14-1)
(I-10)+(S1-1); (I-10)+(S1-2); (I-10)+(S1-3); (I-10)+(S1-4); (I-10)+(S1-5); (I-10)+(S1-6); (I-10)+(S1-7); (I-10)+(S1-8); (I-10)+(S1-9); (I-10)+(S1-10); (I-10)+(S1-11); (I-10)+(S1-12); (I-10)+(S1-13); (I-10)+(S2-1); (I-10)+(S2-2); (I-10)+(S2-3); (I-10)+(S2-4); (I-10)+(S2-5); (I-10)+(S2-6); (I-10)+(S2-7); (I-10)+(S2-8); (I-10)+(S2-9); (I-10)+(S2-10); (I-10)+(S3-1); (I-10)+(S3-2); (I-10)+(S3-3); (I-10)+(S3-4); (I-10)+(S3-5); (I-10)+(S3-6); (I-10)+(S3-7); (I-10)+(S3-8); (I-10)+(S3-9); (I-10)+(S3-10); (I-10)+(S3-11); (I-10)+(S4-1); (I-10)+(S4-2); (I-10)+(S4-3); (I-10)+(S4-4); (I-10)+(S4-5); (I-10)+(S7-1); (I-10)+(S11-1); (I-10)+(S11-2); (I-10)+(S11-3); (I-10)+(S12-1); (I-10)+(S13-1); (I-10)+(S13-2); (I-10)+(S13-3); (I-10)+(S13-4): (I-10)+(S13-5); (I-10)+(S13-6); (I-10)+(S13-7); (I-10)+(S13-8); (I-10)+(S13-9); (I-10)+(S14-1)
(I-11)+(S1-1); (I-11)+(S1-2); (I-11)+(S1-3); (I-11)+(S1-4); (I-11)+(S1-5); (I-11)+(S1-6); (I-11)+(S1-7); (I-11)+(S1-8); (I-11)+(S1-9); (I-11)+(S1-10); (I-11)+(S1-11); (I-11)+(S1-12); (I-11)+(S1-13); (I-11)+(S2-1); (I-11)+(S2-2); (I-11)+(S2-3); (I-11)+(S2-4); (I-11)+(S2-5); (I-11)+(S2-6); (I-11)+(S2-7); (I-11)+(S2-8); (I-11)+(S2-9); (I-11)+(S2-10); (I-11)+(S3-1); (I-11)+(S3-2); (I-11)+(S3-3); (I-11)+(S3-4); (I-11)+(S3-5); (I-11)+(S3-6); (I-11)+(S3-7); (I-11)+(S3-8); (I-11)+(S3-9); (I-11)+(S3-10); (I-11)+(S3-11); (I-11)+(S4-1); (I-11)+(S4-2); (I-11)+(S4-3); (I-11)+(S4-4); (I-11)+(S4-5); (I-11)+(S7-1); (I-11)+(S11-1); (I-11)+(S11-2); (I-11)+(S11-3); (I-11)+(S12-1); (I-11)+(S13-1); (I-11)+(S13-2); (I-11)+(S13-3); (I-11)+(S13-4): (I-11)+(S13-5); (I-11)+(S13-6); (I-11)+(S13-7); (I-11)+(S13-8); (I-11)+(S13-9); (I-11)+(S14-1)
(I-12)+(S1-1); (I-12)+(S1-2); (I-12)+(S1-3); (I-12)+(S1-4); (I-12)+(S1-5); (I-12)+(S1-6); (I-12)+(S1-7); (I-12)+(S1-8); (I-12)+(S1-9); (I-12)+(S1-10); (I-12)+(S1-11); (I-12)+(S1-12); (I-12)+(S1-13); (I-12)+(S2-1); (I-12)+(S2-2); (I-12)+(S2-3); (I-12)+(S2-4); (I-12)+(S2-5); (I-12)+(S2-6); (I-12)+(S2-7); (I-12)+(S2-8); (I-12)+(S2-9); (I-12)+(S2-10); (I-12)+(S3-1); (I-12)+(S3-2); (I-12)+(S3-3); (I-12)+(S3-4); (I-12)+(S3-5); (I-12)+(S3-6); (I-12)+(S3-7); (I-12)+(S3-8); (I-12)+(S3-9); (I-12)+(S3-10); (I-12)+(S3-11); (I-12)+(S4-1); (I-12)+(S4-2); (I-12)+(S4-3); (I-12)+(S4-4); (I-12)+(S4-5); (I-12)+(S7-1); (I-12)+(S11-1); (I-12)+(S11-2); (I-12)+(S11-3); (I-12)+(S12-1); (I-12)+(S13-1); (I-12)+(S13-2); (I-12)+(S13-3); (I-12)+(S13-4): (I-12)+(S13-5); (I-12)+(S13-6); (I-12)+(S13-7); (I-12)+(S13-8); (I-12)+(S13-9); (I-12)+(S14-1)
(I-13)+(S1-1); (I-13)+(S1-2); (I-13)+(S1-3); (I-13)+(S1-4); (I-13)+(S1-5); (I-13)+(S1-6); (I-13)+(S1-7); (I-13)+(S1-8); (I-13)+(S1-9); (I-13)+(S1-10); (I-13)+(S1-11); (I-13)+(S1-12); (I-13)+(S1-13); (I-13)+(S2-1); (I-13)+(S2-2); (I-13)+(S2-3); (I-13)+(S2-4); (I-13)+(S2-5); (I-13)+(S2-6); (I-13)+(S2-7); (I-13)+(S2-8); (I-13)+(S2-9); (I-13)+(S2-10); (I-13)+(S3-1); (I-13)+(S3-2); (I-13)+(S3-3); (I-13)+(S3-4); (I-13)+(S3-5); (I-13)+(S3-6); (I-13)+(S3-7); (I-13)+(S3-8); (I-13)+(S3-9); (I-13)+(S3-10); (I-13)+(S3-11); (I-13)+(S4-1); (I-13)+(S4-2); (I-13)+(S4-3); (I-13)+(S4-4); (I-13)+(S4-5); (I-13)+(S7-1); (I-13)+(S11-1); (I-13)+(S11-2); (I-13)+(S11-3); (I-13)+(S12-1); (I-13)+(S13-1); (I-13)+(S13-2); (I-13)+(S13-3); (I-13)+(S13-4): (I-13)+(S13-5); (I-13)+(S13-6); (I-13)+(S13-7); (I-13)+(S13-8); (I-13)+(S13-9); (I-13)+(S14-1)
(I-14)+(S1-1); (I-14)+(S1-2); (I-14)+(S1-3); (I-14)+(S1-4); (I-14)+(S1-5); (I-14)+(S1-6); (I-14)+(S1-7); (I-14)+(S1-8); (I-14)+(S1-9); (I-14)+(S1-10); (I-14)+(S1-11); (I-14)+(S1-12); (I-14)+(S1-13); (I-14)+(S2-1); (I-14)+(S2-2); (I-14)+(S2-3); (I-14)+(S2-4); (I-14)+(S2-5); (I-14)+(S2-6); (I-14)+(S2-7); (I-14)+(S2-8); (I-14)+(S2-9); (I-14)+(S2-10); (I-14)+(S3-1); (I-14)+(S3-2); (I-14)+(S3-3); (I-14)+(S3-4); (I-14)+(S3-5); (I-14)+(S3-6); (I-14)+(S3-7); (I-14)+(S3-8); (I-14)+(S3-9); (I-14)+(S3-10); (I-14)+(S3-11); (I-14)+(S4-1); (I-14)+(S4-2); (I-14)+(S4-3); (I-14)+(S4-4); (I-14)+(S4-5); (I-14)+(S7-1); (I-14)+(S11-1); (I-14)+(S11-2); (I-14)+(S11-3); (I-14)+(S12-1); (I-14)+(S13-1); (I-14)+(S13-2); (I-14)+(S13-3); (I-14)+(S13-4): (I-14)+(S13-5); (I-14)+(S13-6); (I-14)+(S13-7); (I-14)+(S13-8); (I-14)+(S13-9); (I-14)+(S14-1)
(I-15)+(S1-1); (I-15)+(S1-2); (I-15)+(S1-3); (I-15)+(S1-4); (I-15)+(S1-5); (I-15)+(S1-6); (I-15)+(S1-7); (I-15)+(S1-8); (I-15)+(S1-9); (I-15)+(S1-10); (I-15)+(S1-11); (I-15)+(S1-12); (I-15)+(S1-13); (I-15)+(S2-1); (I-15)+(S2-2); (I-15)+(S2-3); (I-15)+(S2-4); (I-15)+(S2-5); (I-15)+(S2-6); (I-15)+(S2-7); (I-15)+(S2-8); (I-15)+(S2-9); (I-15)+(S2-10); (I-15)+(S3-1); (I-15)+(S3-2); (I-15)+(S3-3); (I-15)+(S3-4); (I-15)+(S3-5); (I-15)+(S3-6); (I-15)+(S3-7); (I-15)+(S3-8); (I-15)+(S3-9); (I-15)+(S3-10); (I-15)+(S3-11); (I-15)+(S4-1); (I-15)+(S4-2); (I-15)+(S4-3); (I-15)+(S4-4); (I-15)+(S4-5); (I-15)+(S7-1); (I-15)+(S11-1); (I-15)+(S11-2); (I-15)+(S11-3); (I-15)+(S12-1); (I-15)+(S13-1); (I-15)+(S13-2); (I-15)+(S13-3); (I-15)+(S13-4): (I-15)+(S13-5); (I-15)+(S13-6); (I-15)+(S13-7); (I-15)+(S13-8); (I-15)+(S13-9); (I-15)+(S14-1)
(I-16)+(S1-1); (I-16)+(S1-2); (I-16)+(S1-3); (I-16)+(S1-4); (I-16)+(S1-5); (I-16)+(S1-6); (I-16)+(S1-7); (I-16)+(S1-8); (I-16)+(S1-9); (I-16)+(S1-10); (I-16)+(S1-11); (I-16)+(S1-12); (I-16)+(S1-13); (I-16)+(S2-1); (I-16)+(S2-2); (I-16)+(S2-3); (I-16)+(S2-4); (I-16)+(S2-5); (I-16)+(S2-6); (I-16)+(S2-7); (I-16)+(S2-8); (I-16)+(S2-9); (I-16)+(S2-10); (I-16)+(S3-1); (I-16)+(S3-2); (I-16)+(S3-3); (I-16)+(S3-4); (I-16)+(S3-5); (I-16)+(S3-6); (I-16)+(S3-7); (I-16)+(S3-8); (I-16)+(S3-9); (I-16)+(S3-10); (I-16)+(S3-11); (I-16)+(S4-1); (I-16)+(S4-2); (I-16)+(S4-3); (I-16)+(S4-4); (I-16)+(S4-5); (I-16)+(S7-1); (I-16)+(S11-1); (I-16)+(S11-2); (I-16)+(S11-3); (I-16)+(S12-1); (I-16)+(S13-1); (I-16)+(S13-2); (I-16)+(S13-3); (I-16)+(S13-4): (I-16)+(S13-5); (I-16)+(S13-6); (I-16)+(S13-7); (I-16)+(S13-8); (I-16)+(S13-9); (I-16)+(S14-1)
(I-17)+(S1-1); (I-17)+(S1-2); (I-17)+(S1-3); (I-17)+(S1-4); (I-17)+(S1-5); (I-17)+(S1-6); (I-17)+(S1-7); (I-17)+(S1-8); (I-17)+(S1-9); (I-17)+(S1-10); (I-17)+(S1-11); (I-17)+(S1-12); (I-17)+(S1-13); (I-17)+(S2-1); (I-17)+(S2-2); (I-17)+(S2-3); (I-17)+(S2-4); (I-17)+(S2-5); (I-17)+(S2-6); (I-17)+(S2-7); (I-17)+(S2-8); (I-17)+(S2-9); (I-17)+(S2-10); (I-17)+(S3-1); (I-17)+(S3-2); (I-17)+(S3-3); (I-17)+(S3-4); (I-17)+(S3-5); (I-17)+(S3-6); (I-17)+(S3-7); (I-17)+(S3-8); (I-17)+(S3-9); (I-17)+(S3-10); (I-17)+(S3-11); (I-17)+(S4-1); (I-17)+(S4-2); (I-17)+(S4-3); (I-17)+(S4-4); (I-17)+(S4-5); (I-17)+(S7-1); (I-17)+(S11-1); (I-17)+(S11-2); (I-17)+(S11-3); (I-17)+(S12-1); (I-17)+(S13-1); (I-17)+(S13-2); (I-17)+(S13-3); (I-17)+(S13-4): (I-17)+(S13-5); (I-17)+(S13-6); (I-17)+(S13-7); (I-17)+(S13-8); (I-17)+(S13-9); (I-17)+(S14-1)
(I-18)+(S1-1); (I-18)+(S1-2); (I-18)+(S1-3); (I-18)+(S1-4); (I-18)+(S1-5); (I-18)+(S1-6); (I-18)+(S1-7); (I-18)+(S1-8); (I-18)+(S1-9); (I-18)+(S1-10); (I-18)+(S1-11); (I-18)+(S1-12); (I-18)+(S1-13); (I-18)+(S2-1); (I-18)+(S2-2); (I-18)+(S2-3); (I-18)+(S2-4); (I-18)+(S2-5); (I-18)+(S2-6); (I-18)+(S2-7); (I-18)+(S2-8); (I-18)+(S2-9); (I-18)+(S2-10); (I-18)+(S3-1); (I-18)+(S3-2); (I-18)+(S3-3); (I-18)+(S3-4); (I-18)+(S3-5); (I-18)+(S3-6); (I-18)+(S3-7); (I-18)+(S3-8); (I-18)+(S3-9); (I-18)+(S3-10); (I-18)+(S3-11); (I-18)+(S4-1); (I-18)+(S4-2); (I-18)+(S4-3); (I-18)+(S4-4); (I-18)+(S4-5); (I-18)+(S7-1); (I-18)+(S11-1); (I-18)+(S11-2); (I-18)+(S11-3); (I-18)+(S12-1); (I-18)+(S13-1); (I-18)+(S13-2); (I-18)+(S13-3); (I-18)+(S13-4): (I-18)+(S13-5); (I-18)+(S13-6); (I-18)+(S13-7); (I-18)+(S13-8); (I-18)+(S13-9); (I-18)+(S14-1)
(I-19)+(S1-1); (I-19)+(S1-2); (I-19)+(S1-3); (I-19)+(S1-4); (I-19)+(S1-5); (I-19)+(S1-6); (I-19)+(S1-7); (I-19)+(S1-8); (I-19)+(S1-9); (I-19)+(S1-10); (I-19)+(S1-11); (I-19)+(S1-12); (I-19)+(S1-13); (I-19)+(S2-1); (I-19)+(S2-2); (I-19)+(S2-3); (I-19)+(S2-4); (I-19)+(S2-5); (I-19)+(S2-6); (I-19)+(S2-7); (I-19)+(S2-8); (I-19)+(S2-9); (I-19)+(S2-10); (I-19)+(S3-1); (I-19)+(S3-2); (I-19)+(S3-3); (I-19)+(S3-4); (I-19)+(S3-5); (I-19)+(S3-6); (I-19)+(S3-7); (I-19)+(S3-8); (I-19)+(S3-9); (I-19)+(S3-10); (I-19)+(S3-11); (I-19)+(S4-1); (I-19)+(S4-2); (I-19)+(S4-3); (I-19)+(S4-4); (I-19)+(S4-5); (I-19)+(S7-1); (I-19)+(S11-1); (I-19)+(S11-2); (I-19)+(S11-3); (I-19)+(S12-1); (I-19)+(S13-1); (I-19)+(S13-2); (I-19)+(S13-3); (I-19)+(S13-4): (I-19)+(S13-5); (I-19)+(S13-6); (I-19)+(S13-7); (I-19)+(S13-8); (I-19)+(S13-9); (I-19)+(S14-1)
(I-20)+(S1-1); (I-20)+(S1-2); (I-20)+(S1-3); (I-20)+(S1-4); (I-20)+(S1-5); (I-20)+(S1-6); (I-20)+(S1-7); (I-20)+(S1-8); (I-20)+(S1-9); (I-20)+(S1-10); (I-20)+(S1-11); (I-20)+(S1-12); (I-20)+(S1-13); (I-20)+(S2-1); (I-20)+(S2-2); (I-20)+(S2-3); (I-20)+(S2-4); (I-20)+(S2-5); (I-20)+(S2-6); (I-20)+(S2-7); (I-20)+(S2-8); (I-20)+(S2-9); (I-20)+(S2-10); (I-20)+(S3-1); (I-20)+(S3-2); (I-20)+(S3-3); (I-20)+(S3-4); (I-20)+(S3-5); (I-20)+(S3-6); (I-20)+(S3-7); (I-20)+(S3-8); (I-20)+(S3-9); (I-20)+(S3-10); (I-20)+(S3-11); (I-20)+(S4-1); (I-20)+(S4-2); (I-20)+(S4-3); (I-20)+(S4-4); (I-20)+(S4-5); (I-20)+(S7-1); (I-20)+(S11-1); (I-20)+(S11-2); (I-20)+(S11-3); (I-20)+(S12-1); (I-20)+(S13-1); (I-20)+(S13-2); (I-20)+(S13-3); (I-20)+(S13-4): (I-20)+(S13-5); (I-20)+(S13-6); (I-20)+(S13-7); (I-20)+(S13-8); (I-20)+(S13-9); (I-20)+(S14-1)
(I-21)+(S1-1); (I-21)+(S1-2); (I-21)+(S1-3); (I-21)+(S1-4); (I-21)+(S1-5); (I-21)+(S1-6); (I-21)+(S1-7); (I-21)+(S1-8); (I-21)+(S1-9); (I-21)+(S1-10); (I-21)+(S1-11); (I-21)+(S1-12); (I-21)+(S1-13); (I-21)+(S2-1); (I-21)+(S2-2); (I-21)+(S2-3); (I-21)+(S2-4); (I-21)+(S2-5); (I-21)+(S2-6); (I-21)+(S2-7); (I-21)+(S2-8); (I-21)+(S2-9); (I-21)+(S2-10); (I-21)+(S3-1); (I-21)+(S3-2); (I-21)+(S3-3); (I-21)+(S3-4); (I-21)+(S3-5); (I-21)+(S3-6); (I-21)+(S3-7); (I-21)+(S3-8); (I-21)+(S3-9); (I-21)+(S3-10); (I-21)+(S3-11); (I-21)+(S4-1); (I-21)+(S4-2); (I-21)+(S4-3); (I-21)+(S4-4); (I-21)+(S4-5); (I-21)+(S7-1); (I-21)+(S11-1); (I-21)+(S11-2); (I-21)+(S11-3); (I-21)+(S12-1); (I-21)+(S13-1); (I-21)+(S13-2); (I-21)+(S13-3); (I-21)+(S13-4): (I-21)+(S13-5); (I-21)+(S13-6); (I-21)+(S13-7); (I-21)+(S13-8); (I-21)+(S13-9); (I-21)+(S14-1)
(I-22)+(S1-1); (I-22)+(S1-2); (I-22)+(S1-3); (I-22)+(S1-4); (I-22)+(S1-5); (I-22)+(S1-6); (I-22)+(S1-7); (I-22)+(S1-8); (I-22)+(S1-9); (I-22)+(S1-10); (I-22)+(S1-11); (I-22)+(S1-12); (I-22)+(S1-13); (I-22)+(S2-1); (I-22)+(S2-2); (I-22)+(S2-3); (I-22)+(S2-4); (I-22)+(S2-5); (I-22)+(S2-6); (I-22)+(S2-7); (I-22)+(S2-8); (I-22)+(S2-9); (I-22)+(S2-10); (I-22)+(S3-1); (I-22)+(S3-2); (I-22)+(S3-3); (I-22)+(S3-4); (I-22)+(S3-5); (I-22)+(S3-6); (I-22)+(S3-7); (I-22)+(S3-8); (I-22)+(S3-9); (I-22)+(S3-10); (I-22)+(S3-11); (I-22)+(S4-1); (I-22)+(S4-2); (I-22)+(S4-3); (I-22)+(S4-4); (I-22)+(S4-5); (I-22)+(S7-1); (I-22)+(S11-1); (I-22)+(S11-2); (I-22)+(S11-3); (I-22)+(S12-1); (I-22)+(S13-1); (I-22)+(S13-2); (I-22)+(S13-3); (I-22)+(S13-4): (I-22)+(S13-5); (I-22)+(S13-6); (I-22)+(S13-7); (I-22)+(S13-8); (I-22)+(S13-9); (I-22)+(S14-1)
(I-23)+(S1-1); (I-23)+(S1-2); (I-23)+(S1-3); (I-23)+(S1-4); (I-23)+(S1-5); (I-23)+(S1-6); (I-23)+(S1-7); (I-23)+(S1-8); (I-23)+(S1-9); (I-23)+(S1-10); (I-23)+(S1-11); (I-23)+(S1-12); (I-23)+(S1-13); (I-23)+(S2-1); (I-23)+(S2-2); (I-23)+(S2-3); (I-23)+(S2-4); (I-23)+(S2-5); (I-23)+(S2-6); (I-23)+(S2-7); (I-23)+(S2-8); (I-23)+(S2-9); (I-23)+(S2-10); (I-23)+(S3-1); (I-23)+(S3-2); (I-23)+(S3-3); (I-23)+(S3-4); (I-23)+(S3-5); (I-23)+(S3-6); (I-23)+(S3-7); (I-23)+(S3-8); (I-23)+(S3-9); (I-23)+(S3-10); (I-23)+(S3-11); (I-23)+(S4-1); (I-23)+(S4-2); (I-23)+(S4-3); (I-23)+(S4-4); (I-23)+(S4-5); (I-23)+(S7-1); (I-23)+(S11-1); (I-23)+(S11-2); (I-23)+(S11-3); (I-23)+(S12-1); (I-23)+(S13-1); (I-23)+(S13-2); (I-23)+(S13-3); (I-23)+(S13-4): (I-23)+(S13-5); (I-23)+(S13-6); (I-23)+(S13-7); (I-23)+(S13-8); (I-23)+(S13-9); (I-23)+(S14-1)
(I-24)+(S1-1); (I-24)+(S1-2); (I-24)+(S1-3); (I-24)+(S1-4); (I-24)+(S1-5); (I-24)+(S1-6); (I-24)+(S1-7); (I-24)+(S1-8); (I-24)+(S1-9); (I-24)+(S1-10); (I-24)+(S1-11); (I-24)+(S1-12); (I-24)+(S1-13); (I-24)+(S2-1); (I-24)+(S2-2); (I-24)+(S2-3); (I-24)+(S2-4); (I-24)+(S2-5); (I-24)+(S2-6); (I-24)+(S2-7); (I-24)+(S2-8); (I-24)+(S2-9); (I-24)+(S2-10); (I-24)+(S3-1); (I-24)+(S3-2); (I-24)+(S3-3); (I-24)+(S3-4); (I-24)+(S3-5); (I-24)+(S3-6); (I-24)+(S3-7); (I-24)+(S3-8); (I-24)+(S3-9); (I-24)+(S3-10); (I-24)+(S3-11); (I-24)+(S4-1); (I-24)+(S4-2); (I-24)+(S4-3); (I-24)+(S4-4); (I-24)+(S4-5); (I-24)+(S7-1); (I-24)+(S11-1); (I-24)+(S11-2); (I-24)+(S11-3); (I-24)+(S12-1); (I-24)+(S13-1); (I-24)+(S13-2); (I-24)+(S13-3); (I-24)+(S13-4): (I-24)+(S13-5); (I-24)+(S13-6); (I-24)+(S13-7); (I-24)+(S13-8); (I-24)+(S13-9); (I-24)+(S14-1)
(I-25)+(S1-1); (I-25)+(S1-2); (I-25)+(S1-3); (I-25)+(S1-4); (I-25)+(S1-5); (I-25)+(S1-6); (I-25)+(S1-7); (I-25)+(S1-8); (I-25)+(S1-9); (I-25)+(S1-10); (I-25)+(S1-11); (I-25)+(S1-12); (I-25)+(S1-13); (I-25)+(S2-1); (I-25)+(S2-2); (I-25)+(S2-3); (I-25)+(S2-4); (I-25)+(S2-5); (I-25)+(S2-6); (I-25)+(S2-7); (I-25)+(S2-8); (I-25)+(S2-9); (I-25)+(S2-10); (I-25)+(S3-1); (I-25)+(S3-2); (I-25)+(S3-3); (I-25)+(S3-4); (I-25)+(S3-5); (I-25)+(S3-6); (I-25)+(S3-7); (I-25)+(S3-8); (I-25)+(S3-9); (I-25)+(S3-10); (I-25)+(S3-11); (I-25)+(S4-1); (I-25)+(S4-2); (I-25)+(S4-3); (I-25)+(S4-4); (I-25)+(S4-5); (I-25)+(S7-1); (I-25)+(S11-1); (I-25)+(S11-2); (I-25)+(S11-3); (I-25)+(S12-1); (I-25)+(S13-1); (I-25)+(S13-2); (I-25)+(S13-3); (I-25)+(S13-4): (I-25)+(S13-5); (I-25)+(S13-6); (I-25)+(S13-7); (I-25)+(S13-8); (I-25)+(S13-9); (I-25)+(S14-1)
(I-26)+(S1-1); (I-26)+(S1-2); (I-26)+(S1-3); (I-26)+(S1-4); (I-26)+(S1-5); (I-26)+(S1-6); (I-26)+(S1-7); (I-26)+(S1-8); (I-26)+(S1-9); (I-26)+(S1-10); (I-26)+(S1-11); (I-26)+(S1-12); (I-26)+(S1-13); (I-26)+(S2-1); (I-26)+(S2-2); (I-26)+(S2-3); (I-26)+(S2-4); (I-26)+(S2-5); (I-26)+(S2-6); (I-26)+(S2-7); (I-26)+(S2-8); (I-26)+(S2-9); (I-26)+(S2-10); (I-26)+(S3-1); (I-26)+(S3-2); (I-26)+(S3-3); (I-26)+(S3-4); (I-26)+(S3-5); (I-26)+(S3-6); (I-26)+(S3-7); (I-26)+(S3-8); (I-26)+(S3-9); (I-26)+(S3-10); (I-26)+(S3-11); (I-26)+(S4-1); (I-26)+(S4-2); (I-26)+(S4-3); (I-26)+(S4-4); (I-26)+(S4-5); (I-26)+(S7-1); (I-26)+(S11-1); (I-26)+(S11-2); (I-26)+(S11-3); (I-26)+(S12-1); (I-26)+(S13-1); (I-26)+(S13-2); (I-26)+(S13-3); (I-26)+(S13-4): (I-26)+(S13-5); (I-26)+(S13-6); (I-26)+(S13-7); (I-26)+(S13-8); (I-26)+(S13-9); (I-26)+(S14-1)
(I-27)+(S1-1); (I-27)+(S1-2); (I-27)+(S1-3); (I-27)+(S1-4); (I-27)+(S1-5); (I-27)+(S1-6); (I-27)+(S1-7); (I-27)+(S1-8); (I-27)+(S1-9); (I-27)+(S1-10); (I-27)+(S1-11); (I-27)+(S1-12); (I-27)+(S1-13); (I-27)+(S2-1); (I-27)+(S2-2); (I-27)+(S2-3); (I-27)+(S2-4); (I-27)+(S2-5); (I-27)+(S2-6); (I-27)+(S2-7); (I-27)+(S2-8); (I-27)+(S2-9); (I-27)+(S2-10); (I-27)+(S3-1); (I-27)+(S3-2); (I-27)+(S3-3); (I-27)+(S3-4); (I-27)+(S3-5); (I-27)+(S3-6); (I-27)+(S3-7); (I-27)+(S3-8); (I-27)+(S3-9); (I-27)+(S3-10); (I-27)+(S3-11); (I-27)+(S4-1); (I-27)+(S4-2); (I-27)+(S4-3); (I-27)+(S4-4); (I-27)+(S4-5); (I-27)+(S7-1); (I-27)+(S11-1); (I-27)+(S11-2); (I-27)+(S11-3); (I-27)+(S12-1); (I-27)+(S13-1); (I-27)+(S13-2); (I-27)+(S13-3); (I-27)+(S13-4): (I-27)+(S13-5); (I-27)+(S13-6); (I-27)+(S13-7); (I-27)+(S13-8); (I-27)+(S13-9); (I-27)+(S14-1)
(I-28)+(S1-1); (I-28)+(S1-2); (I-28)+(S1-3); (I-28)+(S1-4); (I-28)+(S1-5); (I-28)+(S1-6); (I-28)+(S1-7); (I-28)+(S1-8); (I-28)+(S1-9); (I-28)+(S1-10); (I-28)+(S1-11); (I-28)+(S1-12); (I-28)+(S1-13); (I-28)+(S2-1); (I-28)+(S2-2); (I-28)+(S2-3); (I-28)+(S2-4); (I-28)+(S2-5); (I-28)+(S2-6); (I-28)+(S2-7); (I-28)+(S2-8); (I-28)+(S2-9); (I-28)+(S2-10); (I-28)+(S3-1); (I-28)+(S3-2); (I-28)+(S3-3); (I-28)+(S3-4); (I-28)+(S3-5); (I-28)+(S3-6); (I-28)+(S3-7); (I-28)+(S3-8); (I-28)+(S3-9); (I-28)+(S3-10); (I-28)+(S3-11); (I-28)+(S4-1); (I-28)+(S4-2); (I-28)+(S4-3); (I-28)+(S4-4); (I-28)+(S4-5); (I-28)+(S7-1); (I-28)+(S11-1); (I-28)+(S11-2); (I-28)+(S11-3); (I-28)+(S12-1); (I-28)+(S13-1); (I-28)+(S13-2); (I-28)+(S13-3); (I-28)+(S13-4): (I-28)+(S13-5); (I-28)+(S13-6); (I-28)+(S13-7); (I-28)+(S13-8); (I-28)+(S13-9); (I-28)+(S14-1)
(I-29)+(S1-1); (I-29)+(S1-2); (I-29)+(S1-3); (I-29)+(S1-4); (I-29)+(S1-5); (I-29)+(S1-6); (I-29)+(S1-7); (I-29)+(S1-8); (I-29)+(S1-9); (I-29)+(S1-10); (I-29)+(S1-11); (I-29)+(S1-12); (I-29)+(S1-13); (I-29)+(S2-1); (I-29)+(S2-2); (I-29)+(S2-3); (I-29)+(S2-4); (I-29)+(S2-5); (I-29)+(S2-6); (I-29)+(S2-7); (I-29)+(S2-8); (I-29)+(S2-9); (I-29)+(S2-10); (I-29)+(S3-1); (I-29)+(S3-2); (I-29)+(S3-3); (I-29)+(S3-4); (I-29)+(S3-5); (I-29)+(S3-6); (I-29)+(S3-7); (I-29)+(S3-8); (I-29)+(S3-9); (I-29)+(S3-10); (I-29)+(S3-11); (I-29)+(S4-1); (I-29)+(S4-2); (I-29)+(S4-3); (I-29)+(S4-4); (I-29)+(S4-5); (I-29)+(S7-1); (I-29)+(S11-1); (I-29)+(S11-2); (I-29)+(S11-3); (I-29)+(S12-1); (I-29)+(S13-1); (I-29)+(S13-2); (I-29)+(S13-3); (I-29)+(S13-4): (I-29)+(S13-5); (I-29)+(S13-6); (I-29)+(S13-7); (I-29)+(S13-8); (I-29)+(S13-9); (I-29)+(S14-1)
(I-30)+(S1-1); (I-30)+(S1-2); (I-30)+(S1-3); (I-30)+(S1-4); (I-30)+(S1-5); (I-30)+(S1-6); (I-30)+(S1-7); (I-30)+(S1-8); (I-30)+(S1-9); (I-30)+(S1-10); (I-30)+(S1-11); (I-30)+(S1-12); (I-30)+(S1-13); (I-30)+(S2-1); (I-30)+(S2-2); (I-30)+(S2-3); (I-30)+(S2-4); (I-30)+(S2-5); (I-30)+(S2-6); (I-30)+(S2-7); (I-30)+(S2-8); (I-30)+(S2-9); (I-30)+(S2-10); (I-30)+(S3-1); (I-30)+(S3-2); (I-30)+(S3-3); (I-30)+(S3-4); (I-30)+(S3-5); (I-30)+(S3-6); (I-30)+(S3-7); (I-30)+(S3-8); (I-30)+(S3-9); (I-30)+(S3-10); (I-30)+(S3-11); (I-30)+(S4-1); (I-30)+(S4-2); (I-30)+(S4-3); (I-30)+(S4-4); (I-30)+(S4-5); (I-30)+(S7-1); (I-30)+(S11-1); (I-30)+(S11-2); (I-30)+(S11-3); (I-30)+(S12-1); (I-30)+(S13-1); (I-30)+(S13-2); (I-30)+(S13-3); (I-30)+(S13-4): (I-30)+(S13-5); (I-30)+(S13-6); (I-30)+(S13-7); (I-30)+(S13-8); (I-30)+(S13-9); (I-30)+(S14-1)
(I-31)+(S1-1); (I-31)+(S1-2); (I-31)+(S1-3); (I-31)+(S1-4); (I-31)+(S1-5); (I-31)+(S1-6); (I-31)+(S1-7); (I-31)+(S1-8); (I-31)+(S1-9); (I-31)+(S1-10); (I-31)+(S1-11); (I-31)+(S1-12); (I-31)+(S1-13); (I-31)+(S2-1); (I-31)+(S2-2); (I-31)+(S2-3); (I-31)+(S2-4); (I-31)+(S2-5); (I-31)+(S2-6); (I-31)+(S2-7); (I-31)+(S2-8); (I-31)+(S2-9); (I-31)+(S2-10); (I-31)+(S3-1); (I-31)+(S3-2); (I-31)+(S3-3); (I-31)+(S3-4); (I-31)+(S3-5); (I-31)+(S3-6); (I-31)+(S3-7); (I-31)+(S3-8); (I-31)+(S3-9); (I-31)+(S3-10); (I-31)+(S3-11); (I-31)+(S4-1); (I-31)+(S4-2); (I-31)+(S4-3); (I-31)+(S4-4); (I-31)+(S4-5); (I-31)+(S7-1); (I-31)+(S11-1); (I-31)+(S11-2); (I-31)+(S11-3); (I-31)+(S12-1); (I-31)+(S13-1); (I-31)+(S13-2); (I-31)+(S13-3); (I-31)+(S13-4): (I-31)+(S13-5); (I-31)+(S13-6); (I-31)+(S13-7); (I-31)+(S13-8); (I-31)+(S13-9); (I-31)+(S14-1)
(I-32)+(S1-1); (I-32)+(S1-2); (I-32)+(S1-3); (I-32)+(S1-4); (I-32)+(S1-5); (I-32)+(S1-6); (I-32)+(S1-7); (I-32)+(S1-8); (I-32)+(S1-9); (I-32)+(S1-10); (I-32)+(S1-11); (I-32)+(S1-12); (I-32)+(S1-13); (I-32)+(S2-1); (I-32)+(S2-2); (I-32)+(S2-3); (I-32)+(S2-4); (I-32)+(S2-5); (I-32)+(S2-6); (I-32)+(S2-7); (I-32)+(S2-8); (I-32)+(S2-9); (I-32)+(S2-10); (I-32)+(S3-1); (I-32)+(S3-2); (I-32)+(S3-3); (I-32)+(S3-4); (I-32)+(S3-5); (I-32)+(S3-6); (I-32)+(S3-7); (I-32)+(S3-8); (I-32)+(S3-9); (I-32)+(S3-10); (I-32)+(S3-11); (I-32)+(S4-1); (I-32)+(S4-2); (I-32)+(S4-3); (I-32)+(S4-4); (I-32)+(S4-5); (I-32)+(S7-1); (I-32)+(S11-1); (I-32)+(S11-2); (I-32)+(S11-3); (I-32)+(S12-1); (I-32)+(S13-1); (I-32)+(S13-2); (I-32)+(S13-3); (I-32)+(S13-4): (I-32)+(S13-5); (I-32)+(S13-6); (I-32)+(S13-7); (I-32)+(S13-8); (I-32)+(S13-9); (I-32)+(S14-1)
(I-33)+(S1-1); (I-33)+(S1-2); (I-33)+(S1-3); (I-33)+(S1-4); (I-33)+(S1-5); (I-33)+(S1-6); (I-33)+(S1-7); (I-33)+(S1-8); (I-33)+(S1-9); (I-33)+(S1-10); (I-33)+(S1-11); (I-33)+(S1-12); (I-33)+(S1-13); (I-33)+(S2-1); (I-33)+(S2-2); (I-33)+(S2-3); (I-33)+(S2-4); (I-33)+(S2-5); (I-33)+(S2-6); (I-33)+(S2-7); (I-33)+(S2-8); (I-33)+(S2-9); (I-33)+(S2-10); (I-33)+(S3-1); (I-33)+(S3-2); (I-33)+(S3-3); (I-33)+(S3-4); (I-33)+(S3-5); (I-33)+(S3-6); (I-33)+(S3-7); (I-33)+(S3-8); (I-33)+(S3-9); (I-33)+(S3-10); (I-33)+(S3-11); (I-33)+(S4-1); (I-33)+(S4-2); (I-33)+(S4-3); (I-33)+(S4-4); (I-33)+(S4-5); (I-33)+(S7-1); (I-33)+(S11-1); (I-33)+(S11-2); (I-33)+(S11-3); (I-33)+(S12-1); (I-33)+(S13-1); (I-33)+(S13-2); (I-33)+(S13-3); (I-33)+(S13-4): (I-33)+(S13-5); (I-33)+(S13-6); (I-33)+(S13-7); (I-33)+(S13-8); (I-33)+(S13-9); (I-33)+(S14-1)
(I-34)+(S1-1); (I-34)+(S1-2); (I-34)+(S1-3); (I-34)+(S1-4); (I-34)+(S1-5); (I-34)+(S1-6); (I-34)+(S1-7); (I-34)+(S1-8); (I-34)+(S1-9); (I-34)+(S1-10); (I-34)+(S1-11); (I-34)+(S1-12); (I-34)+(S1-13); (I-34)+(S2-1); (I-34)+(S2-2); (I-34)+(S2-3); (I-34)+(S2-4); (I-34)+(S2-5); (I-34)+(S2-6); (I-34)+(S2-7); (I-34)+(S2-8); (I-34)+(S2-9); (I-34)+(S2-10); (I-34)+(S3-1); (I-34)+(S3-2); (I-34)+(S3-3); (I-34)+(S3-4); (I-34)+(S3-5); (I-34)+(S3-6); (I-34)+(S3-7); (I-34)+(S3-8); (I-34)+(S3-9); (I-34)+(S3-10); (I-34)+(S3-11); (I-34)+(S4-1); (I-34)+(S4-2); (I-34)+(S4-3); (I-34)+(S4-4); (I-34)+(S4-5); (I-34)+(S7-1); (I-34)+(S11-1); (I-34)+(S11-2); (I-34)+(S11-3); (I-34)+(S12-1); (I-34)+(S13-1); (I-34)+(S13-2); (I-34)+(S13-3); (I-34)+(S13-4): (I-34)+(S13-5); (I-34)+(S13-6); (I-34)+(S13-7); (I-34)+(S13-8); (I-34)+(S13-9); (I-34)+(S14-1)
(I-35)+(S1-1); (I-35)+(S1-2); (I-35)+(S1-3); (I-35)+(S1-4); (I-35)+(S1-5); (I-35)+(S1-6); (I-35)+(S1-7); (I-35)+(S1-8); (I-35)+(S1-9); (I-35)+(S1-10); (I-35)+(S1-11); (I-35)+(S1-12); (I-35)+(S1-13); (I-35)+(S2-1); (I-35)+(S2-2); (I-35)+(S2-3); (I-35)+(S2-4); (I-35)+(S2-5); (I-35)+(S2-6); (I-35)+(S2-7); (I-35)+(S2-8); (I-35)+(S2-9); (I-35)+(S2-10); (I-35)+(S3-1); (I-35)+(S3-2); (I-35)+(S3-3); (I-35)+(S3-4); (I-35)+(S3-5); (I-35)+(S3-6); (I-35)+(S3-7); (I-35)+(S3-8); (I-35)+(S3-9); (I-35)+(S3-10); (I-35)+(S3-11); (I-35)+(S4-1); (I-35)+(S4-2); (I-35)+(S4-3); (I-35)+(S4-4); (I-35)+(S4-5); (I-35)+(S7-1); (I-35)+(S11-1); (I-35)+(S11-2); (I-35)+(S11-3); (I-35)+(S12-1); (I-35)+(S13-1); (I-35)+(S13-2); (I-35)+(S13-3); (I-35)+(S13-4): (I-35)+(S13-5); (I-35)+(S13-6); (I-35)+(S13-7); (I-35)+(S13-8); (I-35)+(S13-9); (I-35)+(S14-1)
(I-36)+(S1-1); (I-36)+(S1-2); (I-36)+(S1-3); (I-36)+(S1-4); (I-36)+(S1-5); (I-36)+(S1-6); (I-36)+(S1-7); (I-36)+(S1-8); (I-36)+(S1-9); (I-36)+(S1-10); (I-36)+(S1-11); (I-36)+(S1-12); (I-36)+(S1-13); (I-36)+(S2-1); (I-36)+(S2-2); (I-36)+(S2-3); (I-36)+(S2-4); (I-36)+(S2-5); (I-36)+(S2-6); (I-36)+(S2-7); (I-36)+(S2-8); (I-36)+(S2-9); (I-36)+(S2-10); (I-36)+(S3-1); (I-36)+(S3-2); (I-36)+(S3-3); (I-36)+(S3-4); (I-36)+(S3-5); (I-36)+(S3-6); (I-36)+(S3-7); (I-36)+(S3-8); (I-36)+(S3-9); (I-36)+(S3-10); (I-36)+(S3-11); (I-36)+(S4-1); (I-36)+(S4-2); (I-36)+(S4-3); (I-36)+(S4-4); (I-36)+(S4-5); (I-36)+(S7-1); (I-36)+(S11-1); (I-36)+(S11-2); (I-36)+(S11-3); (I-36)+(S12-1); (I-36)+(S13-1); (I-36)+(S13-2); (I-36)+(S13-3); (I-36)+(S13-4): (I-36)+(S13-5); (I-36)+(S13-6); (I-36)+(S13-7); (I-36)+(S13-8); (I-36)+(S13-9); (I-36)+(S14-1)
(I-37)+(S1-1); (I-37)+(S1-2); (I-37)+(S1-3); (I-37)+(S1-4); (I-37)+(S1-5); (I-37)+(S1-6); (I-37)+(S1-7); (I-37)+(S1-8); (I-37)+(S1-9); (I-37)+(S1-10); (I-37)+(S1-11); (I-37)+(S1-12); (I-37)+(S1-13); (I-37)+(S2-1); (I-37)+(S2-2); (I-37)+(S2-3); (I-37)+(S2-4); (I-37)+(S2-5); (I-37)+(S2-6); (I-37)+(S2-7); (I-37)+(S2-8); (I-37)+(S2-9); (I-37)+(S2-10); (I-37)+(S3-1); (I-37)+(S3-2); (I-37)+(S3-3); (I-37)+(S3-4); (I-37)+(S3-5); (I-37)+(S3-6); (I-37)+(S3-7); (I-37)+(S3-8); (I-37)+(S3-9); (I-37)+(S3-10); (I-37)+(S3-11); (I-37)+(S4-1); (I-37)+(S4-2); (I-37)+(S4-3); (I-37)+(S4-4); (I-37)+(S4-5); (I-37)+(S7-1); (I-37)+(S11-1); (I-37)+(S11-2); (I-37)+(S11-3); (I-37)+(S12-1); (I-37)+(S13-1); (I-37)+(S13-2); (I-37)+(S13-3); (I-37)+(S13-4): (I-37)+(S13-5); (I-37)+(S13-6); (I-37)+(S13-7); (I-37)+(S13-8); (I-37)+(S13-9); (I-37)+(S14-1)
(I-38)+(S1-1); (I-38)+(S1-2); (I-38)+(S1-3); (I-38)+(S1-4); (I-38)+(S1-5); (I-38)+(S1-6); (I-38)+(S1-7); (I-38)+(S1-8); (I-38)+(S1-9); (I-38)+(S1-10); (I-38)+(S1-11); (I-38)+(S1-12); (I-38)+(S1-13); (I-38)+(S2-1); (I-38)+(S2-2); (I-38)+(S2-3); (I-38)+(S2-4); (I-38)+(S2-5); (I-38)+(S2-6); (I-38)+(S2-7); (I-38)+(S2-8); (I-38)+(S2-9); (I-38)+(S2-10); (I-38)+(S3-1); (I-38)+(S3-2); (I-38)+(S3-3); (I-38)+(S3-4); (I-38)+(S3-5); (I-38)+(S3-6); (I-38)+(S3-7); (I-38)+(S3-8); (I-38)+(S3-9); (I-38)+(S3-10); (I-38)+(S3-11); (I-38)+(S4-1); (I-38)+(S4-2); (I-38)+(S4-3); (I-38)+(S4-4); (I-38)+(S4-5); (I-38)+(S7-1); (I-38)+(S11-1); (I-38)+(S11-2); (I-38)+(S11-3); (I-38)+(S12-1); (I-38)+(S13-1); (I-38)+(S13-2); (I-38)+(S13-3); (I-38)+(S13-4): (I-38)+(S13-5); (I-38)+(S13-6); (I-38)+(S13-7); (I-38)+(S13-8); (I-38)+(S13-9); (I-38)+(S14-1)
(I-39)+(S1-1); (I-39)+(S1-2); (I-39)+(S1-3); (I-39)+(S1-4); (I-39)+(S1-5); (I-39)+(S1-6); (I-39)+(S1-7); (I-39)+(S1-8); (I-39)+(S1-9); (I-39)+(S1-10); (I-39)+(S1-11); (I-39)+(S1-12); (I-39)+(S1-13); (I-39)+(S2-1); (I-39)+(S2-2); (I-39)+(S2-3); (I-39)+(S2-4); (I-39)+(S2-5); (I-39)+(S2-6); (I-39)+(S2-7); (I-39)+(S2-8); (I-39)+(S2-9); (I-39)+(S2-10); (I-39)+(S3-1); (I-39)+(S3-2); (I-39)+(S3-3); (I-39)+(S3-4); (I-39)+(S3-5); (I-39)+(S3-6); (I-39)+(S3-7); (I-39)+(S3-8); (I-39)+(S3-9); (I-39)+(S3-10); (I-39)+(S3-11); (I-39)+(S4-1); (I-39)+(S4-2); (I-39)+(S4-3); (I-39)+(S4-4); (I-39)+(S4-5); (I-39)+(S7-1); (I-39)+(S11-1); (I-39)+(S11-2); (I-39)+(S11-3); (I-39)+(S12-1); (I-39)+(S13-1); (I-39)+(S13-2); (I-39)+(S13-3); (I-39)+(S13-4): (I-39)+(S13-5); (I-39)+(S13-6); (I-39)+(S13-7); (I-39)+(S13-8); (I-39)+(S13-9); (I-39)+(S14-1)
(I-40)+(S1-1); (I-40)+(S1-2); (I-40)+(S1-3); (I-40)+(S1-4); (I-40)+(S1-5); (I-40)+(S1-6); (I-40)+(S1-7); (I-40)+(S1-8); (I-40)+(S1-9); (I-40)+(S1-10); (I-40)+(S1-11); (I-40)+(S1-12); (I-40)+(S1-13); (I-40)+(S2-1); (I-40)+(S2-2); (I-40)+(S2-3); (I-40)+(S2-4); (I-40)+(S2-5); (I-40)+(S2-6); (I-40)+(S2-7); (I-40)+(S2-8); (I-40)+(S2-9); (I-40)+(S2-10); (I-40)+(S3-1); (I-40)+(S3-2); (I-40)+(S3-3); (I-40)+(S3-4); (I-40)+(S3-5); (I-40)+(S3-6); (I-40)+(S3-7); (I-40)+(S3-8); (I-40)+(S3-9); (I-40)+(S3-10); (I-40)+(S3-11); (I-40)+(S4-1); (I-40)+(S4-2); (I-40)+(S4-3); (I-40)+(S4-4); (I-40)+(S4-5); (I-40)+(S7-1); (I-40)+(S11-1); (I-40)+(S11-2); (I-40)+(S11-3); (I-40)+(S12-1); (I-40)+(S13-1); (I-40)+(S13-2); (I-40)+(S13-3); (I-40)+(S13-4): (I-40)+(S13-5); (I-40)+(S13-6); (I-40)+(S13-7); (I-40)+(S13-8); (I-40)+(S13-9); (I-40)+(S14-1)
(I-41)+(S1-1); (I-41)+(S1-2); (I-41)+(S1-3); (I-41)+(S1-4); (I-41)+(S1-5); (I-41)+(S1-6); (I-41)+(S1-7); (I-41)+(S1-8); (I-41)+(S1-9); (I-41)+(S1-10); (I-41)+(S1-11); (I-41)+(S1-12); (I-41)+(S1-13); (I-41)+(S2-1); (I-41)+(S2-2); (I-41)+(S2-3); (I-41)+(S2-4); (I-41)+(S2-5); (I-41)+(S2-6); (I-41)+(S2-7); (I-41)+(S2-8); (I-41)+(S2-9); (I-41)+(S2-10); (I-41)+(S3-1); (I-41)+(S3-2); (I-41)+(S3-3); (I-41)+(S3-4); (I-41)+(S3-5); (I-41)+(S3-6); (I-41)+(S3-7); (I-41)+(S3-8); (I-41)+(S3-9); (I-41)+(S3-10); (I-41)+(S3-11); (I-41)+(S4-1); (I-41)+(S4-2); (I-41)+(S4-3); (I-41)+(S4-4); (I-41)+(S4-5); (I-41)+(S7-1); (I-41)+(S11-1); (I-41)+(S11-2); (I-41)+(S11-3); (I-41)+(S12-1); (I-41)+(S13-1); (I-41)+(S13-2); (I-41)+(S13-3); (I-41)+(S13-4): (I-41)+(S13-5); (I-41)+(S13-6); (I-41)+(S13-7); (I-41)+(S13-8); (I-41)+(S13-9); (I-41)+(S14-1)
(I-42)+(S1-1); (I-42)+(S1-2); (I-42)+(S1-3); (I-42)+(S1-4); (I-42)+(S1-5); (I-42)+(S1-6); (I-42)+(S1-7); (I-42)+(S1-8); (I-42)+(S1-9); (I-42)+(S1-10); (I-42)+(S1-11); (I-42)+(S1-12); (I-42)+(S1-13); (I-42)+(S2-1); (I-42)+(S2-2); (I-42)+(S2-3); (I-42)+(S2-4); (I-42)+(S2-5); (I-42)+(S2-6); (I-42)+(S2-7); (I-42)+(S2-8); (I-42)+(S2-9); (I-42)+(S2-10); (I-42)+(S3-1); (I-42)+(S3-2); (I-42)+(S3-3); (I-42)+(S3-4); (I-42)+(S3-5); (I-42)+(S3-6); (I-42)+(S3-7); (I-42)+(S3-8); (I-42)+(S3-9); (I-42)+(S3-10); (I-42)+(S3-11); (I-42)+(S4-1); (I-42)+(S4-2); (I-42)+(S4-3); (I-42)+(S4-4); (I-42)+(S4-5); (I-42)+(S7-1); (I-42)+(S11-1); (I-42)+(S11-2); (I-42)+(S11-3); (I-42)+(S12-1); (I-42)+(S13-1); (I-42)+(S13-2); (I-42)+(S13-3); (I-42)+(S13-4): (I-42)+(S13-5); (I-42)+(S13-6); (I-42)+(S13-7); (I-42)+(S13-8); (I-42)+(S13-9); (I-42)+(S14-1)
(I-43)+(S1-1); (I-43)+(S1-2); (I-43)+(S1-3); (I-43)+(S1-4); (I-43)+(S1-5); (I-43)+(S1-6); (I-43)+(S1-7); (I-43)+(S1-8); (I-43)+(S1-9); (I-43)+(S1-10); (I-43)+(S1-11); (I-43)+(S1-12); (I-43)+(S1-13); (I-43)+(S2-1); (I-43)+(S2-2); (I-43)+(S2-3); (I-43)+(S2-4); (I-43)+(S2-5); (I-43)+(S2-6); (I-43)+(S2-7); (I-43)+(S2-8); (I-43)+(S2-9); (I-43)+(S2-10); (I-43)+(S3-1); (I-43)+(S3-2); (I-43)+(S3-3); (I-43)+(S3-4); (I-43)+(S3-5); (I-43)+(S3-6); (I-43)+(S3-7); (I-43)+(S3-8); (I-43)+(S3-9); (I-43)+(S3-10); (I-43)+(S3-11); (I-43)+(S4-1); (I-43)+(S4-2); (I-43)+(S4-3); (I-43)+(S4-4); (I-43)+(S4-5); (I-43)+(S7-1); (I-43)+(S11-1); (I-43)+(S11-2); (I-43)+(S11-3); (I-43)+(S12-1); (I-43)+(S13-1); (I-43)+(S13-2); (I-43)+(S13-3); (I-43)+(S13-4): (I-43)+(S13-5); (I-43)+(S13-6); (I-43)+(S13-7); (I-43)+(S13-8); (I-43)+(S13-9); (I-43)+(S14-1)
(I-44)+(S1-1); (I-44)+(S1-2); (I-44)+(S1-3); (I-44)+(S1-4); (I-44)+(S1-5); (I-44)+(S1-6); (I-44)+(S1-7); (I-44)+(S1-8); (I-44)+(S1-9); (I-44)+(S1-10); (I-44)+(S1-11); (I-44)+(S1-12); (I-44)+(S1-13); (I-44)+(S2-1); (I-44)+(S2-2); (I-44)+(S2-3); (I-44)+(S2-4); (I-44)+(S2-5); (I-44)+(S2-6); (I-44)+(S2-7); (I-44)+(S2-8); (I-44)+(S2-9); (I-44)+(S2-10); (I-44)+(S3-1); (I-44)+(S3-2); (I-44)+(S3-3); (I-44)+(S3-4); (I-44)+(S3-5); (I-44)+(S3-6); (I-44)+(S3-7); (I-44)+(S3-8); (I-44)+(S3-9); (I-44)+(S3-10); (I-44)+(S3-11); (I-44)+(S4-1); (I-44)+(S4-2); (I-44)+(S4-3); (I-44)+(S4-4); (I-44)+(S4-5); (I-44)+(S7-1); (I-44)+(S11-1); (I-44)+(S11-2); (I-44)+(S11-3); (I-44)+(S12-1); (I-44)+(S13-1); (I-44)+(S13-2); (I-44)+(S13-3); (I-44)+(S13-4): (I-44)+(S13-5); (I-44)+(S13-6); (I-44)+(S13-7); (I-44)+(S13-8); (I-44)+(S13-9); (I-44)+(S14-1)
(I-45)+(S1-1); (I-45)+(S1-2); (I-45)+(S1-3); (I-45)+(S1-4); (I-45)+(S1-5); (I-45)+(S1-6); (I-45)+(S1-7); (I-45)+(S1-8); (I-45)+(S1-9); (I-45)+(S1-10); (I-45)+(S1-11); (I-45)+(S1-12); (I-45)+(S1-13); (I-45)+(S2-1); (I-45)+(S2-2); (I-45)+(S2-3); (I-45)+(S2-4); (I-45)+(S2-5); (I-45)+(S2-6); (I-45)+(S2-7); (I-45)+(S2-8); (I-45)+(S2-9); (I-45)+(S2-10); (I-45)+(S3-1); (I-45)+(S3-2); (I-45)+(S3-3); (I-45)+(S3-4); (I-45)+(S3-5); (I-45)+(S3-6); (I-45)+(S3-7); (I-45)+(S3-8); (I-45)+(S3-9); (I-45)+(S3-10); (I-45)+(S3-11); (I-45)+(S4-1); (I-45)+(S4-2); (I-45)+(S4-3); (I-45)+(S4-4); (I-45)+(S4-5); (I-45)+(S7-1); (I-45)+(S11-1); (I-45)+(S11-2); (I-45)+(S11-3); (I-45)+(S12-1); (I-45)+(S13-1); (I-45)+(S13-2); (I-45)+(S13-3); (I-45)+(S13-4): (I-45)+(S13-5); (I-45)+(S13-6); (I-45)+(S13-7); (I-45)+(S13-8); (I-45)+(S13-9); (I-45)+(S14-1)
(I-46)+(S1-1); (I-46)+(S1-2); (I-46)+(S1-3); (I-46)+(S1-4); (I-46)+(S1-5); (I-46)+(S1-6); (I-46)+(S1-7); (I-46)+(S1-8); (I-46)+(S1-9); (I-46)+(S1-10); (I-46)+(S1-11); (I-46)+(S1-12); (I-46)+(S1-13); (I-46)+(S2-1); (I-46)+(S2-2); (I-46)+(S2-3); (I-46)+(S2-4); (I-46)+(S2-5); (I-46)+(S2-6); (I-46)+(S2-7); (I-46)+(S2-8); (I-46)+(S2-9); (I-46)+(S2-10); (I-46)+(S3-1); (I-46)+(S3-2); (I-46)+(S3-3); (I-46)+(S3-4); (I-46)+(S3-5); (I-46)+(S3-6); (I-46)+(S3-7); (I-46)+(S3-8); (I-46)+(S3-9); (I-46)+(S3-10); (I-46)+(S3-11); (I-46)+(S4-1); (I-46)+(S4-2); (I-46)+(S4-3); (I-46)+(S4-4); (I-46)+(S4-5); (I-46)+(S7-1); (I-46)+(S11-1); (I-46)+(S11-2); (I-46)+(S11-3); (I-46)+(S12-1); (I-46)+(S13-1); (I-46)+(S13-2); (I-46)+(S13-3); (I-46)+(S13-4): (I-46)+(S13-5); (I-46)+(S13-6); (I-46)+(S13-7); (I-46)+(S13-8); (I-46)+(S13-9); (I-46)+(S14-1)
(I-47)+(S1-1); (I-47)+(S1-2); (I-47)+(S1-3); (I-47)+(S1-4); (I-47)+(S1-5); (I-47)+(S1-6); (I-47)+(S1-7); (I-47)+(S1-8); (I-47)+(S1-9); (I-47)+(S1-10); (I-47)+(S1-11); (I-47)+(S1-12); (I-47)+(S1-13); (I-47)+(S2-1); (I-47)+(S2-2); (I-47)+(S2-3); (I-47)+(S2-4); (I-47)+(S2-5); (I-47)+(S2-6); (I-47)+(S2-7); (I-47)+(S2-8); (I-47)+(S2-9); (I-47)+(S2-10); (I-47)+(S3-1); (I-47)+(S3-2); (I-47)+(S3-3); (I-47)+(S3-4); (I-47)+(S3-5); (I-47)+(S3-6); (I-47)+(S3-7); (I-47)+(S3-8); (I-47)+(S3-9); (I-47)+(S3-10); (I-47)+(S3-11); (I-47)+(S4-1); (I-47)+(S4-2); (I-47)+(S4-3); (I-47)+(S4-4); (I-47)+(S4-5); (I-47)+(S7-1); (I-47)+(S11-1); (I-47)+(S11-2); (I-47)+(S11-3); (I-47)+(S12-1); (I-47)+(S13-1); (I-47)+(S13-2); (I-47)+(S13-3); (I-47)+(S13-4): (I-47)+(S13-5); (I-47)+(S13-6); (I-47)+(S13-7); (I-47)+(S13-8); (I-47)+(S13-9); (I-47)+(S14-1)
(I-48)+(S1-1); (I-48)+(S1-2); (I-48)+(S1-3); (I-48)+(S1-4); (I-48)+(S1-5); (I-48)+(S1-6); (I-48)+(S1-7); (I-48)+(S1-8); (I-48)+(S1-9); (I-48)+(S1-10); (I-48)+(S1-11); (I-48)+(S1-12); (I-48)+(S1-13); (I-48)+(S2-1); (I-48)+(S2-2); (I-48)+(S2-3); (I-48)+(S2-4); (I-48)+(S2-5); (I-48)+(S2-6); (I-48)+(S2-7); (I-48)+(S2-8); (I-48)+(S2-9); (I-48)+(S2-10); (I-48)+(S3-1); (I-48)+(S3-2); (I-48)+(S3-3); (I-48)+(S3-4); (I-48)+(S3-5); (I-48)+(S3-6); (I-48)+(S3-7); (I-48)+(S3-8); (I-48)+(S3-9); (I-48)+(S3-10); (I-48)+(S3-11); (I-48)+(S4-1); (I-48)+(S4-2); (I-48)+(S4-3); (I-48)+(S4-4); (I-48)+(S4-5); (I-48)+(S7-1); (I-48)+(S11-1); (I-48)+(S11-2); (I-48)+(S11-3); (I-48)+(S12-1); (I-48)+(S13-1); (I-48)+(S13-2); (I-48)+(S13-3); (I-48)+(S13-4): (I-48)+(S13-5); (I-48)+(S13-6); (I-48)+(S13-7); (I-48)+(S13-8); (I-48)+(S13-9); (I-48)+(S14-1)
(I-49)+(S1-1); (I-49)+(S1-2); (I-49)+(S1-3); (I-49)+(S1-4); (I-49)+(S1-5); (I-49)+(S1-6); (I-49)+(S1-7); (I-49)+(S1-8); (I-49)+(S1-9); (I-49)+(S1-10); (I-49)+(S1-11); (I-49)+(S1-12); (I-49)+(S1-13); (I-49)+(S2-1); (I-49)+(S2-2); (I-49)+(S2-3); (I-49)+(S2-4); (I-49)+(S2-5); (I-49)+(S2-6); (I-49)+(S2-7); (I-49)+(S2-8); (I-49)+(S2-9); (I-49)+(S2-10); (I-49)+(S3-1); (I-49)+(S3-2); (I-49)+(S3-3); (I-49)+(S3-4); (I-49)+(S3-5); (I-49)+(S3-6); (I-49)+(S3-7); (I-49)+(S3-8); (I-49)+(S3-9); (I-49)+(S3-10); (I-49)+(S3-11); (I-49)+(S4-1); (I-49)+(S4-2); (I-49)+(S4-3); (I-49)+(S4-4); (I-49)+(S4-5); (I-49)+(S7-1); (I-49)+(S11-1); (I-49)+(S11-2); (I-49)+(S11-3); (I-49)+(S12-1); (I-49)+(S13-1); (I-49)+(S13-2); (I-49)+(S13-3); (I-49)+(S13-4): (I-49)+(S13-5); (I-49)+(S13-6); (I-49)+(S13-7); (I-49)+(S13-8); (I-49)+(S13-9); (I-49)+(S14-1)
(I-50)+(S1-1); (I-50)+(S1-2); (I-50)+(S1-3); (I-50)+(S1-4); (I-50)+(S1-5); (I-50)+(S1-6); (I-50)+(S1-7); (I-50)+(S1-8); (I-50)+(S1-9); (I-50)+(S1-10); (I-50)+(S1-11); (I-50)+(S1-12); (I-50)+(S1-13); (I-50)+(S2-1); (I-50)+(S2-2); (I-50)+(S2-3); (I-50)+(S2-4); (I-50)+(S2-5); (I-50)+(S2-6); (I-50)+(S2-7); (I-50)+(S2-8); (I-50)+(S2-9); (I-50)+(S2-10); (I-50)+(S3-1); (I-50)+(S3-2); (I-50)+(S3-3); (I-50)+(S3-4); (I-50)+(S3-5); (I-50)+(S3-6); (I-50)+(S3-7); (I-50)+(S3-8); (I-50)+(S3-9); (I-50)+(S3-10); (I-50)+(S3-11); (I-50)+(S4-1); (I-50)+(S4-2); (I-50)+(S4-3); (I-50)+(S4-4); (I-50)+(S4-5); (I-50)+(S7-1); (I-50)+(S11-1); (I-50)+(S11-2); (I-50)+(S11-3); (I-50)+(S12-1); (I-50)+(S13-1); (I-50)+(S13-2); (I-50)+(S13-3); (I-50)+(S13-4): (I-50)+(S13-5); (I-50)+(S13-6); (I-50)+(S13-7); (I-50)+(S13-8); (I-50)+(S13-9); (I-50)+(S14-1)
(I-51)+(S1-1); (I-51)+(S1-2); (I-51)+(S1-3); (I-51)+(S1-4); (I-51)+(S1-5); (I-51)+(S1-6); (I-51)+(S1-7); (I-51)+(S1-8); (I-51)+(S1-9); (I-51)+(S1-10); (I-51)+(S1-11); (I-51)+(S1-12); (I-51)+(S1-13); (I-51)+(S2-1); (I-51)+(S2-2); (I-51)+(S2-3); (I-51)+(S2-4); (I-51)+(S2-5); (I-51)+(S2-6); (I-51)+(S2-7); (I-51)+(S2-8); (I-51)+(S2-9); (I-51)+(S2-10); (I-51)+(S3-1); (I-51)+(S3-2); (I-51)+(S3-3); (I-51)+(S3-4); (I-51)+(S3-5); (I-51)+(S3-6); (I-51)+(S3-7); (I-51)+(S3-8); (I-51)+(S3-9); (I-51)+(S3-10); (I-51)+(S3-11); (I-51)+(S4-1); (I-51)+(S4-2); (I-51)+(S4-3); (I-51)+(S4-4); (I-51)+(S4-5); (I-51)+(S7-1); (I-51)+(S11-1); (I-51)+(S11-2); (I-51)+(S11-3); (I-51)+(S12-1); (I-51)+(S13-1); (I-51)+(S13-2); (I-51)+(S13-3); (I-51)+(S13-4): (I-51)+(S13-5); (I-51)+(S13-6); (I-51)+(S13-7); (I-51)+(S13-8); (I-51)+(S13-9); (I-51)+(S14-1)
(I-52)+(S1-1); (I-52)+(S1-2); (I-52)+(S1-3); (I-52)+(S1-4); (I-52)+(S1-5); (I-52)+(S1-6); (I-52)+(S1-7); (I-52)+(S1-8); (I-52)+(S1-9); (I-52)+(S1-10); (I-52)+(S1-11); (I-52)+(S1-12); (I-52)+(S1-13); (I-52)+(S2-1); (I-52)+(S2-2); (I-52)+(S2-3); (I-52)+(S2-4); (I-52)+(S2-5); (I-52)+(S2-6); (I-52)+(S2-7); (I-52)+(S2-8); (I-52)+(S2-9); (I-52)+(S2-10); (I-52)+(S3-1); (I-52)+(S3-2); (I-52)+(S3-3); (I-52)+(S3-4); (I-52)+(S3-5); (I-52)+(S3-6); (I-52)+(S3-7); (I-52)+(S3-8); (I-52)+(S3-9); (I-52)+(S3-10); (I-52)+(S3-11); (I-52)+(S4-1); (I-52)+(S4-2); (I-52)+(S4-3); (I-52)+(S4-4); (I-52)+(S4-5); (I-52)+(S7-1); (I-52)+(S11-1); (I-52)+(S11-2); (I-52)+(S11-3); (I-52)+(S12-1); (I-52)+(S13-1); (I-52)+(S13-2); (I-52)+(S13-3); (I-52)+(S13-4): (I-52)+(S13-5); (I-52)+(S13-6); (I-52)+(S13-7); (I-52)+(S13-8); (I-52)+(S13-9); (I-52)+(S14-1)
(I-53)+(S1-1); (I-53)+(S1-2); (I-53)+(S1-3); (I-53)+(S1-4); (I-53)+(S1-5); (I-53)+(S1-6); (I-53)+(S1-7); (I-53)+(S1-8); (I-53)+(S1-9); (I-53)+(S1-10); (I-53)+(S1-11); (I-53)+(S1-12); (I-53)+(S1-13); (I-53)+(S2-1); (I-53)+(S2-2); (I-53)+(S2-3); (I-53)+(S2-4); (I-53)+(S2-5); (I-53)+(S2-6); (I-53)+(S2-7); (I-53)+(S2-8); (I-53)+(S2-9); (I-53)+(S2-10); (I-53)+(S3-1); (I-53)+(S3-2); (I-53)+(S3-3); (I-53)+(S3-4); (I-53)+(S3-5); (I-53)+(S3-6); (I-53)+(S3-7); (I-53)+(S3-8); (I-53)+(S3-9); (I-53)+(S3-10); (I-53)+(S3-11); (I-53)+(S4-1); (I-53)+(S4-2); (I-53)+(S4-3); (I-53)+(S4-4); (I-53)+(S4-5); (I-53)+(S7-1); (I-53)+(S11-1); (I-53)+(S11-2); (I-53)+(S11-3); (I-53)+(S12-1); (I-53)+(S13-1); (I-53)+(S13-2); (I-53)+(S13-3); (I-53)+(S13-4): (I-53)+(S13-5); (I-53)+(S13-6); (I-53)+(S13-7); (I-53)+(S13-8); (I-53)+(S13-9); (I-53)+(S14-1)
(I-54)+(S1-1); (I-54)+(S1-2); (I-54)+(S1-3); (I-54)+(S1-4); (I-54)+(S1-5); (I-54)+(S1-6); (I-54)+(S1-7); (I-54)+(S1-8); (I-54)+(S1-9); (I-54)+(S1-10); (I-54)+(S1-11); (I-54)+(S1-12); (I-54)+(S1-13); (I-54)+(S2-1); (I-54)+(S2-2); (I-54)+(S2-3); (I-54)+(S2-4); (I-54)+(S2-5); (I-54)+(S2-6); (I-54)+(S2-7); (I-54)+(S2-8); (I-54)+(S2-9); (I-54)+(S2-10); (I-54)+(S3-1); (I-54)+(S3-2); (I-54)+(S3-3); (I-54)+(S3-4); (I-54)+(S3-5); (I-54)+(S3-6); (I-54)+(S3-7); (I-54)+(S3-8); (I-54)+(S3-9); (I-54)+(S3-10); (I-54)+(S3-11); (I-54)+(S4-1); (I-54)+(S4-2); (I-54)+(S4-3); (I-54)+(S4-4); (I-54)+(S4-5); (I-54)+(S7-1); (I-54)+(S11-1); (I-54)+(S11-2); (I-54)+(S11-3); (I-54)+(S12-1); (I-54)+(S13-1); (I-54)+(S13-2); (I-54)+(S13-3); (I-54)+(S13-4): (I-54)+(S13-5); (I-54)+(S13-6); (I-54)+(S13-7); (I-54)+(S13-8); (I-54)+(S13-9); (I-54)+(S14-1)
(I-55)+(S1-1); (I-55)+(S1-2); (I-55)+(S1-3); (I-55)+(S1-4); (I-55)+(S1-5); (I-55)+(S1-6); (I-55)+(S1-7); (I-55)+(S1-8); (I-55)+(S1-9); (I-55)+(S1-10); (I-55)+(S1-11); (I-55)+(S1-12); (I-55)+(S1-13); (I-55)+(S2-1); (I-55)+(S2-2); (I-55)+(S2-3); (I-55)+(S2-4); (I-55)+(S2-5); (I-55)+(S2-6); (I-55)+(S2-7); (I-55)+(S2-8); (I-55)+(S2-9); (I-55)+(S2-10); (I-55)+(S3-1); (I-55)+(S3-2); (I-55)+(S3-3); (I-55)+(S3-4); (I-55)+(S3-5); (I-55)+(S3-6); (I-55)+(S3-7); (I-55)+(S3-8); (I-55)+(S3-9); (I-55)+(S3-10); (I-55)+(S3-11); (I-55)+(S4-1); (I-55)+(S4-2); (I-55)+(S4-3); (I-55)+(S4-4); (I-55)+(S4-5); (I-55)+(S7-1); (I-55)+(S11-1); (I-55)+(S11-2); (I-55)+(S11-3); (I-55)+(S12-1); (I-55)+(S13-1); (I-55)+(S13-2); (I-55)+(S13-3); (I-55)+(S13-4): (I-55)+(S13-5); (I-55)+(S13-6); (I-55)+(S13-7); (I-55)+(S13-8); (I-55)+(S13-9); (I-55)+(S14-1)
(I-56)+(S1-1); (I-56)+(S1-2); (I-56)+(S1-3); (I-56)+(S1-4); (I-56)+(S1-5); (I-56)+(S1-6); (I-56)+(S1-7); (I-56)+(S1-8); (I-56)+(S1-9); (I-56)+(S1-10); (I-56)+(S1-11); (I-56)+(S1-12); (I-56)+(S1-13); (I-56)+(S2-1); (I-56)+(S2-2); (I-56)+(S2-3); (I-56)+(S2-4); (I-56)+(S2-5); (I-56)+(S2-6); (I-56)+(S2-7); (I-56)+(S2-8); (I-56)+(S2-9); (I-56)+(S2-10); (I-56)+(S3-1); (I-56)+(S3-2); (I-56)+(S3-3); (I-56)+(S3-4); (I-56)+(S3-5); (I-56)+(S3-6); (I-56)+(S3-7); (I-56)+(S3-8); (I-56)+(S3-9); (I-56)+(S3-10); (I-56)+(S3-11); (I-56)+(S4-1); (I-56)+(S4-2); (I-56)+(S4-3); (I-56)+(S4-4); (I-56)+(S4-5); (I-56)+(S7-1); (I-56)+(S11-1); (I-56)+(S11-2); (I-56)+(S11-3); (I-56)+(S12-1); (I-56)+(S13-1); (I-56)+(S13-2); (I-56)+(S13-3); (I-56)+(S13-4): (I-56)+(S13-5); (I-56)+(S13-6); (I-56)+(S13-7); (I-56)+(S13-8); (I-56)+(S13-9); (I-56)+(S14-1)
(I-57)+(S1-1); (I-57)+(S1-2); (I-57)+(S1-3); (I-57)+(S1-4); (I-57)+(S1-5); (I-57)+(S1-6); (I-57)+(S1-7); (I-57)+(S1-8); (I-57)+(S1-9); (I-57)+(S1-10); (I-57)+(S1-11); (I-57)+(S1-12); (I-57)+(S1-13); (I-57)+(S2-1); (I-57)+(S2-2); (I-57)+(S2-3); (I-57)+(S2-4); (I-57)+(S2-5); (I-57)+(S2-6); (I-57)+(S2-7); (I-57)+(S2-8); (I-57)+(S2-9); (I-57)+(S2-10); (I-57)+(S3-1); (I-57)+(S3-2); (I-57)+(S3-3); (I-57)+(S3-4); (I-57)+(S3-5); (I-57)+(S3-6); (I-57)+(S3-7); (I-57)+(S3-8); (I-57)+(S3-9); (I-57)+(S3-10); (I-57)+(S3-11); (I-57)+(S4-1); (I-57)+(S4-2); (I-57)+(S4-3); (I-57)+(S4-4); (I-57)+(S4-5); (I-57)+(S7-1); (I-57)+(S11-1); (I-57)+(S11-2); (I-57)+(S11-3); (I-57)+(S12-1); (I-57)+(S13-1); (I-57)+(S13-2); (I-57)+(S13-3); (I-57)+(S13-4): (I-57)+(S13-5); (I-57)+(S13-6); (I-57)+(S13-7); (I-57)+(S13-8); (I-57)+(S13-9); (I-57)+(S14-1)
(I-58)+(S1-1); (I-58)+(S1-2); (I-58)+(S1-3); (I-58)+(S1-4); (I-58)+(S1-5); (I-58)+(S1-6); (I-58)+(S1-7); (I-58)+(S1-8); (I-58)+(S1-9); (I-58)+(S1-10); (I-58)+(S1-11); (I-58)+(S1-12); (I-58)+(S1-13); (I-58)+(S2-1); (I-58)+(S2-2); (I-58)+(S2-3); (I-58)+(S2-4); (I-58)+(S2-5); (I-58)+(S2-6); (I-58)+(S2-7); (I-58)+(S2-8); (I-58)+(S2-9); (I-58)+(S2-10); (I-58)+(S3-1); (I-58)+(S3-2); (I-58)+(S3-3); (I-58)+(S3-4); (I-58)+(S3-5); (I-58)+(S3-6); (I-58)+(S3-7); (I-58)+(S3-8); (I-58)+(S3-9); (I-58)+(S3-10); (I-58)+(S3-11); (I-58)+(S4-1); (I-58)+(S4-2); (I-58)+(S4-3); (I-58)+(S4-4); (I-58)+(S4-5); (I-58)+(S7-1); (I-58)+(S11-1); (I-58)+(S11-2); (I-58)+(S11-3); (I-58)+(S12-1); (I-58)+(S13-1); (I-58)+(S13-2); (I-58)+(S13-3); (I-58)+(S13-4): (I-58)+(S13-5); (I-58)+(S13-6); (I-58)+(S13-7); (I-58)+(S13-8); (I-58)+(S13-9); (I-58)+(S14-1)
(I-59)+(S1-1); (I-59)+(S1-2); (I-59)+(S1-3); (I-59)+(S1-4); (I-59)+(S1-5); (I-59)+(S1-6); (I-59)+(S1-7); (I-59)+(S1-8); (I-59)+(S1-9); (I-59)+(S1-10); (I-59)+(S1-11); (I-59)+(S1-12); (I-59)+(S1-13); (I-59)+(S2-1); (I-59)+(S2-2); (I-59)+(S2-3); (I-59)+(S2-4); (I-59)+(S2-5); (I-59)+(S2-6); (I-59)+(S2-7); (I-59)+(S2-8); (I-59)+(S2-9); (I-59)+(S2-10); (I-59)+(S3-1); (I-59)+(S3-2); (I-59)+(S3-3); (I-59)+(S3-4); (I-59)+(S3-5); (I-59)+(S3-6); (I-59)+(S3-7); (I-59)+(S3-8); (I-59)+(S3-9); (I-59)+(S3-10); (I-59)+(S3-11); (I-59)+(S4-1); (I-59)+(S4-2); (I-59)+(S4-3); (I-59)+(S4-4); (I-59)+(S4-5); (I-59)+(S7-1); (I-59)+(S11-1); (I-59)+(S11-2); (I-59)+(S11-3); (I-59)+(S12-1); (I-59)+(S13-1); (I-59)+(S13-2); (I-59)+(S13-3); (I-59)+(S13-4): (I-59)+(S13-5); (I-59)+(S13-6); (I-59)+(S13-7); (I-59)+(S13-8); (I-59)+(S13-9); (I-59)+(S14-1)
(I-60)+(S1-1); (I-60)+(S1-2); (I-60)+(S1-3); (I-60)+(S1-4); (I-60)+(S1-5); (I-60)+(S1-6); (I-60)+(S1-7); (I-60)+(S1-8); (I-60)+(S1-9); (I-60)+(S1-10); (I-60)+(S1-11); (I-60)+(S1-12); (I-60)+(S1-13); (I-60)+(S2-1); (I-60)+(S2-2); (I-60)+(S2-3); (I-60)+(S2-4); (I-60)+(S2-5); (I-60)+(S2-6); (I-60)+(S2-7); (I-60)+(S2-8); (I-60)+(S2-9); (I-60)+(S2-10); (I-60)+(S3-1); (I-60)+(S3-2); (I-60)+(S3-3); (I-60)+(S3-4); (I-60)+(S3-5); (I-60)+(S3-6); (I-60)+(S3-7); (I-60)+(S3-8); (I-60)+(S3-9); (I-60)+(S3-10); (I-60)+(S3-11); (I-60)+(S4-1); (I-60)+(S4-2); (I-60)+(S4-3); (I-60)+(S4-4); (I-60)+(S4-5); (I-60)+(S7-1); (I-60)+(S11-1); (I-60)+(S11-2); (I-60)+(S11-3); (I-60)+(S12-1); (I-60)+(S13-1); (I-60)+(S13-2); (I-60)+(S13-3); (I-60)+(S13-4): (I-60)+(S13-5); (I-60)+(S13-6); (I-60)+(S13-7); (I-60)+(S13-8); (I-60)+(S13-9); (I-60)+(S14-1)
(I-61)+(S1-1); (I-61)+(S1-2); (I-61)+(S1-3); (I-61)+(S1-4); (I-61)+(S1-5); (I-61)+(S1-6); (I-61)+(S1-7); (I-61)+(S1-8); (I-61)+(S1-9); (I-61)+(S1-10); (I-61)+(S1-11); (I-61)+(S1-12); (I-61)+(S1-13); (I-61)+(S2-1); (I-61)+(S2-2); (I-61)+(S2-3); (I-61)+(S2-4); (I-61)+(S2-5); (I-61)+(S2-6); (I-61)+(S2-7); (I-61)+(S2-8); (I-61)+(S2-9); (I-61)+(S2-10); (I-61)+(S3-1); (I-61)+(S3-2); (I-61)+(S3-3); (I-61)+(S3-4); (I-61)+(S3-5); (I-61)+(S3-6); (I-61)+(S3-7); (I-61)+(S3-8); (I-61)+(S3-9); (I-61)+(S3-10); (I-61)+(S3-11); (I-61)+(S4-1); (I-61)+(S4-2); (I-61)+(S4-3); (I-61)+(S4-4); (I-61)+(S4-5); (I-61)+(S7-1); (I-61)+(S11-1); (I-61)+(S11-2); (I-61)+(S11-3); (I-61)+(S12-1); (I-61)+(S13-1); (I-61)+(S13-2); (I-61)+(S13-3); (I-61)+(S13-4): (I-61)+(S13-5); (I-61)+(S13-6); (I-61)+(S13-7); (I-61)+(S13-8); (I-61)+(S13-9); (I-61)+(S14-1)
(I-62)+(S1-1); (I-62)+(S1-2); (I-62)+(S1-3); (I-62)+(S1-4); (I-62)+(S1-5); (I-62)+(S1-6); (I-62)+(S1-7); (I-62)+(S1-8); (I-62)+(S1-9); (I-62)+(S1-10); (I-62)+(S1-11); (I-62)+(S1-12); (I-62)+(S1-13); (I-62)+(S2-1); (I-62)+(S2-2); (I-62)+(S2-3); (I-62)+(S2-4); (I-62)+(S2-5); (I-62)+(S2-6); (I-62)+(S2-7); (I-62)+(S2-8); (I-62)+(S2-9); (I-62)+(S2-10); (I-62)+(S3-1); (I-62)+(S3-2); (I-62)+(S3-3); (I-62)+(S3-4); (I-62)+(S3-5); (I-62)+(S3-6); (I-62)+(S3-7); (I-62)+(S3-8); (I-62)+(S3-9); (I-62)+(S3-10); (I-62)+(S3-11); (I-62)+(S4-1); (I-62)+(S4-2); (I-62)+(S4-3); (I-62)+(S4-4); (I-62)+(S4-5); (I-62)+(S7-1); (I-62)+(S11-1); (I-62)+(S11-2); (I-62)+(S11-3); (I-62)+(S12-1); (I-62)+(S13-1); (I-62)+(S13-2); (I-62)+(S13-3); (I-62)+(S13-4): (I-62)+(S13-5); (I-62)+(S13-6); (I-62)+(S13-7); (I-62)+(S13-8); (I-62)+(S13-9); (I-62)+(S14-1)
(I-63)+(S1-1); (I-63)+(S1-2); (I-63)+(S1-3); (I-63)+(S1-4); (I-63)+(S1-5); (I-63)+(S1-6); (I-63)+(S1-7); (I-63)+(S1-8); (I-63)+(S1-9); (I-63)+(S1-10); (I-63)+(S1-11); (I-63)+(S1-12); (I-63)+(S1-13); (I-63)+(S2-1); (I-63)+(S2-2); (I-63)+(S2-3); (I-63)+(S2-4); (I-63)+(S2-5); (I-63)+(S2-6); (I-63)+(S2-7); (I-63)+(S2-8); (I-63)+(S2-9); (I-63)+(S2-10); (I-63)+(S3-1); (I-63)+(S3-2); (I-63)+(S3-3); (I-63)+(S3-4); (I-63)+(S3-5); (I-63)+(S3-6); (I-63)+(S3-7); (I-63)+(S3-8); (I-63)+(S3-9); (I-63)+(S3-10); (I-63)+(S3-11); (I-63)+(S4-1); (I-63)+(S4-2); (I-63)+(S4-3); (I-63)+(S4-4); (I-63)+(S4-5); (I-63)+(S7-1); (I-63)+(S11-1); (I-63)+(S11-2); (I-63)+(S11-3); (I-63)+(S12-1); (I-63)+(S13-1); (I-63)+(S13-2); (I-63)+(S13-3); (I-63)+(S13-4): (I-63)+(S13-5); (I-63)+(S13-6); (I-63)+(S13-7); (I-63)+(S13-8); (I-63)+(S13-9); (I-63)+(S14-1)
(I-64)+(S1-1); (I-64)+(S1-2); (I-64)+(S1-3); (I-64)+(S1-4); (I-64)+(S1-5); (I-64)+(S1-6); (I-64)+(S1-7); (I-64)+(S1-8); (I-64)+(S1-9); (I-64)+(S1-10); (I-64)+(S1-11); (I-64)+(S1-12); (I-64)+(S1-13); (I-64)+(S2-1); (I-64)+(S2-2); (I-64)+(S2-3); (I-64)+(S2-4); (I-64)+(S2-5); (I-64)+(S2-6); (I-64)+(S2-7); (I-64)+(S2-8); (I-64)+(S2-9); (I-64)+(S2-10); (I-64)+(S3-1); (I-64)+(S3-2); (I-64)+(S3-3); (I-64)+(S3-4); (I-64)+(S3-5); (I-64)+(S3-6); (I-64)+(S3-7); (I-64)+(S3-8); (I-64)+(S3-9); (I-64)+(S3-10); (I-64)+(S3-11); (I-64)+(S4-1); (I-64)+(S4-2); (I-64)+(S4-3); (I-64)+(S4-4); (I-64)+(S4-5); (I-64)+(S7-1); (I-64)+(S11-1); (I-64)+(S11-2); (I-64)+(S11-3); (I-64)+(S12-1); (I-64)+(S13-1); (I-64)+(S13-2); (I-64)+(S13-3); (I-64)+(S13-4): (I-64)+(S13-5); (I-64)+(S13-6); (I-64)+(S13-7); (I-64)+(S13-8); (I-64)+(S13-9); (I-64)+(S14-1)
(I-65)+(S1-1); (I-65)+(S1-2); (I-65)+(S1-3); (I-65)+(S1-4); (I-65)+(S1-5); (I-65)+(S1-6); (I-65)+(S1-7); (I-65)+(S1-8); (I-65)+(S1-9); (I-65)+(S1-10); (I-65)+(S1-11); (I-65)+(S1-12); (I-65)+(S1-13); (I-65)+(S2-1); (I-65)+(S2-2); (I-65)+(S2-3); (I-65)+(S2-4); (I-65)+(S2-5); (I-65)+(S2-6); (I-65)+(S2-7); (I-65)+(S2-8); (I-65)+(S2-9); (I-65)+(S2-10); (I-65)+(S3-1); (I-65)+(S3-2); (I-65)+(S3-3); (I-65)+(S3-4); (I-65)+(S3-5); (I-65)+(S3-6); (I-65)+(S3-7); (I-65)+(S3-8); (I-65)+(S3-9); (I-65)+(S3-10); (I-65)+(S3-11); (I-65)+(S4-1); (I-65)+(S4-2); (I-65)+(S4-3); (I-65)+(S4-4); (I-65)+(S4-5); (I-65)+(S7-1); (I-65)+(S11-1); (I-65)+(S11-2); (I-65)+(S11-3); (I-65)+(S12-1); (I-65)+(S13-1); (I-65)+(S13-2); (I-65)+(S13-3); (I-65)+(S13-4): (I-65)+(S13-5); (I-65)+(S13-6); (I-65)+(S13-7); (I-65)+(S13-8); (I-65)+(S13-9); (I-65)+(S14-1)
(I-66)+(S1-1); (I-66)+(S1-2); (I-66)+(S1-3); (I-66)+(S1-4); (I-66)+(S1-5); (I-66)+(S1-6); (I-66)+(S1-7); (I-66)+(S1-8); (I-66)+(S1-9); (I-66)+(S1-10); (I-66)+(S1-11); (I-66)+(S1-12); (I-66)+(S1-13); (I-66)+(S2-1); (I-66)+(S2-2); (I-66)+(S2-3); (I-66)+(S2-4); (I-66)+(S2-5); (I-66)+(S2-6); (I-66)+(S2-7); (I-66)+(S2-8); (I-66)+(S2-9); (I-66)+(S2-10); (I-66)+(S3-1); (I-66)+(S3-2); (I-66)+(S3-3); (I-66)+(S3-4); (I-66)+(S3-5); (I-66)+(S3-6); (I-66)+(S3-7); (I-66)+(S3-8); (I-66)+(S3-9); (I-66)+(S3-10); (I-66)+(S3-11); (I-66)+(S4-1); (I-66)+(S4-2); (I-66)+(S4-3); (I-66)+(S4-4); (I-66)+(S4-5); (I-66)+(S7-1); (I-66)+(S11-1); (I-66)+(S11-2); (I-66)+(S11-3); (I-66)+(S12-1); (I-66)+(S13-1); (I-66)+(S13-2); (I-66)+(S13-3); (I-66)+(S13-4): (I-66)+(S13-5); (I-66)+(S13-6); (I-66)+(S13-7); (I-66)+(S13-8); (I-66)+(S13-9); (I-66)+(S14-1)
(I-67)+(S1-1); (I-67)+(S1-2); (I-67)+(S1-3); (I-67)+(S1-4); (I-67)+(S1-5); (I-67)+(S1-6); (I-67)+(S1-7); (I-67)+(S1-8); (I-67)+(S1-9); (I-67)+(S1-10); (I-67)+(S1-11); (I-67)+(S1-12); (I-67)+(S1-13); (I-67)+(S2-1); (I-67)+(S2-2); (I-67)+(S2-3); (I-67)+(S2-4); (I-67)+(S2-5); (I-67)+(S2-6); (I-67)+(S2-7); (I-67)+(S2-8); (I-67)+(S2-9); (I-67)+(S2-10); (I-67)+(S3-1); (I-67)+(S3-2); (I-67)+(S3-3); (I-67)+(S3-4); (I-67)+(S3-5); (I-67)+(S3-6); (I-67)+(S3-7); (I-67)+(S3-8); (I-67)+(S3-9); (I-67)+(S3-10); (I-67)+(S3-11); (I-67)+(S4-1); (I-67)+(S4-2); (I-67)+(S4-3); (I-67)+(S4-4); (I-67)+(S4-5); (I-67)+(S7-1); (I-67)+(S11-1); (I-67)+(S11-2); (I-67)+(S11-3); (I-67)+(S12-1); (I-67)+(S13-1); (I-67)+(S13-2); (I-67)+(S13-3); (I-67)+(S13-4): (I-67)+(S13-5); (I-67)+(S13-6); (I-67)+(S13-7); (I-67)+(S13-8); (I-67)+(S13-9); (I-67)+(S14-1)
(I-68)+(S1-1); (I-68)+(S1-2); (I-68)+(S1-3); (I-68)+(S1-4); (I-68)+(S1-5); (I-68)+(S1-6); (I-68)+(S1-7); (I-68)+(S1-8); (I-68)+(S1-9); (I-68)+(S1-10); (I-68)+(S1-11); (I-68)+(S1-12); (I-68)+(S1-13); (I-68)+(S2-1); (I-68)+(S2-2); (I-68)+(S2-3); (I-68)+(S2-4); (I-68)+(S2-5); (I-68)+(S2-6); (I-68)+(S2-7); (I-68)+(S2-8); (I-68)+(S2-9); (I-68)+(S2-10); (I-68)+(S3-1); (I-68)+(S3-2); (I-68)+(S3-3); (I-68)+(S3-4); (I-68)+(S3-5); (I-68)+(S3-6); (I-68)+(S3-7); (I-68)+(S3-8); (I-68)+(S3-9); (I-68)+(S3-10); (I-68)+(S3-11); (I-68)+(S4-1); (I-68)+(S4-2); (I-68)+(S4-3); (I-68)+(S4-4); (I-68)+(S4-5); (I-68)+(S7-1); (I-68)+(S11-1); (I-68)+(S11-2); (I-68)+(S11-3); (I-68)+(S12-1); (I-68)+(S13-1); (I-68)+(S13-2); (I-68)+(S13-3); (I-68)+(S13-4): (I-68)+(S13-5); (I-68)+(S13-6); (I-68)+(S13-7); (I-68)+(S13-8); (I-68)+(S13-9); (I-68)+(S14-1)
(I-69)+(S1-1); (I-69)+(S1-2); (I-69)+(S1-3); (I-69)+(S1-4); (I-69)+(S1-5); (I-69)+(S1-6); (I-69)+(S1-7); (I-69)+(S1-8); (I-69)+(S1-9); (I-69)+(S1-10); (I-69)+(S1-11); (I-69)+(S1-12); (I-69)+(S1-13); (I-69)+(S2-1); (I-69)+(S2-2); (I-69)+(S2-3); (I-69)+(S2-4); (I-69)+(S2-5); (I-69)+(S2-6); (I-69)+(S2-7); (I-69)+(S2-8); (I-69)+(S2-9); (I-69)+(S2-10); (I-69)+(S3-1); (I-69)+(S3-2); (I-69)+(S3-3); (I-69)+(S3-4); (I-69)+(S3-5); (I-69)+(S3-6); (I-69)+(S3-7); (I-69)+(S3-8); (I-69)+(S3-9); (I-69)+(S3-10); (I-69)+(S3-11); (I-69)+(S4-1); (I-69)+(S4-2); (I-69)+(S4-3); (I-69)+(S4-4); (I-69)+(S4-5); (I-69)+(S7-1); (I-69)+(S11-1); (I-69)+(S11-2); (I-69)+(S11-3); (I-69)+(S12-1); (I-69)+(S13-1); (I-69)+(S13-2); (I-69)+(S13-3); (I-69)+(S13-4): (I-69)+(S13-5); (I-69)+(S13-6); (I-69)+(S13-7); (I-69)+(S13-8); (I-69)+(S13-9); (I-69)+(S14-1)
(I-70)+(S1-1); (I-70)+(S1-2); (I-70)+(S1-3); (I-70)+(S1-4); (I-70)+(S1-5); (I-70)+(S1-6); (I-70)+(S1-7); (I-70)+(S1-8); (I-70)+(S1-9); (I-70)+(S1-10); (I-70)+(S1-11); (I-70)+(S1-12); (I-70)+(S1-13); (I-70)+(S2-1); (I-70)+(S2-2); (I-70)+(S2-3); (I-70)+(S2-4); (I-70)+(S2-5); (I-70)+(S2-6); (I-70)+(S2-7); (I-70)+(S2-8); (I-70)+(S2-9); (I-70)+(S2-10); (I-70)+(S3-1); (I-70)+(S3-2); (I-70)+(S3-3); (I-70)+(S3-4); (I-70)+(S3-5); (I-70)+(S3-6); (I-70)+(S3-7); (I-70)+(S3-8); (I-70)+(S3-9); (I-70)+(S3-10); (I-70)+(S3-11); (I-70)+(S4-1); (I-70)+(S4-2); (I-70)+(S4-3); (I-70)+(S4-4); (I-70)+(S4-5); (I-70)+(S7-1); (I-70)+(S11-1); (I-70)+(S11-2); (I-70)+(S11-3); (I-70)+(S12-1); (I-70)+(S13-1); (I-70)+(S13-2); (I-70)+(S13-3); (I-70)+(S13-4): (I-70)+(S13-5); (I-70)+(S13-6); (I-70)+(S13-7); (I-70)+(S13-8); (I-70)+(S13-9); (I-70)+(S14-1)
(I-71)+(S1-1); (I-71)+(S1-2); (I-71)+(S1-3); (I-71)+(S1-4); (I-71)+(S1-5); (I-71)+(S1-6); (I-71)+(S1-7); (I-71)+(S1-8); (I-71)+(S1-9); (I-71)+(S1-10); (I-71)+(S1-11); (I-71)+(S1-12); (I-71)+(S1-13); (I-71)+(S2-1); (I-71)+(S2-2); (I-71)+(S2-3); (I-71)+(S2-4); (I-71)+(S2-5); (I-71)+(S2-6); (I-71)+(S2-7); (I-71)+(S2-8); (I-71)+(S2-9); (I-71)+(S2-10); (I-71)+(S3-1); (I-71)+(S3-2); (I-71)+(S3-3); (I-71)+(S3-4); (I-71)+(S3-5); (I-71)+(S3-6); (I-71)+(S3-7); (I-71)+(S3-8); (I-71)+(S3-9); (I-71)+(S3-10); (I-71)+(S3-11); (I-71)+(S4-1); (I-71)+(S4-2); (I-71)+(S4-3); (I-71)+(S4-4); (I-71)+(S4-5); (I-71)+(S7-1); (I-71)+(S11-1); (I-71)+(S11-2); (I-71)+(S11-3); (I-71)+(S12-1); (I-71)+(S13-1); (I-71)+(S13-2); (I-71)+(S13-3); (I-71)+(S13-4): (I-71)+(S13-5); (I-71)+(S13-6); (I-71)+(S13-7); (I-71)+(S13-8); (I-71)+(S13-9); (I-71)+(S14-1)
(I-72)+(S1-1); (I-72)+(S1-2); (I-72)+(S1-3); (I-72)+(S1-4); (I-72)+(S1-5); (I-72)+(S1-6); (I-72)+(S1-7); (I-72)+(S1-8); (I-72)+(S1-9); (I-72)+(S1-10); (I-72)+(S1-11); (I-72)+(S1-12); (I-72)+(S1-13); (I-72)+(S2-1); (I-72)+(S2-2); (I-72)+(S2-3); (I-72)+(S2-4); (I-72)+(S2-5); (I-72)+(S2-6); (I-72)+(S2-7); (I-72)+(S2-8); (I-72)+(S2-9); (I-72)+(S2-10); (I-72)+(S3-1); (I-72)+(S3-2); (I-72)+(S3-3); (I-72)+(S3-4); (I-72)+(S3-5); (I-72)+(S3-6); (I-72)+(S3-7); (I-72)+(S3-8); (I-72)+(S3-9); (I-72)+(S3-10); (I-72)+(S3-11); (I-72)+(S4-1); (I-72)+(S4-2); (I-72)+(S4-3); (I-72)+(S4-4); (I-72)+(S4-5); (I-72)+(S7-1); (I-72)+(S11-1); (I-72)+(S11-2); (I-72)+(S11-3); (I-72)+(S12-1); (I-72)+(S13-1); (I-72)+(S13-2); (I-72)+(S13-3); (I-72)+(S13-4): (I-72)+(S13-5); (I-72)+(S13-6); (I-72)+(S13-7); (I-72)+(S13-8); (I-72)+(S13-9); (I-72)+(S14-1)
(I-73)+(S1-1); (I-73)+(S1-2); (I-73)+(S1-3); (I-73)+(S1-4); (I-73)+(S1-5); (I-73)+(S1-6); (I-73)+(S1-7); (I-73)+(S1-8); (I-73)+(S1-9); (I-73)+(S1-10); (I-73)+(S1-11); (I-73)+(S1-12); (I-73)+(S1-13); (I-73)+(S2-1); (I-73)+(S2-2); (I-73)+(S2-3); (I-73)+(S2-4); (I-73)+(S2-5); (I-73)+(S2-6); (I-73)+(S2-7); (I-73)+(S2-8); (I-73)+(S2-9); (I-73)+(S2-10); (I-73)+(S3-1); (I-73)+(S3-2); (I-73)+(S3-3); (I-73)+(S3-4); (I-73)+(S3-5); (I-73)+(S3-6); (I-73)+(S3-7); (I-73)+(S3-8); (I-73)+(S3-9); (I-73)+(S3-10); (I-73)+(S3-11); (I-73)+(S4-1); (I-73)+(S4-2); (I-73)+(S4-3); (I-73)+(S4-4); (I-73)+(S4-5); (I-73)+(S7-1); (I-73)+(S11-1); (I-73)+(S11-2); (I-73)+(S11-3); (I-73)+(S12-1); (I-73)+(S13-1); (I-73)+(S13-2); (I-73)+(S13-3); (I-73)+(S13-4): (I-73)+(S13-5); (I-73)+(S13-6); (I-73)+(S13-7); (I-73)+(S13-8); (I-73)+(S13-9); (I-73)+(S14-1)
(I-74)+(S1-1); (I-74)+(S1-2); (I-74)+(S1-3); (I-74)+(S1-4); (I-74)+(S1-5); (I-74)+(S1-6); (I-74)+(S1-7); (I-74)+(S1-8); (I-74)+(S1-9); (I-74)+(S1-10); (I-74)+(S1-11); (I-74)+(S1-12); (I-74)+(S1-13); (I-74)+(S2-1); (I-74)+(S2-2); (I-74)+(S2-3); (I-74)+(S2-4); (I-74)+(S2-5); (I-74)+(S2-6); (I-74)+(S2-7); (I-74)+(S2-8); (I-74)+(S2-9); (I-74)+(S2-10); (I-74)+(S3-1); (I-74)+(S3-2); (I-74)+(S3-3); (I-74)+(S3-4); (I-74)+(S3-5); (I-74)+(S3-6); (I-74)+(S3-7); (I-74)+(S3-8); (I-74)+(S3-9); (I-74)+(S3-10); (I-74)+(S3-11); (I-74)+(S4-1); (I-74)+(S4-2); (I-74)+(S4-3); (I-74)+(S4-4); (I-74)+(S4-5); (I-74)+(S7-1); (I-74)+(S11-1); (I-74)+(S11-2); (I-74)+(S11-3); (I-74)+(S12-1); (I-74)+(S13-1); (I-74)+(S13-2); (I-74)+(S13-3); (I-74)+(S13-4): (I-74)+(S13-5); (I-74)+(S13-6); (I-74)+(S13-7); (I-74)+(S13-8); (I-74)+(S13-9); (I-74)+(S14-1)
(I-75)+(S1-1); (I-75)+(S1-2); (I-75)+(S1-3); (I-75)+(S1-4); (I-75)+(S1-5); (I-75)+(S1-6); (I-75)+(S1-7); (I-75)+(S1-8); (I-75)+(S1-9); (I-75)+(S1-10); (I-75)+(S1-11); (I-75)+(S1-12); (I-75)+(S1-13); (I-75)+(S2-1); (I-75)+(S2-2); (I-75)+(S2-3); (I-75)+(S2-4); (I-75)+(S2-5); (I-75)+(S2-6); (I-75)+(S2-7); (I-75)+(S2-8); (I-75)+(S2-9); (I-75)+(S2-10); (I-75)+(S3-1); (I-75)+(S3-2); (I-75)+(S3-3); (I-75)+(S3-4); (I-75)+(S3-5); (I-75)+(S3-6); (I-75)+(S3-7); (I-75)+(S3-8); (I-75)+(S3-9); (I-75)+(S3-10); (I-75)+(S3-11); (I-75)+(S4-1); (I-75)+(S4-2); (I-75)+(S4-3); (I-75)+(S4-4); (I-75)+(S4-5); (I-75)+(S7-1); (I-75)+(S11-1); (I-75)+(S11-2); (I-75)+(S11-3); (I-75)+(S12-1); (I-75)+(S13-1); (I-75)+(S13-2); (I-75)+(S13-3); (I-75)+(S13-4): (I-75)+(S13-5); (I-75)+(S13-6); (I-75)+(S13-7); (I-75)+(S13-8); (I-75)+(S13-9); (I-75)+(S14-1)
(I-76)+(S1-1); (I-76)+(S1-2); (I-76)+(S1-3); (I-76)+(S1-4); (I-76)+(S1-5); (I-76)+(S1-6); (I-76)+(S1-7); (I-76)+(S1-8); (I-76)+(S1-9); (I-76)+(S1-10); (I-76)+(S1-11); (I-76)+(S1-12); (I-76)+(S1-13); (I-76)+(S2-1); (I-76)+(S2-2); (I-76)+(S2-3); (I-76)+(S2-4); (I-76)+(S2-5); (I-76)+(S2-6); (I-76)+(S2-7); (I-76)+(S2-8); (I-76)+(S2-9); (I-76)+(S2-10); (I-76)+(S3-1); (I-76)+(S3-2); (I-76)+(S3-3); (I-76)+(S3-4); (I-76)+(S3-5); (I-76)+(S3-6); (I-76)+(S3-7); (I-76)+(S3-8); (I-76)+(S3-9); (I-76)+(S3-10); (I-76)+(S3-11); (I-76)+(S4-1); (I-76)+(S4-2); (I-76)+(S4-3); (I-76)+(S4-4); (I-76)+(S4-5); (I-76)+(S7-1); (I-76)+(S11-1); (I-76)+(S11-2); (I-76)+(S11-3); (I-76)+(S12-1); (I-76)+(S13-1); (I-76)+(S13-2); (I-76)+(S13-3); (I-76)+(S13-4): (I-76)+(S13-5); (I-76)+(S13-6); (I-76)+(S13-7); (I-76)+(S13-8); (I-76)+(S13-9); (I-76)+(S14-1)
(I-77)+(S1-1); (I-77)+(S1-2); (I-77)+(S1-3); (I-77)+(S1-4); (I-77)+(S1-5); (I-77)+(S1-6); (I-77)+(S1-7); (I-77)+(S1-8); (I-77)+(S1-9); (I-77)+(S1-10); (I-77)+(S1-11); (I-77)+(S1-12); (I-77)+(S1-13); (I-77)+(S2-1); (I-77)+(S2-2); (I-77)+(S2-3); (I-77)+(S2-4); (I-77)+(S2-5); (I-77)+(S2-6); (I-77)+(S2-7); (I-77)+(S2-8); (I-77)+(S2-9); (I-77)+(S2-10); (I-77)+(S3-1); (I-77)+(S3-2); (I-77)+(S3-3); (I-77)+(S3-4); (I-77)+(S3-5); (I-77)+(S3-6); (I-77)+(S3-7); (I-77)+(S3-8); (I-77)+(S3-9); (I-77)+(S3-10); (I-77)+(S3-11); (I-77)+(S4-1); (I-77)+(S4-2); (I-77)+(S4-3); (I-77)+(S4-4); (I-77)+(S4-5); (I-77)+(S7-1); (I-77)+(S11-1); (I-77)+(S11-2); (I-77)+(S11-3); (I-77)+(S12-1); (I-77)+(S13-1); (I-77)+(S13-2); (I-77)+(S13-3); (I-77)+(S13-4): (I-77)+(S13-5); (I-77)+(S13-6); (I-77)+(S13-7); (I-77)+(S13-8); (I-77)+(S13-9); (I-77)+(S14-1)
(I-78)+(S1-1); (I-78)+(S1-2); (I-78)+(S1-3); (I-78)+(S1-4); (I-78)+(S1-5); (I-78)+(S1-6); (I-78)+(S1-7); (I-78)+(S1-8); (I-78)+(S1-9); (I-78)+(S1-10); (I-78)+(S1-11); (I-78)+(S1-12); (I-78)+(S1-13); (I-78)+(S2-1); (I-78)+(S2-2); (I-78)+(S2-3); (I-78)+(S2-4); (I-78)+(S2-5); (I-78)+(S2-6); (I-78)+(S2-7); (I-78)+(S2-8); (I-78)+(S2-9); (I-78)+(S2-10); (I-78)+(S3-1); (I-78)+(S3-2); (I-78)+(S3-3); (I-78)+(S3-4); (I-78)+(S3-5); (I-78)+(S3-6); (I-78)+(S3-7); (I-78)+(S3-8); (I-78)+(S3-9); (I-78)+(S3-10); (I-78)+(S3-11); (I-78)+(S4-1); (I-78)+(S4-2); (I-78)+(S4-3); (I-78)+(S4-4); (I-78)+(S4-5); (I-78)+(S7-1); (I-78)+(S11-1); (I-78)+(S11-2); (I-78)+(S11-3); (I-78)+(S12-1); (I-78)+(S13-1); (I-78)+(S13-2); (I-78)+(S13-3); (I-78)+(S13-4): (I-78)+(S13-5); (I-78)+(S13-6); (I-78)+(S13-7); (I-78)+(S13-8); (I-78)+(S13-9); (I-78)+(S14-1)
(I-79)+(S1-1); (I-79)+(S1-2); (I-79)+(S1-3); (I-79)+(S1-4); (I-79)+(S1-5); (I-79)+(S1-6); (I-79)+(S1-7); (I-79)+(S1-8); (I-79)+(S1-9); (I-79)+(S1-10); (I-79)+(S1-11); (I-79)+(S1-12); (I-79)+(S1-13); (I-79)+(S2-1); (I-79)+(S2-2); (I-79)+(S2-3); (I-79)+(S2-4); (I-79)+(S2-5); (I-79)+(S2-6); (I-79)+(S2-7); (I-79)+(S2-8); (I-79)+(S2-9); (I-79)+(S2-10); (I-79)+(S3-1); (I-79)+(S3-2); (I-79)+(S3-3); (I-79)+(S3-4); (I-79)+(S3-5); (I-79)+(S3-6); (I-79)+(S3-7); (I-79)+(S3-8); (I-79)+(S3-9); (I-79)+(S3-10); (I-79)+(S3-11); (I-79)+(S4-1); (I-79)+(S4-2); (I-79)+(S4-3); (I-79)+(S4-4); (I-79)+(S4-5); (I-79)+(S7-1); (I-79)+(S11-1); (I-79)+(S11-2); (I-79)+(S11-3); (I-79)+(S12-1); (I-79)+(S13-1); (I-79)+(S13-2); (I-79)+(S13-3); (I-79)+(S13-4): (I-79)+(S13-5); (I-79)+(S13-6); (I-79)+(S13-7); (I-79)+(S13-8); (I-79)+(S13-9); (I-79)+(S14-1)
(I-80)+(S1-1); (I-80)+(S1-2); (I-80)+(S1-3); (I-80)+(S1-4); (I-80)+(S1-5); (I-80)+(S1-6); (I-80)+(S1-7); (I-80)+(S1-8); (I-80)+(S1-9); (I-80)+(S1-10); (I-80)+(S1-11); (I-80)+(S1-12); (I-80)+(S1-13); (I-80)+(S2-1); (I-80)+(S2-2); (I-80)+(S2-3); (I-80)+(S2-4); (I-80)+(S2-5); (I-80)+(S2-6); (I-80)+(S2-7); (I-80)+(S2-8); (I-80)+(S2-9); (I-80)+(S2-10); (I-80)+(S3-1); (I-80)+(S3-2); (I-80)+(S3-3); (I-80)+(S3-4); (I-80)+(S3-5); (I-80)+(S3-6); (I-80)+(S3-7); (I-80)+(S3-8); (I-80)+(S3-9); (I-80)+(S3-10); (I-80)+(S3-11); (I-80)+(S4-1); (I-80)+(S4-2); (I-80)+(S4-3); (I-80)+(S4-4); (I-80)+(S4-5); (I-80)+(S7-1); (I-80)+(S11-1); (I-80)+(S11-2); (I-80)+(S11-3); (I-80)+(S12-1); (I-80)+(S13-1); (I-80)+(S13-2); (I-80)+(S13-3); (I-80)+(S13-4): (I-80)+(S13-5); (I-80)+(S13-6); (I-80)+(S13-7); (I-80)+(S13-8); (I-80)+(S13-9); (I-80)+(S14-1)
(I-81)+(S1-1); (I-81)+(S1-2); (I-81)+(S1-3); (I-81)+(S1-4); (I-81)+(S1-5); (I-81)+(S1-6); (I-81)+(S1-7); (I-81)+(S1-8); (I-81)+(S1-9); (I-81)+(S1-10); (I-81)+(S1-11); (I-81)+(S1-12); (I-81)+(S1-13); (I-81)+(S2-1); (I-81)+(S2-2); (I-81)+(S2-3); (I-81)+(S2-4); (I-81)+(S2-5); (I-81)+(S2-6); (I-81)+(S2-7); (I-81)+(S2-8); (I-81)+(S2-9); (I-81)+(S2-10); (I-81)+(S3-1); (I-81)+(S3-2); (I-81)+(S3-3); (I-81)+(S3-4); (I-81)+(S3-5); (I-81)+(S3-6); (I-81)+(S3-7); (I-81)+(S3-8); (I-81)+(S3-9); (I-81)+(S3-10); (I-81)+(S3-11); (I-81)+(S4-1); (I-81)+(S4-2); (I-81)+(S4-3); (I-81)+(S4-4); (I-81)+(S4-5); (I-81)+(S7-1); (I-81)+(S11-1); (I-81)+(S11-2); (I-81)+(S11-3); (I-81)+(S12-1); (I-81)+(S13-1); (I-81)+(S13-2); (I-81)+(S13-3); (I-81)+(S13-4): (I-81)+(S13-5); (I-81)+(S13-6); (I-81)+(S13-7); (I-81)+(S13-8); (I-81)+(S13-9); (I-81)+(S14-1)
(I-82)+(S1-1); (I-82)+(S1-2); (I-82)+(S1-3); (I-82)+(S1-4); (I-82)+(S1-5); (I-82)+(S1-6); (I-82)+(S1-7); (I-82)+(S1-8); (I-82)+(S1-9); (I-82)+(S1-10); (I-82)+(S1-11); (I-82)+(S1-12); (I-82)+(S1-13); (I-82)+(S2-1); (I-82)+(S2-2); (I-82)+(S2-3); (I-82)+(S2-4); (I-82)+(S2-5); (I-82)+(S2-6); (I-82)+(S2-7); (I-82)+(S2-8); (I-82)+(S2-9); (I-82)+(S2-10); (I-82)+(S3-1); (I-82)+(S3-2); (I-82)+(S3-3); (I-82)+(S3-4); (I-82)+(S3-5); (I-82)+(S3-6); (I-82)+(S3-7); (I-82)+(S3-8); (I-82)+(S3-9); (I-82)+(S3-10); (I-82)+(S3-11); (I-82)+(S4-1); (I-82)+(S4-2); (I-82)+(S4-3); (I-82)+(S4-4); (I-82)+(S4-5); (I-82)+(S7-1); (I-82)+(S11-1); (I-82)+(S11-2); (I-82)+(S11-3); (I-82)+(S12-1); (I-82)+(S13-1); (I-82)+(S13-2); (I-82)+(S13-3); (I-82)+(S13-4): (I-82)+(S13-5); (I-82)+(S13-6); (I-82)+(S13-7); (I-82)+(S13-8); (I-82)+(S13-9); (I-82)+(S14-1)
(I-83)+(S1-1); (I-83)+(S1-2); (I-83)+(S1-3); (I-83)+(S1-4); (I-83)+(S1-5); (I-83)+(S1-6); (I-83)+(S1-7); (I-83)+(S1-8); (I-83)+(S1-9); (I-83)+(S1-10); (I-83)+(S1-11); (I-83)+(S1-12); (I-83)+(S1-13); (I-83)+(S2-1); (I-83)+(S2-2); (I-83)+(S2-3); (I-83)+(S2-4); (I-83)+(S2-5); (I-83)+(S2-6); (I-83)+(S2-7); (I-83)+(S2-8); (I-83)+(S2-9); (I-83)+(S2-10); (I-83)+(S3-1); (I-83)+(S3-2); (I-83)+(S3-3); (I-83)+(S3-4); (I-83)+(S3-5); (I-83)+(S3-6); (I-83)+(S3-7); (I-83)+(S3-8); (I-83)+(S3-9); (I-83)+(S3-10); (I-83)+(S3-11); (I-83)+(S4-1); (I-83)+(S4-2); (I-83)+(S4-3); (I-83)+(S4-4); (I-83)+(S4-5); (I-83)+(S7-1); (I-83)+(S11-1); (I-83)+(S11-2); (I-83)+(S11-3); (I-83)+(S12-1); (I-83)+(S13-1); (I-83)+(S13-2); (I-83)+(S13-3); (I-83)+(S13-4): (I-83)+(S13-5); (I-83)+(S13-6); (I-83)+(S13-7); (I-83)+(S13-8); (I-83)+(S13-9); (I-83)+(S14-1)
(I-84)+(S1-1); (I-84)+(S1-2); (I-84)+(S1-3); (I-84)+(S1-4); (I-84)+(S1-5); (I-84)+(S1-6); (I-84)+(S1-7); (I-84)+(S1-8); (I-84)+(S1-9); (I-84)+(S1-10); (I-84)+(S1-11); (I-84)+(S1-12); (I-84)+(S1-13); (I-84)+(S2-1); (I-84)+(S2-2); (I-84)+(S2-3); (I-84)+(S2-4); (I-84)+(S2-5); (I-84)+(S2-6); (I-84)+(S2-7); (I-84)+(S2-8); (I-84)+(S2-9); (I-84)+(S2-10); (I-84)+(S3-1); (I-84)+(S3-2); (I-84)+(S3-3); (I-84)+(S3-4); (I-84)+(S3-5); (I-84)+(S3-6); (I-84)+(S3-7); (I-84)+(S3-8); (I-84)+(S3-9); (I-84)+(S3-10); (I-84)+(S3-11); (I-84)+(S4-1); (I-84)+(S4-2); (I-84)+(S4-3); (I-84)+(S4-4); (I-84)+(S4-5); (I-84)+(S7-1); (I-84)+(S11-1); (I-84)+(S11-2); (I-84)+(S11-3); (I-84)+(S12-1); (I-84)+(S13-1); (I-84)+(S13-2); (I-84)+(S13-3); (I-84)+(S13-4): (I-84)+(S13-5); (I-84)+(S13-6); (I-84)+(S13-7); (I-84)+(S13-8); (I-84)+(S13-9); (I-84)+(S14-1)
(I-85)+(S1-1); (I-85)+(S1-2); (I-85)+(S1-3); (I-85)+(S1-4); (I-85)+(S1-5); (I-85)+(S1-6); (I-85)+(S1-7); (I-85)+(S1-8); (I-85)+(S1-9); (I-85)+(S1-10); (I-85)+(S1-11); (I-85)+(S1-12); (I-85)+(S1-13); (I-85)+(S2-1); (I-85)+(S2-2); (I-85)+(S2-3); (I-85)+(S2-4); (I-85)+(S2-5); (I-85)+(S2-6); (I-85)+(S2-7); (I-85)+(S2-8); (I-85)+(S2-9); (I-85)+(S2-10); (I-85)+(S3-1); (I-85)+(S3-2); (I-85)+(S3-3); (I-85)+(S3-4); (I-85)+(S3-5); (I-85)+(S3-6); (I-85)+(S3-7); (I-85)+(S3-8); (I-85)+(S3-9); (I-85)+(S3-10); (I-85)+(S3-11); (I-85)+(S4-1); (I-85)+(S4-2); (I-85)+(S4-3); (I-85)+(S4-4); (I-85)+(S4-5); (I-85)+(S7-1); (I-85)+(S11-1); (I-85)+(S11-2); (I-85)+(S11-3); (I-85)+(S12-1); (I-85)+(S13-1); (I-85)+(S13-2); (I-85)+(S13-3); (I-85)+(S13-4): (I-85)+(S13-5); (I-85)+(S13-6); (I-85)+(S13-7); (I-85)+(S13-8); (I-85)+(S13-9); (I-85)+(S14-1)
(I-86)+(S1-1); (I-86)+(S1-2); (I-86)+(S1-3); (I-86)+(S1-4); (I-86)+(S1-5); (I-86)+(S1-6); (I-86)+(S1-7); (I-86)+(S1-8); (I-86)+(S1-9); (I-86)+(S1-10); (I-86)+(S1-11); (I-86)+(S1-12); (I-86)+(S1-13); (I-86)+(S2-1); (I-86)+(S2-2); (I-86)+(S2-3); (I-86)+(S2-4); (I-86)+(S2-5); (I-86)+(S2-6); (I-86)+(S2-7); (I-86)+(S2-8); (I-86)+(S2-9); (I-86)+(S2-10); (I-86)+(S3-1); (I-86)+(S3-2); (I-86)+(S3-3); (I-86)+(S3-4); (I-86)+(S3-5); (I-86)+(S3-6); (I-86)+(S3-7); (I-86)+(S3-8); (I-86)+(S3-9); (I-86)+(S3-10); (I-86)+(S3-11); (I-86)+(S4-1); (I-86)+(S4-2); (I-86)+(S4-3); (I-86)+(S4-4); (I-86)+(S4-5); (I-86)+(S7-1); (I-86)+(S11-1); (I-86)+(S11-2); (I-86)+(S11-3); (I-86)+(S12-1); (I-86)+(S13-1); (I-86)+(S13-2); (I-86)+(S13-3); (I-86)+(S13-4): (I-86)+(S13-5); (I-86)+(S13-6); (I-86)+(S13-7); (I-86)+(S13-8); (I-86)+(S13-9); (I-86)+(S14-1)
(I-87)+(S1-1); (I-87)+(S1-2); (I-87)+(S1-3); (I-87)+(S1-4); (I-87)+(S1-5); (I-87)+(S1-6); (I-87)+(S1-7); (I-87)+(S1-8); (I-87)+(S1-9); (I-87)+(S1-10); (I-87)+(S1-11); (I-87)+(S1-12); (I-87)+(S1-13); (I-87)+(S2-1); (I-87)+(S2-2); (I-87)+(S2-3); (I-87)+(S2-4); (I-87)+(S2-5); (I-87)+(S2-6); (I-87)+(S2-7); (I-87)+(S2-8); (I-87)+(S2-9); (I-87)+(S2-10); (I-87)+(S3-1); (I-87)+(S3-2); (I-87)+(S3-3); (I-87)+(S3-4); (I-87)+(S3-5); (I-87)+(S3-6); (I-87)+(S3-7); (I-87)+(S3-8); (I-87)+(S3-9); (I-87)+(S3-10); (I-87)+(S3-11); (I-87)+(S4-1); (I-87)+(S4-2); (I-87)+(S4-3); (I-87)+(S4-4); (I-87)+(S4-5); (I-87)+(S7-1); (I-87)+(S11-1); (I-87)+(S11-2); (I-87)+(S11-3); (I-87)+(S12-1); (I-87)+(S13-1); (I-87)+(S13-2); (I-87)+(S13-3); (I-87)+(S13-4): (I-87)+(S13-5); (I-87)+(S13-6); (I-87)+(S13-7); (I-87)+(S13-8); (I-87)+(S13-9); (I-87)+(S14-1)
(I-88)+(S1-1); (I-88)+(S1-2); (I-88)+(S1-3); (I-88)+(S1-4); (I-88)+(S1-5); (I-88)+(S1-6); (I-88)+(S1-7); (I-88)+(S1-8); (I-88)+(S1-9); (I-88)+(S1-10); (I-88)+(S1-11); (I-88)+(S1-12); (I-88)+(S1-13); (I-88)+(S2-1); (I-88)+(S2-2); (I-88)+(S2-3); (I-88)+(S2-4); (I-88)+(S2-5); (I-88)+(S2-6); (I-88)+(S2-7); (I-88)+(S2-8); (I-88)+(S2-9); (I-88)+(S2-10); (I-88)+(S3-1); (I-88)+(S3-2); (I-88)+(S3-3); (I-88)+(S3-4); (I-88)+(S3-5); (I-88)+(S3-6); (I-88)+(S3-7); (I-88)+(S3-8); (I-88)+(S3-9); (I-88)+(S3-10); (I-88)+(S3-11); (I-88)+(S4-1); (I-88)+(S4-2); (I-88)+(S4-3); (I-88)+(S4-4); (I-88)+(S4-5); (I-88)+(S7-1); (I-88)+(S11-1); (I-88)+(S11-2); (I-88)+(S11-3); (I-88)+(S12-1); (I-88)+(S13-1); (I-88)+(S13-2); (I-88)+(S13-3); (I-88)+(S13-4): (I-88)+(S13-5); (I-88)+(S13-6); (I-88)+(S13-7); (I-88)+(S13-8); (I-88)+(S13-9); (I-88)+(S14-1)
(I-89)+(S1-1); (I-89)+(S1-2); (I-89)+(S1-3); (I-89)+(S1-4); (I-89)+(S1-5); (I-89)+(S1-6); (I-89)+(S1-7); (I-89)+(S1-8); (I-89)+(S1-9); (I-89)+(S1-10); (I-89)+(S1-11); (I-89)+(S1-12); (I-89)+(S1-13); (I-89)+(S2-1); (I-89)+(S2-2); (I-89)+(S2-3); (I-89)+(S2-4); (I-89)+(S2-5); (I-89)+(S2-6); (I-89)+(S2-7); (I-89)+(S2-8); (I-89)+(S2-9); (I-89)+(S2-10); (I-89)+(S3-1); (I-89)+(S3-2); (I-89)+(S3-3); (I-89)+(S3-4); (I-89)+(S3-5); (I-89)+(S3-6); (I-89)+(S3-7); (I-89)+(S3-8); (I-89)+(S3-9); (I-89)+(S3-10); (I-89)+(S3-11); (I-89)+(S4-1); (I-89)+(S4-2); (I-89)+(S4-3); (I-89)+(S4-4); (I-89)+(S4-5); (I-89)+(S7-1); (I-89)+(S11-1); (I-89)+(S11-2); (I-89)+(S11-3); (I-89)+(S12-1); (I-89)+(S13-1); (I-89)+(S13-2); (I-89)+(S13-3); (I-89)+(S13-4): (I-89)+(S13-5); (I-89)+(S13-6); (I-89)+(S13-7); (I-89)+(S13-8); (I-89)+(S13-9); (I-89)+(S14-1)
(I-90)+(S1-1); (I-90)+(S1-2); (I-90)+(S1-3); (I-90)+(S1-4); (I-90)+(S1-5); (I-90)+(S1-6); (I-90)+(S1-7); (I-90)+(S1-8); (I-90)+(S1-9); (I-90)+(S1-10); (I-90)+(S1-11); (I-90)+(S1-12); (I-90)+(S1-13); (I-90)+(S2-1); (I-90)+(S2-2); (I-90)+(S2-3); (I-90)+(S2-4); (I-90)+(S2-5); (I-90)+(S2-6); (I-90)+(S2-7); (I-90)+(S2-8); (I-90)+(S2-9); (I-90)+(S2-10); (I-90)+(S3-1); (I-90)+(S3-2); (I-90)+(S3-3); (I-90)+(S3-4); (I-90)+(S3-5); (I-90)+(S3-6); (I-90)+(S3-7); (I-90)+(S3-8); (I-90)+(S3-9); (I-90)+(S3-10); (I-90)+(S3-11); (I-90)+(S4-1); (I-90)+(S4-2); (I-90)+(S4-3); (I-90)+(S4-4); (I-90)+(S4-5); (I-90)+(S7-1); (I-90)+(S11-1); (I-90)+(S11-2); (I-90)+(S11-3); (I-90)+(S12-1); (I-90)+(S13-1); (I-90)+(S13-2); (I-90)+(S13-3); (I-90)+(S13-4): (I-90)+(S13-5); (I-90)+(S13-6); (I-90)+(S13-7); (I-90)+(S13-8); (I-90)+(S13-9); (I-90)+(S14-1)
(I-91)+(S1-1); (I-91)+(S1-2); (I-91)+(S1-3); (I-91)+(S1-4); (I-91)+(S1-5); (I-91)+(S1-6); (I-91)+(S1-7); (I-91)+(S1-8); (I-91)+(S1-9); (I-91)+(S1-10); (I-91)+(S1-11); (I-91)+(S1-12); (I-91)+(S1-13); (I-91)+(S2-1); (I-91)+(S2-2); (I-91)+(S2-3); (I-91)+(S2-4); (I-91)+(S2-5); (I-91)+(S2-6); (I-91)+(S2-7); (I-91)+(S2-8); (I-91)+(S2-9); (I-91)+(S2-10); (I-91)+(S3-1); (I-91)+(S3-2); (I-91)+(S3-3); (I-91)+(S3-4); (I-91)+(S3-5); (I-91)+(S3-6); (I-91)+(S3-7); (I-91)+(S3-8); (I-91)+(S3-9); (I-91)+(S3-10); (I-91)+(S3-11); (I-91)+(S4-1); (I-91)+(S4-2); (I-91)+(S4-3); (I-91)+(S4-4); (I-91)+(S4-5); (I-91)+(S7-1); (I-91)+(S11-1); (I-91)+(S11-2); (I-91)+(S11-3); (I-91)+(S12-1); (I-91)+(S13-1); (I-91)+(S13-2); (I-91)+(S13-3); (I-91)+(S13-4): (I-91)+(S13-5); (I-91)+(S13-6); (I-91)+(S13-7); (I-91)+(S13-8); (I-91)+(S13-9); (I-91)+(S14-1)
(I-92)+(S1-1); (I-92)+(S1-2); (I-92)+(S1-3); (I-92)+(S1-4); (I-92)+(S1-5); (I-92)+(S1-6); (I-92)+(S1-7); (I-92)+(S1-8); (I-92)+(S1-9); (I-92)+(S1-10); (I-92)+(S1-11); (I-92)+(S1-12); (I-92)+(S1-13); (I-92)+(S2-1); (I-92)+(S2-2); (I-92)+(S2-3); (I-92)+(S2-4); (I-92)+(S2-5); (I-92)+(S2-6); (I-92)+(S2-7); (I-92)+(S2-8); (I-92)+(S2-9); (I-92)+(S2-10); (I-92)+(S3-1); (I-92)+(S3-2); (I-92)+(S3-3); (I-92)+(S3-4); (I-92)+(S3-5); (I-92)+(S3-6); (I-92)+(S3-7); (I-92)+(S3-8); (I-92)+(S3-9); (I-92)+(S3-10); (I-92)+(S3-11); (I-92)+(S4-1); (I-92)+(S4-2); (I-92)+(S4-3); (I-92)+(S4-4); (I-92)+(S4-5); (I-92)+(S7-1); (I-92)+(S11-1); (I-92)+(S11-2); (I-92)+(S11-3); (I-92)+(S12-1); (I-92)+(S13-1); (I-92)+(S13-2); (I-92)+(S13-3); (I-92)+(S13-4): (I-92)+(S13-5); (I-92)+(S13-6); (I-92)+(S13-7); (I-92)+(S13-8); (I-92)+(S13-9); (I-92)+(S14-1)
(I-93)+(S1-1); (I-93)+(S1-2); (I-93)+(S1-3); (I-93)+(S1-4); (I-93)+(S1-5); (I-93)+(S1-6); (I-93)+(S1-7); (I-93)+(S1-8); (I-93)+(S1-9); (I-93)+(S1-10); (I-93)+(S1-11); (I-93)+(S1-12); (I-93)+(S1-13); (I-93)+(S2-1); (I-93)+(S2-2); (I-93)+(S2-3); (I-93)+(S2-4); (I-93)+(S2-5); (I-93)+(S2-6); (I-93)+(S2-7); (I-93)+(S2-8); (I-93)+(S2-9); (I-93)+(S2-10); (I-93)+(S3-1); (I-93)+(S3-2); (I-93)+(S3-3); (I-93)+(S3-4); (I-93)+(S3-5); (I-93)+(S3-6); (I-93)+(S3-7); (I-93)+(S3-8); (I-93)+(S3-9); (I-93)+(S3-10); (I-93)+(S3-11); (I-93)+(S4-1); (I-93)+(S4-2); (I-93)+(S4-3); (I-93)+(S4-4); (I-93)+(S4-5); (I-93)+(S7-1); (I-93)+(S11-1); (I-93)+(S11-2); (I-93)+(S11-3); (I-93)+(S12-1); (I-93)+(S13-1); (I-93)+(S13-2); (I-93)+(S13-3); (I-93)+(S13-4): (I-93)+(S13-5); (I-93)+(S13-6); (I-93)+(S13-7); (I-93)+(S13-8); (I-93)+(S13-9); (I-93)+(S14-1)
(I-94)+(S1-1); (I-94)+(S1-2); (I-94)+(S1-3); (I-94)+(S1-4); (I-94)+(S1-5); (I-94)+(S1-6); (I-94)+(S1-7); (I-94)+(S1-8); (I-94)+(S1-9); (I-94)+(S1-10); (I-94)+(S1-11); (I-94)+(S1-12); (I-94)+(S1-13); (I-94)+(S2-1); (I-94)+(S2-2); (I-94)+(S2-3); (I-94)+(S2-4); (I-94)+(S2-5); (I-94)+(S2-6); (I-94)+(S2-7); (I-94)+(S2-8); (I-94)+(S2-9); (I-94)+(S2-10); (I-94)+(S3-1); (I-94)+(S3-2); (I-94)+(S3-3); (I-94)+(S3-4); (I-94)+(S3-5); (I-94)+(S3-6); (I-94)+(S3-7); (I-94)+(S3-8); (I-94)+(S3-9); (I-94)+(S3-10); (I-94)+(S3-11); (I-94)+(S4-1); (I-94)+(S4-2); (I-94)+(S4-3); (I-94)+(S4-4); (I-94)+(S4-5); (I-94)+(S7-1); (I-94)+(S11-1); (I-94)+(S11-2); (I-94)+(S11-3); (I-94)+(S12-1); (I-94)+(S13-1); (I-94)+(S13-2); (I-94)+(S13-3); (I-94)+(S13-4): (I-94)+(S13-5); (I-94)+(S13-6); (I-94)+(S13-7); (I-94)+(S13-8); (I-94)+(S13-9); (I-94)+(S14-1)
(I-95)+(S1-1); (I-95)+(S1-2); (I-95)+(S1-3); (I-95)+(S1-4); (I-95)+(S1-5); (I-95)+(S1-6); (I-95)+(S1-7); (I-95)+(S1-8); (I-95)+(S1-9); (I-95)+(S1-10); (I-95)+(S1-11); (I-95)+(S1-12); (I-95)+(S1-13); (I-95)+(S2-1); (I-95)+(S2-2); (I-95)+(S2-3); (I-95)+(S2-4); (I-95)+(S2-5); (I-95)+(S2-6); (I-95)+(S2-7); (I-95)+(S2-8); (I-95)+(S2-9); (I-95)+(S2-10); (I-95)+(S3-1); (I-95)+(S3-2); (I-95)+(S3-3); (I-95)+(S3-4); (I-95)+(S3-5); (I-95)+(S3-6); (I-95)+(S3-7); (I-95)+(S3-8); (I-95)+(S3-9); (I-95)+(S3-10); (I-95)+(S3-11); (I-95)+(S4-1); (I-95)+(S4-2); (I-95)+(S4-3); (I-95)+(S4-4); (I-95)+(S4-5); (I-95)+(S7-1); (I-95)+(S11-1); (I-95)+(S11-2); (I-95)+(S11-3); (I-95)+(S12-1); (I-95)+(S13-1); (I-95)+(S13-2); (I-95)+(S13-3); (I-95)+(S13-4): (I-95)+(S13-5); (I-95)+(S13-6); (I-95)+(S13-7); (I-95)+(S13-8); (I-95)+(S13-9); (I-95)+(S14-1)
(I-96)+(S1-1); (I-96)+(S1-2); (I-96)+(S1-3); (I-96)+(S1-4); (I-96)+(S1-5); (I-96)+(S1-6); (I-96)+(S1-7); (I-96)+(S1-8); (I-96)+(S1-9); (I-96)+(S1-10); (I-96)+(S1-11); (I-96)+(S1-12); (I-96)+(S1-13); (I-96)+(S2-1); (I-96)+(S2-2); (I-96)+(S2-3); (I-96)+(S2-4); (I-96)+(S2-5); (I-96)+(S2-6); (I-96)+(S2-7); (I-96)+(S2-8); (I-96)+(S2-9); (I-96)+(S2-10); (I-96)+(S3-1); (I-96)+(S3-2); (I-96)+(S3-3); (I-96)+(S3-4); (I-96)+(S3-5); (I-96)+(S3-6); (I-96)+(S3-7); (I-96)+(S3-8); (I-96)+(S3-9); (I-96)+(S3-10); (I-96)+(S3-11); (I-96)+(S4-1); (I-96)+(S4-2); (I-96)+(S4-3); (I-96)+(S4-4); (I-96)+(S4-5); (I-96)+(S7-1); (I-96)+(S11-1); (I-96)+(S11-2); (I-96)+(S11-3); (I-96)+(S12-1); (I-96)+(S13-1); (I-96)+(S13-2); (I-96)+(S13-3); (I-96)+(S13-4): (I-96)+(S13-5); (I-96)+(S13-6); (I-96)+(S13-7); (I-96)+(S13-8); (I-96)+(S13-9); (I-96)+(S14-1)
(I-97)+(S1-1); (I-97)+(S1-2); (I-97)+(S1-3); (I-97)+(S1-4); (I-97)+(S1-5); (I-97)+(S1-6); (I-97)+(S1-7); (I-97)+(S1-8); (I-97)+(S1-9); (I-97)+(S1-10); (I-97)+(S1-11); (I-97)+(S1-12); (I-97)+(S1-13); (I-97)+(S2-1); (I-97)+(S2-2); (I-97)+(S2-3); (I-97)+(S2-4); (I-97)+(S2-5); (I-97)+(S2-6); (I-97)+(S2-7); (I-97)+(S2-8); (I-97)+(S2-9); (I-97)+(S2-10); (I-97)+(S3-1); (I-97)+(S3-2); (I-97)+(S3-3); (I-97)+(S3-4); (I-97)+(S3-5); (I-97)+(S3-6); (I-97)+(S3-7); (I-97)+(S3-8); (I-97)+(S3-9); (I-97)+(S3-10); (I-97)+(S3-11); (I-97)+(S4-1); (I-97)+(S4-2); (I-97)+(S4-3); (I-97)+(S4-4); (I-97)+(S4-5); (I-97)+(S7-1); (I-97)+(S11-1); (I-97)+(S11-2); (I-97)+(S11-3); (I-97)+(S12-1); (I-97)+(S13-1); (I-97)+(S13-2); (I-97)+(S13-3); (I-97)+(S13-4): (I-97)+(S13-5); (I-97)+(S13-6); (I-97)+(S13-7); (I-97)+(S13-8); (I-97)+(S13-9); (I-97)+(S14-1)
(I-98)+(S1-1); (I-98)+(S1-2); (I-98)+(S1-3); (I-98)+(S1-4); (I-98)+(S1-5); (I-98)+(S1-6); (I-98)+(S1-7); (I-98)+(S1-8); (I-98)+(S1-9); (I-98)+(S1-10); (I-98)+(S1-11); (I-98)+(S1-12); (I-98)+(S1-13); (I-98)+(S2-1); (I-98)+(S2-2); (I-98)+(S2-3); (I-98)+(S2-4); (I-98)+(S2-5); (I-98)+(S2-6); (I-98)+(S2-7); (I-98)+(S2-8); (I-98)+(S2-9); (I-98)+(S2-10); (I-98)+(S3-1); (I-98)+(S3-2); (I-98)+(S3-3); (I-98)+(S3-4); (I-98)+(S3-5); (I-98)+(S3-6); (I-98)+(S3-7); (I-98)+(S3-8); (I-98)+(S3-9); (I-98)+(S3-10); (I-98)+(S3-11); (I-98)+(S4-1); (I-98)+(S4-2); (I-98)+(S4-3); (I-98)+(S4-4); (I-98)+(S4-5); (I-98)+(S7-1); (I-98)+(S11-1); (I-98)+(S11-2); (I-98)+(S11-3); (I-98)+(S12-1); (I-98)+(S13-1); (I-98)+(S13-2); (I-98)+(S13-3); (I-98)+(S13-4): (I-98)+(S13-5); (I-98)+(S13-6); (I-98)+(S13-7); (I-98)+(S13-8); (I-98)+(S13-9); (I-98)+(S14-1)
(I-99)+(S1-1); (I-99)+(S1-2); (I-99)+(S1-3); (I-99)+(S1-4); (I-99)+(S1-5); (I-99)+(S1-6); (I-99)+(S1-7); (I-99)+(S1-8); (I-99)+(S1-9); (I-99)+(S1-10); (I-99)+(S1-11); (I-99)+(S1-12); (I-99)+(S1-13); (I-99)+(S2-1); (I-99)+(S2-2); (I-99)+(S2-3); (I-99)+(S2-4); (I-99)+(S2-5); (I-99)+(S2-6); (I-99)+(S2-7); (I-99)+(S2-8); (I-99)+(S2-9); (I-99)+(S2-10); (I-99)+(S3-1); (I-99)+(S3-2); (I-99)+(S3-3); (I-99)+(S3-4); (I-99)+(S3-5); (I-99)+(S3-6); (I-99)+(S3-7); (I-99)+(S3-8); (I-99)+(S3-9); (I-99)+(S3-10); (I-99)+(S3-11); (I-99)+(S4-1); (I-99)+(S4-2); (I-99)+(S4-3); (I-99)+(S4-4); (I-99)+(S4-5); (I-99)+(S7-1); (I-99)+(S11-1); (I-99)+(S11-2); (I-99)+(S11-3); (I-99)+(S12-1); (I-99)+(S13-1); (I-99)+(S13-2); (I-99)+(S13-3); (I-99)+(S13-4): (I-99)+(S13-5); (I-99)+(S13-6); (I-99)+(S13-7); (I-99)+(S13-8); (I-99)+(S13-9); (I-99)+(S14-1)
(I-100)+(S1-1); (I-100)+(S1-2); (I-100)+(S1-3); (I-100)+(S1-4); (I-100)+(S1-5); (I-100)+(S1-6); (I-100)+(S1-7); (I-100)+(S1-8); (I-100)+(S1-9); (I-100)+(S1-10); (I-100)+(S1-11); (I-100)+(S1-12); (I-100)+(S1-13); (I-100)+(S2-1); (I-100)+(S2-2); (I-100)+(S2-3); (I-100)+(S2-4); (I-100)+(S2-5); (I-100)+(S2-6); (I-100)+(S2-7); (I-100)+(S2-8); (I-100)+(S2-9); (I-100)+(S2-10); (I-100)+(S3-1); (I-100)+(S3-2); (I-100)+(S3-3); (I-100)+(S3-4); (I-100)+(S3-5); (I-100)+(S3-6); (I-100)+(S3-7); (I-100)+(S3-8); (I-100)+(S3-9); (I-100)+(S3-10); (I-100)+(S3-11); (I-100)+(S4-1); (I-100)+(S4-2); (I-100)+(S4-3); (I-100)+(S4-4); (I-100)+(S4-5); (I-100)+(S7-1); (I-100)+(S11-1); (I-100)+(S11-2); (I-100)+(S11-3); (I-100)+(S12-1); (I-100)+(S13-1); (I-100)+(S13-2); (I-100)+(S13-3); (I-100)+(S13-4): (I-100)+(S13-5); (I-100)+(S13-6); (I-100)+(S13-7); (I-100)+(S13-8); (I-100)+(S13-9); (I-100)+(S14-1)
(I-101)+(S1-1); (I-101)+(S1-2); (I-101)+(S1-3); (I-101)+(S1-4); (I-101)+(S1-5); (I-101)+(S1-6); (I-101)+(S1-7); (I-101)+(S1-8); (I-101)+(S1-9); (I-101)+(S1-10); (I-101)+(S1-11); (I-101)+(S1-12); (I-101)+(S1-13); (I-101)+(S2-1); (I-101)+(S2-2); (I-101)+(S2-3); (I-101)+(S2-4); (I-101)+(S2-5); (I-101)+(S2-6); (I-101)+(S2-7); (I-101)+(S2-8); (I-101)+(S2-9); (I-101)+(S2-10); (I-101)+(S3-1); (I-101)+(S3-2); (I-101)+(S3-3); (I-101)+(S3-4); (I-101)+(S3-5); (I-101)+(S3-6); (I-101)+(S3-7); (I-101)+(S3-8); (I-101)+(S3-9); (I-101)+(S3-10); (I-101)+(S3-11); (I-101)+(S4-1); (I-101)+(S4-2); (I-101)+(S4-3); (I-101)+(S4-4); (I-101)+(S4-5); (I-101)+(S7-1); (I-101)+(S11-1); (I-101)+(S11-2); (I-101)+(S11-3); (I-101)+(S12-1); (I-101)+(S13-1); (I-101)+(S13-2); (I-101)+(S13-3); (I-101)+(S13-4): (I-101)+(S13-5); (I-101)+(S13-6); (I-101)+(S13-7); (I-101)+(S13-8); (I-101)+(S13-9); (I-101)+(S14-1)
(I-102)+(S1-1); (I-102)+(S1-2); (I-102)+(S1-3); (I-102)+(S1-4); (I-102)+(S1-5); (I-102)+(S1-6); (I-102)+(S1-7); (I-102)+(S1-8); (I-102)+(S1-9); (I-102)+(S1-10); (I-102)+(S1-11); (I-102)+(S1-12); (I-102)+(S1-13); (I-102)+(S2-1); (I-102)+(S2-2); (I-102)+(S2-3); (I-102)+(S2-4); (I-102)+(S2-5); (I-102)+(S2-6); (I-102)+(S2-7); (I-102)+(S2-8); (I-102)+(S2-9); (I-102)+(S2-10); (I-102)+(S3-1); (I-102)+(S3-2); (I-102)+(S3-3); (I-102)+(S3-4); (I-102)+(S3-5); (I-102)+(S3-6); (I-102)+(S3-7); (I-102)+(S3-8); (I-102)+(S3-9); (I-102)+(S3-10); (I-102)+(S3-11); (I-102)+(S4-1); (I-102)+(S4-2); (I-102)+(S4-3); (I-102)+(S4-4); (I-102)+(S4-5); (I-102)+(S7-1); (I-102)+(S11-1); (I-102)+(S11-2); (I-102)+(S11-3); (I-102)+(S12-1); (I-102)+(S13-1); (I-102)+(S13-2); (I-102)+(S13-3); (I-102)+(S13-4): (I-102)+(S13-5); (I-102)+(S13-6); (I-102)+(S13-7); (I-102)+(S13-8); (I-102)+(S13-9); (I-102)+(S14-1)
(I-103)+(S1-1); (I-103)+(S1-2); (I-103)+(S1-3); (I-103)+(S1-4); (I-103)+(S1-5); (I-103)+(S1-6); (I-103)+(S1-7); (I-103)+(S1-8); (I-103)+(S1-9); (I-103)+(S1-10); (I-103)+(S1-11); (I-103)+(S1-12); (I-103)+(S1-13); (I-103)+(S2-1); (I-103)+(S2-2); (I-103)+(S2-3); (I-103)+(S2-4); (I-103)+(S2-5); (I-103)+(S2-6); (I-103)+(S2-7); (I-103)+(S2-8); (I-103)+(S2-9); (I-103)+(S2-10); (I-103)+(S3-1); (I-103)+(S3-2); (I-103)+(S3-3); (I-103)+(S3-4); (I-103)+(S3-5); (I-103)+(S3-6); (I-103)+(S3-7); (I-103)+(S3-8); (I-103)+(S3-9); (I-103)+(S3-10); (I-103)+(S3-11); (I-103)+(S4-1); (I-103)+(S4-2); (I-103)+(S4-3); (I-103)+(S4-4); (I-103)+(S4-5); (I-103)+(S7-1); (I-103)+(S11-1); (I-103)+(S11-2); (I-103)+(S11-3); (I-103)+(S12-1); (I-103)+(S13-1); (I-103)+(S13-2); (I-103)+(S13-3); (I-103)+(S13-4): (I-103)+(S13-5); (I-103)+(S13-6); (I-103)+(S13-7); (I-103)+(S13-8); (I-103)+(S13-9); (I-103)+(S14-1)
(I-104)+(S1-1); (I-104)+(S1-2); (I-104)+(S1-3); (I-104)+(S1-4); (I-104)+(S1-5); (I-104)+(S1-6); (I-104)+(S1-7); (I-104)+(S1-8); (I-104)+(S1-9); (I-104)+(S1-10); (I-104)+(S1-11); (I-104)+(S1-12); (I-104)+(S1-13); (I-104)+(S2-1); (I-104)+(S2-2); (I-104)+(S2-3); (I-104)+(S2-4); (I-104)+(S2-5); (I-104)+(S2-6); (I-104)+(S2-7); (I-104)+(S2-8); (I-104)+(S2-9); (I-104)+(S2-10); (I-104)+(S3-1); (I-104)+(S3-2); (I-104)+(S3-3); (I-104)+(S3-4); (I-104)+(S3-5); (I-104)+(S3-6); (I-104)+(S3-7); (I-104)+(S3-8); (I-104)+(S3-9); (I-104)+(S3-10); (I-104)+(S3-11); (I-104)+(S4-1); (I-104)+(S4-2); (I-104)+(S4-3); (I-104)+(S4-4); (I-104)+(S4-5); (I-104)+(S7-1); (I-104)+(S11-1); (I-104)+(S11-2); (I-104)+(S11-3); (I-104)+(S12-1); (I-104)+(S13-1); (I-104)+(S13-2); (I-104)+(S13-3); (I-104)+(S13-4): (I-104)+(S13-5); (I-104)+(S13-6); (I-104)+(S13-7); (I-104)+(S13-8); (I-104)+(S13-9); (I-104)+(S14-1)
(I-105)+(S1-1); (I-105)+(S1-2); (I-105)+(S1-3); (I-105)+(S1-4); (I-105)+(S1-5); (I-105)+(S1-6); (I-105)+(S1-7); (I-105)+(S1-8); (I-105)+(S1-9); (I-105)+(S1-10); (I-105)+(S1-11); (I-105)+(S1-12); (I-105)+(S1-13); (I-105)+(S2-1); (I-105)+(S2-2); (I-105)+(S2-3); (I-105)+(S2-4); (I-105)+(S2-5); (I-105)+(S2-6); (I-105)+(S2-7); (I-105)+(S2-8); (I-105)+(S2-9); (I-105)+(S2-10); (I-105)+(S3-1); (I-105)+(S3-2); (I-105)+(S3-3); (I-105)+(S3-4); (I-105)+(S3-5); (I-105)+(S3-6); (I-105)+(S3-7); (I-105)+(S3-8); (I-105)+(S3-9); (I-105)+(S3-10); (I-105)+(S3-11); (I-105)+(S4-1); (I-105)+(S4-2); (I-105)+(S4-3); (I-105)+(S4-4); (I-105)+(S4-5); (I-105)+(S7-1); (I-105)+(S11-1); (I-105)+(S11-2); (I-105)+(S11-3); (I-105)+(S12-1); (I-105)+(S13-1); (I-105)+(S13-2); (I-105)+(S13-3); (I-105)+(S13-4): (I-105)+(S13-5); (I-105)+(S13-6); (I-105)+(S13-7); (I-105)+(S13-8); (I-105)+(S13-9); (I-105)+(S14-1)
(I-106)+(S1-1); (I-106)+(S1-2); (I-106)+(S1-3); (I-106)+(S1-4); (I-106)+(S1-5); (I-106)+(S1-6); (I-106)+(S1-7); (I-106)+(S1-8); (I-106)+(S1-9); (I-106)+(S1-10); (I-106)+(S1-11); (I-106)+(S1-12); (I-106)+(S1-13); (I-106)+(S2-1); (I-106)+(S2-2); (I-106)+(S2-3); (I-106)+(S2-4); (I-106)+(S2-5); (I-106)+(S2-6); (I-106)+(S2-7); (I-106)+(S2-8); (I-106)+(S2-9); (I-106)+(S2-10); (I-106)+(S3-1); (I-106)+(S3-2); (I-106)+(S3-3); (I-106)+(S3-4); (I-106)+(S3-5); (I-106)+(S3-6); (I-106)+(S3-7); (I-106)+(S3-8); (I-106)+(S3-9); (I-106)+(S3-10); (I-106)+(S3-11); (I-106)+(S4-1); (I-106)+(S4-2); (I-106)+(S4-3); (I-106)+(S4-4); (I-106)+(S4-5); (I-106)+(S7-1); (I-106)+(S11-1); (I-106)+(S11-2); (I-106)+(S11-3); (I-106)+(S12-1); (I-106)+(S13-1); (I-106)+(S13-2); (I-106)+(S13-3); (I-106)+(S13-4): (I-106)+(S13-5); (I-106)+(S13-6); (I-106)+(S13-7); (I-106)+(S13-8); (I-106)+(S13-9); (I-106)+(S14-1)
(I-107)+(S1-1); (I-107)+(S1-2); (I-107)+(S1-3); (I-107)+(S1-4); (I-107)+(S1-5); (I-107)+(S1-6); (I-107)+(S1-7); (I-107)+(S1-8); (I-107)+(S1-9); (I-107)+(S1-10); (I-107)+(S1-11); (I-107)+(S1-12); (I-107)+(S1-13); (I-107)+(S2-1); (I-107)+(S2-2); (I-107)+(S2-3); (I-107)+(S2-4); (I-107)+(S2-5); (I-107)+(S2-6); (I-107)+(S2-7); (I-107)+(S2-8); (I-107)+(S2-9); (I-107)+(S2-10); (I-107)+(S3-1); (I-107)+(S3-2); (I-107)+(S3-3); (I-107)+(S3-4); (I-107)+(S3-5); (I-107)+(S3-6); (I-107)+(S3-7); (I-107)+(S3-8); (I-107)+(S3-9); (I-107)+(S3-10); (I-107)+(S3-11); (I-107)+(S4-1); (I-107)+(S4-2); (I-107)+(S4-3); (I-107)+(S4-4); (I-107)+(S4-5); (I-107)+(S7-1); (I-107)+(S11-1); (I-107)+(S11-2); (I-107)+(S11-3); (I-107)+(S12-1); (I-107)+(S13-1); (I-107)+(S13-2); (I-107)+(S13-3); (I-107)+(S13-4): (I-107)+(S13-5); (I-107)+(S13-6); (I-107)+(S13-7); (I-107)+(S13-8); (I-107)+(S13-9); (I-107)+(S14-1)
(I-108)+(S1-1); (I-108)+(S1-2); (I-108)+(S1-3); (I-108)+(S1-4); (I-108)+(S1-5); (I-108)+(S1-6); (I-108)+(S1-7); (I-108)+(S1-8); (I-108)+(S1-9); (I-108)+(S1-10); (I-108)+(S1-11); (I-108)+(S1-12); (I-108)+(S1-13); (I-108)+(S2-1); (I-108)+(S2-2); (I-108)+(S2-3); (I-108)+(S2-4); (I-108)+(S2-5); (I-108)+(S2-6); (I-108)+(S2-7); (I-108)+(S2-8); (I-108)+(S2-9); (I-108)+(S2-10); (I-108)+(S3-1); (I-108)+(S3-2); (I-108)+(S3-3); (I-108)+(S3-4); (I-108)+(S3-5); (I-108)+(S3-6); (I-108)+(S3-7); (I-108)+(S3-8); (I-108)+(S3-9); (I-108)+(S3-10); (I-108)+(S3-11); (I-108)+(S4-1); (I-108)+(S4-2); (I-108)+(S4-3); (I-108)+(S4-4); (I-108)+(S4-5); (I-108)+(S7-1); (I-108)+(S11-1); (I-108)+(S11-2); (I-108)+(S11-3); (I-108)+(S12-1); (I-108)+(S13-1); (I-108)+(S13-2); (I-108)+(S13-3); (I-108)+(S13-4): (I-108)+(S13-5); (I-108)+(S13-6); (I-108)+(S13-7); (I-108)+(S13-8); (I-108)+(S13-9); (I-108)+(S14-1)
(I-109)+(S1-1); (I-109)+(S1-2); (I-109)+(S1-3); (I-109)+(S1-4); (I-109)+(S1-5); (I-109)+(S1-6); (I-109)+(S1-7); (I-109)+(S1-8); (I-109)+(S1-9); (I-109)+(S1-10); (I-109)+(S1-11); (I-109)+(S1-12); (I-109)+(S1-13); (I-109)+(S2-1); (I-109)+(S2-2); (I-109)+(S2-3); (I-109)+(S2-4); (I-109)+(S2-5); (I-109)+(S2-6); (I-109)+(S2-7); (I-109)+(S2-8); (I-109)+(S2-9); (I-109)+(S2-10); (I-109)+(S3-1); (I-109)+(S3-2); (I-109)+(S3-3); (I-109)+(S3-4); (I-109)+(S3-5); (I-109)+(S3-6); (I-109)+(S3-7); (I-109)+(S3-8); (I-109)+(S3-9); (I-109)+(S3-10); (I-109)+(S3-11); (I-109)+(S4-1); (I-109)+(S4-2); (I-109)+(S4-3); (I-109)+(S4-4); (I-109)+(S4-5); (I-109)+(S7-1); (I-109)+(S11-1); (I-109)+(S11-2); (I-109)+(S11-3); (I-109)+(S12-1); (I-109)+(S13-1); (I-109)+(S13-2); (I-109)+(S13-3); (I-109)+(S13-4): (I-109)+(S13-5); (I-109)+(S13-6); (I-109)+(S13-7); (I-109)+(S13-8); (I-109)+(S13-9); (I-109)+(S14-1)
(I-110)+(S1-1); (I-110)+(S1-2); (I-110)+(S1-3); (I-110)+(S1-4); (I-110)+(S1-5); (I-110)+(S1-6); (I-110)+(S1-7); (I-110)+(S1-8); (I-110)+(S1-9); (I-110)+(S1-10); (I-110)+(S1-11); (I-110)+(S1-12); (I-110)+(S1-13); (I-110)+(S2-1); (I-110)+(S2-2); (I-110)+(S2-3); (I-110)+(S2-4); (I-110)+(S2-5); (I-110)+(S2-6); (I-110)+(S2-7); (I-110)+(S2-8); (I-110)+(S2-9); (I-110)+(S2-10); (I-110)+(S3-1); (I-110)+(S3-2); (I-110)+(S3-3); (I-110)+(S3-4); (I-110)+(S3-5); (I-110)+(S3-6); (I-110)+(S3-7); (I-110)+(S3-8); (I-110)+(S3-9); (I-110)+(S3-10); (I-110)+(S3-11); (I-110)+(S4-1); (I-110)+(S4-2); (I-110)+(S4-3); (I-110)+(S4-4); (I-110)+(S4-5); (I-110)+(S7-1); (I-110)+(S11-1); (I-110)+(S11-2); (I-110)+(S11-3); (I-110)+(S12-1); (I-110)+(S13-1); (I-110)+(S13-2); (I-110)+(S13-3); (I-110)+(S13-4): (I-110)+(S13-5); (I-110)+(S13-6); (I-110)+(S13-7); (I-110)+(S13-8); (I-110)+(S13-9); (I-110)+(S14-1)
(I-111)+(S1-1); (I-111)+(S1-2); (I-111)+(S1-3); (I-111)+(S1-4); (I-111)+(S1-5); (I-111)+(S1-6); (I-111)+(S1-7); (I-111)+(S1-8); (I-111)+(S1-9); (I-111)+(S1-10); (I-111)+(S1-11); (I-111)+(S1-12); (I-111)+(S1-13); (I-111)+(S2-1); (I-111)+(S2-2); (I-111)+(S2-3); (I-111)+(S2-4); (I-111)+(S2-5); (I-111)+(S2-6); (I-111)+(S2-7); (I-111)+(S2-8); (I-111)+(S2-9); (I-111)+(S2-10); (I-111)+(S3-1); (I-111)+(S3-2); (I-111)+(S3-3); (I-111)+(S3-4); (I-111)+(S3-5); (I-111)+(S3-6); (I-111)+(S3-7); (I-111)+(S3-8); (I-111)+(S3-9); (I-111)+(S3-10); (I-111)+(S3-11); (I-111)+(S4-1); (I-111)+(S4-2); (I-111)+(S4-3); (I-111)+(S4-4); (I-111)+(S4-5); (I-111)+(S7-1); (I-111)+(S11-1); (I-111)+(S11-2); (I-111)+(S11-3); (I-111)+(S12-1); (I-111)+(S13-1); (I-111)+(S13-2); (I-111)+(S13-3); (I-111)+(S13-4): (I-111)+(S13-5); (I-111)+(S13-6); (I-111)+(S13-7); (I-111)+(S13-8); (I-111)+(S13-9); (I-111)+(S14-1)
(I-112)+(S1-1); (I-112)+(S1-2); (I-112)+(S1-3); (I-112)+(S1-4); (I-112)+(S1-5); (I-112)+(S1-6); (I-112)+(S1-7); (I-112)+(S1-8); (I-112)+(S1-9); (I-112)+(S1-10); (I-112)+(S1-11); (I-112)+(S1-12); (I-112)+(S1-13); (I-112)+(S2-1); (I-112)+(S2-2); (I-112)+(S2-3); (I-112)+(S2-4); (I-112)+(S2-5); (I-112)+(S2-6); (I-112)+(S2-7); (I-112)+(S2-8); (I-112)+(S2-9); (I-112)+(S2-10); (I-112)+(S3-1); (I-112)+(S3-2); (I-112)+(S3-3); (I-112)+(S3-4); (I-112)+(S3-5); (I-112)+(S3-6); (I-112)+(S3-7); (I-112)+(S3-8); (I-112)+(S3-9); (I-112)+(S3-10); (I-112)+(S3-11); (I-112)+(S4-1); (I-112)+(S4-2); (I-112)+(S4-3); (I-112)+(S4-4); (I-112)+(S4-5); (I-112)+(S7-1); (I-112)+(S11-1); (I-112)+(S11-2); (I-112)+(S11-3); (I-112)+(S12-1); (I-112)+(S13-1); (I-112)+(S13-2); (I-112)+(S13-3); (I-112)+(S13-4): (I-112)+(S13-5); (I-112)+(S13-6); (I-112)+(S13-7); (I-112)+(S13-8); (I-112)+(S13-9); (I-112)+(S14-1)
(I-113)+(S1-1); (I-113)+(S1-2); (I-113)+(S1-3); (I-113)+(S1-4); (I-113)+(S1-5); (I-113)+(S1-6); (I-113)+(S1-7); (I-113)+(S1-8); (I-113)+(S1-9); (I-113)+(S1-10); (I-113)+(S1-11); (I-113)+(S1-12); (I-113)+(S1-13); (I-113)+(S2-1); (I-113)+(S2-2); (I-113)+(S2-3); (I-113)+(S2-4); (I-113)+(S2-5); (I-113)+(S2-6); (I-113)+(S2-7); (I-113)+(S2-8); (I-113)+(S2-9); (I-113)+(S2-10); (I-113)+(S3-1); (I-113)+(S3-2); (I-113)+(S3-3); (I-113)+(S3-4); (I-113)+(S3-5); (I-113)+(S3-6); (I-113)+(S3-7); (I-113)+(S3-8); (I-113)+(S3-9); (I-113)+(S3-10); (I-113)+(S3-11); (I-113)+(S4-1); (I-113)+(S4-2); (I-113)+(S4-3); (I-113)+(S4-4); (I-113)+(S4-5); (I-113)+(S7-1); (I-113)+(S11-1); (I-113)+(S11-2); (I-113)+(S11-3); (I-113)+(S12-1); (I-113)+(S13-1); (I-113)+(S13-2); (I-113)+(S13-3); (I-113)+(S13-4): (I-113)+(S13-5); (I-113)+(S13-6); (I-113)+(S13-7); (I-113)+(S13-8); (I-113)+(S13-9); (I-113)+(S14-1)
(I-114)+(S1-1); (I-114)+(S1-2); (I-114)+(S1-3); (I-114)+(S1-4); (I-114)+(S1-5); (I-114)+(S1-6); (I-114)+(S1-7); (I-114)+(S1-8); (I-114)+(S1-9); (I-114)+(S1-10); (I-114)+(S1-11); (I-114)+(S1-12); (I-114)+(S1-13); (I-114)+(S2-1); (I-114)+(S2-2); (I-114)+(S2-3); (I-114)+(S2-4); (I-114)+(S2-5); (I-114)+(S2-6); (I-114)+(S2-7); (I-114)+(S2-8); (I-114)+(S2-9); (I-114)+(S2-10); (I-114)+(S3-1); (I-114)+(S3-2); (I-114)+(S3-3); (I-114)+(S3-4); (I-114)+(S3-5); (I-114)+(S3-6); (I-114)+(S3-7); (I-114)+(S3-8); (I-114)+(S3-9); (I-114)+(S3-10); (I-114)+(S3-11); (I-114)+(S4-1); (I-114)+(S4-2); (I-114)+(S4-3); (I-114)+(S4-4); (I-114)+(S4-5); (I-114)+(S7-1); (I-114)+(S11-1); (I-114)+(S11-2); (I-114)+(S11-3); (I-114)+(S12-1); (I-114)+(S13-1); (I-114)+(S13-2); (I-114)+(S13-3); (I-114)+(S13-4): (I-114)+(S13-5); (I-114)+(S13-6); (I-114)+(S13-7); (I-114)+(S13-8); (I-114)+(S13-9); (I-114)+(S14-1)
(I-115)+(S1-1); (I-115)+(S1-2); (I-115)+(S1-3); (I-115)+(S1-4); (I-115)+(S1-5); (I-115)+(S1-6); (I-115)+(S1-7); (I-115)+(S1-8); (I-115)+(S1-9); (I-115)+(S1-10); (I-115)+(S1-11); (I-115)+(S1-12); (I-115)+(S1-13); (I-115)+(S2-1); (I-115)+(S2-2); (I-115)+(S2-3); (I-115)+(S2-4); (I-115)+(S2-5); (I-115)+(S2-6); (I-115)+(S2-7); (I-115)+(S2-8); (I-115)+(S2-9); (I-115)+(S2-10); (I-115)+(S3-1); (I-115)+(S3-2); (I-115)+(S3-3); (I-115)+(S3-4); (I-115)+(S3-5); (I-115)+(S3-6); (I-115)+(S3-7); (I-115)+(S3-8); (I-115)+(S3-9); (I-115)+(S3-10); (I-115)+(S3-11); (I-115)+(S4-1); (I-115)+(S4-2); (I-115)+(S4-3); (I-115)+(S4-4); (I-115)+(S4-5); (I-115)+(S7-1); (I-115)+(S11-1); (I-115)+(S11-2); (I-115)+(S11-3); (I-115)+(S12-1); (I-115)+(S13-1); (I-115)+(S13-2); (I-115)+(S13-3); (I-115)+(S13-4): (I-115)+(S13-5); (I-115)+(S13-6); (I-115)+(S13-7); (I-115)+(S13-8); (I-115)+(S13-9); (I-115)+(S14-1)
(I-116)+(S1-1); (I-116)+(S1-2); (I-116)+(S1-3); (I-116)+(S1-4); (I-116)+(S1-5); (I-116)+(S1-6); (I-116)+(S1-7); (I-116)+(S1-8); (I-116)+(S1-9); (I-116)+(S1-10); (I-116)+(S1-11); (I-116)+(S1-12); (I-116)+(S1-13); (I-116)+(S2-1); (I-116)+(S2-2); (I-116)+(S2-3); (I-116)+(S2-4); (I-116)+(S2-5); (I-116)+(S2-6); (I-116)+(S2-7); (I-116)+(S2-8); (I-116)+(S2-9); (I-116)+(S2-10); (I-116)+(S3-1); (I-116)+(S3-2); (I-116)+(S3-3); (I-116)+(S3-4); (I-116)+(S3-5); (I-116)+(S3-6); (I-116)+(S3-7); (I-116)+(S3-8); (I-116)+(S3-9); (I-116)+(S3-10); (I-116)+(S3-11); (I-116)+(S4-1); (I-116)+(S4-2); (I-116)+(S4-3); (I-116)+(S4-4); (I-116)+(S4-5); (I-116)+(S7-1); (I-116)+(S11-1); (I-116)+(S11-2); (I-116)+(S11-3); (I-116)+(S12-1); (I-116)+(S13-1); (I-116)+(S13-2); (I-116)+(S13-3); (I-116)+(S13-4): (I-116)+(S13-5); (I-116)+(S13-6); (I-116)+(S13-7); (I-116)+(S13-8); (I-116)+(S13-9); (I-116)+(S14-1)
(I-117)+(S1-1); (I-117)+(S1-2); (I-117)+(S1-3); (I-117)+(S1-4); (I-117)+(S1-5); (I-117)+(S1-6); (I-117)+(S1-7); (I-117)+(S1-8); (I-117)+(S1-9); (I-117)+(S1-10); (I-117)+(S1-11); (I-117)+(S1-12); (I-117)+(S1-13); (I-117)+(S2-1); (I-117)+(S2-2); (I-117)+(S2-3); (I-117)+(S2-4); (I-117)+(S2-5); (I-117)+(S2-6); (I-117)+(S2-7); (I-117)+(S2-8); (I-117)+(S2-9); (I-117)+(S2-10); (I-117)+(S3-1); (I-117)+(S3-2); (I-117)+(S3-3); (I-117)+(S3-4); (I-117)+(S3-5); (I-117)+(S3-6); (I-117)+(S3-7); (I-117)+(S3-8); (I-117)+(S3-9); (I-117)+(S3-10); (I-117)+(S3-11); (I-117)+(S4-1); (I-117)+(S4-2); (I-117)+(S4-3); (I-117)+(S4-4); (I-117)+(S4-5); (I-117)+(S7-1); (I-117)+(S11-1); (I-117)+(S11-2); (I-117)+(S11-3); (I-117)+(S12-1); (I-117)+(S13-1); (I-117)+(S13-2); (I-117)+(S13-3); (I-117)+(S13-4): (I-117)+(S13-5); (I-117)+(S13-6); (I-117)+(S13-7); (I-117)+(S13-8); (I-117)+(S13-9); (I-117)+(S14-1)
(I-118)+(S1-1); (I-118)+(S1-2); (I-118)+(S1-3); (I-118)+(S1-4); (I-118)+(S1-5); (I-118)+(S1-6); (I-118)+(S1-7); (I-118)+(S1-8); (I-118)+(S1-9); (I-118)+(S1-10); (I-118)+(S1-11); (I-118)+(S1-12); (I-118)+(S1-13); (I-118)+(S2-1); (I-118)+(S2-2); (I-118)+(S2-3); (I-118)+(S2-4); (I-118)+(S2-5); (I-118)+(S2-6); (I-118)+(S2-7); (I-118)+(S2-8); (I-118)+(S2-9); (I-118)+(S2-10); (I-118)+(S3-1); (I-118)+(S3-2); (I-118)+(S3-3); (I-118)+(S3-4); (I-118)+(S3-5); (I-118)+(S3-6); (I-118)+(S3-7); (I-118)+(S3-8); (I-118)+(S3-9); (I-118)+(S3-10); (I-118)+(S3-11); (I-118)+(S4-1); (I-118)+(S4-2); (I-118)+(S4-3); (I-118)+(S4-4); (I-118)+(S4-5); (I-118)+(S7-1); (I-118)+(S11-1); (I-118)+(S11-2); (I-118)+(S11-3); (I-118)+(S12-1); (I-118)+(S13-1); (I-118)+(S13-2); (I-118)+(S13-3); (I-118)+(S13-4): (I-118)+(S13-5); (I-118)+(S13-6); (I-118)+(S13-7); (I-118)+(S13-8); (I-118)+(S13-9); (I-118)+(S14-1)
(I-119)+(S1-1); (I-119)+(S1-2); (I-119)+(S1-3); (I-119)+(S1-4); (I-119)+(S1-5); (I-119)+(S1-6); (I-119)+(S1-7); (I-119)+(S1-8); (I-119)+(S1-9); (I-119)+(S1-10); (I-119)+(S1-11); (I-119)+(S1-12); (I-119)+(S1-13); (I-119)+(S2-1); (I-119)+(S2-2); (I-119)+(S2-3); (I-119)+(S2-4); (I-119)+(S2-5); (I-119)+(S2-6); (I-119)+(S2-7); (I-119)+(S2-8); (I-119)+(S2-9); (I-119)+(S2-10); (I-119)+(S3-1); (I-119)+(S3-2); (I-119)+(S3-3); (I-119)+(S3-4); (I-119)+(S3-5); (I-119)+(S3-6); (I-119)+(S3-7); (I-119)+(S3-8); (I-119)+(S3-9); (I-119)+(S3-10); (I-119)+(S3-11); (I-119)+(S4-1); (I-119)+(S4-2); (I-119)+(S4-3); (I-119)+(S4-4); (I-119)+(S4-5); (I-119)+(S7-1); (I-119)+(S11-1); (I-119)+(S11-2); (I-119)+(S11-3); (I-119)+(S12-1); (I-119)+(S13-1); (I-119)+(S13-2); (I-119)+(S13-3); (I-119)+(S13-4): (I-119)+(S13-5); (I-119)+(S13-6); (I-119)+(S13-7); (I-119)+(S13-8); (I-119)+(S13-9); (I-119)+(S14-1)
(I-120)+(S1-1); (I-120)+(S1-2); (I-120)+(S1-3); (I-120)+(S1-4); (I-120)+(S1-5); (I-120)+(S1-6); (I-120)+(S1-7); (I-120)+(S1-8); (I-120)+(S1-9); (I-120)+(S1-10); (I-120)+(S1-11); (I-120)+(S1-12); (I-120)+(S1-13); (I-120)+(S2-1); (I-120)+(S2-2); (I-120)+(S2-3); (I-120)+(S2-4); (I-120)+(S2-5); (I-120)+(S2-6); (I-120)+(S2-7); (I-120)+(S2-8); (I-120)+(S2-9); (I-120)+(S2-10); (I-120)+(S3-1); (I-120)+(S3-2); (I-120)+(S3-3); (I-120)+(S3-4); (I-120)+(S3-5); (I-120)+(S3-6); (I-120)+(S3-7); (I-120)+(S3-8); (I-120)+(S3-9); (I-120)+(S3-10); (I-120)+(S3-11); (I-120)+(S4-1); (I-120)+(S4-2); (I-120)+(S4-3); (I-120)+(S4-4); (I-120)+(S4-5); (I-120)+(S7-1); (I-120)+(S11-1); (I-120)+(S11-2); (I-120)+(S11-3); (I-120)+(S12-1); (I-120)+(S13-1); (I-120)+(S13-2); (I-120)+(S13-3); (I-120)+(S13-4): (I-120)+(S13-5); (I-120)+(S13-6); (I-120)+(S13-7); (I-120)+(S13-8); (I-120)+(S13-9); (I-120)+(S14-1)
(I-121)+(S1-1); (I-121)+(S1-2); (I-121)+(S1-3); (I-121)+(S1-4); (I-121)+(S1-5); (I-121)+(S1-6); (I-121)+(S1-7); (I-121)+(S1-8); (I-121)+(S1-9); (I-121)+(S1-10); (I-121)+(S1-11); (I-121)+(S1-12); (I-121)+(S1-13); (I-121)+(S2-1); (I-121)+(S2-2); (I-121)+(S2-3); (I-121)+(S2-4); (I-121)+(S2-5); (I-121)+(S2-6); (I-121)+(S2-7); (I-121)+(S2-8); (I-121)+(S2-9); (I-121)+(S2-10); (I-121)+(S3-1); (I-121)+(S3-2); (I-121)+(S3-3); (I-121)+(S3-4); (I-121)+(S3-5); (I-121)+(S3-6); (I-121)+(S3-7); (I-121)+(S3-8); (I-121)+(S3-9); (I-121)+(S3-10); (I-121)+(S3-11); (I-121)+(S4-1); (I-121)+(S4-2); (I-121)+(S4-3); (I-121)+(S4-4); (I-121)+(S4-5); (I-121)+(S7-1); (I-121)+(S11-1); (I-121)+(S11-2); (I-121)+(S11-3); (I-121)+(S12-1); (I-121)+(S13-1); (I-121)+(S13-2); (I-121)+(S13-3); (I-121)+(S13-4): (I-121)+(S13-5); (I-121)+(S13-6); (I-121)+(S13-7); (I-121)+(S13-8); (I-121)+(S13-9); (I-121)+(S14-1)
(I-122)+(S1-1); (I-122)+(S1-2); (I-122)+(S1-3); (I-122)+(S1-4); (I-122)+(S1-5); (I-122)+(S1-6); (I-122)+(S1-7); (I-122)+(S1-8); (I-122)+(S1-9); (I-122)+(S1-10); (I-122)+(S1-11); (I-122)+(S1-12); (I-122)+(S1-13); (I-122)+(S2-1); (I-122)+(S2-2); (I-122)+(S2-3); (I-122)+(S2-4); (I-122)+(S2-5); (I-122)+(S2-6); (I-122)+(S2-7); (I-122)+(S2-8); (I-122)+(S2-9); (I-122)+(S2-10); (I-122)+(S3-1); (I-122)+(S3-2); (I-122)+(S3-3); (I-122)+(S3-4); (I-122)+(S3-5); (I-122)+(S3-6); (I-122)+(S3-7); (I-122)+(S3-8); (I-122)+(S3-9); (I-122)+(S3-10); (I-122)+(S3-11); (I-122)+(S4-1); (I-122)+(S4-2); (I-122)+(S4-3); (I-122)+(S4-4); (I-122)+(S4-5); (I-122)+(S7-1); (I-122)+(S11-1); (I-122)+(S11-2); (I-122)+(S11-3); (I-122)+(S12-1); (I-122)+(S13-1); (I-122)+(S13-2); (I-122)+(S13-3); (I-122)+(S13-4): (I-122)+(S13-5); (I-122)+(S13-6); (I-122)+(S13-7); (I-122)+(S13-8); (I-122)+(S13-9); (I-122)+(S14-1)
(I-123)+(S1-1); (I-123)+(S1-2); (I-123)+(S1-3); (I-123)+(S1-4); (I-123)+(S1-5); (I-123)+(S1-6); (I-123)+(S1-7); (I-123)+(S1-8); (I-123)+(S1-9); (I-123)+(S1-10); (I-123)+(S1-11); (I-123)+(S1-12); (I-123)+(S1-13); (I-123)+(S2-1); (I-123)+(S2-2); (I-123)+(S2-3); (I-123)+(S2-4); (I-123)+(S2-5); (I-123)+(S2-6); (I-123)+(S2-7); (I-123)+(S2-8); (I-123)+(S2-9); (I-123)+(S2-10); (I-123)+(S3-1); (I-123)+(S3-2); (I-123)+(S3-3); (I-123)+(S3-4); (I-123)+(S3-5); (I-123)+(S3-6); (I-123)+(S3-7); (I-123)+(S3-8); (I-123)+(S3-9); (I-123)+(S3-10); (I-123)+(S3-11); (I-123)+(S4-1); (I-123)+(S4-2); (I-123)+(S4-3); (I-123)+(S4-4); (I-123)+(S4-5); (I-123)+(S7-1); (I-123)+(S11-1); (I-123)+(S11-2); (I-123)+(S11-3); (I-123)+(S12-1); (I-123)+(S13-1); (I-123)+(S13-2); (I-123)+(S13-3); (I-123)+(S13-4): (I-123)+(S13-5); (I-123)+(S13-6); (I-123)+(S13-7); (I-123)+(S13-8); (I-123)+(S13-9); (I-123)+(S14-1)
(I-124)+(S1-1); (I-124)+(S1-2); (I-124)+(S1-3); (I-124)+(S1-4); (I-124)+(S1-5); (I-124)+(S1-6); (I-124)+(S1-7); (I-124)+(S1-8); (I-124)+(S1-9); (I-124)+(S1-10); (I-124)+(S1-11); (I-124)+(S1-12); (I-124)+(S1-13); (I-124)+(S2-1); (I-124)+(S2-2); (I-124)+(S2-3); (I-124)+(S2-4); (I-124)+(S2-5); (I-124)+(S2-6); (I-124)+(S2-7); (I-124)+(S2-8); (I-124)+(S2-9); (I-124)+(S2-10); (I-124)+(S3-1); (I-124)+(S3-2); (I-124)+(S3-3); (I-124)+(S3-4); (I-124)+(S3-5); (I-124)+(S3-6); (I-124)+(S3-7); (I-124)+(S3-8); (I-124)+(S3-9); (I-124)+(S3-10); (I-124)+(S3-11); (I-124)+(S4-1); (I-124)+(S4-2); (I-124)+(S4-3); (I-124)+(S4-4); (I-124)+(S4-5); (I-124)+(S7-1); (I-124)+(S11-1); (I-124)+(S11-2); (I-124)+(S11-3); (I-124)+(S12-1); (I-124)+(S13-1); (I-124)+(S13-2); (I-124)+(S13-3); (I-124)+(S13-4): (I-124)+(S13-5); (I-124)+(S13-6); (I-124)+(S13-7); (I-124)+(S13-8); (I-124)+(S13-9); (I-124)+(S14-1)
(I-125)+(S1-1); (I-125)+(S1-2); (I-125)+(S1-3); (I-125)+(S1-4); (I-125)+(S1-5); (I-125)+(S1-6); (I-125)+(S1-7); (I-125)+(S1-8); (I-125)+(S1-9); (I-125)+(S1-10); (I-125)+(S1-11); (I-125)+(S1-12); (I-125)+(S1-13); (I-125)+(S2-1); (I-125)+(S2-2); (I-125)+(S2-3); (I-125)+(S2-4); (I-125)+(S2-5); (I-125)+(S2-6); (I-125)+(S2-7); (I-125)+(S2-8); (I-125)+(S2-9); (I-125)+(S2-10); (I-125)+(S3-1); (I-125)+(S3-2); (I-125)+(S3-3); (I-125)+(S3-4); (I-125)+(S3-5); (I-125)+(S3-6); (I-125)+(S3-7); (I-125)+(S3-8); (I-125)+(S3-9); (I-125)+(S3-10); (I-125)+(S3-11); (I-125)+(S4-1); (I-125)+(S4-2); (I-125)+(S4-3); (I-125)+(S4-4); (I-125)+(S4-5); (I-125)+(S7-1); (I-125)+(S11-1); (I-125)+(S11-2); (I-125)+(S11-3); (I-125)+(S12-1); (I-125)+(S13-1); (I-125)+(S13-2); (I-125)+(S13-3); (I-125)+(S13-4): (I-125)+(S13-5); (I-125)+(S13-6); (I-125)+(S13-7); (I-125)+(S13-8); (I-125)+(S13-9); (I-125)+(S14-1)
(I-126)+(S1-1); (I-126)+(S1-2); (I-126)+(S1-3); (I-126)+(S1-4); (I-126)+(S1-5); (I-126)+(S1-6); (I-126)+(S1-7); (I-126)+(S1-8); (I-126)+(S1-9); (I-126)+(S1-10); (I-126)+(S1-11); (I-126)+(S1-12); (I-126)+(S1-13); (I-126)+(S2-1); (I-126)+(S2-2); (I-126)+(S2-3); (I-126)+(S2-4); (I-126)+(S2-5); (I-126)+(S2-6); (I-126)+(S2-7); (I-126)+(S2-8); (I-126)+(S2-9); (I-126)+(S2-10); (I-126)+(S3-1); (I-126)+(S3-2); (I-126)+(S3-3); (I-126)+(S3-4); (I-126)+(S3-5); (I-126)+(S3-6); (I-126)+(S3-7); (I-126)+(S3-8); (I-126)+(S3-9); (I-126)+(S3-10); (I-126)+(S3-11); (I-126)+(S4-1); (I-126)+(S4-2); (I-126)+(S4-3); (I-126)+(S4-4); (I-126)+(S4-5); (I-126)+(S7-1); (I-126)+(S11-1); (I-126)+(S11-2); (I-126)+(S11-3); (I-126)+(S12-1); (I-126)+(S13-1); (I-126)+(S13-2); (I-126)+(S13-3); (I-126)+(S13-4): (I-126)+(S13-5); (I-126)+(S13-6); (I-126)+(S13-7); (I-126)+(S13-8); (I-126)+(S13-9); (I-126)+(S14-1)
(I-127)+(S1-1); (I-127)+(S1-2); (I-127)+(S1-3); (I-127)+(S1-4); (I-127)+(S1-5); (I-127)+(S1-6); (I-127)+(S1-7); (I-127)+(S1-8); (I-127)+(S1-9); (I-127)+(S1-10); (I-127)+(S1-11); (I-127)+(S1-12); (I-127)+(S1-13); (I-127)+(S2-1); (I-127)+(S2-2); (I-127)+(S2-3); (I-127)+(S2-4); (I-127)+(S2-5); (I-127)+(S2-6); (I-127)+(S2-7); (I-127)+(S2-8); (I-127)+(S2-9); (I-127)+(S2-10); (I-127)+(S3-1); (I-127)+(S3-2); (I-127)+(S3-3); (I-127)+(S3-4); (I-127)+(S3-5); (I-127)+(S3-6); (I-127)+(S3-7); (I-127)+(S3-8); (I-127)+(S3-9); (I-127)+(S3-10); (I-127)+(S3-11); (I-127)+(S4-1); (I-127)+(S4-2); (I-127)+(S4-3); (I-127)+(S4-4); (I-127)+(S4-5); (I-127)+(S7-1); (I-127)+(S11-1); (I-127)+(S11-2); (I-127)+(S11-3); (I-127)+(S12-1); (I-127)+(S13-1); (I-127)+(S13-2); (I-127)+(S13-3); (I-127)+(S13-4): (I-127)+(S13-5); (I-127)+(S13-6); (I-127)+(S13-7); (I-127)+(S13-8); (I-127)+(S13-9); (I-127)+(S14-1)
(I-128)+(S1-1); (I-128)+(S1-2); (I-128)+(S1-3); (I-128)+(S1-4); (I-128)+(S1-5); (I-128)+(S1-6); (I-128)+(S1-7); (I-128)+(S1-8); (I-128)+(S1-9); (I-128)+(S1-10); (I-128)+(S1-11); (I-128)+(S1-12); (I-128)+(S1-13); (I-128)+(S2-1); (I-128)+(S2-2); (I-128)+(S2-3); (I-128)+(S2-4); (I-128)+(S2-5); (I-128)+(S2-6); (I-128)+(S2-7); (I-128)+(S2-8); (I-128)+(S2-9); (I-128)+(S2-10); (I-128)+(S3-1); (I-128)+(S3-2); (I-128)+(S3-3); (I-128)+(S3-4); (I-128)+(S3-5); (I-128)+(S3-6); (I-128)+(S3-7); (I-128)+(S3-8); (I-128)+(S3-9); (I-128)+(S3-10); (I-128)+(S3-11); (I-128)+(S4-1); (I-128)+(S4-2); (I-128)+(S4-3); (I-128)+(S4-4); (I-128)+(S4-5); (I-128)+(S7-1); (I-128)+(S11-1); (I-128)+(S11-2); (I-128)+(S11-3); (I-128)+(S12-1); (I-128)+(S13-1); (I-128)+(S13-2); (I-128)+(S13-3); (I-128)+(S13-4): (I-128)+(S13-5); (I-128)+(S13-6); (I-128)+(S13-7); (I-128)+(S13-8); (I-128)+(S13-9); (I-128)+(S14-1)
(I-129)+(S1-1); (I-129)+(S1-2); (I-129)+(S1-3); (I-129)+(S1-4); (I-129)+(S1-5); (I-129)+(S1-6); (I-129)+(S1-7); (I-129)+(S1-8); (I-129)+(S1-9); (I-129)+(S1-10); (I-129)+(S1-11); (I-129)+(S1-12); (I-129)+(S1-13); (I-129)+(S2-1); (I-129)+(S2-2); (I-129)+(S2-3); (I-129)+(S2-4); (I-129)+(S2-5); (I-129)+(S2-6); (I-129)+(S2-7); (I-129)+(S2-8); (I-129)+(S2-9); (I-129)+(S2-10); (I-129)+(S3-1); (I-129)+(S3-2); (I-129)+(S3-3); (I-129)+(S3-4); (I-129)+(S3-5); (I-129)+(S3-6); (I-129)+(S3-7); (I-129)+(S3-8); (I-129)+(S3-9); (I-129)+(S3-10); (I-129)+(S3-11); (I-129)+(S4-1); (I-129)+(S4-2); (I-129)+(S4-3); (I-129)+(S4-4); (I-129)+(S4-5); (I-129)+(S7-1); (I-129)+(S11-1); (I-129)+(S11-2); (I-129)+(S11-3); (I-129)+(S12-1); (I-129)+(S13-1); (I-129)+(S13-2); (I-129)+(S13-3); (I-129)+(S13-4): (I-129)+(S13-5); (I-129)+(S13-6); (I-129)+(S13-7); (I-129)+(S13-8); (I-129)+(S13-9); (I-129)+(S14-1)
(I-130)+(S1-1); (I-130)+(S1-2); (I-130)+(S1-3); (I-130)+(S1-4); (I-130)+(S1-5); (I-130)+(S1-6); (I-130)+(S1-7); (I-130)+(S1-8); (I-130)+(S1-9); (I-130)+(S1-10); (I-130)+(S1-11); (I-130)+(S1-12); (I-130)+(S1-13); (I-130)+(S2-1); (I-130)+(S2-2); (I-130)+(S2-3); (I-130)+(S2-4); (I-130)+(S2-5); (I-130)+(S2-6); (I-130)+(S2-7); (I-130)+(S2-8); (I-130)+(S2-9); (I-130)+(S2-10); (I-130)+(S3-1); (I-130)+(S3-2); (I-130)+(S3-3); (I-130)+(S3-4); (I-130)+(S3-5); (I-130)+(S3-6); (I-130)+(S3-7); (I-130)+(S3-8); (I-130)+(S3-9); (I-130)+(S3-10); (I-130)+(S3-11); (I-130)+(S4-1); (I-130)+(S4-2); (I-130)+(S4-3); (I-130)+(S4-4); (I-130)+(S4-5); (I-130)+(S7-1); (I-130)+(S11-1); (I-130)+(S11-2); (I-130)+(S11-3); (I-130)+(S12-1); (I-130)+(S13-1); (I-130)+(S13-2); (I-130)+(S13-3); (I-130)+(S13-4): (I-130)+(S13-5); (I-130)+(S13-6); (I-130)+(S13-7); (I-130)+(S13-8); (I-130)+(S13-9); (I-130)+(S14-1)
(I-131)+(S1-1); (I-131)+(S1-2); (I-131)+(S1-3); (I-131)+(S1-4); (I-131)+(S1-5); (I-131)+(S1-6); (I-131)+(S1-7); (I-131)+(S1-8); (I-131)+(S1-9); (I-131)+(S1-10); (I-131)+(S1-11); (I-131)+(S1-12); (I-131)+(S1-13); (I-131)+(S2-1); (I-131)+(S2-2); (I-131)+(S2-3); (I-131)+(S2-4); (I-131)+(S2-5); (I-131)+(S2-6); (I-131)+(S2-7); (I-131)+(S2-8); (I-131)+(S2-9); (I-131)+(S2-10); (I-131)+(S3-1); (I-131)+(S3-2); (I-131)+(S3-3); (I-131)+(S3-4); (I-131)+(S3-5); (I-131)+(S3-6); (I-131)+(S3-7); (I-131)+(S3-8); (I-131)+(S3-9); (I-131)+(S3-10); (I-131)+(S3-11); (I-131)+(S4-1); (I-131)+(S4-2); (I-131)+(S4-3); (I-131)+(S4-4); (I-131)+(S4-5); (I-131)+(S7-1); (I-131)+(S11-1); (I-131)+(S11-2); (I-131)+(S11-3); (I-131)+(S12-1); (I-131)+(S13-1); (I-131)+(S13-2); (I-131)+(S13-3); (I-131)+(S13-4): (I-131)+(S13-5); (I-131)+(S13-6); (I-131)+(S13-7); (I-131)+(S13-8); (I-131)+(S13-9); (I-131)+(S14-1)
(I-132)+(S1-1); (I-132)+(S1-2); (I-132)+(S1-3); (I-132)+(S1-4); (I-132)+(S1-5); (I-132)+(S1-6); (I-132)+(S1-7); (I-132)+(S1-8); (I-132)+(S1-9); (I-132)+(S1-10); (I-132)+(S1-11); (I-132)+(S1-12); (I-132)+(S1-13); (I-132)+(S2-1); (I-132)+(S2-2); (I-132)+(S2-3); (I-132)+(S2-4); (I-132)+(S2-5); (I-132)+(S2-6); (I-132)+(S2-7); (I-132)+(S2-8); (I-132)+(S2-9); (I-132)+(S2-10); (I-132)+(S3-1); (I-132)+(S3-2); (I-132)+(S3-3); (I-132)+(S3-4); (I-132)+(S3-5); (I-132)+(S3-6); (I-132)+(S3-7); (I-132)+(S3-8); (I-132)+(S3-9); (I-132)+(S3-10); (I-132)+(S3-11); (I-132)+(S4-1); (I-132)+(S4-2); (I-132)+(S4-3); (I-132)+(S4-4); (I-132)+(S4-5); (I-132)+(S7-1); (I-132)+(S11-1); (I-132)+(S11-2); (I-132)+(S11-3); (I-132)+(S12-1); (I-132)+(S13-1); (I-132)+(S13-2); (I-132)+(S13-3); (I-132)+(S13-4): (I-132)+(S13-5); (I-132)+(S13-6); (I-132)+(S13-7); (I-132)+(S13-8); (I-132)+(S13-9); (I-132)+(S14-1)
(I-133)+(S1-1); (I-133)+(S1-2); (I-133)+(S1-3); (I-133)+(S1-4); (I-133)+(S1-5); (I-133)+(S1-6); (I-133)+(S1-7); (I-133)+(S1-8); (I-133)+(S1-9); (I-133)+(S1-10); (I-133)+(S1-11); (I-133)+(S1-12); (I-133)+(S1-13); (I-133)+(S2-1); (I-133)+(S2-2); (I-133)+(S2-3); (I-133)+(S2-4); (I-133)+(S2-5); (I-133)+(S2-6); (I-133)+(S2-7); (I-133)+(S2-8); (I-133)+(S2-9); (I-133)+(S2-10); (I-133)+(S3-1); (I-133)+(S3-2); (I-133)+(S3-3); (I-133)+(S3-4); (I-133)+(S3-5); (I-133)+(S3-6); (I-133)+(S3-7); (I-133)+(S3-8); (I-133)+(S3-9); (I-133)+(S3-10); (I-133)+(S3-11); (I-133)+(S4-1); (I-133)+(S4-2); (I-133)+(S4-3); (I-133)+(S4-4); (I-133)+(S4-5); (I-133)+(S7-1); (I-133)+(S11-1); (I-133)+(S11-2); (I-133)+(S11-3); (I-133)+(S12-1); (I-133)+(S13-1); (I-133)+(S13-2); (I-133)+(S13-3); (I-133)+(S13-4): (I-133)+(S13-5); (I-133)+(S13-6); (I-133)+(S13-7); (I-133)+(S13-8); (I-133)+(S13-9); (I-133)+(S14-1)
(I-134)+(S1-1); (I-134)+(S1-2); (I-134)+(S1-3); (I-134)+(S1-4); (I-134)+(S1-5); (I-134)+(S1-6); (I-134)+(S1-7); (I-134)+(S1-8); (I-134)+(S1-9); (I-134)+(S1-10); (I-134)+(S1-11); (I-134)+(S1-12); (I-134)+(S1-13); (I-134)+(S2-1); (I-134)+(S2-2); (I-134)+(S2-3); (I-134)+(S2-4); (I-134)+(S2-5); (I-134)+(S2-6); (I-134)+(S2-7); (I-134)+(S2-8); (I-134)+(S2-9); (I-134)+(S2-10); (I-134)+(S3-1); (I-134)+(S3-2); (I-134)+(S3-3); (I-134)+(S3-4); (I-134)+(S3-5); (I-134)+(S3-6); (I-134)+(S3-7); (I-134)+(S3-8); (I-134)+(S3-9); (I-134)+(S3-10); (I-134)+(S3-11); (I-134)+(S4-1); (I-134)+(S4-2); (I-134)+(S4-3); (I-134)+(S4-4); (I-134)+(S4-5); (I-134)+(S7-1); (I-134)+(S11-1); (I-134)+(S11-2); (I-134)+(S11-3); (I-134)+(S12-1); (I-134)+(S13-1); (I-134)+(S13-2); (I-134)+(S13-3); (I-134)+(S13-4): (I-134)+(S13-5); (I-134)+(S13-6); (I-134)+(S13-7); (I-134)+(S13-8); (I-134)+(S13-9); (I-134)+(S14-1)
(I-135)+(S1-1); (I-135)+(S1-2); (I-135)+(S1-3); (I-135)+(S1-4); (I-135)+(S1-5); (I-135)+(S1-6); (I-135)+(S1-7); (I-135)+(S1-8); (I-135)+(S1-9); (I-135)+(S1-10); (I-135)+(S1-11); (I-135)+(S1-12); (I-135)+(S1-13); (I-135)+(S2-1); (I-135)+(S2-2); (I-135)+(S2-3); (I-135)+(S2-4); (I-135)+(S2-5); (I-135)+(S2-6); (I-135)+(S2-7); (I-135)+(S2-8); (I-135)+(S2-9); (I-135)+(S2-10); (I-135)+(S3-1); (I-135)+(S3-2); (I-135)+(S3-3); (I-135)+(S3-4); (I-135)+(S3-5); (I-135)+(S3-6); (I-135)+(S3-7); (I-135)+(S3-8); (I-135)+(S3-9); (I-135)+(S3-10); (I-135)+(S3-11); (I-135)+(S4-1); (I-135)+(S4-2); (I-135)+(S4-3); (I-135)+(S4-4); (I-135)+(S4-5); (I-135)+(S7-1); (I-135)+(S11-1); (I-135)+(S11-2); (I-135)+(S11-3); (I-135)+(S12-1); (I-135)+(S13-1); (I-135)+(S13-2); (I-135)+(S13-3); (I-135)+(S13-4): (I-135)+(S13-5); (I-135)+(S13-6); (I-135)+(S13-7); (I-135)+(S13-8); (I-135)+(S13-9); (I-135)+(S14-1)
(I-136)+(S1-1); (I-136)+(S1-2); (I-136)+(S1-3); (I-136)+(S1-4); (I-136)+(S1-5); (I-136)+(S1-6); (I-136)+(S1-7); (I-136)+(S1-8); (I-136)+(S1-9); (I-136)+(S1-10); (I-136)+(S1-11); (I-136)+(S1-12); (I-136)+(S1-13); (I-136)+(S2-1); (I-136)+(S2-2); (I-136)+(S2-3); (I-136)+(S2-4); (I-136)+(S2-5); (I-136)+(S2-6); (I-136)+(S2-7); (I-136)+(S2-8); (I-136)+(S2-9); (I-136)+(S2-10); (I-136)+(S3-1); (I-136)+(S3-2); (I-136)+(S3-3); (I-136)+(S3-4); (I-136)+(S3-5); (I-136)+(S3-6); (I-136)+(S3-7); (I-136)+(S3-8); (I-136)+(S3-9); (I-136)+(S3-10); (I-136)+(S3-11); (I-136)+(S4-1); (I-136)+(S4-2); (I-136)+(S4-3); (I-136)+(S4-4); (I-136)+(S4-5); (I-136)+(S7-1); (I-136)+(S11-1); (I-136)+(S11-2); (I-136)+(S11-3); (I-136)+(S12-1); (I-136)+(S13-1); (I-136)+(S13-2); (I-136)+(S13-3); (I-136)+(S13-4): (I-136)+(S13-5); (I-136)+(S13-6); (I-136)+(S13-7); (I-136)+(S13-8); (I-136)+(S13-9); (I-136)+(S14-1)
(I-137)+(S1-1); (I-137)+(S1-2); (I-137)+(S1-3); (I-137)+(S1-4); (I-137)+(S1-5); (I-137)+(S1-6); (I-137)+(S1-7); (I-137)+(S1-8); (I-137)+(S1-9); (I-137)+(S1-10); (I-137)+(S1-11); (I-137)+(S1-12); (I-137)+(S1-13); (I-137)+(S2-1); (I-137)+(S2-2); (I-137)+(S2-3); (I-137)+(S2-4); (I-137)+(S2-5); (I-137)+(S2-6); (I-137)+(S2-7); (I-137)+(S2-8); (I-137)+(S2-9); (I-137)+(S2-10); (I-137)+(S3-1); (I-137)+(S3-2); (I-137)+(S3-3); (I-137)+(S3-4); (I-137)+(S3-5); (I-137)+(S3-6); (I-137)+(S3-7); (I-137)+(S3-8); (I-137)+(S3-9); (I-137)+(S3-10); (I-137)+(S3-11); (I-137)+(S4-1); (I-137)+(S4-2); (I-137)+(S4-3); (I-137)+(S4-4); (I-137)+(S4-5); (I-137)+(S7-1); (I-137)+(S11-1); (I-137)+(S11-2); (I-137)+(S11-3); (I-137)+(S12-1); (I-137)+(S13-1); (I-137)+(S13-2); (I-137)+(S13-3); (I-137)+(S13-4): (I-137)+(S13-5); (I-137)+(S13-6); (I-137)+(S13-7); (I-137)+(S13-8); (I-137)+(S13-9); (I-137)+(S14-1)
(I-138)+(S1-1); (I-138)+(S1-2); (I-138)+(S1-3); (I-138)+(S1-4); (I-138)+(S1-5); (I-138)+(S1-6); (I-138)+(S1-7); (I-138)+(S1-8); (I-138)+(S1-9); (I-138)+(S1-10); (I-138)+(S1-11); (I-138)+(S1-12); (I-138)+(S1-13); (I-138)+(S2-1); (I-138)+(S2-2); (I-138)+(S2-3); (I-138)+(S2-4); (I-138)+(S2-5); (I-138)+(S2-6); (I-138)+(S2-7); (I-138)+(S2-8); (I-138)+(S2-9); (I-138)+(S2-10); (I-138)+(S3-1); (I-138)+(S3-2); (I-138)+(S3-3); (I-138)+(S3-4); (I-138)+(S3-5); (I-138)+(S3-6); (I-138)+(S3-7); (I-138)+(S3-8); (I-138)+(S3-9); (I-138)+(S3-10); (I-138)+(S3-11); (I-138)+(S4-1); (I-138)+(S4-2); (I-138)+(S4-3); (I-138)+(S4-4); (I-138)+(S4-5); (I-138)+(S7-1); (I-138)+(S11-1); (I-138)+(S11-2); (I-138)+(S11-3); (I-138)+(S12-1); (I-138)+(S13-1); (I-138)+(S13-2); (I-138)+(S13-3); (I-138)+(S13-4): (I-138)+(S13-5); (I-138)+(S13-6); (I-138)+(S13-7); (I-138)+(S13-8); (I-138)+(S13-9); (I-138)+(S14-1)
(I-139)+(S1-1); (I-139)+(S1-2); (I-139)+(S1-3); (I-139)+(S1-4); (I-139)+(S1-5); (I-139)+(S1-6); (I-139)+(S1-7); (I-139)+(S1-8); (I-139)+(S1-9); (I-139)+(S1-10); (I-139)+(S1-11); (I-139)+(S1-12); (I-139)+(S1-13); (I-139)+(S2-1); (I-139)+(S2-2); (I-139)+(S2-3); (I-139)+(S2-4); (I-139)+(S2-5); (I-139)+(S2-6); (I-139)+(S2-7); (I-139)+(S2-8); (I-139)+(S2-9); (I-139)+(S2-10); (I-139)+(S3-1); (I-139)+(S3-2); (I-139)+(S3-3); (I-139)+(S3-4); (I-139)+(S3-5); (I-139)+(S3-6); (I-139)+(S3-7); (I-139)+(S3-8); (I-139)+(S3-9); (I-139)+(S3-10); (I-139)+(S3-11); (I-139)+(S4-1); (I-139)+(S4-2); (I-139)+(S4-3); (I-139)+(S4-4); (I-139)+(S4-5); (I-139)+(S7-1); (I-139)+(S11-1); (I-139)+(S11-2); (I-139)+(S11-3); (I-139)+(S12-1); (I-139)+(S13-1); (I-139)+(S13-2); (I-139)+(S13-3); (I-139)+(S13-4): (I-139)+(S13-5); (I-139)+(S13-6); (I-139)+(S13-7); (I-139)+(S13-8); (I-139)+(S13-9); (I-139)+(S14-1)
(I-140)+(S1-1); (I-140)+(S1-2); (I-140)+(S1-3); (I-140)+(S1-4); (I-140)+(S1-5); (I-140)+(S1-6); (I-140)+(S1-7); (I-140)+(S1-8); (I-140)+(S1-9); (I-140)+(S1-10); (I-140)+(S1-11); (I-140)+(S1-12); (I-140)+(S1-13); (I-140)+(S2-1); (I-140)+(S2-2); (I-140)+(S2-3); (I-140)+(S2-4); (I-140)+(S2-5); (I-140)+(S2-6); (I-140)+(S2-7); (I-140)+(S2-8); (I-140)+(S2-9); (I-140)+(S2-10); (I-140)+(S3-1); (I-140)+(S3-2); (I-140)+(S3-3); (I-140)+(S3-4); (I-140)+(S3-5); (I-140)+(S3-6); (I-140)+(S3-7); (I-140)+(S3-8); (I-140)+(S3-9); (I-140)+(S3-10); (I-140)+(S3-11); (I-140)+(S4-1); (I-140)+(S4-2); (I-140)+(S4-3); (I-140)+(S4-4); (I-140)+(S4-5); (I-140)+(S7-1); (I-140)+(S11-1); (I-140)+(S11-2); (I-140)+(S11-3); (I-140)+(S12-1); (I-140)+(S13-1); (I-140)+(S13-2); (I-140)+(S13-3); (I-140)+(S13-4): (I-140)+(S13-5); (I-140)+(S13-6); (I-140)+(S13-7); (I-140)+(S13-8); (I-140)+(S13-9); (I-140)+(S14-1)
(I-141)+(S1-1); (I-141)+(S1-2); (I-141)+(S1-3); (I-141)+(S1-4); (I-141)+(S1-5); (I-141)+(S1-6); (I-141)+(S1-7); (I-141)+(S1-8); (I-141)+(S1-9); (I-141)+(S1-10); (I-141)+(S1-11); (I-141)+(S1-12); (I-141)+(S1-13); (I-141)+(S2-1); (I-141)+(S2-2); (I-141)+(S2-3); (I-141)+(S2-4); (I-141)+(S2-5); (I-141)+(S2-6); (I-141)+(S2-7); (I-141)+(S2-8); (I-141)+(S2-9); (I-141)+(S2-10); (I-141)+(S3-1); (I-141)+(S3-2); (I-141)+(S3-3); (I-141)+(S3-4); (I-141)+(S3-5); (I-141)+(S3-6); (I-141)+(S3-7); (I-141)+(S3-8); (I-141)+(S3-9); (I-141)+(S3-10); (I-141)+(S3-11); (I-141)+(S4-1); (I-141)+(S4-2); (I-141)+(S4-3); (I-141)+(S4-4); (I-141)+(S4-5); (I-141)+(S7-1); (I-141)+(S11-1); (I-141)+(S11-2); (I-141)+(S11-3); (I-141)+(S12-1); (I-141)+(S13-1); (I-141)+(S13-2); (I-141)+(S13-3); (I-141)+(S13-4): (I-141)+(S13-5); (I-141)+(S13-6); (I-141)+(S13-7); (I-141)+(S13-8); (I-141)+(S13-9); (I-141)+(S14-1)
(I-142)+(S1-1); (I-142)+(S1-2); (I-142)+(S1-3); (I-142)+(S1-4); (I-142)+(S1-5); (I-142)+(S1-6); (I-142)+(S1-7); (I-142)+(S1-8); (I-142)+(S1-9); (I-142)+(S1-10); (I-142)+(S1-11); (I-142)+(S1-12); (I-142)+(S1-13); (I-142)+(S2-1); (I-142)+(S2-2); (I-142)+(S2-3); (I-142)+(S2-4); (I-142)+(S2-5); (I-142)+(S2-6); (I-142)+(S2-7); (I-142)+(S2-8); (I-142)+(S2-9); (I-142)+(S2-10); (I-142)+(S3-1); (I-142)+(S3-2); (I-142)+(S3-3); (I-142)+(S3-4); (I-142)+(S3-5); (I-142)+(S3-6); (I-142)+(S3-7); (I-142)+(S3-8); (I-142)+(S3-9); (I-142)+(S3-10); (I-142)+(S3-11); (I-142)+(S4-1); (I-142)+(S4-2); (I-142)+(S4-3); (I-142)+(S4-4); (I-142)+(S4-5); (I-142)+(S7-1); (I-142)+(S11-1); (I-142)+(S11-2); (I-142)+(S11-3); (I-142)+(S12-1); (I-142)+(S13-1); (I-142)+(S13-2); (I-142)+(S13-3); (I-142)+(S13-4): (I-142)+(S13-5); (I-142)+(S13-6); (I-142)+(S13-7); (I-142)+(S13-8); (I-142)+(S13-9); (I-142)+(S14-1)
(I-143)+(S1-1); (I-143)+(S1-2); (I-143)+(S1-3); (I-143)+(S1-4); (I-143)+(S1-5); (I-143)+(S1-6); (I-143)+(S1-7); (I-143)+(S1-8); (I-143)+(S1-9); (I-143)+(S1-10); (I-143)+(S1-11); (I-143)+(S1-12); (I-143)+(S1-13); (I-143)+(S2-1); (I-143)+(S2-2); (I-143)+(S2-3); (I-143)+(S2-4); (I-143)+(S2-5); (I-143)+(S2-6); (I-143)+(S2-7); (I-143)+(S2-8); (I-143)+(S2-9); (I-143)+(S2-10); (I-143)+(S3-1); (I-143)+(S3-2); (I-143)+(S3-3); (I-143)+(S3-4); (I-143)+(S3-5); (I-143)+(S3-6); (I-143)+(S3-7); (I-143)+(S3-8); (I-143)+(S3-9); (I-143)+(S3-10); (I-143)+(S3-11); (I-143)+(S4-1); (I-143)+(S4-2); (I-143)+(S4-3); (I-143)+(S4-4); (I-143)+(S4-5); (I-143)+(S7-1); (I-143)+(S11-1); (I-143)+(S11-2); (I-143)+(S11-3); (I-143)+(S12-1); (I-143)+(S13-1); (I-143)+(S13-2); (I-143)+(S13-3); (I-143)+(S13-4): (I-143)+(S13-5); (I-143)+(S13-6); (I-143)+(S13-7); (I-143)+(S13-8); (I-143)+(S13-9); (I-143)+(S14-1)
(I-144)+(S1-1); (I-144)+(S1-2); (I-144)+(S1-3); (I-144)+(S1-4); (I-144)+(S1-5); (I-144)+(S1-6); (I-144)+(S1-7); (I-144)+(S1-8); (I-144)+(S1-9); (I-144)+(S1-10); (I-144)+(S1-11); (I-144)+(S1-12); (I-144)+(S1-13); (I-144)+(S2-1); (I-144)+(S2-2); (I-144)+(S2-3); (I-144)+(S2-4); (I-144)+(S2-5); (I-144)+(S2-6); (I-144)+(S2-7); (I-144)+(S2-8); (I-144)+(S2-9); (I-144)+(S2-10); (I-144)+(S3-1); (I-144)+(S3-2); (I-144)+(S3-3); (I-144)+(S3-4); (I-144)+(S3-5); (I-144)+(S3-6); (I-144)+(S3-7); (I-144)+(S3-8); (I-144)+(S3-9); (I-144)+(S3-10); (I-144)+(S3-11); (I-144)+(S4-1); (I-144)+(S4-2); (I-144)+(S4-3); (I-144)+(S4-4); (I-144)+(S4-5); (I-144)+(S7-1); (I-144)+(S11-1); (I-144)+(S11-2); (I-144)+(S11-3); (I-144)+(S12-1); (I-144)+(S13-1); (I-144)+(S13-2); (I-144)+(S13-3); (I-144)+(S13-4): (I-144)+(S13-5); (I-144)+(S13-6); (I-144)+(S13-7); (I-144)+(S13-8); (I-144)+(S13-9); (I-144)+(S14-1)
(I-145)+(S1-1); (I-145)+(S1-2); (I-145)+(S1-3); (I-145)+(S1-4); (I-145)+(S1-5); (I-145)+(S1-6); (I-145)+(S1-7); (I-145)+(S1-8); (I-145)+(S1-9); (I-145)+(S1-10); (I-145)+(S1-11); (I-145)+(S1-12); (I-145)+(S1-13); (I-145)+(S2-1); (I-145)+(S2-2); (I-145)+(S2-3); (I-145)+(S2-4); (I-145)+(S2-5); (I-145)+(S2-6); (I-145)+(S2-7); (I-145)+(S2-8); (I-145)+(S2-9); (I-145)+(S2-10); (I-145)+(S3-1); (I-145)+(S3-2); (I-145)+(S3-3); (I-145)+(S3-4); (I-145)+(S3-5); (I-145)+(S3-6); (I-145)+(S3-7); (I-145)+(S3-8); (I-145)+(S3-9); (I-145)+(S3-10); (I-145)+(S3-11); (I-145)+(S4-1); (I-145)+(S4-2); (I-145)+(S4-3); (I-145)+(S4-4); (I-145)+(S4-5); (I-145)+(S7-1); (I-145)+(S11-1); (I-145)+(S11-2); (I-145)+(S11-3); (I-145)+(S12-1); (I-145)+(S13-1); (I-145)+(S13-2); (I-145)+(S13-3); (I-145)+(S13-4): (I-145)+(S13-5); (I-145)+(S13-6); (I-145)+(S13-7); (I-145)+(S13-8); (I-145)+(S13-9); (I-145)+(S14-1)
(I-146)+(S1-1); (I-146)+(S1-2); (I-146)+(S1-3); (I-146)+(S1-4); (I-146)+(S1-5); (I-146)+(S1-6); (I-146)+(S1-7); (I-146)+(S1-8); (I-146)+(S1-9); (I-146)+(S1-10); (I-146)+(S1-11); (I-146)+(S1-12); (I-146)+(S1-13); (I-146)+(S2-1); (I-146)+(S2-2); (I-146)+(S2-3); (I-146)+(S2-4); (I-146)+(S2-5); (I-146)+(S2-6); (I-146)+(S2-7); (I-146)+(S2-8); (I-146)+(S2-9); (I-146)+(S2-10); (I-146)+(S3-1); (I-146)+(S3-2); (I-146)+(S3-3); (I-146)+(S3-4); (I-146)+(S3-5); (I-146)+(S3-6); (I-146)+(S3-7); (I-146)+(S3-8); (I-146)+(S3-9); (I-146)+(S3-10); (I-146)+(S3-11); (I-146)+(S4-1); (I-146)+(S4-2); (I-146)+(S4-3); (I-146)+(S4-4); (I-146)+(S4-5); (I-146)+(S7-1); (I-146)+(S11-1); (I-146)+(S11-2); (I-146)+(S11-3); (I-146)+(S12-1); (I-146)+(S13-1); (I-146)+(S13-2); (I-146)+(S13-3); (I-146)+(S13-4): (I-146)+(S13-5); (I-146)+(S13-6); (I-146)+(S13-7); (I-146)+(S13-8); (I-146)+(S13-9); (I-146)+(S14-1)
(I-147)+(S1-1); (I-147)+(S1-2); (I-147)+(S1-3); (I-147)+(S1-4); (I-147)+(S1-5); (I-147)+(S1-6); (I-147)+(S1-7); (I-147)+(S1-8); (I-147)+(S1-9); (I-147)+(S1-10); (I-147)+(S1-11); (I-147)+(S1-12); (I-147)+(S1-13); (I-147)+(S2-1); (I-147)+(S2-2); (I-147)+(S2-3); (I-147)+(S2-4); (I-147)+(S2-5); (I-147)+(S2-6); (I-147)+(S2-7); (I-147)+(S2-8); (I-147)+(S2-9); (I-147)+(S2-10); (I-147)+(S3-1); (I-147)+(S3-2); (I-147)+(S3-3); (I-147)+(S3-4); (I-147)+(S3-5); (I-147)+(S3-6); (I-147)+(S3-7); (I-147)+(S3-8); (I-147)+(S3-9); (I-147)+(S3-10); (I-147)+(S3-11); (I-147)+(S4-1); (I-147)+(S4-2); (I-147)+(S4-3); (I-147)+(S4-4); (I-147)+(S4-5); (I-147)+(S7-1); (I-147)+(S11-1); (I-147)+(S11-2); (I-147)+(S11-3); (I-147)+(S12-1); (I-147)+(S13-1); (I-147)+(S13-2); (I-147)+(S13-3); (I-147)+(S13-4): (I-147)+(S13-5); (I-147)+(S13-6); (I-147)+(S13-7); (I-147)+(S13-8); (I-147)+(S13-9); (I-147)+(S14-1)
(I-148)+(S1-1); (I-148)+(S1-2); (I-148)+(S1-3); (I-148)+(S1-4); (I-148)+(S1-5); (I-148)+(S1-6); (I-148)+(S1-7); (I-148)+(S1-8); (I-148)+(S1-9); (I-148)+(S1-10); (I-148)+(S1-11); (I-148)+(S1-12); (I-148)+(S1-13); (I-148)+(S2-1); (I-148)+(S2-2); (I-148)+(S2-3); (I-148)+(S2-4); (I-148)+(S2-5); (I-148)+(S2-6); (I-148)+(S2-7); (I-148)+(S2-8); (I-148)+(S2-9); (I-148)+(S2-10); (I-148)+(S3-1); (I-148)+(S3-2); (I-148)+(S3-3); (I-148)+(S3-4); (I-148)+(S3-5); (I-148)+(S3-6); (I-148)+(S3-7); (I-148)+(S3-8); (I-148)+(S3-9); (I-148)+(S3-10); (I-148)+(S3-11); (I-148)+(S4-1); (I-148)+(S4-2); (I-148)+(S4-3); (I-148)+(S4-4); (I-148)+(S4-5); (I-148)+(S7-1); (I-148)+(S11-1); (I-148)+(S11-2); (I-148)+(S11-3); (I-148)+(S12-1); (I-148)+(S13-1); (I-148)+(S13-2); (I-148)+(S13-3); (I-148)+(S13-4): (I-148)+(S13-5); (I-148)+(S13-6); (I-148)+(S13-7); (I-148)+(S13-8); (I-148)+(S13-9); (I-148)+(S14-1)
(I-149)+(S1-1); (I-149)+(S1-2); (I-149)+(S1-3); (I-149)+(S1-4); (I-149)+(S1-5); (I-149)+(S1-6); (I-149)+(S1-7); (I-149)+(S1-8); (I-149)+(S1-9); (I-149)+(S1-10); (I-149)+(S1-11); (I-149)+(S1-12); (I-149)+(S1-13); (I-149)+(S2-1); (I-149)+(S2-2); (I-149)+(S2-3); (I-149)+(S2-4); (I-149)+(S2-5); (I-149)+(S2-6); (I-149)+(S2-7); (I-149)+(S2-8); (I-149)+(S2-9); (I-149)+(S2-10); (I-149)+(S3-1); (I-149)+(S3-2); (I-149)+(S3-3); (I-149)+(S3-4); (I-149)+(S3-5); (I-149)+(S3-6); (I-149)+(S3-7); (I-149)+(S3-8); (I-149)+(S3-9); (I-149)+(S3-10); (I-149)+(S3-11); (I-149)+(S4-1); (I-149)+(S4-2); (I-149)+(S4-3); (I-149)+(S4-4); (I-149)+(S4-5); (I-149)+(S7-1); (I-149)+(S11-1); (I-149)+(S11-2); (I-149)+(S11-3); (I-149)+(S12-1); (I-149)+(S13-1); (I-149)+(S13-2); (I-149)+(S13-3); (I-149)+(S13-4): (I-149)+(S13-5); (I-149)+(S13-6); (I-149)+(S13-7); (I-149)+(S13-8); (I-149)+(S13-9); (I-149)+(S14-1)
(I-150)+(S1-1); (I-150)+(S1-2); (I-150)+(S1-3); (I-150)+(S1-4); (I-150)+(S1-5); (I-150)+(S1-6); (I-150)+(S1-7); (I-150)+(S1-8); (I-150)+(S1-9); (I-150)+(S1-10); (I-150)+(S1-11); (I-150)+(S1-12); (I-150)+(S1-13); (I-150)+(S2-1); (I-150)+(S2-2); (I-150)+(S2-3); (I-150)+(S2-4); (I-150)+(S2-5); (I-150)+(S2-6); (I-150)+(S2-7); (I-150)+(S2-8); (I-150)+(S2-9); (I-150)+(S2-10); (I-150)+(S3-1); (I-150)+(S3-2); (I-150)+(S3-3); (I-150)+(S3-4); (I-150)+(S3-5); (I-150)+(S3-6); (I-150)+(S3-7); (I-150)+(S3-8); (I-150)+(S3-9); (I-150)+(S3-10); (I-150)+(S3-11); (I-150)+(S4-1); (I-150)+(S4-2); (I-150)+(S4-3); (I-150)+(S4-4); (I-150)+(S4-5); (I-150)+(S7-1); (I-150)+(S11-1); (I-150)+(S11-2); (I-150)+(S11-3); (I-150)+(S12-1); (I-150)+(S13-1); (I-150)+(S13-2); (I-150)+(S13-3); (I-150)+(S13-4): (I-150)+(S13-5); (I-150)+(S13-6); (I-150)+(S13-7); (I-150)+(S13-8); (I-150)+(S13-9); (I-150)+(S14-1)
(I-151)+(S1-1); (I-151)+(S1-2); (I-151)+(S1-3); (I-151)+(S1-4); (I-151)+(S1-5); (I-151)+(S1-6); (I-151)+(S1-7); (I-151)+(S1-8); (I-151)+(S1-9); (I-151)+(S1-10); (I-151)+(S1-11); (I-151)+(S1-12); (I-151)+(S1-13); (I-151)+(S2-1); (I-151)+(S2-2); (I-151)+(S2-3); (I-151)+(S2-4); (I-151)+(S2-5); (I-151)+(S2-6); (I-151)+(S2-7); (I-151)+(S2-8); (I-151)+(S2-9); (I-151)+(S2-10); (I-151)+(S3-1); (I-151)+(S3-2); (I-151)+(S3-3); (I-151)+(S3-4); (I-151)+(S3-5); (I-151)+(S3-6); (I-151)+(S3-7); (I-151)+(S3-8); (I-151)+(S3-9); (I-151)+(S3-10); (I-151)+(S3-11); (I-151)+(S4-1); (I-151)+(S4-2); (I-151)+(S4-3); (I-151)+(S4-4); (I-151)+(S4-5); (I-151)+(S7-1); (I-151)+(S11-1); (I-151)+(S11-2); (I-151)+(S11-3); (I-151)+(S12-1); (I-151)+(S13-1); (I-151)+(S13-2); (I-151)+(S13-3); (I-151)+(S13-4): (I-151)+(S13-5); (I-151)+(S13-6); (I-151)+(S13-7); (I-151)+(S13-8); (I-151)+(S13-9); (I-151)+(S14-1)
(I-152)+(S1-1); (I-152)+(S1-2); (I-152)+(S1-3); (I-152)+(S1-4); (I-152)+(S1-5); (I-152)+(S1-6); (I-152)+(S1-7); (I-152)+(S1-8); (I-152)+(S1-9); (I-152)+(S1-10); (I-152)+(S1-11); (I-152)+(S1-12); (I-152)+(S1-13); (I-152)+(S2-1); (I-152)+(S2-2); (I-152)+(S2-3); (I-152)+(S2-4); (I-152)+(S2-5); (I-152)+(S2-6); (I-152)+(S2-7); (I-152)+(S2-8); (I-152)+(S2-9); (I-152)+(S2-10); (I-152)+(S3-1); (I-152)+(S3-2); (I-152)+(S3-3); (I-152)+(S3-4); (I-152)+(S3-5); (I-152)+(S3-6); (I-152)+(S3-7); (I-152)+(S3-8); (I-152)+(S3-9); (I-152)+(S3-10); (I-152)+(S3-11); (I-152)+(S4-1); (I-152)+(S4-2); (I-152)+(S4-3); (I-152)+(S4-4); (I-152)+(S4-5); (I-152)+(S7-1); (I-152)+(S11-1); (I-152)+(S11-2); (I-152)+(S11-3); (I-152)+(S12-1); (I-152)+(S13-1); (I-152)+(S13-2); (I-152)+(S13-3); (I-152)+(S13-4): (I-152)+(S13-5); (I-152)+(S13-6); (I-152)+(S13-7); (I-152)+(S13-8); (I-152)+(S13-9); (I-152)+(S14-1)
(I-153)+(S1-1); (I-153)+(S1-2); (I-153)+(S1-3); (I-153)+(S1-4); (I-153)+(S1-5); (I-153)+(S1-6); (I-153)+(S1-7); (I-153)+(S1-8); (I-153)+(S1-9); (I-153)+(S1-10); (I-153)+(S1-11); (I-153)+(S1-12); (I-153)+(S1-13); (I-153)+(S2-1); (I-153)+(S2-2); (I-153)+(S2-3); (I-153)+(S2-4); (I-153)+(S2-5); (I-153)+(S2-6); (I-153)+(S2-7); (I-153)+(S2-8); (I-153)+(S2-9); (I-153)+(S2-10); (I-153)+(S3-1); (I-153)+(S3-2); (I-153)+(S3-3); (I-153)+(S3-4); (I-153)+(S3-5); (I-153)+(S3-6); (I-153)+(S3-7); (I-153)+(S3-8); (I-153)+(S3-9); (I-153)+(S3-10); (I-153)+(S3-11); (I-153)+(S4-1); (I-153)+(S4-2); (I-153)+(S4-3); (I-153)+(S4-4); (I-153)+(S4-5); (I-153)+(S7-1); (I-153)+(S11-1); (I-153)+(S11-2); (I-153)+(S11-3); (I-153)+(S12-1); (I-153)+(S13-1); (I-153)+(S13-2); (I-153)+(S13-3); (I-153)+(S13-4): (I-153)+(S13-5); (I-153)+(S13-6); (I-153)+(S13-7); (I-153)+(S13-8); (I-153)+(S13-9); (I-153)+(S14-1)
(I-154)+(S1-1); (I-154)+(S1-2); (I-154)+(S1-3); (I-154)+(S1-4); (I-154)+(S1-5); (I-154)+(S1-6); (I-154)+(S1-7); (I-154)+(S1-8); (I-154)+(S1-9); (I-154)+(S1-10); (I-154)+(S1-11); (I-154)+(S1-12); (I-154)+(S1-13); (I-154)+(S2-1); (I-154)+(S2-2); (I-154)+(S2-3); (I-154)+(S2-4); (I-154)+(S2-5); (I-154)+(S2-6); (I-154)+(S2-7); (I-154)+(S2-8); (I-154)+(S2-9); (I-154)+(S2-10); (I-154)+(S3-1); (I-154)+(S3-2); (I-154)+(S3-3); (I-154)+(S3-4); (I-154)+(S3-5); (I-154)+(S3-6); (I-154)+(S3-7); (I-154)+(S3-8); (I-154)+(S3-9); (I-154)+(S3-10); (I-154)+(S3-11); (I-154)+(S4-1); (I-154)+(S4-2); (I-154)+(S4-3); (I-154)+(S4-4); (I-154)+(S4-5); (I-154)+(S7-1); (I-154)+(S11-1); (I-154)+(S11-2); (I-154)+(S11-3); (I-154)+(S12-1); (I-154)+(S13-1); (I-154)+(S13-2); (I-154)+(S13-3); (I-154)+(S13-4): (I-154)+(S13-5); (I-154)+(S13-6); (I-154)+(S13-7); (I-154)+(S13-8); (I-154)+(S13-9); (I-154)+(S14-1)
(I-155)+(S1-1); (I-155)+(S1-2); (I-155)+(S1-3); (I-155)+(S1-4); (I-155)+(S1-5); (I-155)+(S1-6); (I-155)+(S1-7); (I-155)+(S1-8); (I-155)+(S1-9); (I-155)+(S1-10); (I-155)+(S1-11); (I-155)+(S1-12); (I-155)+(S1-13); (I-155)+(S2-1); (I-155)+(S2-2); (I-155)+(S2-3); (I-155)+(S2-4); (I-155)+(S2-5); (I-155)+(S2-6); (I-155)+(S2-7); (I-155)+(S2-8); (I-155)+(S2-9); (I-155)+(S2-10); (I-155)+(S3-1); (I-155)+(S3-2); (I-155)+(S3-3); (I-155)+(S3-4); (I-155)+(S3-5); (I-155)+(S3-6); (I-155)+(S3-7); (I-155)+(S3-8); (I-155)+(S3-9); (I-155)+(S3-10); (I-155)+(S3-11); (I-155)+(S4-1); (I-155)+(S4-2); (I-155)+(S4-3); (I-155)+(S4-4); (I-155)+(S4-5); (I-155)+(S7-1); (I-155)+(S11-1); (I-155)+(S11-2); (I-155)+(S11-3); (I-155)+(S12-1); (I-155)+(S13-1); (I-155)+(S13-2); (I-155)+(S13-3); (I-155)+(S13-4): (I-155)+(S13-5); (I-155)+(S13-6); (I-155)+(S13-7); (I-155)+(S13-8); (I-155)+(S13-9); (I-155)+(S14-1)
(I-156)+(S1-1); (I-156)+(S1-2); (I-156)+(S1-3); (I-156)+(S1-4); (I-156)+(S1-5); (I-156)+(S1-6); (I-156)+(S1-7); (I-156)+(S1-8); (I-156)+(S1-9); (I-156)+(S1-10); (I-156)+(S1-11); (I-156)+(S1-12); (I-156)+(S1-13); (I-156)+(S2-1); (I-156)+(S2-2); (I-156)+(S2-3); (I-156)+(S2-4); (I-156)+(S2-5); (I-156)+(S2-6); (I-156)+(S2-7); (I-156)+(S2-8); (I-156)+(S2-9); (I-156)+(S2-10); (I-156)+(S3-1); (I-156)+(S3-2); (I-156)+(S3-3); (I-156)+(S3-4); (I-156)+(S3-5); (I-156)+(S3-6); (I-156)+(S3-7); (I-156)+(S3-8); (I-156)+(S3-9); (I-156)+(S3-10); (I-156)+(S3-11); (I-156)+(S4-1); (I-156)+(S4-2); (I-156)+(S4-3); (I-156)+(S4-4); (I-156)+(S4-5); (I-156)+(S7-1); (I-156)+(S11-1); (I-156)+(S11-2); (I-156)+(S11-3); (I-156)+(S12-1); (I-156)+(S13-1); (I-156)+(S13-2); (I-156)+(S13-3); (I-156)+(S13-4): (I-156)+(S13-5); (I-156)+(S13-6); (I-156)+(S13-7); (I-156)+(S13-8); (I-156)+(S13-9); (I-156)+(S14-1)
(I-157)+(S1-1); (I-157)+(S1-2); (I-157)+(S1-3); (I-157)+(S1-4); (I-157)+(S1-5); (I-157)+(S1-6); (I-157)+(S1-7); (I-157)+(S1-8); (I-157)+(S1-9); (I-157)+(S1-10); (I-157)+(S1-11); (I-157)+(S1-12); (I-157)+(S1-13); (I-157)+(S2-1); (I-157)+(S2-2); (I-157)+(S2-3); (I-157)+(S2-4); (I-157)+(S2-5); (I-157)+(S2-6); (I-157)+(S2-7); (I-157)+(S2-8); (I-157)+(S2-9); (I-157)+(S2-10); (I-157)+(S3-1); (I-157)+(S3-2); (I-157)+(S3-3); (I-157)+(S3-4); (I-157)+(S3-5); (I-157)+(S3-6); (I-157)+(S3-7); (I-157)+(S3-8); (I-157)+(S3-9); (I-157)+(S3-10); (I-157)+(S3-11); (I-157)+(S4-1); (I-157)+(S4-2); (I-157)+(S4-3); (I-157)+(S4-4); (I-157)+(S4-5); (I-157)+(S7-1); (I-157)+(S11-1); (I-157)+(S11-2); (I-157)+(S11-3); (I-157)+(S12-1); (I-157)+(S13-1); (I-157)+(S13-2); (I-157)+(S13-3); (I-157)+(S13-4): (I-157)+(S13-5); (I-157)+(S13-6); (I-157)+(S13-7); (I-157)+(S13-8); (I-157)+(S13-9); (I-157)+(S14-1)
(I-158)+(S1-1); (I-158)+(S1-2); (I-158)+(S1-3); (I-158)+(S1-4); (I-158)+(S1-5); (I-158)+(S1-6); (I-158)+(S1-7); (I-158)+(S1-8); (I-158)+(S1-9); (I-158)+(S1-10); (I-158)+(S1-11); (I-158)+(S1-12); (I-158)+(S1-13); (I-158)+(S2-1); (I-158)+(S2-2); (I-158)+(S2-3); (I-158)+(S2-4); (I-158)+(S2-5); (I-158)+(S2-6); (I-158)+(S2-7); (I-158)+(S2-8); (I-158)+(S2-9); (I-158)+(S2-10); (I-158)+(S3-1); (I-158)+(S3-2); (I-158)+(S3-3); (I-158)+(S3-4); (I-158)+(S3-5); (I-158)+(S3-6); (I-158)+(S3-7); (I-158)+(S3-8); (I-158)+(S3-9); (I-158)+(S3-10); (I-158)+(S3-11); (I-158)+(S4-1); (I-158)+(S4-2); (I-158)+(S4-3); (I-158)+(S4-4); (I-158)+(S4-5); (I-158)+(S7-1); (I-158)+(S11-1); (I-158)+(S11-2); (I-158)+(S11-3); (I-158)+(S12-1); (I-158)+(S13-1); (I-158)+(S13-2); (I-158)+(S13-3); (I-158)+(S13-4): (I-158)+(S13-5); (I-158)+(S13-6); (I-158)+(S13-7); (I-158)+(S13-8); (I-158)+(S13-9); (I-158)+(S14-1)
(I-159)+(S1-1); (I-159)+(S1-2); (I-159)+(S1-3); (I-159)+(S1-4); (I-159)+(S1-5); (I-159)+(S1-6); (I-159)+(S1-7); (I-159)+(S1-8); (I-159)+(S1-9); (I-159)+(S1-10); (I-159)+(S1-11); (I-159)+(S1-12); (I-159)+(S1-13); (I-159)+(S2-1); (I-159)+(S2-2); (I-159)+(S2-3); (I-159)+(S2-4); (I-159)+(S2-5); (I-159)+(S2-6); (I-159)+(S2-7); (I-159)+(S2-8); (I-159)+(S2-9); (I-159)+(S2-10); (I-159)+(S3-1); (I-159)+(S3-2); (I-159)+(S3-3); (I-159)+(S3-4); (I-159)+(S3-5); (I-159)+(S3-6); (I-159)+(S3-7); (I-159)+(S3-8); (I-159)+(S3-9); (I-159)+(S3-10); (I-159)+(S3-11); (I-159)+(S4-1); (I-159)+(S4-2); (I-159)+(S4-3); (I-159)+(S4-4); (I-159)+(S4-5); (I-159)+(S7-1); (I-159)+(S11-1); (I-159)+(S11-2); (I-159)+(S11-3); (I-159)+(S12-1); (I-159)+(S13-1); (I-159)+(S13-2); (I-159)+(S13-3); (I-159)+(S13-4): (I-159)+(S13-5); (I-159)+(S13-6); (I-159)+(S13-7); (I-159)+(S13-8); (I-159)+(S13-9); (I-159)+(S14-1)
(I-160)+(S1-1); (I-160)+(S1-2); (I-160)+(S1-3); (I-160)+(S1-4); (I-160)+(S1-5); (I-160)+(S1-6); (I-160)+(S1-7); (I-160)+(S1-8); (I-160)+(S1-9); (I-160)+(S1-10); (I-160)+(S1-11); (I-160)+(S1-12); (I-160)+(S1-13); (I-160)+(S2-1); (I-160)+(S2-2); (I-160)+(S2-3); (I-160)+(S2-4); (I-160)+(S2-5); (I-160)+(S2-6); (I-160)+(S2-7); (I-160)+(S2-8); (I-160)+(S2-9); (I-160)+(S2-10); (I-160)+(S3-1); (I-160)+(S3-2); (I-160)+(S3-3); (I-160)+(S3-4); (I-160)+(S3-5); (I-160)+(S3-6); (I-160)+(S3-7); (I-160)+(S3-8); (I-160)+(S3-9); (I-160)+(S3-10); (I-160)+(S3-11); (I-160)+(S4-1); (I-160)+(S4-2); (I-160)+(S4-3); (I-160)+(S4-4); (I-160)+(S4-5); (I-160)+(S7-1); (I-160)+(S11-1); (I-160)+(S11-2); (I-160)+(S11-3); (I-160)+(S12-1); (I-160)+(S13-1); (I-160)+(S13-2); (I-160)+(S13-3); (I-160)+(S13-4): (I-160)+(S13-5); (I-160)+(S13-6); (I-160)+(S13-7); (I-160)+(S13-8); (I-160)+(S13-9); (I-160)+(S14-1)
(I-161)+(S1-1); (I-161)+(S1-2); (I-161)+(S1-3); (I-161)+(S1-4); (I-161)+(S1-5); (I-161)+(S1-6); (I-161)+(S1-7); (I-161)+(S1-8); (I-161)+(S1-9); (I-161)+(S1-10); (I-161)+(S1-11); (I-161)+(S1-12); (I-161)+(S1-13); (I-161)+(S2-1); (I-161)+(S2-2); (I-161)+(S2-3); (I-161)+(S2-4); (I-161)+(S2-5); (I-161)+(S2-6); (I-161)+(S2-7); (I-161)+(S2-8); (I-161)+(S2-9); (I-161)+(S2-10); (I-161)+(S3-1); (I-161)+(S3-2); (I-161)+(S3-3); (I-161)+(S3-4); (I-161)+(S3-5); (I-161)+(S3-6); (I-161)+(S3-7); (I-161)+(S3-8); (I-161)+(S3-9); (I-161)+(S3-10); (I-161)+(S3-11); (I-161)+(S4-1); (I-161)+(S4-2); (I-161)+(S4-3); (I-161)+(S4-4); (I-161)+(S4-5); (I-161)+(S7-1); (I-161)+(S11-1); (I-161)+(S11-2); (I-161)+(S11-3); (I-161)+(S12-1); (I-161)+(S13-1); (I-161)+(S13-2); (I-161)+(S13-3); (I-161)+(S13-4): (I-161)+(S13-5); (I-161)+(S13-6); (I-161)+(S13-7); (I-161)+(S13-8); (I-161)+(S13-9); (I-161)+(S14-1)
(I-162)+(S1-1); (I-162)+(S1-2); (I-162)+(S1-3); (I-162)+(S1-4); (I-162)+(S1-5); (I-162)+(S1-6); (I-162)+(S1-7); (I-162)+(S1-8); (I-162)+(S1-9); (I-162)+(S1-10); (I-162)+(S1-11); (I-162)+(S1-12); (I-162)+(S1-13); (I-162)+(S2-1); (I-162)+(S2-2); (I-162)+(S2-3); (I-162)+(S2-4); (I-162)+(S2-5); (I-162)+(S2-6); (I-162)+(S2-7); (I-162)+(S2-8); (I-162)+(S2-9); (I-162)+(S2-10); (I-162)+(S3-1); (I-162)+(S3-2); (I-162)+(S3-3); (I-162)+(S3-4); (I-162)+(S3-5); (I-162)+(S3-6); (I-162)+(S3-7); (I-162)+(S3-8); (I-162)+(S3-9); (I-162)+(S3-10); (I-162)+(S3-11); (I-162)+(S4-1); (I-162)+(S4-2); (I-162)+(S4-3); (I-162)+(S4-4); (I-162)+(S4-5); (I-162)+(S7-1); (I-162)+(S11-1); (I-162)+(S11-2); (I-162)+(S11-3); (I-162)+(S12-1); (I-162)+(S13-1); (I-162)+(S13-2); (I-162)+(S13-3); (I-162)+(S13-4): (I-162)+(S13-5); (I-162)+(S13-6); (I-162)+(S13-7); (I-162)+(S13-8); (I-162)+(S13-9); (I-162)+(S14-1)
(I-163)+(S1-1); (I-163)+(S1-2); (I-163)+(S1-3); (I-163)+(S1-4); (I-163)+(S1-5); (I-163)+(S1-6); (I-163)+(S1-7); (I-163)+(S1-8); (I-163)+(S1-9); (I-163)+(S1-10); (I-163)+(S1-11); (I-163)+(S1-12); (I-163)+(S1-13); (I-163)+(S2-1); (I-163)+(S2-2); (I-163)+(S2-3); (I-163)+(S2-4); (I-163)+(S2-5); (I-163)+(S2-6); (I-163)+(S2-7); (I-163)+(S2-8); (I-163)+(S2-9); (I-163)+(S2-10); (I-163)+(S3-1); (I-163)+(S3-2); (I-163)+(S3-3); (I-163)+(S3-4); (I-163)+(S3-5); (I-163)+(S3-6); (I-163)+(S3-7); (I-163)+(S3-8); (I-163)+(S3-9); (I-163)+(S3-10); (I-163)+(S3-11); (I-163)+(S4-1); (I-163)+(S4-2); (I-163)+(S4-3); (I-163)+(S4-4); (I-163)+(S4-5); (I-163)+(S7-1); (I-163)+(S11-1); (I-163)+(S11-2); (I-163)+(S11-3); (I-163)+(S12-1); (I-163)+(S13-1); (I-163)+(S13-2); (I-163)+(S13-3); (I-163)+(S13-4): (I-163)+(S13-5); (I-163)+(S13-6); (I-163)+(S13-7); (I-163)+(S13-8); (I-163)+(S13-9); (I-163)+(S14-1)
(I-164)+(S1-1); (I-164)+(S1-2); (I-164)+(S1-3); (I-164)+(S1-4); (I-164)+(S1-5); (I-164)+(S1-6); (I-164)+(S1-7); (I-164)+(S1-8); (I-164)+(S1-9); (I-164)+(S1-10); (I-164)+(S1-11); (I-164)+(S1-12); (I-164)+(S1-13); (I-164)+(S2-1); (I-164)+(S2-2); (I-164)+(S2-3); (I-164)+(S2-4); (I-164)+(S2-5); (I-164)+(S2-6); (I-164)+(S2-7); (I-164)+(S2-8); (I-164)+(S2-9); (I-164)+(S2-10); (I-164)+(S3-1); (I-164)+(S3-2); (I-164)+(S3-3); (I-164)+(S3-4); (I-164)+(S3-5); (I-164)+(S3-6); (I-164)+(S3-7); (I-164)+(S3-8); (I-164)+(S3-9); (I-164)+(S3-10); (I-164)+(S3-11); (I-164)+(S4-1); (I-164)+(S4-2); (I-164)+(S4-3); (I-164)+(S4-4); (I-164)+(S4-5); (I-164)+(S7-1); (I-164)+(S11-1); (I-164)+(S11-2); (I-164)+(S11-3); (I-164)+(S12-1); (I-164)+(S13-1); (I-164)+(S13-2); (I-164)+(S13-3); (I-164)+(S13-4): (I-164)+(S13-5); (I-164)+(S13-6); (I-164)+(S13-7); (I-164)+(S13-8); (I-164)+(S13-9); (I-164)+(S14-1)
(I-165)+(S1-1); (I-165)+(S1-2); (I-165)+(S1-3); (I-165)+(S1-4); (I-165)+(S1-5); (I-165)+(S1-6); (I-165)+(S1-7); (I-165)+(S1-8); (I-165)+(S1-9); (I-165)+(S1-10); (I-165)+(S1-11); (I-165)+(S1-12); (I-165)+(S1-13); (I-165)+(S2-1); (I-165)+(S2-2); (I-165)+(S2-3); (I-165)+(S2-4); (I-165)+(S2-5); (I-165)+(S2-6); (I-165)+(S2-7); (I-165)+(S2-8); (I-165)+(S2-9); (I-165)+(S2-10); (I-165)+(S3-1); (I-165)+(S3-2); (I-165)+(S3-3); (I-165)+(S3-4); (I-165)+(S3-5); (I-165)+(S3-6); (I-165)+(S3-7); (I-165)+(S3-8); (I-165)+(S3-9); (I-165)+(S3-10); (I-165)+(S3-11); (I-165)+(S4-1); (I-165)+(S4-2); (I-165)+(S4-3); (I-165)+(S4-4); (I-165)+(S4-5); (I-165)+(S7-1); (I-165)+(S11-1); (I-165)+(S11-2); (I-165)+(S11-3); (I-165)+(S12-1); (I-165)+(S13-1); (I-165)+(S13-2); (I-165)+(S13-3); (I-165)+(S13-4): (I-165)+(S13-5); (I-165)+(S13-6); (I-165)+(S13-7); (I-165)+(S13-8); (I-165)+(S13-9); (I-165)+(S14-1)
(I-166)+(S1-1); (I-166)+(S1-2); (I-166)+(S1-3); (I-166)+(S1-4); (I-166)+(S1-5); (I-166)+(S1-6); (I-166)+(S1-7); (I-166)+(S1-8); (I-166)+(S1-9); (I-166)+(S1-10); (I-166)+(S1-11); (I-166)+(S1-12); (I-166)+(S1-13); (I-166)+(S2-1); (I-166)+(S2-2); (I-166)+(S2-3); (I-166)+(S2-4); (I-166)+(S2-5); (I-166)+(S2-6); (I-166)+(S2-7); (I-166)+(S2-8); (I-166)+(S2-9); (I-166)+(S2-10); (I-166)+(S3-1); (I-166)+(S3-2); (I-166)+(S3-3); (I-166)+(S3-4); (I-166)+(S3-5); (I-166)+(S3-6); (I-166)+(S3-7); (I-166)+(S3-8); (I-166)+(S3-9); (I-166)+(S3-10); (I-166)+(S3-11); (I-166)+(S4-1); (I-166)+(S4-2); (I-166)+(S4-3); (I-166)+(S4-4); (I-166)+(S4-5); (I-166)+(S7-1); (I-166)+(S11-1); (I-166)+(S11-2); (I-166)+(S11-3); (I-166)+(S12-1); (I-166)+(S13-1); (I-166)+(S13-2); (I-166)+(S13-3); (I-166)+(S13-4): (I-166)+(S13-5); (I-166)+(S13-6); (I-166)+(S13-7); (I-166)+(S13-8); (I-166)+(S13-9); (I-166)+(S14-1)
(I-167)+(S1-1); (I-167)+(S1-2); (I-167)+(S1-3); (I-167)+(S1-4); (I-167)+(S1-5); (I-167)+(S1-6); (I-167)+(S1-7); (I-167)+(S1-8); (I-167)+(S1-9); (I-167)+(S1-10); (I-167)+(S1-11); (I-167)+(S1-12); (I-167)+(S1-13); (I-167)+(S2-1); (I-167)+(S2-2); (I-167)+(S2-3); (I-167)+(S2-4); (I-167)+(S2-5); (I-167)+(S2-6); (I-167)+(S2-7); (I-167)+(S2-8); (I-167)+(S2-9); (I-167)+(S2-10); (I-167)+(S3-1); (I-167)+(S3-2); (I-167)+(S3-3); (I-167)+(S3-4); (I-167)+(S3-5); (I-167)+(S3-6); (I-167)+(S3-7); (I-167)+(S3-8); (I-167)+(S3-9); (I-167)+(S3-10); (I-167)+(S3-11); (I-167)+(S4-1); (I-167)+(S4-2); (I-167)+(S4-3); (I-167)+(S4-4); (I-167)+(S4-5); (I-167)+(S7-1); (I-167)+(S11-1); (I-167)+(S11-2); (I-167)+(S11-3); (I-167)+(S12-1); (I-167)+(S13-1); (I-167)+(S13-2); (I-167)+(S13-3); (I-167)+(S13-4): (I-167)+(S13-5); (I-167)+(S13-6); (I-167)+(S13-7); (I-167)+(S13-8); (I-167)+(S13-9); (I-167)+(S14-1)
(I-168)+(S1-1); (I-168)+(S1-2); (I-168)+(S1-3); (I-168)+(S1-4); (I-168)+(S1-5); (I-168)+(S1-6); (I-168)+(S1-7); (I-168)+(S1-8); (I-168)+(S1-9); (I-168)+(S1-10); (I-168)+(S1-11); (I-168)+(S1-12); (I-168)+(S1-13); (I-168)+(S2-1); (I-168)+(S2-2); (I-168)+(S2-3); (I-168)+(S2-4); (I-168)+(S2-5); (I-168)+(S2-6); (I-168)+(S2-7); (I-168)+(S2-8); (I-168)+(S2-9); (I-168)+(S2-10); (I-168)+(S3-1); (I-168)+(S3-2); (I-168)+(S3-3); (I-168)+(S3-4); (I-168)+(S3-5); (I-168)+(S3-6); (I-168)+(S3-7); (I-168)+(S3-8); (I-168)+(S3-9); (I-168)+(S3-10); (I-168)+(S3-11); (I-168)+(S4-1); (I-168)+(S4-2); (I-168)+(S4-3); (I-168)+(S4-4); (I-168)+(S4-5); (I-168)+(S7-1); (I-168)+(S11-1); (I-168)+(S11-2); (I-168)+(S11-3); (I-168)+(S12-1); (I-168)+(S13-1); (I-168)+(S13-2); (I-168)+(S13-3); (I-168)+(S13-4): (I-168)+(S13-5); (I-168)+(S13-6); (I-168)+(S13-7); (I-168)+(S13-8); (I-168)+(S13-9); (I-168)+(S14-1)
(I-169)+(S1-1); (I-169)+(S1-2); (I-169)+(S1-3); (I-169)+(S1-4); (I-169)+(S1-5); (I-169)+(S1-6); (I-169)+(S1-7); (I-169)+(S1-8); (I-169)+(S1-9); (I-169)+(S1-10); (I-169)+(S1-11); (I-169)+(S1-12); (I-169)+(S1-13); (I-169)+(S2-1); (I-169)+(S2-2); (I-169)+(S2-3); (I-169)+(S2-4); (I-169)+(S2-5); (I-169)+(S2-6); (I-169)+(S2-7); (I-169)+(S2-8); (I-169)+(S2-9); (I-169)+(S2-10); (I-169)+(S3-1); (I-169)+(S3-2); (I-169)+(S3-3); (I-169)+(S3-4); (I-169)+(S3-5); (I-169)+(S3-6); (I-169)+(S3-7); (I-169)+(S3-8); (I-169)+(S3-9); (I-169)+(S3-10); (I-169)+(S3-11); (I-169)+(S4-1); (I-169)+(S4-2); (I-169)+(S4-3); (I-169)+(S4-4); (I-169)+(S4-5); (I-169)+(S7-1); (I-169)+(S11-1); (I-169)+(S11-2); (I-169)+(S11-3); (I-169)+(S12-1); (I-169)+(S13-1); (I-169)+(S13-2); (I-169)+(S13-3); (I-169)+(S13-4): (I-169)+(S13-5); (I-169)+(S13-6); (I-169)+(S13-7); (I-169)+(S13-8); (I-169)+(S13-9); (I-169)+(S14-1)
(I-170)+(S1-1); (I-170)+(S1-2); (I-170)+(S1-3); (I-170)+(S1-4); (I-170)+(S1-5); (I-170)+(S1-6); (I-170)+(S1-7); (I-170)+(S1-8); (I-170)+(S1-9); (I-170)+(S1-10); (I-170)+(S1-11); (I-170)+(S1-12); (I-170)+(S1-13); (I-170)+(S2-1); (I-170)+(S2-2); (I-170)+(S2-3); (I-170)+(S2-4); (I-170)+(S2-5); (I-170)+(S2-6); (I-170)+(S2-7); (I-170)+(S2-8); (I-170)+(S2-9); (I-170)+(S2-10); (I-170)+(S3-1); (I-170)+(S3-2); (I-170)+(S3-3); (I-170)+(S3-4); (I-170)+(S3-5); (I-170)+(S3-6); (I-170)+(S3-7); (I-170)+(S3-8); (I-170)+(S3-9); (I-170)+(S3-10); (I-170)+(S3-11); (I-170)+(S4-1); (I-170)+(S4-2); (I-170)+(S4-3); (I-170)+(S4-4); (I-170)+(S4-5); (I-170)+(S7-1); (I-170)+(S11-1); (I-170)+(S11-2); (I-170)+(S11-3); (I-170)+(S12-1); (I-170)+(S13-1); (I-170)+(S13-2); (I-170)+(S13-3); (I-170)+(S13-4): (I-170)+(S13-5); (I-170)+(S13-6); (I-170)+(S13-7); (I-170)+(S13-8); (I-170)+(S13-9); (I-170)+(S14-1)
(I-171)+(S1-1); (I-171)+(S1-2); (I-171)+(S1-3); (I-171)+(S1-4); (I-171)+(S1-5); (I-171)+(S1-6); (I-171)+(S1-7); (I-171)+(S1-8); (I-171)+(S1-9); (I-171)+(S1-10); (I-171)+(S1-11); (I-171)+(S1-12); (I-171)+(S1-13); (I-171)+(S2-1); (I-171)+(S2-2); (I-171)+(S2-3); (I-171)+(S2-4); (I-171)+(S2-5); (I-171)+(S2-6); (I-171)+(S2-7); (I-171)+(S2-8); (I-171)+(S2-9); (I-171)+(S2-10); (I-171)+(S3-1); (I-171)+(S3-2); (I-171)+(S3-3); (I-171)+(S3-4); (I-171)+(S3-5); (I-171)+(S3-6); (I-171)+(S3-7); (I-171)+(S3-8); (I-171)+(S3-9); (I-171)+(S3-10); (I-171)+(S3-11); (I-171)+(S4-1); (I-171)+(S4-2); (I-171)+(S4-3); (I-171)+(S4-4); (I-171)+(S4-5); (I-171)+(S7-1); (I-171)+(S11-1); (I-171)+(S11-2); (I-171)+(S11-3); (I-171)+(S12-1); (I-171)+(S13-1); (I-171)+(S13-2); (I-171)+(S13-3); (I-171)+(S13-4): (I-171)+(S13-5); (I-171)+(S13-6); (I-171)+(S13-7); (I-171)+(S13-8); (I-171)+(S13-9); (I-171)+(S14-1)
(I-172)+(S1-1); (I-172)+(S1-2); (I-172)+(S1-3); (I-172)+(S1-4); (I-172)+(S1-5); (I-172)+(S1-6); (I-172)+(S1-7); (I-172)+(S1-8); (I-172)+(S1-9); (I-172)+(S1-10); (I-172)+(S1-11); (I-172)+(S1-12); (I-172)+(S1-13); (I-172)+(S2-1); (I-172)+(S2-2); (I-172)+(S2-3); (I-172)+(S2-4); (I-172)+(S2-5); (I-172)+(S2-6); (I-172)+(S2-7); (I-172)+(S2-8); (I-172)+(S2-9); (I-172)+(S2-10); (I-172)+(S3-1); (I-172)+(S3-2); (I-172)+(S3-3); (I-172)+(S3-4); (I-172)+(S3-5); (I-172)+(S3-6); (I-172)+(S3-7); (I-172)+(S3-8); (I-172)+(S3-9); (I-172)+(S3-10); (I-172)+(S3-11); (I-172)+(S4-1); (I-172)+(S4-2); (I-172)+(S4-3); (I-172)+(S4-4); (I-172)+(S4-5); (I-172)+(S7-1); (I-172)+(S11-1); (I-172)+(S11-2); (I-172)+(S11-3); (I-172)+(S12-1); (I-172)+(S13-1); (I-172)+(S13-2); (I-172)+(S13-3); (I-172)+(S13-4): (I-172)+(S13-5); (I-172)+(S13-6); (I-172)+(S13-7); (I-172)+(S13-8); (I-172)+(S13-9); (I-172)+(S14-1)
(I-173)+(S1-1); (I-173)+(S1-2); (I-173)+(S1-3); (I-173)+(S1-4); (I-173)+(S1-5); (I-173)+(S1-6); (I-173)+(S1-7); (I-173)+(S1-8); (I-173)+(S1-9); (I-173)+(S1-10); (I-173)+(S1-11); (I-173)+(S1-12); (I-173)+(S1-13); (I-173)+(S2-1); (I-173)+(S2-2); (I-173)+(S2-3); (I-173)+(S2-4); (I-173)+(S2-5); (I-173)+(S2-6); (I-173)+(S2-7); (I-173)+(S2-8); (I-173)+(S2-9); (I-173)+(S2-10); (I-173)+(S3-1); (I-173)+(S3-2); (I-173)+(S3-3); (I-173)+(S3-4); (I-173)+(S3-5); (I-173)+(S3-6); (I-173)+(S3-7); (I-173)+(S3-8); (I-173)+(S3-9); (I-173)+(S3-10); (I-173)+(S3-11); (I-173)+(S4-1); (I-173)+(S4-2); (I-173)+(S4-3); (I-173)+(S4-4); (I-173)+(S4-5); (I-173)+(S7-1); (I-173)+(S11-1); (I-173)+(S11-2); (I-173)+(S11-3); (I-173)+(S12-1); (I-173)+(S13-1); (I-173)+(S13-2); (I-173)+(S13-3); (I-173)+(S13-4): (I-173)+(S13-5); (I-173)+(S13-6); (I-173)+(S13-7); (I-173)+(S13-8); (I-173)+(S13-9); (I-173)+(S14-1)
(I-174)+(S1-1); (I-174)+(S1-2); (I-174)+(S1-3); (I-174)+(S1-4); (I-174)+(S1-5); (I-174)+(S1-6); (I-174)+(S1-7); (I-174)+(S1-8); (I-174)+(S1-9); (I-174)+(S1-10); (I-174)+(S1-11); (I-174)+(S1-12); (I-174)+(S1-13); (I-174)+(S2-1); (I-174)+(S2-2); (I-174)+(S2-3); (I-174)+(S2-4); (I-174)+(S2-5); (I-174)+(S2-6); (I-174)+(S2-7); (I-174)+(S2-8); (I-174)+(S2-9); (I-174)+(S2-10); (I-174)+(S3-1); (I-174)+(S3-2); (I-174)+(S3-3); (I-174)+(S3-4); (I-174)+(S3-5); (I-174)+(S3-6); (I-174)+(S3-7); (I-174)+(S3-8); (I-174)+(S3-9); (I-174)+(S3-10); (I-174)+(S3-11); (I-174)+(S4-1); (I-174)+(S4-2); (I-174)+(S4-3); (I-174)+(S4-4); (I-174)+(S4-5); (I-174)+(S7-1); (I-174)+(S11-1); (I-174)+(S11-2); (I-174)+(S11-3); (I-174)+(S12-1); (I-174)+(S13-1); (I-174)+(S13-2); (I-174)+(S13-3); (I-174)+(S13-4): (I-174)+(S13-5); (I-174)+(S13-6); (I-174)+(S13-7); (I-174)+(S13-8); (I-174)+(S13-9); (I-174)+(S14-1)
(I-175)+(S1-1); (I-175)+(S1-2); (I-175)+(S1-3); (I-175)+(S1-4); (I-175)+(S1-5); (I-175)+(S1-6); (I-175)+(S1-7); (I-175)+(S1-8); (I-175)+(S1-9); (I-175)+(S1-10); (I-175)+(S1-11); (I-175)+(S1-12); (I-175)+(S1-13); (I-175)+(S2-1); (I-175)+(S2-2); (I-175)+(S2-3); (I-175)+(S2-4); (I-175)+(S2-5); (I-175)+(S2-6); (I-175)+(S2-7); (I-175)+(S2-8); (I-175)+(S2-9); (I-175)+(S2-10); (I-175)+(S3-1); (I-175)+(S3-2); (I-175)+(S3-3); (I-175)+(S3-4); (I-175)+(S3-5); (I-175)+(S3-6); (I-175)+(S3-7); (I-175)+(S3-8); (I-175)+(S3-9); (I-175)+(S3-10); (I-175)+(S3-11); (I-175)+(S4-1); (I-175)+(S4-2); (I-175)+(S4-3); (I-175)+(S4-4); (I-175)+(S4-5); (I-175)+(S7-1); (I-175)+(S11-1); (I-175)+(S11-2); (I-175)+(S11-3); (I-175)+(S12-1); (I-175)+(S13-1); (I-175)+(S13-2); (I-175)+(S13-3); (I-175)+(S13-4): (I-175)+(S13-5); (I-175)+(S13-6); (I-175)+(S13-7); (I-175)+(S13-8); (I-175)+(S13-9); (I-175)+(S14-1)
(I-176)+(S1-1); (I-176)+(S1-2); (I-176)+(S1-3); (I-176)+(S1-4); (I-176)+(S1-5); (I-176)+(S1-6); (I-176)+(S1-7); (I-176)+(S1-8); (I-176)+(S1-9); (I-176)+(S1-10); (I-176)+(S1-11); (I-176)+(S1-12); (I-176)+(S1-13); (I-176)+(S2-1); (I-176)+(S2-2); (I-176)+(S2-3); (I-176)+(S2-4); (I-176)+(S2-5); (I-176)+(S2-6); (I-176)+(S2-7); (I-176)+(S2-8); (I-176)+(S2-9); (I-176)+(S2-10); (I-176)+(S3-1); (I-176)+(S3-2); (I-176)+(S3-3); (I-176)+(S3-4); (I-176)+(S3-5); (I-176)+(S3-6); (I-176)+(S3-7); (I-176)+(S3-8); (I-176)+(S3-9); (I-176)+(S3-10); (I-176)+(S3-11); (I-176)+(S4-1); (I-176)+(S4-2); (I-176)+(S4-3); (I-176)+(S4-4); (I-176)+(S4-5); (I-176)+(S7-1); (I-176)+(S11-1); (I-176)+(S11-2); (I-176)+(S11-3); (I-176)+(S12-1); (I-176)+(S13-1); (I-176)+(S13-2); (I-176)+(S13-3); (I-176)+(S13-4): (I-176)+(S13-5); (I-176)+(S13-6); (I-176)+(S13-7); (I-176)+(S13-8); (I-176)+(S13-9); (I-176)+(S14-1)
(I-177)+(S1-1); (I-177)+(S1-2); (I-177)+(S1-3); (I-177)+(S1-4); (I-177)+(S1-5); (I-177)+(S1-6); (I-177)+(S1-7); (I-177)+(S1-8); (I-177)+(S1-9); (I-177)+(S1-10); (I-177)+(S1-11); (I-177)+(S1-12); (I-177)+(S1-13); (I-177)+(S2-1); (I-177)+(S2-2); (I-177)+(S2-3); (I-177)+(S2-4); (I-177)+(S2-5); (I-177)+(S2-6); (I-177)+(S2-7); (I-177)+(S2-8); (I-177)+(S2-9); (I-177)+(S2-10); (I-177)+(S3-1); (I-177)+(S3-2); (I-177)+(S3-3); (I-177)+(S3-4); (I-177)+(S3-5); (I-177)+(S3-6); (I-177)+(S3-7); (I-177)+(S3-8); (I-177)+(S3-9); (I-177)+(S3-10); (I-177)+(S3-11); (I-177)+(S4-1); (I-177)+(S4-2); (I-177)+(S4-3); (I-177)+(S4-4); (I-177)+(S4-5); (I-177)+(S7-1); (I-177)+(S11-1); (I-177)+(S11-2); (I-177)+(S11-3); (I-177)+(S12-1); (I-177)+(S13-1); (I-177)+(S13-2); (I-177)+(S13-3); (I-177)+(S13-4): (I-177)+(S13-5); (I-177)+(S13-6); (I-177)+(S13-7); (I-177)+(S13-8); (I-177)+(S13-9); (I-177)+(S14-1)
(I-178)+(S1-1); (I-178)+(S1-2); (I-178)+(S1-3); (I-178)+(S1-4); (I-178)+(S1-5); (I-178)+(S1-6); (I-178)+(S1-7); (I-178)+(S1-8); (I-178)+(S1-9); (I-178)+(S1-10); (I-178)+(S1-11); (I-178)+(S1-12); (I-178)+(S1-13); (I-178)+(S2-1); (I-178)+(S2-2); (I-178)+(S2-3); (I-178)+(S2-4); (I-178)+(S2-5); (I-178)+(S2-6); (I-178)+(S2-7); (I-178)+(S2-8); (I-178)+(S2-9); (I-178)+(S2-10); (I-178)+(S3-1); (I-178)+(S3-2); (I-178)+(S3-3); (I-178)+(S3-4); (I-178)+(S3-5); (I-178)+(S3-6); (I-178)+(S3-7); (I-178)+(S3-8); (I-178)+(S3-9); (I-178)+(S3-10); (I-178)+(S3-11); (I-178)+(S4-1); (I-178)+(S4-2); (I-178)+(S4-3); (I-178)+(S4-4); (I-178)+(S4-5); (I-178)+(S7-1); (I-178)+(S11-1); (I-178)+(S11-2); (I-178)+(S11-3); (I-178)+(S12-1); (I-178)+(S13-1); (I-178)+(S13-2); (I-178)+(S13-3); (I-178)+(S13-4): (I-178)+(S13-5); (I-178)+(S13-6); (I-178)+(S13-7); (I-178)+(S13-8); (I-178)+(S13-9); (I-178)+(S14-1)
(I-179)+(S1-1); (I-179)+(S1-2); (I-179)+(S1-3); (I-179)+(S1-4); (I-179)+(S1-5); (I-179)+(S1-6); (I-179)+(S1-7); (I-179)+(S1-8); (I-179)+(S1-9); (I-179)+(S1-10); (I-179)+(S1-11); (I-179)+(S1-12); (I-179)+(S1-13); (I-179)+(S2-1); (I-179)+(S2-2); (I-179)+(S2-3); (I-179)+(S2-4); (I-179)+(S2-5); (I-179)+(S2-6); (I-179)+(S2-7); (I-179)+(S2-8); (I-179)+(S2-9); (I-179)+(S2-10); (I-179)+(S3-1); (I-179)+(S3-2); (I-179)+(S3-3); (I-179)+(S3-4); (I-179)+(S3-5); (I-179)+(S3-6); (I-179)+(S3-7); (I-179)+(S3-8); (I-179)+(S3-9); (I-179)+(S3-10); (I-179)+(S3-11); (I-179)+(S4-1); (I-179)+(S4-2); (I-179)+(S4-3); (I-179)+(S4-4); (I-179)+(S4-5); (I-179)+(S7-1); (I-179)+(S11-1); (I-179)+(S11-2); (I-179)+(S11-3); (I-179)+(S12-1); (I-179)+(S13-1); (I-179)+(S13-2); (I-179)+(S13-3); (I-179)+(S13-4): (I-179)+(S13-5); (I-179)+(S13-6); (I-179)+(S13-7); (I-179)+(S13-8); (I-179)+(S13-9); (I-179)+(S14-1)
(I-180)+(S1-1); (I-180)+(S1-2); (I-180)+(S1-3); (I-180)+(S1-4); (I-180)+(S1-5); (I-180)+(S1-6); (I-180)+(S1-7); (I-180)+(S1-8); (I-180)+(S1-9); (I-180)+(S1-10); (I-180)+(S1-11); (I-180)+(S1-12); (I-180)+(S1-13); (I-180)+(S2-1); (I-180)+(S2-2); (I-180)+(S2-3); (I-180)+(S2-4); (I-180)+(S2-5); (I-180)+(S2-6); (I-180)+(S2-7); (I-180)+(S2-8); (I-180)+(S2-9); (I-180)+(S2-10); (I-180)+(S3-1); (I-180)+(S3-2); (I-180)+(S3-3); (I-180)+(S3-4); (I-180)+(S3-5); (I-180)+(S3-6); (I-180)+(S3-7); (I-180)+(S3-8); (I-180)+(S3-9); (I-180)+(S3-10); (I-180)+(S3-11); (I-180)+(S4-1); (I-180)+(S4-2); (I-180)+(S4-3); (I-180)+(S4-4); (I-180)+(S4-5); (I-180)+(S7-1); (I-180)+(S11-1); (I-180)+(S11-2); (I-180)+(S11-3); (I-180)+(S12-1); (I-180)+(S13-1); (I-180)+(S13-2); (I-180)+(S13-3); (I-180)+(S13-4): (I-180)+(S13-5); (I-180)+(S13-6); (I-180)+(S13-7); (I-180)+(S13-8); (I-180)+(S13-9); (I-180)+(S14-1)
(I-181)+(S1-1); (I-181)+(S1-2); (I-181)+(S1-3); (I-181)+(S1-4); (I-181)+(S1-5); (I-181)+(S1-6); (I-181)+(S1-7); (I-181)+(S1-8); (I-181)+(S1-9); (I-181)+(S1-10); (I-181)+(S1-11); (I-181)+(S1-12); (I-181)+(S1-13); (I-181)+(S2-1); (I-181)+(S2-2); (I-181)+(S2-3); (I-181)+(S2-4); (I-181)+(S2-5); (I-181)+(S2-6); (I-181)+(S2-7); (I-181)+(S2-8); (I-181)+(S2-9); (I-181)+(S2-10); (I-181)+(S3-1); (I-181)+(S3-2); (I-181)+(S3-3); (I-181)+(S3-4); (I-181)+(S3-5); (I-181)+(S3-6); (I-181)+(S3-7); (I-181)+(S3-8); (I-181)+(S3-9); (I-181)+(S3-10); (I-181)+(S3-11); (I-181)+(S4-1); (I-181)+(S4-2); (I-181)+(S4-3); (I-181)+(S4-4); (I-181)+(S4-5); (I-181)+(S7-1); (I-181)+(S11-1); (I-181)+(S11-2); (I-181)+(S11-3); (I-181)+(S12-1); (I-181)+(S13-1); (I-181)+(S13-2); (I-181)+(S13-3); (I-181)+(S13-4): (I-181)+(S13-5); (I-181)+(S13-6); (I-181)+(S13-7); (I-181)+(S13-8); (I-181)+(S13-9); (I-181)+(S14-1)
(I-182)+(S1-1); (I-182)+(S1-2); (I-182)+(S1-3); (I-182)+(S1-4); (I-182)+(S1-5); (I-182)+(S1-6); (I-182)+(S1-7); (I-182)+(S1-8); (I-182)+(S1-9); (I-182)+(S1-10); (I-182)+(S1-11); (I-182)+(S1-12); (I-182)+(S1-13); (I-182)+(S2-1); (I-182)+(S2-2); (I-182)+(S2-3); (I-182)+(S2-4); (I-182)+(S2-5); (I-182)+(S2-6); (I-182)+(S2-7); (I-182)+(S2-8); (I-182)+(S2-9); (I-182)+(S2-10); (I-182)+(S3-1); (I-182)+(S3-2); (I-182)+(S3-3); (I-182)+(S3-4); (I-182)+(S3-5); (I-182)+(S3-6); (I-182)+(S3-7); (I-182)+(S3-8); (I-182)+(S3-9); (I-182)+(S3-10); (I-182)+(S3-11); (I-182)+(S4-1); (I-182)+(S4-2); (I-182)+(S4-3); (I-182)+(S4-4); (I-182)+(S4-5); (I-182)+(S7-1); (I-182)+(S11-1); (I-182)+(S11-2); (I-182)+(S11-3); (I-182)+(S12-1); (I-182)+(S13-1); (I-182)+(S13-2); (I-182)+(S13-3); (I-182)+(S13-4): (I-182)+(S13-5); (I-182)+(S13-6); (I-182)+(S13-7); (I-182)+(S13-8); (I-182)+(S13-9); (I-182)+(S14-1)
(I-183)+(S1-1); (I-183)+(S1-2); (I-183)+(S1-3); (I-183)+(S1-4); (I-183)+(S1-5); (I-183)+(S1-6); (I-183)+(S1-7); (I-183)+(S1-8); (I-183)+(S1-9); (I-183)+(S1-10); (I-183)+(S1-11); (I-183)+(S1-12); (I-183)+(S1-13); (I-183)+(S2-1); (I-183)+(S2-2); (I-183)+(S2-3); (I-183)+(S2-4); (I-183)+(S2-5); (I-183)+(S2-6); (I-183)+(S2-7); (I-183)+(S2-8); (I-183)+(S2-9); (I-183)+(S2-10); (I-183)+(S3-1); (I-183)+(S3-2); (I-183)+(S3-3); (I-183)+(S3-4); (I-183)+(S3-5); (I-183)+(S3-6); (I-183)+(S3-7); (I-183)+(S3-8); (I-183)+(S3-9); (I-183)+(S3-10); (I-183)+(S3-11); (I-183)+(S4-1); (I-183)+(S4-2); (I-183)+(S4-3); (I-183)+(S4-4); (I-183)+(S4-5); (I-183)+(S7-1); (I-183)+(S11-1); (I-183)+(S11-2); (I-183)+(S11-3); (I-183)+(S12-1); (I-183)+(S13-1); (I-183)+(S13-2); (I-183)+(S13-3); (I-183)+(S13-4): (I-183)+(S13-5); (I-183)+(S13-6); (I-183)+(S13-7); (I-183)+(S13-8); (I-183)+(S13-9); (I-183)+(S14-1)
(I-184)+(S1-1); (I-184)+(S1-2); (I-184)+(S1-3); (I-184)+(S1-4); (I-184)+(S1-5); (I-184)+(S1-6); (I-184)+(S1-7); (I-184)+(S1-8); (I-184)+(S1-9); (I-184)+(S1-10); (I-184)+(S1-11); (I-184)+(S1-12); (I-184)+(S1-13); (I-184)+(S2-1); (I-184)+(S2-2); (I-184)+(S2-3); (I-184)+(S2-4); (I-184)+(S2-5); (I-184)+(S2-6); (I-184)+(S2-7); (I-184)+(S2-8); (I-184)+(S2-9); (I-184)+(S2-10); (I-184)+(S3-1); (I-184)+(S3-2); (I-184)+(S3-3); (I-184)+(S3-4); (I-184)+(S3-5); (I-184)+(S3-6); (I-184)+(S3-7); (I-184)+(S3-8); (I-184)+(S3-9); (I-184)+(S3-10); (I-184)+(S3-11); (I-184)+(S4-1); (I-184)+(S4-2); (I-184)+(S4-3); (I-184)+(S4-4); (I-184)+(S4-5); (I-184)+(S7-1); (I-184)+(S11-1); (I-184)+(S11-2); (I-184)+(S11-3); (I-184)+(S12-1); (I-184)+(S13-1); (I-184)+(S13-2); (I-184)+(S13-3); (I-184)+(S13-4): (I-184)+(S13-5); (I-184)+(S13-6); (I-184)+(S13-7); (I-184)+(S13-8); (I-184)+(S13-9); (I-184)+(S14-1)
(I-185)+(S1-1); (I-185)+(S1-2); (I-185)+(S1-3); (I-185)+(S1-4); (I-185)+(S1-5); (I-185)+(S1-6); (I-185)+(S1-7); (I-185)+(S1-8); (I-185)+(S1-9); (I-185)+(S1-10); (I-185)+(S1-11); (I-185)+(S1-12); (I-185)+(S1-13); (I-185)+(S2-1); (I-185)+(S2-2); (I-185)+(S2-3); (I-185)+(S2-4); (I-185)+(S2-5); (I-185)+(S2-6); (I-185)+(S2-7); (I-185)+(S2-8); (I-185)+(S2-9); (I-185)+(S2-10); (I-185)+(S3-1); (I-185)+(S3-2); (I-185)+(S3-3); (I-185)+(S3-4); (I-185)+(S3-5); (I-185)+(S3-6); (I-185)+(S3-7); (I-185)+(S3-8); (I-185)+(S3-9); (I-185)+(S3-10); (I-185)+(S3-11); (I-185)+(S4-1); (I-185)+(S4-2); (I-185)+(S4-3); (I-185)+(S4-4); (I-185)+(S4-5); (I-185)+(S7-1); (I-185)+(S11-1); (I-185)+(S11-2); (I-185)+(S11-3); (I-185)+(S12-1); (I-185)+(S13-1); (I-185)+(S13-2); (I-185)+(S13-3); (I-185)+(S13-4): (I-185)+(S13-5); (I-185)+(S13-6); (I-185)+(S13-7); (I-185)+(S13-8); (I-185)+(S13-9); (I-185)+(S14-1)
(I-186)+(S1-1); (I-186)+(S1-2); (I-186)+(S1-3); (I-186)+(S1-4); (I-186)+(S1-5); (I-186)+(S1-6); (I-186)+(S1-7); (I-186)+(S1-8); (I-186)+(S1-9); (I-186)+(S1-10); (I-186)+(S1-11); (I-186)+(S1-12); (I-186)+(S1-13); (I-186)+(S2-1); (I-186)+(S2-2); (I-186)+(S2-3); (I-186)+(S2-4); (I-186)+(S2-5); (I-186)+(S2-6); (I-186)+(S2-7); (I-186)+(S2-8); (I-186)+(S2-9); (I-186)+(S2-10); (I-186)+(S3-1); (I-186)+(S3-2); (I-186)+(S3-3); (I-186)+(S3-4); (I-186)+(S3-5); (I-186)+(S3-6); (I-186)+(S3-7); (I-186)+(S3-8); (I-186)+(S3-9); (I-186)+(S3-10); (I-186)+(S3-11); (I-186)+(S4-1); (I-186)+(S4-2); (I-186)+(S4-3); (I-186)+(S4-4); (I-186)+(S4-5); (I-186)+(S7-1); (I-186)+(S11-1); (I-186)+(S11-2); (I-186)+(S11-3); (I-186)+(S12-1); (I-186)+(S13-1); (I-186)+(S13-2); (I-186)+(S13-3); (I-186)+(S13-4): (I-186)+(S13-5); (I-186)+(S13-6); (I-186)+(S13-7); (I-186)+(S13-8); (I-186)+(S13-9); (I-186)+(S14-1)
(I-187)+(S1-1); (I-187)+(S1-2); (I-187)+(S1-3); (I-187)+(S1-4); (I-187)+(S1-5); (I-187)+(S1-6); (I-187)+(S1-7); (I-187)+(S1-8); (I-187)+(S1-9); (I-187)+(S1-10); (I-187)+(S1-11); (I-187)+(S1-12); (I-187)+(S1-13); (I-187)+(S2-1); (I-187)+(S2-2); (I-187)+(S2-3); (I-187)+(S2-4); (I-187)+(S2-5); (I-187)+(S2-6); (I-187)+(S2-7); (I-187)+(S2-8); (I-187)+(S2-9); (I-187)+(S2-10); (I-187)+(S3-1); (I-187)+(S3-2); (I-187)+(S3-3); (I-187)+(S3-4); (I-187)+(S3-5); (I-187)+(S3-6); (I-187)+(S3-7); (I-187)+(S3-8); (I-187)+(S3-9); (I-187)+(S3-10); (I-187)+(S3-11); (I-187)+(S4-1); (I-187)+(S4-2); (I-187)+(S4-3); (I-187)+(S4-4); (I-187)+(S4-5); (I-187)+(S7-1); (I-187)+(S11-1); (I-187)+(S11-2); (I-187)+(S11-3); (I-187)+(S12-1); (I-187)+(S13-1); (I-187)+(S13-2); (I-187)+(S13-3); (I-187)+(S13-4): (I-187)+(S13-5); (I-187)+(S13-6); (I-187)+(S13-7); (I-187)+(S13-8); (I-187)+(S13-9); (I-187)+(S14-1)
(I-188)+(S1-1); (I-188)+(S1-2); (I-188)+(S1-3); (I-188)+(S1-4); (I-188)+(S1-5); (I-188)+(S1-6); (I-188)+(S1-7); (I-188)+(S1-8); (I-188)+(S1-9); (I-188)+(S1-10); (I-188)+(S1-11); (I-188)+(S1-12); (I-188)+(S1-13); (I-188)+(S2-1); (I-188)+(S2-2); (I-188)+(S2-3); (I-188)+(S2-4); (I-188)+(S2-5); (I-188)+(S2-6); (I-188)+(S2-7); (I-188)+(S2-8); (I-188)+(S2-9); (I-188)+(S2-10); (I-188)+(S3-1); (I-188)+(S3-2); (I-188)+(S3-3); (I-188)+(S3-4); (I-188)+(S3-5); (I-188)+(S3-6); (I-188)+(S3-7); (I-188)+(S3-8); (I-188)+(S3-9); (I-188)+(S3-10); (I-188)+(S3-11); (I-188)+(S4-1); (I-188)+(S4-2); (I-188)+(S4-3); (I-188)+(S4-4); (I-188)+(S4-5); (I-188)+(S7-1); (I-188)+(S11-1); (I-188)+(S11-2); (I-188)+(S11-3); (I-188)+(S12-1); (I-188)+(S13-1); (I-188)+(S13-2); (I-188)+(S13-3); (I-188)+(S13-4): (I-188)+(S13-5); (I-188)+(S13-6); (I-188)+(S13-7); (I-188)+(S13-8); (I-188)+(S13-9); (I-188)+(S14-1)
(I-189)+(S1-1); (I-189)+(S1-2); (I-189)+(S1-3); (I-189)+(S1-4); (I-189)+(S1-5); (I-189)+(S1-6); (I-189)+(S1-7); (I-189)+(S1-8); (I-189)+(S1-9); (I-189)+(S1-10); (I-189)+(S1-11); (I-189)+(S1-12); (I-189)+(S1-13); (I-189)+(S2-1); (I-189)+(S2-2); (I-189)+(S2-3); (I-189)+(S2-4); (I-189)+(S2-5); (I-189)+(S2-6); (I-189)+(S2-7); (I-189)+(S2-8); (I-189)+(S2-9); (I-189)+(S2-10); (I-189)+(S3-1); (I-189)+(S3-2); (I-189)+(S3-3); (I-189)+(S3-4); (I-189)+(S3-5); (I-189)+(S3-6); (I-189)+(S3-7); (I-189)+(S3-8); (I-189)+(S3-9); (I-189)+(S3-10); (I-189)+(S3-11); (I-189)+(S4-1); (I-189)+(S4-2); (I-189)+(S4-3); (I-189)+(S4-4); (I-189)+(S4-5); (I-189)+(S7-1); (I-189)+(S11-1); (I-189)+(S11-2); (I-189)+(S11-3); (I-189)+(S12-1); (I-189)+(S13-1); (I-189)+(S13-2); (I-189)+(S13-3); (I-189)+(S13-4): (I-189)+(S13-5); (I-189)+(S13-6); (I-189)+(S13-7); (I-189)+(S13-8); (I-189)+(S13-9); (I-189)+(S14-1)
(I-190)+(S1-1); (I-190)+(S1-2); (I-190)+(S1-3); (I-190)+(S1-4); (I-190)+(S1-5); (I-190)+(S1-6); (I-190)+(S1-7); (I-190)+(S1-8); (I-190)+(S1-9); (I-190)+(S1-10); (I-190)+(S1-11); (I-190)+(S1-12); (I-190)+(S1-13); (I-190)+(S2-1); (I-190)+(S2-2); (I-190)+(S2-3); (I-190)+(S2-4); (I-190)+(S2-5); (I-190)+(S2-6); (I-190)+(S2-7); (I-190)+(S2-8); (I-190)+(S2-9); (I-190)+(S2-10); (I-190)+(S3-1); (I-190)+(S3-2); (I-190)+(S3-3); (I-190)+(S3-4); (I-190)+(S3-5); (I-190)+(S3-6); (I-190)+(S3-7); (I-190)+(S3-8); (I-190)+(S3-9); (I-190)+(S3-10); (I-190)+(S3-11); (I-190)+(S4-1); (I-190)+(S4-2); (I-190)+(S4-3); (I-190)+(S4-4); (I-190)+(S4-5); (I-190)+(S7-1); (I-190)+(S11-1); (I-190)+(S11-2); (I-190)+(S11-3); (I-190)+(S12-1); (I-190)+(S13-1); (I-190)+(S13-2); (I-190)+(S13-3); (I-190)+(S13-4): (I-190)+(S13-5); (I-190)+(S13-6); (I-190)+(S13-7); (I-190)+(S13-8); (I-190)+(S13-9); (I-190)+(S14-1)
(I-191)+(S1-1); (I-191)+(S1-2); (I-191)+(S1-3); (I-191)+(S1-4); (I-191)+(S1-5); (I-191)+(S1-6); (I-191)+(S1-7); (I-191)+(S1-8); (I-191)+(S1-9); (I-191)+(S1-10); (I-191)+(S1-11); (I-191)+(S1-12); (I-191)+(S1-13); (I-191)+(S2-1); (I-191)+(S2-2); (I-191)+(S2-3); (I-191)+(S2-4); (I-191)+(S2-5); (I-191)+(S2-6); (I-191)+(S2-7); (I-191)+(S2-8); (I-191)+(S2-9); (I-191)+(S2-10); (I-191)+(S3-1); (I-191)+(S3-2); (I-191)+(S3-3); (I-191)+(S3-4); (I-191)+(S3-5); (I-191)+(S3-6); (I-191)+(S3-7); (I-191)+(S3-8); (I-191)+(S3-9); (I-191)+(S3-10); (I-191)+(S3-11); (I-191)+(S4-1); (I-191)+(S4-2); (I-191)+(S4-3); (I-191)+(S4-4); (I-191)+(S4-5); (I-191)+(S7-1); (I-191)+(S11-1); (I-191)+(S11-2); (I-191)+(S11-3); (I-191)+(S12-1); (I-191)+(S13-1); (I-191)+(S13-2); (I-191)+(S13-3); (I-191)+(S13-4): (I-191)+(S13-5); (I-191)+(S13-6); (I-191)+(S13-7); (I-191)+(S13-8); (I-191)+(S13-9); (I-191)+(S14-1)
(I-192)+(S1-1); (I-192)+(S1-2); (I-192)+(S1-3); (I-192)+(S1-4); (I-192)+(S1-5); (I-192)+(S1-6); (I-192)+(S1-7); (I-192)+(S1-8); (I-192)+(S1-9); (I-192)+(S1-10); (I-192)+(S1-11); (I-192)+(S1-12); (I-192)+(S1-13); (I-192)+(S2-1); (I-192)+(S2-2); (I-192)+(S2-3); (I-192)+(S2-4); (I-192)+(S2-5); (I-192)+(S2-6); (I-192)+(S2-7); (I-192)+(S2-8); (I-192)+(S2-9); (I-192)+(S2-10); (I-192)+(S3-1); (I-192)+(S3-2); (I-192)+(S3-3); (I-192)+(S3-4); (I-192)+(S3-5); (I-192)+(S3-6); (I-192)+(S3-7); (I-192)+(S3-8); (I-192)+(S3-9); (I-192)+(S3-10); (I-192)+(S3-11); (I-192)+(S4-1); (I-192)+(S4-2); (I-192)+(S4-3); (I-192)+(S4-4); (I-192)+(S4-5); (I-192)+(S7-1); (I-192)+(S11-1); (I-192)+(S11-2); (I-192)+(S11-3); (I-192)+(S12-1); (I-192)+(S13-1); (I-192)+(S13-2); (I-192)+(S13-3); (I-192)+(S13-4): (I-192)+(S13-5); (I-192)+(S13-6); (I-192)+(S13-7); (I-192)+(S13-8); (I-192)+(S13-9); (I-192)+(S14-1)
(I-193)+(S1-1); (I-193)+(S1-2); (I-193)+(S1-3); (I-193)+(S1-4); (I-193)+(S1-5); (I-193)+(S1-6); (I-193)+(S1-7); (I-193)+(S1-8); (I-193)+(S1-9); (I-193)+(S1-10); (I-193)+(S1-11); (I-193)+(S1-12); (I-193)+(S1-13); (I-193)+(S2-1); (I-193)+(S2-2); (I-193)+(S2-3); (I-193)+(S2-4); (I-193)+(S2-5); (I-193)+(S2-6); (I-193)+(S2-7); (I-193)+(S2-8); (I-193)+(S2-9); (I-193)+(S2-10); (I-193)+(S3-1); (I-193)+(S3-2); (I-193)+(S3-3); (I-193)+(S3-4); (I-193)+(S3-5); (I-193)+(S3-6); (I-193)+(S3-7); (I-193)+(S3-8); (I-193)+(S3-9); (I-193)+(S3-10); (I-193)+(S3-11); (I-193)+(S4-1); (I-193)+(S4-2); (I-193)+(S4-3); (I-193)+(S4-4); (I-193)+(S4-5); (I-193)+(S7-1); (I-193)+(S11-1); (I-193)+(S11-2); (I-193)+(S11-3); (I-193)+(S12-1); (I-193)+(S13-1); (I-193)+(S13-2); (I-193)+(S13-3); (I-193)+(S13-4): (I-193)+(S13-5); (I-193)+(S13-6); (I-193)+(S13-7); (I-193)+(S13-8); (I-193)+(S13-9); (I-193)+(S14-1)
(I-194)+(S1-1); (I-194)+(S1-2); (I-194)+(S1-3); (I-194)+(S1-4); (I-194)+(S1-5); (I-194)+(S1-6); (I-194)+(S1-7); (I-194)+(S1-8); (I-194)+(S1-9); (I-194)+(S1-10); (I-194)+(S1-11); (I-194)+(S1-12); (I-194)+(S1-13); (I-194)+(S2-1); (I-194)+(S2-2); (I-194)+(S2-3); (I-194)+(S2-4); (I-194)+(S2-5); (I-194)+(S2-6); (I-194)+(S2-7); (I-194)+(S2-8); (I-194)+(S2-9); (I-194)+(S2-10); (I-194)+(S3-1); (I-194)+(S3-2); (I-194)+(S3-3); (I-194)+(S3-4); (I-194)+(S3-5); (I-194)+(S3-6); (I-194)+(S3-7); (I-194)+(S3-8); (I-194)+(S3-9); (I-194)+(S3-10); (I-194)+(S3-11); (I-194)+(S4-1); (I-194)+(S4-2); (I-194)+(S4-3); (I-194)+(S4-4); (I-194)+(S4-5); (I-194)+(S7-1); (I-194)+(S11-1); (I-194)+(S11-2); (I-194)+(S11-3); (I-194)+(S12-1); (I-194)+(S13-1); (I-194)+(S13-2); (I-194)+(S13-3); (I-194)+(S13-4): (I-194)+(S13-5); (I-194)+(S13-6); (I-194)+(S13-7); (I-194)+(S13-8); (I-194)+(S13-9); (I-194)+(S14-1)
(I-195)+(S1-1); (I-195)+(S1-2); (I-195)+(S1-3); (I-195)+(S1-4); (I-195)+(S1-5); (I-195)+(S1-6); (I-195)+(S1-7); (I-195)+(S1-8); (I-195)+(S1-9); (I-195)+(S1-10); (I-195)+(S1-11); (I-195)+(S1-12); (I-195)+(S1-13); (I-195)+(S2-1); (I-195)+(S2-2); (I-195)+(S2-3); (I-195)+(S2-4); (I-195)+(S2-5); (I-195)+(S2-6); (I-195)+(S2-7); (I-195)+(S2-8); (I-195)+(S2-9); (I-195)+(S2-10); (I-195)+(S3-1); (I-195)+(S3-2); (I-195)+(S3-3); (I-195)+(S3-4); (I-195)+(S3-5); (I-195)+(S3-6); (I-195)+(S3-7); (I-195)+(S3-8); (I-195)+(S3-9); (I-195)+(S3-10); (I-195)+(S3-11); (I-195)+(S4-1); (I-195)+(S4-2); (I-195)+(S4-3); (I-195)+(S4-4); (I-195)+(S4-5); (I-195)+(S7-1); (I-195)+(S11-1); (I-195)+(S11-2); (I-195)+(S11-3); (I-195)+(S12-1); (I-195)+(S13-1); (I-195)+(S13-2); (I-195)+(S13-3); (I-195)+(S13-4): (I-195)+(S13-5); (I-195)+(S13-6); (I-195)+(S13-7); (I-195)+(S13-8); (I-195)+(S13-9); (I-195)+(S14-1)
(I-196)+(S1-1); (I-196)+(S1-2); (I-196)+(S1-3); (I-196)+(S1-4); (I-196)+(S1-5); (I-196)+(S1-6); (I-196)+(S1-7); (I-196)+(S1-8); (I-196)+(S1-9); (I-196)+(S1-10); (I-196)+(S1-11); (I-196)+(S1-12); (I-196)+(S1-13); (I-196)+(S2-1); (I-196)+(S2-2); (I-196)+(S2-3); (I-196)+(S2-4); (I-196)+(S2-5); (I-196)+(S2-6); (I-196)+(S2-7); (I-196)+(S2-8); (I-196)+(S2-9); (I-196)+(S2-10); (I-196)+(S3-1); (I-196)+(S3-2); (I-196)+(S3-3); (I-196)+(S3-4); (I-196)+(S3-5); (I-196)+(S3-6); (I-196)+(S3-7); (I-196)+(S3-8); (I-196)+(S3-9); (I-196)+(S3-10); (I-196)+(S3-11); (I-196)+(S4-1); (I-196)+(S4-2); (I-196)+(S4-3); (I-196)+(S4-4); (I-196)+(S4-5); (I-196)+(S7-1); (I-196)+(S11-1); (I-196)+(S11-2); (I-196)+(S11-3); (I-196)+(S12-1); (I-196)+(S13-1); (I-196)+(S13-2); (I-196)+(S13-3); (I-196)+(S13-4): (I-196)+(S13-5); (I-196)+(S13-6); (I-196)+(S13-7); (I-196)+(S13-8); (I-196)+(S13-9); (I-196)+(S14-1)
(I-197)+(S1-1); (I-197)+(S1-2); (I-197)+(S1-3); (I-197)+(S1-4); (I-197)+(S1-5); (I-197)+(S1-6); (I-197)+(S1-7); (I-197)+(S1-8); (I-197)+(S1-9); (I-197)+(S1-10); (I-197)+(S1-11); (I-197)+(S1-12); (I-197)+(S1-13); (I-197)+(S2-1); (I-197)+(S2-2); (I-197)+(S2-3); (I-197)+(S2-4); (I-197)+(S2-5); (I-197)+(S2-6); (I-197)+(S2-7); (I-197)+(S2-8); (I-197)+(S2-9); (I-197)+(S2-10); (I-197)+(S3-1); (I-197)+(S3-2); (I-197)+(S3-3); (I-197)+(S3-4); (I-197)+(S3-5); (I-197)+(S3-6); (I-197)+(S3-7); (I-197)+(S3-8); (I-197)+(S3-9); (I-197)+(S3-10); (I-197)+(S3-11); (I-197)+(S4-1); (I-197)+(S4-2); (I-197)+(S4-3); (I-197)+(S4-4); (I-197)+(S4-5); (I-197)+(S7-1); (I-197)+(S11-1); (I-197)+(S11-2); (I-197)+(S11-3); (I-197)+(S12-1); (I-197)+(S13-1); (I-197)+(S13-2); (I-197)+(S13-3); (I-197)+(S13-4): (I-197)+(S13-5); (I-197)+(S13-6); (I-197)+(S13-7); (I-197)+(S13-8); (I-197)+(S13-9); (I-197)+(S14-1)
(I-198)+(S1-1); (I-198)+(S1-2); (I-198)+(S1-3); (I-198)+(S1-4); (I-198)+(S1-5); (I-198)+(S1-6); (I-198)+(S1-7); (I-198)+(S1-8); (I-198)+(S1-9); (I-198)+(S1-10); (I-198)+(S1-11); (I-198)+(S1-12); (I-198)+(S1-13); (I-198)+(S2-1); (I-198)+(S2-2); (I-198)+(S2-3); (I-198)+(S2-4); (I-198)+(S2-5); (I-198)+(S2-6); (I-198)+(S2-7); (I-198)+(S2-8); (I-198)+(S2-9); (I-198)+(S2-10); (I-198)+(S3-1); (I-198)+(S3-2); (I-198)+(S3-3); (I-198)+(S3-4); (I-198)+(S3-5); (I-198)+(S3-6); (I-198)+(S3-7); (I-198)+(S3-8); (I-198)+(S3-9); (I-198)+(S3-10); (I-198)+(S3-11); (I-198)+(S4-1); (I-198)+(S4-2); (I-198)+(S4-3); (I-198)+(S4-4); (I-198)+(S4-5); (I-198)+(S7-1); (I-198)+(S11-1); (I-198)+(S11-2); (I-198)+(S11-3); (I-198)+(S12-1); (I-198)+(S13-1); (I-198)+(S13-2); (I-198)+(S13-3); (I-198)+(S13-4): (I-198)+(S13-5); (I-198)+(S13-6); (I-198)+(S13-7); (I-198)+(S13-8); (I-198)+(S13-9); (I-198)+(S14-1)
(I-199)+(S1-1); (I-199)+(S1-2); (I-199)+(S1-3); (I-199)+(S1-4); (I-199)+(S1-5); (I-199)+(S1-6); (I-199)+(S1-7); (I-199)+(S1-8); (I-199)+(S1-9); (I-199)+(S1-10); (I-199)+(S1-11); (I-199)+(S1-12); (I-199)+(S1-13); (I-199)+(S2-1); (I-199)+(S2-2); (I-199)+(S2-3); (I-199)+(S2-4); (I-199)+(S2-5); (I-199)+(S2-6); (I-199)+(S2-7); (I-199)+(S2-8); (I-199)+(S2-9); (I-199)+(S2-10); (I-199)+(S3-1); (I-199)+(S3-2); (I-199)+(S3-3); (I-199)+(S3-4); (I-199)+(S3-5); (I-199)+(S3-6); (I-199)+(S3-7); (I-199)+(S3-8); (I-199)+(S3-9); (I-199)+(S3-10); (I-199)+(S3-11); (I-199)+(S4-1); (I-199)+(S4-2); (I-199)+(S4-3); (I-199)+(S4-4); (I-199)+(S4-5); (I-199)+(S7-1); (I-199)+(S11-1); (I-199)+(S11-2); (I-199)+(S11-3); (I-199)+(S12-1); (I-199)+(S13-1); (I-199)+(S13-2); (I-199)+(S13-3); (I-199)+(S13-4): (I-199)+(S13-5); (I-199)+(S13-6); (I-199)+(S13-7); (I-199)+(S13-8); (I-199)+(S13-9); (I-199)+(S14-1)
(I-200)+(S1-1); (I-200)+(S1-2); (I-200)+(S1-3); (I-200)+(S1-4); (I-200)+(S1-5); (I-200)+(S1-6); (I-200)+(S1-7); (I-200)+(S1-8); (I-200)+(S1-9); (I-200)+(S1-10); (I-200)+(S1-11); (I-200)+(S1-12); (I-200)+(S1-13); (I-200)+(S2-1); (I-200)+(S2-2); (I-200)+(S2-3); (I-200)+(S2-4); (I-200)+(S2-5); (I-200)+(S2-6); (I-200)+(S2-7); (I-200)+(S2-8); (I-200)+(S2-9); (I-200)+(S2-10); (I-200)+(S3-1); (I-200)+(S3-2); (I-200)+(S3-3); (I-200)+(S3-4); (I-200)+(S3-5); (I-200)+(S3-6); (I-200)+(S3-7); (I-200)+(S3-8); (I-200)+(S3-9); (I-200)+(S3-10); (I-200)+(S3-11); (I-200)+(S4-1); (I-200)+(S4-2); (I-200)+(S4-3); (I-200)+(S4-4); (I-200)+(S4-5); (I-200)+(S7-1); (I-200)+(S11-1); (I-200)+(S11-2); (I-200)+(S11-3); (I-200)+(S12-1); (I-200)+(S13-1); (I-200)+(S13-2); (I-200)+(S13-3); (I-200)+(S13-4): (I-200)+(S13-5); (I-200)+(S13-6); (I-200)+(S13-7); (I-200)+(S13-8); (I-200)+(S13-9); (I-200)+(S14-1)
(I-201)+(S1-1); (I-201)+(S1-2); (I-201)+(S1-3); (I-201)+(S1-4); (I-201)+(S1-5); (I-201)+(S1-6); (I-201)+(S1-7); (I-201)+(S1-8); (I-201)+(S1-9); (I-201)+(S1-10); (I-201)+(S1-11); (I-201)+(S1-12); (I-201)+(S1-13); (I-201)+(S2-1); (I-201)+(S2-2); (I-201)+(S2-3); (I-201)+(S2-4); (I-201)+(S2-5); (I-201)+(S2-6); (I-201)+(S2-7); (I-201)+(S2-8); (I-201)+(S2-9); (I-201)+(S2-10); (I-201)+(S3-1); (I-201)+(S3-2); (I-201)+(S3-3); (I-201)+(S3-4); (I-201)+(S3-5); (I-201)+(S3-6); (I-201)+(S3-7); (I-201)+(S3-8); (I-201)+(S3-9); (I-201)+(S3-10); (I-201)+(S3-11); (I-201)+(S4-1); (I-201)+(S4-2); (I-201)+(S4-3); (I-201)+(S4-4); (I-201)+(S4-5); (I-201)+(S7-1); (I-201)+(S11-1); (I-201)+(S11-2); (I-201)+(S11-3); (I-201)+(S12-1); (I-201)+(S13-1); (I-201)+(S13-2); (I-201)+(S13-3); (I-201)+(S13-4): (I-201)+(S13-5); (I-201)+(S13-6); (I-201)+(S13-7); (I-201)+(S13-8); (I-201)+(S13-9); (I-201)+(S14-1)
(I-202)+(S1-1); (I-202)+(S1-2); (I-202)+(S1-3); (I-202)+(S1-4); (I-202)+(S1-5); (I-202)+(S1-6); (I-202)+(S1-7); (I-202)+(S1-8); (I-202)+(S1-9); (I-202)+(S1-10); (I-202)+(S1-11); (I-202)+(S1-12); (I-202)+(S1-13); (I-202)+(S2-1); (I-202)+(S2-2); (I-202)+(S2-3); (I-202)+(S2-4); (I-202)+(S2-5); (I-202)+(S2-6); (I-202)+(S2-7); (I-202)+(S2-8); (I-202)+(S2-9); (I-202)+(S2-10); (I-202)+(S3-1); (I-202)+(S3-2); (I-202)+(S3-3); (I-202)+(S3-4); (I-202)+(S3-5); (I-202)+(S3-6); (I-202)+(S3-7); (I-202)+(S3-8); (I-202)+(S3-9); (I-202)+(S3-10); (I-202)+(S3-11); (I-202)+(S4-1); (I-202)+(S4-2); (I-202)+(S4-3); (I-202)+(S4-4); (I-202)+(S4-5); (I-202)+(S7-1); (I-202)+(S11-1); (I-202)+(S11-2); (I-202)+(S11-3); (I-202)+(S12-1); (I-202)+(S13-1); (I-202)+(S13-2); (I-202)+(S13-3); (I-202)+(S13-4): (I-202)+(S13-5); (I-202)+(S13-6); (I-202)+(S13-7); (I-202)+(S13-8); (I-202)+(S13-9); (I-202)+(S14-1)
(I-203)+(S1-1); (I-203)+(S1-2); (I-203)+(S1-3); (I-203)+(S1-4); (I-203)+(S1-5); (I-203)+(S1-6); (I-203)+(S1-7); (I-203)+(S1-8); (I-203)+(S1-9); (I-203)+(S1-10); (I-203)+(S1-11); (I-203)+(S1-12); (I-203)+(S1-13); (I-203)+(S2-1); (I-203)+(S2-2); (I-203)+(S2-3); (I-203)+(S2-4); (I-203)+(S2-5); (I-203)+(S2-6); (I-203)+(S2-7); (I-203)+(S2-8); (I-203)+(S2-9); (I-203)+(S2-10); (I-203)+(S3-1); (I-203)+(S3-2); (I-203)+(S3-3); (I-203)+(S3-4); (I-203)+(S3-5); (I-203)+(S3-6); (I-203)+(S3-7); (I-203)+(S3-8); (I-203)+(S3-9); (I-203)+(S3-10); (I-203)+(S3-11); (I-203)+(S4-1); (I-203)+(S4-2); (I-203)+(S4-3); (I-203)+(S4-4); (I-203)+(S4-5); (I-203)+(S7-1); (I-203)+(S11-1); (I-203)+(S11-2); (I-203)+(S11-3); (I-203)+(S12-1); (I-203)+(S13-1); (I-203)+(S13-2); (I-203)+(S13-3); (I-203)+(S13-4): (I-203)+(S13-5); (I-203)+(S13-6); (I-203)+(S13-7); (I-203)+(S13-8); (I-203)+(S13-9); (I-203)+(S14-1)
(I-204)+(S1-1); (I-204)+(S1-2); (I-204)+(S1-3); (I-204)+(S1-4); (I-204)+(S1-5); (I-204)+(S1-6); (I-204)+(S1-7); (I-204)+(S1-8); (I-204)+(S1-9); (I-204)+(S1-10); (I-204)+(S1-11); (I-204)+(S1-12); (I-204)+(S1-13); (I-204)+(S2-1); (I-204)+(S2-2); (I-204)+(S2-3); (I-204)+(S2-4); (I-204)+(S2-5); (I-204)+(S2-6); (I-204)+(S2-7); (I-204)+(S2-8); (I-204)+(S2-9); (I-204)+(S2-10); (I-204)+(S3-1); (I-204)+(S3-2); (I-204)+(S3-3); (I-204)+(S3-4); (I-204)+(S3-5); (I-204)+(S3-6); (I-204)+(S3-7); (I-204)+(S3-8); (I-204)+(S3-9); (I-204)+(S3-10); (I-204)+(S3-11); (I-204)+(S4-1); (I-204)+(S4-2); (I-204)+(S4-3); (I-204)+(S4-4); (I-204)+(S4-5); (I-204)+(S7-1); (I-204)+(S11-1); (I-204)+(S11-2); (I-204)+(S11-3); (I-204)+(S12-1); (I-204)+(S13-1); (I-204)+(S13-2); (I-204)+(S13-3); (I-204)+(S13-4): (I-204)+(S13-5); (I-204)+(S13-6); (I-204)+(S13-7); (I-204)+(S13-8); (I-204)+(S13-9); (I-204)+(S14-1)
(I-205)+(S1-1); (I-205)+(S1-2); (I-205)+(S1-3); (I-205)+(S1-4); (I-205)+(S1-5); (I-205)+(S1-6); (I-205)+(S1-7); (I-205)+(S1-8); (I-205)+(S1-9); (I-205)+(S1-10); (I-205)+(S1-11); (I-205)+(S1-12); (I-205)+(S1-13); (I-205)+(S2-1); (I-205)+(S2-2); (I-205)+(S2-3); (I-205)+(S2-4); (I-205)+(S2-5); (I-205)+(S2-6); (I-205)+(S2-7); (I-205)+(S2-8); (I-205)+(S2-9); (I-205)+(S2-10); (I-205)+(S3-1); (I-205)+(S3-2); (I-205)+(S3-3); (I-205)+(S3-4); (I-205)+(S3-5); (I-205)+(S3-6); (I-205)+(S3-7); (I-205)+(S3-8); (I-205)+(S3-9); (I-205)+(S3-10); (I-205)+(S3-11); (I-205)+(S4-1); (I-205)+(S4-2); (I-205)+(S4-3); (I-205)+(S4-4); (I-205)+(S4-5); (I-205)+(S7-1); (I-205)+(S11-1); (I-205)+(S11-2); (I-205)+(S11-3); (I-205)+(S12-1); (I-205)+(S13-1); (I-205)+(S13-2); (I-205)+(S13-3); (I-205)+(S13-4): (I-205)+(S13-5); (I-205)+(S13-6); (I-205)+(S13-7); (I-205)+(S13-8); (I-205)+(S13-9); (I-205)+(S14-1)
(I-206)+(S1-1); (I-206)+(S1-2); (I-206)+(S1-3); (I-206)+(S1-4); (I-206)+(S1-5); (I-206)+(S1-6); (I-206)+(S1-7); (I-206)+(S1-8); (I-206)+(S1-9); (I-206)+(S1-10); (I-206)+(S1-11); (I-206)+(S1-12); (I-206)+(S1-13); (I-206)+(S2-1); (I-206)+(S2-2); (I-206)+(S2-3); (I-206)+(S2-4); (I-206)+(S2-5); (I-206)+(S2-6); (I-206)+(S2-7); (I-206)+(S2-8); (I-206)+(S2-9); (I-206)+(S2-10); (I-206)+(S3-1); (I-206)+(S3-2); (I-206)+(S3-3); (I-206)+(S3-4); (I-206)+(S3-5); (I-206)+(S3-6); (I-206)+(S3-7); (I-206)+(S3-8); (I-206)+(S3-9); (I-206)+(S3-10); (I-206)+(S3-11); (I-206)+(S4-1); (I-206)+(S4-2); (I-206)+(S4-3); (I-206)+(S4-4); (I-206)+(S4-5); (I-206)+(S7-1); (I-206)+(S11-1); (I-206)+(S11-2); (I-206)+(S11-3); (I-206)+(S12-1); (I-206)+(S13-1); (I-206)+(S13-2); (I-206)+(S13-3); (I-206)+(S13-4): (I-206)+(S13-5); (I-206)+(S13-6); (I-206)+(S13-7); (I-206)+(S13-8); (I-206)+(S13-9); (I-206)+(S14-1)
(I-207)+(S1-1); (I-207)+(S1-2); (I-207)+(S1-3); (I-207)+(S1-4); (I-207)+(S1-5); (I-207)+(S1-6); (I-207)+(S1-7); (I-207)+(S1-8); (I-207)+(S1-9); (I-207)+(S1-10); (I-207)+(S1-11); (I-207)+(S1-12); (I-207)+(S1-13); (I-207)+(S2-1); (I-207)+(S2-2); (I-207)+(S2-3); (I-207)+(S2-4); (I-207)+(S2-5); (I-207)+(S2-6); (I-207)+(S2-7); (I-207)+(S2-8); (I-207)+(S2-9); (I-207)+(S2-10); (I-207)+(S3-1); (I-207)+(S3-2); (I-207)+(S3-3); (I-207)+(S3-4); (I-207)+(S3-5); (I-207)+(S3-6); (I-207)+(S3-7); (I-207)+(S3-8); (I-207)+(S3-9); (I-207)+(S3-10); (I-207)+(S3-11); (I-207)+(S4-1); (I-207)+(S4-2); (I-207)+(S4-3); (I-207)+(S4-4); (I-207)+(S4-5); (I-207)+(S7-1); (I-207)+(S11-1); (I-207)+(S11-2); (I-207)+(S11-3); (I-207)+(S12-1); (I-207)+(S13-1); (I-207)+(S13-2); (I-207)+(S13-3); (I-207)+(S13-4): (I-207)+(S13-5); (I-207)+(S13-6); (I-207)+(S13-7); (I-207)+(S13-8); (I-207)+(S13-9); (I-207)+(S14-1)
(I-208)+(S1-1); (I-208)+(S1-2); (I-208)+(S1-3); (I-208)+(S1-4); (I-208)+(S1-5); (I-208)+(S1-6); (I-208)+(S1-7); (I-208)+(S1-8); (I-208)+(S1-9); (I-208)+(S1-10); (I-208)+(S1-11); (I-208)+(S1-12); (I-208)+(S1-13); (I-208)+(S2-1); (I-208)+(S2-2); (I-208)+(S2-3); (I-208)+(S2-4); (I-208)+(S2-5); (I-208)+(S2-6); (I-208)+(S2-7); (I-208)+(S2-8); (I-208)+(S2-9); (I-208)+(S2-10); (I-208)+(S3-1); (I-208)+(S3-2); (I-208)+(S3-3); (I-208)+(S3-4); (I-208)+(S3-5); (I-208)+(S3-6); (I-208)+(S3-7); (I-208)+(S3-8); (I-208)+(S3-9); (I-208)+(S3-10); (I-208)+(S3-11); (I-208)+(S4-1); (I-208)+(S4-2); (I-208)+(S4-3); (I-208)+(S4-4); (I-208)+(S4-5); (I-208)+(S7-1); (I-208)+(S11-1); (I-208)+(S11-2); (I-208)+(S11-3); (I-208)+(S12-1); (I-208)+(S13-1); (I-208)+(S13-2); (I-208)+(S13-3); (I-208)+(S13-4): (I-208)+(S13-5); (I-208)+(S13-6); (I-208)+(S13-7); (I-208)+(S13-8); (I-208)+(S13-9); (I-208)+(S14-1)
(I-209)+(S1-1); (I-209)+(S1-2); (I-209)+(S1-3); (I-209)+(S1-4); (I-209)+(S1-5); (I-209)+(S1-6); (I-209)+(S1-7); (I-209)+(S1-8); (I-209)+(S1-9); (I-209)+(S1-10); (I-209)+(S1-11); (I-209)+(S1-12); (I-209)+(S1-13); (I-209)+(S2-1); (I-209)+(S2-2); (I-209)+(S2-3); (I-209)+(S2-4); (I-209)+(S2-5); (I-209)+(S2-6); (I-209)+(S2-7); (I-209)+(S2-8); (I-209)+(S2-9); (I-209)+(S2-10); (I-209)+(S3-1); (I-209)+(S3-2); (I-209)+(S3-3); (I-209)+(S3-4); (I-209)+(S3-5); (I-209)+(S3-6); (I-209)+(S3-7); (I-209)+(S3-8); (I-209)+(S3-9); (I-209)+(S3-10); (I-209)+(S3-11); (I-209)+(S4-1); (I-209)+(S4-2); (I-209)+(S4-3); (I-209)+(S4-4); (I-209)+(S4-5); (I-209)+(S7-1); (I-209)+(S11-1); (I-209)+(S11-2); (I-209)+(S11-3); (I-209)+(S12-1); (I-209)+(S13-1); (I-209)+(S13-2); (I-209)+(S13-3); (I-209)+(S13-4): (I-209)+(S13-5); (I-209)+(S13-6); (I-209)+(S13-7); (I-209)+(S13-8); (I-209)+(S13-9); (I-209)+(S14-1)
(I-210)+(S1-1); (I-210)+(S1-2); (I-210)+(S1-3); (I-210)+(S1-4); (I-210)+(S1-5); (I-210)+(S1-6); (I-210)+(S1-7); (I-210)+(S1-8); (I-210)+(S1-9); (I-210)+(S1-10); (I-210)+(S1-11); (I-210)+(S1-12); (I-210)+(S1-13); (I-210)+(S2-1); (I-210)+(S2-2); (I-210)+(S2-3); (I-210)+(S2-4); (I-210)+(S2-5); (I-210)+(S2-6); (I-210)+(S2-7); (I-210)+(S2-8); (I-210)+(S2-9); (I-210)+(S2-10); (I-210)+(S3-1); (I-210)+(S3-2); (I-210)+(S3-3); (I-210)+(S3-4); (I-210)+(S3-5); (I-210)+(S3-6); (I-210)+(S3-7); (I-210)+(S3-8); (I-210)+(S3-9); (I-210)+(S3-10); (I-210)+(S3-11); (I-210)+(S4-1); (I-210)+(S4-2); (I-210)+(S4-3); (I-210)+(S4-4); (I-210)+(S4-5); (I-210)+(S7-1); (I-210)+(S11-1); (I-210)+(S11-2); (I-210)+(S11-3); (I-210)+(S12-1); (I-210)+(S13-1); (I-210)+(S13-2); (I-210)+(S13-3); (I-210)+(S13-4): (I-210)+(S13-5); (I-210)+(S13-6); (I-210)+(S13-7); (I-210)+(S13-8); (I-210)+(S13-9); (I-210)+(S14-1)
(I-211)+(S1-1); (I-211)+(S1-2); (I-211)+(S1-3); (I-211)+(S1-4); (I-211)+(S1-5); (I-211)+(S1-6); (I-211)+(S1-7); (I-211)+(S1-8); (I-211)+(S1-9); (I-211)+(S1-10); (I-211)+(S1-11); (I-211)+(S1-12); (I-211)+(S1-13); (I-211)+(S2-1); (I-211)+(S2-2); (I-211)+(S2-3); (I-211)+(S2-4); (I-211)+(S2-5); (I-211)+(S2-6); (I-211)+(S2-7); (I-211)+(S2-8); (I-211)+(S2-9); (I-211)+(S2-10); (I-211)+(S3-1); (I-211)+(S3-2); (I-211)+(S3-3); (I-211)+(S3-4); (I-211)+(S3-5); (I-211)+(S3-6); (I-211)+(S3-7); (I-211)+(S3-8); (I-211)+(S3-9); (I-211)+(S3-10); (I-211)+(S3-11); (I-211)+(S4-1); (I-211)+(S4-2); (I-211)+(S4-3); (I-211)+(S4-4); (I-211)+(S4-5); (I-211)+(S7-1); (I-211)+(S11-1); (I-211)+(S11-2); (I-211)+(S11-3); (I-211)+(S12-1); (I-211)+(S13-1); (I-211)+(S13-2); (I-211)+(S13-3); (I-211)+(S13-4): (I-211)+(S13-5); (I-211)+(S13-6); (I-211)+(S13-7); (I-211)+(S13-8); (I-211)+(S13-9); (I-211)+(S14-1)
(I-212)+(S1-1); (I-212)+(S1-2); (I-212)+(S1-3); (I-212)+(S1-4); (I-212)+(S1-5); (I-212)+(S1-6); (I-212)+(S1-7); (I-212)+(S1-8); (I-212)+(S1-9); (I-212)+(S1-10); (I-212)+(S1-11); (I-212)+(S1-12); (I-212)+(S1-13); (I-212)+(S2-1); (I-212)+(S2-2); (I-212)+(S2-3); (I-212)+(S2-4); (I-212)+(S2-5); (I-212)+(S2-6); (I-212)+(S2-7); (I-212)+(S2-8); (I-212)+(S2-9); (I-212)+(S2-10); (I-212)+(S3-1); (I-212)+(S3-2); (I-212)+(S3-3); (I-212)+(S3-4); (I-212)+(S3-5); (I-212)+(S3-6); (I-212)+(S3-7); (I-212)+(S3-8); (I-212)+(S3-9); (I-212)+(S3-10); (I-212)+(S3-11); (I-212)+(S4-1); (I-212)+(S4-2); (I-212)+(S4-3); (I-212)+(S4-4); (I-212)+(S4-5); (I-212)+(S7-1); (I-212)+(S11-1); (I-212)+(S11-2); (I-212)+(S11-3); (I-212)+(S12-1); (I-212)+(S13-1); (I-212)+(S13-2); (I-212)+(S13-3); (I-212)+(S13-4): (I-212)+(S13-5); (I-212)+(S13-6); (I-212)+(S13-7); (I-212)+(S13-8); (I-212)+(S13-9); (I-212)+(S14-1)
(I-213)+(S1-1); (I-213)+(S1-2); (I-213)+(S1-3); (I-213)+(S1-4); (I-213)+(S1-5); (I-213)+(S1-6); (I-213)+(S1-7); (I-213)+(S1-8); (I-213)+(S1-9); (I-213)+(S1-10); (I-213)+(S1-11); (I-213)+(S1-12); (I-213)+(S1-13); (I-213)+(S2-1); (I-213)+(S2-2); (I-213)+(S2-3); (I-213)+(S2-4); (I-213)+(S2-5); (I-213)+(S2-6); (I-213)+(S2-7); (I-213)+(S2-8); (I-213)+(S2-9); (I-213)+(S2-10); (I-213)+(S3-1); (I-213)+(S3-2); (I-213)+(S3-3); (I-213)+(S3-4); (I-213)+(S3-5); (I-213)+(S3-6); (I-213)+(S3-7); (I-213)+(S3-8); (I-213)+(S3-9); (I-213)+(S3-10); (I-213)+(S3-11); (I-213)+(S4-1); (I-213)+(S4-2); (I-213)+(S4-3); (I-213)+(S4-4); (I-213)+(S4-5); (I-213)+(S7-1); (I-213)+(S11-1); (I-213)+(S11-2); (I-213)+(S11-3); (I-213)+(S12-1); (I-213)+(S13-1); (I-213)+(S13-2); (I-213)+(S13-3); (I-213)+(S13-4): (I-213)+(S13-5); (I-213)+(S13-6); (I-213)+(S13-7); (I-213)+(S13-8); (I-213)+(S13-9); (I-213)+(S14-1)
(I-214)+(S1-1); (I-214)+(S1-2); (I-214)+(S1-3); (I-214)+(S1-4); (I-214)+(S1-5); (I-214)+(S1-6); (I-214)+(S1-7); (I-214)+(S1-8); (I-214)+(S1-9); (I-214)+(S1-10); (I-214)+(S1-11); (I-214)+(S1-12); (I-214)+(S1-13); (I-214)+(S2-1); (I-214)+(S2-2); (I-214)+(S2-3); (I-214)+(S2-4); (I-214)+(S2-5); (I-214)+(S2-6); (I-214)+(S2-7); (I-214)+(S2-8); (I-214)+(S2-9); (I-214)+(S2-10); (I-214)+(S3-1); (I-214)+(S3-2); (I-214)+(S3-3); (I-214)+(S3-4); (I-214)+(S3-5); (I-214)+(S3-6); (I-214)+(S3-7); (I-214)+(S3-8); (I-214)+(S3-9); (I-214)+(S3-10); (I-214)+(S3-11); (I-214)+(S4-1); (I-214)+(S4-2); (I-214)+(S4-3); (I-214)+(S4-4); (I-214)+(S4-5); (I-214)+(S7-1); (I-214)+(S11-1); (I-214)+(S11-2); (I-214)+(S11-3); (I-214)+(S12-1); (I-214)+(S13-1); (I-214)+(S13-2); (I-214)+(S13-3); (I-214)+(S13-4): (I-214)+(S13-5); (I-214)+(S13-6); (I-214)+(S13-7); (I-214)+(S13-8); (I-214)+(S13-9); (I-214)+(S14-1)
(I-215)+(S1-1); (I-215)+(S1-2); (I-215)+(S1-3); (I-215)+(S1-4); (I-215)+(S1-5); (I-215)+(S1-6); (I-215)+(S1-7); (I-215)+(S1-8); (I-215)+(S1-9); (I-215)+(S1-10); (I-215)+(S1-11); (I-215)+(S1-12); (I-215)+(S1-13); (I-215)+(S2-1); (I-215)+(S2-2); (I-215)+(S2-3); (I-215)+(S2-4); (I-215)+(S2-5); (I-215)+(S2-6); (I-215)+(S2-7); (I-215)+(S2-8); (I-215)+(S2-9); (I-215)+(S2-10); (I-215)+(S3-1); (I-215)+(S3-2); (I-215)+(S3-3); (I-215)+(S3-4); (I-215)+(S3-5); (I-215)+(S3-6); (I-215)+(S3-7); (I-215)+(S3-8); (I-215)+(S3-9); (I-215)+(S3-10); (I-215)+(S3-11); (I-215)+(S4-1); (I-215)+(S4-2); (I-215)+(S4-3); (I-215)+(S4-4); (I-215)+(S4-5); (I-215)+(S7-1); (I-215)+(S11-1); (I-215)+(S11-2); (I-215)+(S11-3); (I-215)+(S12-1); (I-215)+(S13-1); (I-215)+(S13-2); (I-215)+(S13-3); (I-215)+(S13-4): (I-215)+(S13-5); (I-215)+(S13-6); (I-215)+(S13-7); (I-215)+(S13-8); (I-215)+(S13-9); (I-215)+(S14-1)
(I-216)+(S1-1); (I-216)+(S1-2); (I-216)+(S1-3); (I-216)+(S1-4); (I-216)+(S1-5); (I-216)+(S1-6); (I-216)+(S1-7); (I-216)+(S1-8); (I-216)+(S1-9); (I-216)+(S1-10); (I-216)+(S1-11); (I-216)+(S1-12); (I-216)+(S1-13); (I-216)+(S2-1); (I-216)+(S2-2); (I-216)+(S2-3); (I-216)+(S2-4); (I-216)+(S2-5); (I-216)+(S2-6); (I-216)+(S2-7); (I-216)+(S2-8); (I-216)+(S2-9); (I-216)+(S2-10); (I-216)+(S3-1); (I-216)+(S3-2); (I-216)+(S3-3); (I-216)+(S3-4); (I-216)+(S3-5); (I-216)+(S3-6); (I-216)+(S3-7); (I-216)+(S3-8); (I-216)+(S3-9); (I-216)+(S3-10); (I-216)+(S3-11); (I-216)+(S4-1); (I-216)+(S4-2); (I-216)+(S4-3); (I-216)+(S4-4); (I-216)+(S4-5); (I-216)+(S7-1); (I-216)+(S11-1); (I-216)+(S11-2); (I-216)+(S11-3); (I-216)+(S12-1); (I-216)+(S13-1); (I-216)+(S13-2); (I-216)+(S13-3); (I-216)+(S13-4): (I-216)+(S13-5); (I-216)+(S13-6); (I-216)+(S13-7); (I-216)+(S13-8); (I-216)+(S13-9); (I-216)+(S14-1)
(I-217)+(S1-1); (I-217)+(S1-2); (I-217)+(S1-3); (I-217)+(S1-4); (I-217)+(S1-5); (I-217)+(S1-6); (I-217)+(S1-7); (I-217)+(S1-8); (I-217)+(S1-9); (I-217)+(S1-10); (I-217)+(S1-11); (I-217)+(S1-12); (I-217)+(S1-13); (I-217)+(S2-1); (I-217)+(S2-2); (I-217)+(S2-3); (I-217)+(S2-4); (I-217)+(S2-5); (I-217)+(S2-6); (I-217)+(S2-7); (I-217)+(S2-8); (I-217)+(S2-9); (I-217)+(S2-10); (I-217)+(S3-1); (I-217)+(S3-2); (I-217)+(S3-3); (I-217)+(S3-4); (I-217)+(S3-5); (I-217)+(S3-6); (I-217)+(S3-7); (I-217)+(S3-8); (I-217)+(S3-9); (I-217)+(S3-10); (I-217)+(S3-11); (I-217)+(S4-1); (I-217)+(S4-2); (I-217)+(S4-3); (I-217)+(S4-4); (I-217)+(S4-5); (I-217)+(S7-1); (I-217)+(S11-1); (I-217)+(S11-2); (I-217)+(S11-3); (I-217)+(S12-1); (I-217)+(S13-1); (I-217)+(S13-2); (I-217)+(S13-3); (I-217)+(S13-4): (I-217)+(S13-5); (I-217)+(S13-6); (I-217)+(S13-7); (I-217)+(S13-8); (I-217)+(S13-9); (I-217)+(S14-1)
(I-218)+(S1-1); (I-218)+(S1-2); (I-218)+(S1-3); (I-218)+(S1-4); (I-218)+(S1-5); (I-218)+(S1-6); (I-218)+(S1-7); (I-218)+(S1-8); (I-218)+(S1-9); (I-218)+(S1-10); (I-218)+(S1-11); (I-218)+(S1-12); (I-218)+(S1-13); (I-218)+(S2-1); (I-218)+(S2-2); (I-218)+(S2-3); (I-218)+(S2-4); (I-218)+(S2-5); (I-218)+(S2-6); (I-218)+(S2-7); (I-218)+(S2-8); (I-218)+(S2-9); (I-218)+(S2-10); (I-218)+(S3-1); (I-218)+(S3-2); (I-218)+(S3-3); (I-218)+(S3-4); (I-218)+(S3-5); (I-218)+(S3-6); (I-218)+(S3-7); (I-218)+(S3-8); (I-218)+(S3-9); (I-218)+(S3-10); (I-218)+(S3-11); (I-218)+(S4-1); (I-218)+(S4-2); (I-218)+(S4-3); (I-218)+(S4-4); (I-218)+(S4-5); (I-218)+(S7-1); (I-218)+(S11-1); (I-218)+(S11-2); (I-218)+(S11-3); (I-218)+(S12-1); (I-218)+(S13-1); (I-218)+(S13-2); (I-218)+(S13-3); (I-218)+(S13-4): (I-218)+(S13-5); (I-218)+(S13-6); (I-218)+(S13-7); (I-218)+(S13-8); (I-218)+(S13-9); (I-218)+(S14-1)
(I-219)+(S1-1); (I-219)+(S1-2); (I-219)+(S1-3); (I-219)+(S1-4); (I-219)+(S1-5); (I-219)+(S1-6); (I-219)+(S1-7); (I-219)+(S1-8); (I-219)+(S1-9); (I-219)+(S1-10); (I-219)+(S1-11); (I-219)+(S1-12); (I-219)+(S1-13); (I-219)+(S2-1); (I-219)+(S2-2); (I-219)+(S2-3); (I-219)+(S2-4); (I-219)+(S2-5); (I-219)+(S2-6); (I-219)+(S2-7); (I-219)+(S2-8); (I-219)+(S2-9); (I-219)+(S2-10); (I-219)+(S3-1); (I-219)+(S3-2); (I-219)+(S3-3); (I-219)+(S3-4); (I-219)+(S3-5); (I-219)+(S3-6); (I-219)+(S3-7); (I-219)+(S3-8); (I-219)+(S3-9); (I-219)+(S3-10); (I-219)+(S3-11); (I-219)+(S4-1); (I-219)+(S4-2); (I-219)+(S4-3); (I-219)+(S4-4); (I-219)+(S4-5); (I-219)+(S7-1); (I-219)+(S11-1); (I-219)+(S11-2); (I-219)+(S11-3); (I-219)+(S12-1); (I-219)+(S13-1); (I-219)+(S13-2); (I-219)+(S13-3); (I-219)+(S13-4): (I-219)+(S13-5); (I-219)+(S13-6); (I-219)+(S13-7); (I-219)+(S13-8); (I-219)+(S13-9); (I-219)+(S14-1)
(I-220)+(S1-1); (I-220)+(S1-2); (I-220)+(S1-3); (I-220)+(S1-4); (I-220)+(S1-5); (I-220)+(S1-6); (I-220)+(S1-7); (I-220)+(S1-8); (I-220)+(S1-9); (I-220)+(S1-10); (I-220)+(S1-11); (I-220)+(S1-12); (I-220)+(S1-13); (I-220)+(S2-1); (I-220)+(S2-2); (I-220)+(S2-3); (I-220)+(S2-4); (I-220)+(S2-5); (I-220)+(S2-6); (I-220)+(S2-7); (I-220)+(S2-8); (I-220)+(S2-9); (I-220)+(S2-10); (I-220)+(S3-1); (I-220)+(S3-2); (I-220)+(S3-3); (I-220)+(S3-4); (I-220)+(S3-5); (I-220)+(S3-6); (I-220)+(S3-7); (I-220)+(S3-8); (I-220)+(S3-9); (I-220)+(S3-10); (I-220)+(S3-11); (I-220)+(S4-1); (I-220)+(S4-2); (I-220)+(S4-3); (I-220)+(S4-4); (I-220)+(S4-5); (I-220)+(S7-1); (I-220)+(S11-1); (I-220)+(S11-2); (I-220)+(S11-3); (I-220)+(S12-1); (I-220)+(S13-1); (I-220)+(S13-2); (I-220)+(S13-3); (I-220)+(S13-4): (I-220)+(S13-5); (I-220)+(S13-6); (I-220)+(S13-7); (I-220)+(S13-8); (I-220)+(S13-9); (I-220)+(S14-1)
(I-221)+(S1-1); (I-221)+(S1-2); (I-221)+(S1-3); (I-221)+(S1-4); (I-221)+(S1-5); (I-221)+(S1-6); (I-221)+(S1-7); (I-221)+(S1-8); (I-221)+(S1-9); (I-221)+(S1-10); (I-221)+(S1-11); (I-221)+(S1-12); (I-221)+(S1-13); (I-221)+(S2-1); (I-221)+(S2-2); (I-221)+(S2-3); (I-221)+(S2-4); (I-221)+(S2-5); (I-221)+(S2-6); (I-221)+(S2-7); (I-221)+(S2-8); (I-221)+(S2-9); (I-221)+(S2-10); (I-221)+(S3-1); (I-221)+(S3-2); (I-221)+(S3-3); (I-221)+(S3-4); (I-221)+(S3-5); (I-221)+(S3-6); (I-221)+(S3-7); (I-221)+(S3-8); (I-221)+(S3-9); (I-221)+(S3-10); (I-221)+(S3-11); (I-221)+(S4-1); (I-221)+(S4-2); (I-221)+(S4-3); (I-221)+(S4-4); (I-221)+(S4-5); (I-221)+(S7-1); (I-221)+(S11-1); (I-221)+(S11-2); (I-221)+(S11-3); (I-221)+(S12-1); (I-221)+(S13-1); (I-221)+(S13-2); (I-221)+(S13-3); (I-221)+(S13-4): (I-221)+(S13-5); (I-221)+(S13-6); (I-221)+(S13-7); (I-221)+(S13-8); (I-221)+(S13-9); (I-221)+(S14-1)
(I-222)+(S1-1); (I-222)+(S1-2); (I-222)+(S1-3); (I-222)+(S1-4); (I-222)+(S1-5); (I-222)+(S1-6); (I-222)+(S1-7); (I-222)+(S1-8); (I-222)+(S1-9); (I-222)+(S1-10); (I-222)+(S1-11); (I-222)+(S1-12); (I-222)+(S1-13); (I-222)+(S2-1); (I-222)+(S2-2); (I-222)+(S2-3); (I-222)+(S2-4); (I-222)+(S2-5); (I-222)+(S2-6); (I-222)+(S2-7); (I-222)+(S2-8); (I-222)+(S2-9); (I-222)+(S2-10); (I-222)+(S3-1); (I-222)+(S3-2); (I-222)+(S3-3); (I-222)+(S3-4); (I-222)+(S3-5); (I-222)+(S3-6); (I-222)+(S3-7); (I-222)+(S3-8); (I-222)+(S3-9); (I-222)+(S3-10); (I-222)+(S3-11); (I-222)+(S4-1); (I-222)+(S4-2); (I-222)+(S4-3); (I-222)+(S4-4); (I-222)+(S4-5); (I-222)+(S7-1); (I-222)+(S11-1); (I-222)+(S11-2); (I-222)+(S11-3); (I-222)+(S12-1); (I-222)+(S13-1); (I-222)+(S13-2); (I-222)+(S13-3); (I-222)+(S13-4): (I-222)+(S13-5); (I-222)+(S13-6); (I-222)+(S13-7); (I-222)+(S13-8); (I-222)+(S13-9); (I-222)+(S14-1)
(I-223)+(S1-1); (I-223)+(S1-2); (I-223)+(S1-3); (I-223)+(S1-4); (I-223)+(S1-5); (I-223)+(S1-6); (I-223)+(S1-7); (I-223)+(S1-8); (I-223)+(S1-9); (I-223)+(S1-10); (I-223)+(S1-11); (I-223)+(S1-12); (I-223)+(S1-13); (I-223)+(S2-1); (I-223)+(S2-2); (I-223)+(S2-3); (I-223)+(S2-4); (I-223)+(S2-5); (I-223)+(S2-6); (I-223)+(S2-7); (I-223)+(S2-8); (I-223)+(S2-9); (I-223)+(S2-10); (I-223)+(S3-1); (I-223)+(S3-2); (I-223)+(S3-3); (I-223)+(S3-4); (I-223)+(S3-5); (I-223)+(S3-6); (I-223)+(S3-7); (I-223)+(S3-8); (I-223)+(S3-9); (I-223)+(S3-10); (I-223)+(S3-11); (I-223)+(S4-1); (I-223)+(S4-2); (I-223)+(S4-3); (I-223)+(S4-4); (I-223)+(S4-5); (I-223)+(S7-1); (I-223)+(S11-1); (I-223)+(S11-2); (I-223)+(S11-3); (I-223)+(S12-1); (I-223)+(S13-1); (I-223)+(S13-2); (I-223)+(S13-3); (I-223)+(S13-4): (I-223)+(S13-5); (I-223)+(S13-6); (I-223)+(S13-7); (I-223)+(S13-8); (I-223)+(S13-9); (I-223)+(S14-1)
(I-224)+(S1-1); (I-224)+(S1-2); (I-224)+(S1-3); (I-224)+(S1-4); (I-224)+(S1-5); (I-224)+(S1-6); (I-224)+(S1-7); (I-224)+(S1-8); (I-224)+(S1-9); (I-224)+(S1-10); (I-224)+(S1-11); (I-224)+(S1-12); (I-224)+(S1-13); (I-224)+(S2-1); (I-224)+(S2-2); (I-224)+(S2-3); (I-224)+(S2-4); (I-224)+(S2-5); (I-224)+(S2-6); (I-224)+(S2-7); (I-224)+(S2-8); (I-224)+(S2-9); (I-224)+(S2-10); (I-224)+(S3-1); (I-224)+(S3-2); (I-224)+(S3-3); (I-224)+(S3-4); (I-224)+(S3-5); (I-224)+(S3-6); (I-224)+(S3-7); (I-224)+(S3-8); (I-224)+(S3-9); (I-224)+(S3-10); (I-224)+(S3-11); (I-224)+(S4-1); (I-224)+(S4-2); (I-224)+(S4-3); (I-224)+(S4-4); (I-224)+(S4-5); (I-224)+(S7-1); (I-224)+(S11-1); (I-224)+(S11-2); (I-224)+(S11-3); (I-224)+(S12-1); (I-224)+(S13-1); (I-224)+(S13-2); (I-224)+(S13-3); (I-224)+(S13-4): (I-224)+(S13-5); (I-224)+(S13-6); (I-224)+(S13-7); (I-224)+(S13-8); (I-224)+(S13-9); (I-224)+(S14-1)
(I-225)+(S1-1); (I-225)+(S1-2); (I-225)+(S1-3); (I-225)+(S1-4); (I-225)+(S1-5); (I-225)+(S1-6); (I-225)+(S1-7); (I-225)+(S1-8); (I-225)+(S1-9); (I-225)+(S1-10); (I-225)+(S1-11); (I-225)+(S1-12); (I-225)+(S1-13); (I-225)+(S2-1); (I-225)+(S2-2); (I-225)+(S2-3); (I-225)+(S2-4); (I-225)+(S2-5); (I-225)+(S2-6); (I-225)+(S2-7); (I-225)+(S2-8); (I-225)+(S2-9); (I-225)+(S2-10); (I-225)+(S3-1); (I-225)+(S3-2); (I-225)+(S3-3); (I-225)+(S3-4); (I-225)+(S3-5); (I-225)+(S3-6); (I-225)+(S3-7); (I-225)+(S3-8); (I-225)+(S3-9); (I-225)+(S3-10); (I-225)+(S3-11); (I-225)+(S4-1); (I-225)+(S4-2); (I-225)+(S4-3); (I-225)+(S4-4); (I-225)+(S4-5); (I-225)+(S7-1); (I-225)+(S11-1); (I-225)+(S11-2); (I-225)+(S11-3); (I-225)+(S12-1); (I-225)+(S13-1); (I-225)+(S13-2); (I-225)+(S13-3); (I-225)+(S13-4): (I-225)+(S13-5); (I-225)+(S13-6); (I-225)+(S13-7); (I-225)+(S13-8); (I-225)+(S13-9); (I-225)+(S14-1)
(I-226)+(S1-1); (I-226)+(S1-2); (I-226)+(S1-3); (I-226)+(S1-4); (I-226)+(S1-5); (I-226)+(S1-6); (I-226)+(S1-7); (I-226)+(S1-8); (I-226)+(S1-9); (I-226)+(S1-10); (I-226)+(S1-11); (I-226)+(S1-12); (I-226)+(S1-13); (I-226)+(S2-1); (I-226)+(S2-2); (I-226)+(S2-3); (I-226)+(S2-4); (I-226)+(S2-5); (I-226)+(S2-6); (I-226)+(S2-7); (I-226)+(S2-8); (I-226)+(S2-9); (I-226)+(S2-10); (I-226)+(S3-1); (I-226)+(S3-2); (I-226)+(S3-3); (I-226)+(S3-4); (I-226)+(S3-5); (I-226)+(S3-6); (I-226)+(S3-7); (I-226)+(S3-8); (I-226)+(S3-9); (I-226)+(S3-10); (I-226)+(S3-11); (I-226)+(S4-1); (I-226)+(S4-2); (I-226)+(S4-3); (I-226)+(S4-4); (I-226)+(S4-5); (I-226)+(S7-1); (I-226)+(S11-1); (I-226)+(S11-2); (I-226)+(S11-3); (I-226)+(S12-1); (I-226)+(S13-1); (I-226)+(S13-2); (I-226)+(S13-3); (I-226)+(S13-4): (I-226)+(S13-5); (I-226)+(S13-6); (I-226)+(S13-7); (I-226)+(S13-8); (I-226)+(S13-9); (I-226)+(S14-1)
(I-227)+(S1-1); (I-227)+(S1-2); (I-227)+(S1-3); (I-227)+(S1-4); (I-227)+(S1-5); (I-227)+(S1-6); (I-227)+(S1-7); (I-227)+(S1-8); (I-227)+(S1-9); (I-227)+(S1-10); (I-227)+(S1-11); (I-227)+(S1-12); (I-227)+(S1-13); (I-227)+(S2-1); (I-227)+(S2-2); (I-227)+(S2-3); (I-227)+(S2-4); (I-227)+(S2-5); (I-227)+(S2-6); (I-227)+(S2-7); (I-227)+(S2-8); (I-227)+(S2-9); (I-227)+(S2-10); (I-227)+(S3-1); (I-227)+(S3-2); (I-227)+(S3-3); (I-227)+(S3-4); (I-227)+(S3-5); (I-227)+(S3-6); (I-227)+(S3-7); (I-227)+(S3-8); (I-227)+(S3-9); (I-227)+(S3-10); (I-227)+(S3-11); (I-227)+(S4-1); (I-227)+(S4-2); (I-227)+(S4-3); (I-227)+(S4-4); (I-227)+(S4-5); (I-227)+(S7-1); (I-227)+(S11-1); (I-227)+(S11-2); (I-227)+(S11-3); (I-227)+(S12-1); (I-227)+(S13-1); (I-227)+(S13-2); (I-227)+(S13-3); (I-227)+(S13-4): (I-227)+(S13-5); (I-227)+(S13-6); (I-227)+(S13-7); (I-227)+(S13-8); (I-227)+(S13-9); (I-227)+(S14-1)
(I-228)+(S1-1); (I-228)+(S1-2); (I-228)+(S1-3); (I-228)+(S1-4); (I-228)+(S1-5); (I-228)+(S1-6); (I-228)+(S1-7); (I-228)+(S1-8); (I-228)+(S1-9); (I-228)+(S1-10); (I-228)+(S1-11); (I-228)+(S1-12); (I-228)+(S1-13); (I-228)+(S2-1); (I-228)+(S2-2); (I-228)+(S2-3); (I-228)+(S2-4); (I-228)+(S2-5); (I-228)+(S2-6); (I-228)+(S2-7); (I-228)+(S2-8); (I-228)+(S2-9); (I-228)+(S2-10); (I-228)+(S3-1); (I-228)+(S3-2); (I-228)+(S3-3); (I-228)+(S3-4); (I-228)+(S3-5); (I-228)+(S3-6); (I-228)+(S3-7); (I-228)+(S3-8); (I-228)+(S3-9); (I-228)+(S3-10); (I-228)+(S3-11); (I-228)+(S4-1); (I-228)+(S4-2); (I-228)+(S4-3); (I-228)+(S4-4); (I-228)+(S4-5); (I-228)+(S7-1); (I-228)+(S11-1); (I-228)+(S11-2); (I-228)+(S11-3); (I-228)+(S12-1); (I-228)+(S13-1); (I-228)+(S13-2); (I-228)+(S13-3); (I-228)+(S13-4): (I-228)+(S13-5); (I-228)+(S13-6); (I-228)+(S13-7); (I-228)+(S13-8); (I-228)+(S13-9); (I-228)+(S14-1)
(I-229)+(S1-1); (I-229)+(S1-2); (I-229)+(S1-3); (I-229)+(S1-4); (I-229)+(S1-5); (I-229)+(S1-6); (I-229)+(S1-7); (I-229)+(S1-8); (I-229)+(S1-9); (I-229)+(S1-10); (I-229)+(S1-11); (I-229)+(S1-12); (I-229)+(S1-13); (I-229)+(S2-1); (I-229)+(S2-2); (I-229)+(S2-3); (I-229)+(S2-4); (I-229)+(S2-5); (I-229)+(S2-6); (I-229)+(S2-7); (I-229)+(S2-8); (I-229)+(S2-9); (I-229)+(S2-10); (I-229)+(S3-1); (I-229)+(S3-2); (I-229)+(S3-3); (I-229)+(S3-4); (I-229)+(S3-5); (I-229)+(S3-6); (I-229)+(S3-7); (I-229)+(S3-8); (I-229)+(S3-9); (I-229)+(S3-10); (I-229)+(S3-11); (I-229)+(S4-1); (I-229)+(S4-2); (I-229)+(S4-3); (I-229)+(S4-4); (I-229)+(S4-5); (I-229)+(S7-1); (I-229)+(S11-1); (I-229)+(S11-2); (I-229)+(S11-3); (I-229)+(S12-1); (I-229)+(S13-1); (I-229)+(S13-2); (I-229)+(S13-3); (I-229)+(S13-4): (I-229)+(S13-5); (I-229)+(S13-6); (I-229)+(S13-7); (I-229)+(S13-8); (I-229)+(S13-9); (I-229)+(S14-1)
(I-230)+(S1-1); (I-230)+(S1-2); (I-230)+(S1-3); (I-230)+(S1-4); (I-230)+(S1-5); (I-230)+(S1-6); (I-230)+(S1-7); (I-230)+(S1-8); (I-230)+(S1-9); (I-230)+(S1-10); (I-230)+(S1-11); (I-230)+(S1-12); (I-230)+(S1-13); (I-230)+(S2-1); (I-230)+(S2-2); (I-230)+(S2-3); (I-230)+(S2-4); (I-230)+(S2-5); (I-230)+(S2-6); (I-230)+(S2-7); (I-230)+(S2-8); (I-230)+(S2-9); (I-230)+(S2-10); (I-230)+(S3-1); (I-230)+(S3-2); (I-230)+(S3-3); (I-230)+(S3-4); (I-230)+(S3-5); (I-230)+(S3-6); (I-230)+(S3-7); (I-230)+(S3-8); (I-230)+(S3-9); (I-230)+(S3-10); (I-230)+(S3-11); (I-230)+(S4-1); (I-230)+(S4-2); (I-230)+(S4-3); (I-230)+(S4-4); (I-230)+(S4-5); (I-230)+(S7-1); (I-230)+(S11-1); (I-230)+(S11-2); (I-230)+(S11-3); (I-230)+(S12-1); (I-230)+(S13-1); (I-230)+(S13-2); (I-230)+(S13-3); (I-230)+(S13-4): (I-230)+(S13-5); (I-230)+(S13-6); (I-230)+(S13-7); (I-230)+(S13-8); (I-230)+(S13-9); (I-230)+(S14-1)
(I-231)+(S1-1); (I-231)+(S1-2); (I-231)+(S1-3); (I-231)+(S1-4); (I-231)+(S1-5); (I-231)+(S1-6); (I-231)+(S1-7); (I-231)+(S1-8); (I-231)+(S1-9); (I-231)+(S1-10); (I-231)+(S1-11); (I-231)+(S1-12); (I-231)+(S1-13); (I-231)+(S2-1); (I-231)+(S2-2); (I-231)+(S2-3); (I-231)+(S2-4); (I-231)+(S2-5); (I-231)+(S2-6); (I-231)+(S2-7); (I-231)+(S2-8); (I-231)+(S2-9); (I-231)+(S2-10); (I-231)+(S3-1); (I-231)+(S3-2); (I-231)+(S3-3); (I-231)+(S3-4); (I-231)+(S3-5); (I-231)+(S3-6); (I-231)+(S3-7); (I-231)+(S3-8); (I-231)+(S3-9); (I-231)+(S3-10); (I-231)+(S3-11); (I-231)+(S4-1); (I-231)+(S4-2); (I-231)+(S4-3); (I-231)+(S4-4); (I-231)+(S4-5); (I-231)+(S7-1); (I-231)+(S11-1); (I-231)+(S11-2); (I-231)+(S11-3); (I-231)+(S12-1); (I-231)+(S13-1); (I-231)+(S13-2); (I-231)+(S13-3); (I-231)+(S13-4): (I-231)+(S13-5); (I-231)+(S13-6); (I-231)+(S13-7); (I-231)+(S13-8); (I-231)+(S13-9); (I-231)+(S14-1)
(I-232)+(S1-1); (I-232)+(S1-2); (I-232)+(S1-3); (I-232)+(S1-4); (I-232)+(S1-5); (I-232)+(S1-6); (I-232)+(S1-7); (I-232)+(S1-8); (I-232)+(S1-9); (I-232)+(S1-10); (I-232)+(S1-11); (I-232)+(S1-12); (I-232)+(S1-13); (I-232)+(S2-1); (I-232)+(S2-2); (I-232)+(S2-3); (I-232)+(S2-4); (I-232)+(S2-5); (I-232)+(S2-6); (I-232)+(S2-7); (I-232)+(S2-8); (I-232)+(S2-9); (I-232)+(S2-10); (I-232)+(S3-1); (I-232)+(S3-2); (I-232)+(S3-3); (I-232)+(S3-4); (I-232)+(S3-5); (I-232)+(S3-6); (I-232)+(S3-7); (I-232)+(S3-8); (I-232)+(S3-9); (I-232)+(S3-10); (I-232)+(S3-11); (I-232)+(S4-1); (I-232)+(S4-2); (I-232)+(S4-3); (I-232)+(S4-4); (I-232)+(S4-5); (I-232)+(S7-1); (I-232)+(S11-1); (I-232)+(S11-2); (I-232)+(S11-3); (I-232)+(S12-1); (I-232)+(S13-1); (I-232)+(S13-2); (I-232)+(S13-3); (I-232)+(S13-4): (I-232)+(S13-5); (I-232)+(S13-6); (I-232)+(S13-7); (I-232)+(S13-8); (I-232)+(S13-9); (I-232)+(S14-1)
(I-233)+(S1-1); (I-233)+(S1-2); (I-233)+(S1-3); (I-233)+(S1-4); (I-233)+(S1-5); (I-233)+(S1-6); (I-233)+(S1-7); (I-233)+(S1-8); (I-233)+(S1-9); (I-233)+(S1-10); (I-233)+(S1-11); (I-233)+(S1-12); (I-233)+(S1-13); (I-233)+(S2-1); (I-233)+(S2-2); (I-233)+(S2-3); (I-233)+(S2-4); (I-233)+(S2-5); (I-233)+(S2-6); (I-233)+(S2-7); (I-233)+(S2-8); (I-233)+(S2-9); (I-233)+(S2-10); (I-233)+(S3-1); (I-233)+(S3-2); (I-233)+(S3-3); (I-233)+(S3-4); (I-233)+(S3-5); (I-233)+(S3-6); (I-233)+(S3-7); (I-233)+(S3-8); (I-233)+(S3-9); (I-233)+(S3-10); (I-233)+(S3-11); (I-233)+(S4-1); (I-233)+(S4-2); (I-233)+(S4-3); (I-233)+(S4-4); (I-233)+(S4-5); (I-233)+(S7-1); (I-233)+(S11-1); (I-233)+(S11-2); (I-233)+(S11-3); (I-233)+(S12-1); (I-233)+(S13-1); (I-233)+(S13-2); (I-233)+(S13-3); (I-233)+(S13-4): (I-233)+(S13-5); (I-233)+(S13-6); (I-233)+(S13-7); (I-233)+(S13-8); (I-233)+(S13-9); (I-233)+(S14-1)
(I-234)+(S1-1); (I-234)+(S1-2); (I-234)+(S1-3); (I-234)+(S1-4); (I-234)+(S1-5); (I-234)+(S1-6); (I-234)+(S1-7); (I-234)+(S1-8); (I-234)+(S1-9); (I-234)+(S1-10); (I-234)+(S1-11); (I-234)+(S1-12); (I-234)+(S1-13); (I-234)+(S2-1); (I-234)+(S2-2); (I-234)+(S2-3); (I-234)+(S2-4); (I-234)+(S2-5); (I-234)+(S2-6); (I-234)+(S2-7); (I-234)+(S2-8); (I-234)+(S2-9); (I-234)+(S2-10); (I-234)+(S3-1); (I-234)+(S3-2); (I-234)+(S3-3); (I-234)+(S3-4); (I-234)+(S3-5); (I-234)+(S3-6); (I-234)+(S3-7); (I-234)+(S3-8); (I-234)+(S3-9); (I-234)+(S3-10); (I-234)+(S3-11); (I-234)+(S4-1); (I-234)+(S4-2); (I-234)+(S4-3); (I-234)+(S4-4); (I-234)+(S4-5); (I-234)+(S7-1); (I-234)+(S11-1); (I-234)+(S11-2); (I-234)+(S11-3); (I-234)+(S12-1); (I-234)+(S13-1); (I-234)+(S13-2); (I-234)+(S13-3); (I-234)+(S13-4): (I-234)+(S13-5); (I-234)+(S13-6); (I-234)+(S13-7); (I-234)+(S13-8); (I-234)+(S13-9); (I-234)+(S14-1)
(I-235)+(S1-1); (I-235)+(S1-2); (I-235)+(S1-3); (I-235)+(S1-4); (I-235)+(S1-5); (I-235)+(S1-6); (I-235)+(S1-7); (I-235)+(S1-8); (I-235)+(S1-9); (I-235)+(S1-10); (I-235)+(S1-11); (I-235)+(S1-12); (I-235)+(S1-13); (I-235)+(S2-1); (I-235)+(S2-2); (I-235)+(S2-3); (I-235)+(S2-4); (I-235)+(S2-5); (I-235)+(S2-6); (I-235)+(S2-7); (I-235)+(S2-8); (I-235)+(S2-9); (I-235)+(S2-10); (I-235)+(S3-1); (I-235)+(S3-2); (I-235)+(S3-3); (I-235)+(S3-4); (I-235)+(S3-5); (I-235)+(S3-6); (I-235)+(S3-7); (I-235)+(S3-8); (I-235)+(S3-9); (I-235)+(S3-10); (I-235)+(S3-11); (I-235)+(S4-1); (I-235)+(S4-2); (I-235)+(S4-3); (I-235)+(S4-4); (I-235)+(S4-5); (I-235)+(S7-1); (I-235)+(S11-1); (I-235)+(S11-2); (I-235)+(S11-3); (I-235)+(S12-1); (I-235)+(S13-1); (I-235)+(S13-2); (I-235)+(S13-3); (I-235)+(S13-4): (I-235)+(S13-5); (I-235)+(S13-6); (I-235)+(S13-7); (I-235)+(S13-8); (I-235)+(S13-9); (I-235)+(S14-1)
(I-236)+(S1-1); (I-236)+(S1-2); (I-236)+(S1-3); (I-236)+(S1-4); (I-236)+(S1-5); (I-236)+(S1-6); (I-236)+(S1-7); (I-236)+(S1-8); (I-236)+(S1-9); (I-236)+(S1-10); (I-236)+(S1-11); (I-236)+(S1-12); (I-236)+(S1-13); (I-236)+(S2-1); (I-236)+(S2-2); (I-236)+(S2-3); (I-236)+(S2-4); (I-236)+(S2-5); (I-236)+(S2-6); (I-236)+(S2-7); (I-236)+(S2-8); (I-236)+(S2-9); (I-236)+(S2-10); (I-236)+(S3-1); (I-236)+(S3-2); (I-236)+(S3-3); (I-236)+(S3-4); (I-236)+(S3-5); (I-236)+(S3-6); (I-236)+(S3-7); (I-236)+(S3-8); (I-236)+(S3-9); (I-236)+(S3-10); (I-236)+(S3-11); (I-236)+(S4-1); (I-236)+(S4-2); (I-236)+(S4-3); (I-236)+(S4-4); (I-236)+(S4-5); (I-236)+(S7-1); (I-236)+(S11-1); (I-236)+(S11-2); (I-236)+(S11-3); (I-236)+(S12-1); (I-236)+(S13-1); (I-236)+(S13-2); (I-236)+(S13-3); (I-236)+(S13-4): (I-236)+(S13-5); (I-236)+(S13-6); (I-236)+(S13-7); (I-236)+(S13-8); (I-236)+(S13-9); (I-236)+(S14-1)
(I-237)+(S1-1); (I-237)+(S1-2); (I-237)+(S1-3); (I-237)+(S1-4); (I-237)+(S1-5); (I-237)+(S1-6); (I-237)+(S1-7); (I-237)+(S1-8); (I-237)+(S1-9); (I-237)+(S1-10); (I-237)+(S1-11); (I-237)+(S1-12); (I-237)+(S1-13); (I-237)+(S2-1); (I-237)+(S2-2); (I-237)+(S2-3); (I-237)+(S2-4); (I-237)+(S2-5); (I-237)+(S2-6); (I-237)+(S2-7); (I-237)+(S2-8); (I-237)+(S2-9); (I-237)+(S2-10); (I-237)+(S3-1); (I-237)+(S3-2); (I-237)+(S3-3); (I-237)+(S3-4); (I-237)+(S3-5); (I-237)+(S3-6); (I-237)+(S3-7); (I-237)+(S3-8); (I-237)+(S3-9); (I-237)+(S3-10); (I-237)+(S3-11); (I-237)+(S4-1); (I-237)+(S4-2); (I-237)+(S4-3); (I-237)+(S4-4); (I-237)+(S4-5); (I-237)+(S7-1); (I-237)+(S11-1); (I-237)+(S11-2); (I-237)+(S11-3); (I-237)+(S12-1); (I-237)+(S13-1); (I-237)+(S13-2); (I-237)+(S13-3); (I-237)+(S13-4): (I-237)+(S13-5); (I-237)+(S13-6); (I-237)+(S13-7); (I-237)+(S13-8); (I-237)+(S13-9); (I-237)+(S14-1)
(I-238)+(S1-1); (I-238)+(S1-2); (I-238)+(S1-3); (I-238)+(S1-4); (I-238)+(S1-5); (I-238)+(S1-6); (I-238)+(S1-7); (I-238)+(S1-8); (I-238)+(S1-9); (I-238)+(S1-10); (I-238)+(S1-11); (I-238)+(S1-12); (I-238)+(S1-13); (I-238)+(S2-1); (I-238)+(S2-2); (I-238)+(S2-3); (I-238)+(S2-4); (I-238)+(S2-5); (I-238)+(S2-6); (I-238)+(S2-7); (I-238)+(S2-8); (I-238)+(S2-9); (I-238)+(S2-10); (I-238)+(S3-1); (I-238)+(S3-2); (I-238)+(S3-3); (I-238)+(S3-4); (I-238)+(S3-5); (I-238)+(S3-6); (I-238)+(S3-7); (I-238)+(S3-8); (I-238)+(S3-9); (I-238)+(S3-10); (I-238)+(S3-11); (I-238)+(S4-1); (I-238)+(S4-2); (I-238)+(S4-3); (I-238)+(S4-4); (I-238)+(S4-5); (I-238)+(S7-1); (I-238)+(S11-1); (I-238)+(S11-2); (I-238)+(S11-3); (I-238)+(S12-1); (I-238)+(S13-1); (I-238)+(S13-2); (I-238)+(S13-3); (I-238)+(S13-4): (I-238)+(S13-5); (I-238)+(S13-6); (I-238)+(S13-7); (I-238)+(S13-8); (I-238)+(S13-9); (I-238)+(S14-1)
(I-239)+(S1-1); (I-239)+(S1-2); (I-239)+(S1-3); (I-239)+(S1-4); (I-239)+(S1-5); (I-239)+(S1-6); (I-239)+(S1-7); (I-239)+(S1-8); (I-239)+(S1-9); (I-239)+(S1-10); (I-239)+(S1-11); (I-239)+(S1-12); (I-239)+(S1-13); (I-239)+(S2-1); (I-239)+(S2-2); (I-239)+(S2-3); (I-239)+(S2-4); (I-239)+(S2-5); (I-239)+(S2-6); (I-239)+(S2-7); (I-239)+(S2-8); (I-239)+(S2-9); (I-239)+(S2-10); (I-239)+(S3-1); (I-239)+(S3-2); (I-239)+(S3-3); (I-239)+(S3-4); (I-239)+(S3-5); (I-239)+(S3-6); (I-239)+(S3-7); (I-239)+(S3-8); (I-239)+(S3-9); (I-239)+(S3-10); (I-239)+(S3-11); (I-239)+(S4-1); (I-239)+(S4-2); (I-239)+(S4-3); (I-239)+(S4-4); (I-239)+(S4-5); (I-239)+(S7-1); (I-239)+(S11-1); (I-239)+(S11-2); (I-239)+(S11-3); (I-239)+(S12-1); (I-239)+(S13-1); (I-239)+(S13-2); (I-239)+(S13-3); (I-239)+(S13-4): (I-239)+(S13-5); (I-239)+(S13-6); (I-239)+(S13-7); (I-239)+(S13-8); (I-239)+(S13-9); (I-239)+(S14-1)
(I-240)+(S1-1); (I-240)+(S1-2); (I-240)+(S1-3); (I-240)+(S1-4); (I-240)+(S1-5); (I-240)+(S1-6); (I-240)+(S1-7); (I-240)+(S1-8); (I-240)+(S1-9); (I-240)+(S1-10); (I-240)+(S1-11); (I-240)+(S1-12); (I-240)+(S1-13); (I-240)+(S2-1); (I-240)+(S2-2); (I-240)+(S2-3); (I-240)+(S2-4); (I-240)+(S2-5); (I-240)+(S2-6); (I-240)+(S2-7); (I-240)+(S2-8); (I-240)+(S2-9); (I-240)+(S2-10); (I-240)+(S3-1); (I-240)+(S3-2); (I-240)+(S3-3); (I-240)+(S3-4); (I-240)+(S3-5); (I-240)+(S3-6); (I-240)+(S3-7); (I-240)+(S3-8); (I-240)+(S3-9); (I-240)+(S3-10); (I-240)+(S3-11); (I-240)+(S4-1); (I-240)+(S4-2); (I-240)+(S4-3); (I-240)+(S4-4); (I-240)+(S4-5); (I-240)+(S7-1); (I-240)+(S11-1); (I-240)+(S11-2); (I-240)+(S11-3); (I-240)+(S12-1); (I-240)+(S13-1); (I-240)+(S13-2); (I-240)+(S13-3); (I-240)+(S13-4): (I-240)+(S13-5); (I-240)+(S13-6); (I-240)+(S13-7); (I-240)+(S13-8); (I-240)+(S13-9); (I-240)+(S14-1)
(I-241)+(S1-1); (I-241)+(S1-2); (I-241)+(S1-3); (I-241)+(S1-4); (I-241)+(S1-5); (I-241)+(S1-6); (I-241)+(S1-7); (I-241)+(S1-8); (I-241)+(S1-9); (I-241)+(S1-10); (I-241)+(S1-11); (I-241)+(S1-12); (I-241)+(S1-13); (I-241)+(S2-1); (I-241)+(S2-2); (I-241)+(S2-3); (I-241)+(S2-4); (I-241)+(S2-5); (I-241)+(S2-6); (I-241)+(S2-7); (I-241)+(S2-8); (I-241)+(S2-9); (I-241)+(S2-10); (I-241)+(S3-1); (I-241)+(S3-2); (I-241)+(S3-3); (I-241)+(S3-4); (I-241)+(S3-5); (I-241)+(S3-6); (I-241)+(S3-7); (I-241)+(S3-8); (I-241)+(S3-9); (I-241)+(S3-10); (I-241)+(S3-11); (I-241)+(S4-1); (I-241)+(S4-2); (I-241)+(S4-3); (I-241)+(S4-4); (I-241)+(S4-5); (I-241)+(S7-1); (I-241)+(S11-1); (I-241)+(S11-2); (I-241)+(S11-3); (I-241)+(S12-1); (I-241)+(S13-1); (I-241)+(S13-2); (I-241)+(S13-3); (I-241)+(S13-4): (I-241)+(S13-5); (I-241)+(S13-6); (I-241)+(S13-7); (I-241)+(S13-8); (I-241)+(S13-9); (I-241)+(S14-1)
(I-242)+(S1-1); (I-242)+(S1-2); (I-242)+(S1-3); (I-242)+(S1-4); (I-242)+(S1-5); (I-242)+(S1-6); (I-242)+(S1-7); (I-242)+(S1-8); (I-242)+(S1-9); (I-242)+(S1-10); (I-242)+(S1-11); (I-242)+(S1-12); (I-242)+(S1-13); (I-242)+(S2-1); (I-242)+(S2-2); (I-242)+(S2-3); (I-242)+(S2-4); (I-242)+(S2-5); (I-242)+(S2-6); (I-242)+(S2-7); (I-242)+(S2-8); (I-242)+(S2-9); (I-242)+(S2-10); (I-242)+(S3-1); (I-242)+(S3-2); (I-242)+(S3-3); (I-242)+(S3-4); (I-242)+(S3-5); (I-242)+(S3-6); (I-242)+(S3-7); (I-242)+(S3-8); (I-242)+(S3-9); (I-242)+(S3-10); (I-242)+(S3-11); (I-242)+(S4-1); (I-242)+(S4-2); (I-242)+(S4-3); (I-242)+(S4-4); (I-242)+(S4-5); (I-242)+(S7-1); (I-242)+(S11-1); (I-242)+(S11-2); (I-242)+(S11-3); (I-242)+(S12-1); (I-242)+(S13-1); (I-242)+(S13-2); (I-242)+(S13-3); (I-242)+(S13-4): (I-242)+(S13-5); (I-242)+(S13-6); (I-242)+(S13-7); (I-242)+(S13-8); (I-242)+(S13-9); (I-242)+(S14-1)
(I-243)+(S1-1); (I-243)+(S1-2); (I-243)+(S1-3); (I-243)+(S1-4); (I-243)+(S1-5); (I-243)+(S1-6); (I-243)+(S1-7); (I-243)+(S1-8); (I-243)+(S1-9); (I-243)+(S1-10); (I-243)+(S1-11); (I-243)+(S1-12); (I-243)+(S1-13); (I-243)+(S2-1); (I-243)+(S2-2); (I-243)+(S2-3); (I-243)+(S2-4); (I-243)+(S2-5); (I-243)+(S2-6); (I-243)+(S2-7); (I-243)+(S2-8); (I-243)+(S2-9); (I-243)+(S2-10); (I-243)+(S3-1); (I-243)+(S3-2); (I-243)+(S3-3); (I-243)+(S3-4); (I-243)+(S3-5); (I-243)+(S3-6); (I-243)+(S3-7); (I-243)+(S3-8); (I-243)+(S3-9); (I-243)+(S3-10); (I-243)+(S3-11); (I-243)+(S4-1); (I-243)+(S4-2); (I-243)+(S4-3); (I-243)+(S4-4); (I-243)+(S4-5); (I-243)+(S7-1); (I-243)+(S11-1); (I-243)+(S11-2); (I-243)+(S11-3); (I-243)+(S12-1); (I-243)+(S13-1); (I-243)+(S13-2); (I-243)+(S13-3); (I-243)+(S13-4): (I-243)+(S13-5); (I-243)+(S13-6); (I-243)+(S13-7); (I-243)+(S13-8); (I-243)+(S13-9); (I-243)+(S14-1)
(I-244)+(S1-1); (I-244)+(S1-2); (I-244)+(S1-3); (I-244)+(S1-4); (I-244)+(S1-5); (I-244)+(S1-6); (I-244)+(S1-7); (I-244)+(S1-8); (I-244)+(S1-9); (I-244)+(S1-10); (I-244)+(S1-11); (I-244)+(S1-12); (I-244)+(S1-13); (I-244)+(S2-1); (I-244)+(S2-2); (I-244)+(S2-3); (I-244)+(S2-4); (I-244)+(S2-5); (I-244)+(S2-6); (I-244)+(S2-7); (I-244)+(S2-8); (I-244)+(S2-9); (I-244)+(S2-10); (I-244)+(S3-1); (I-244)+(S3-2); (I-244)+(S3-3); (I-244)+(S3-4); (I-244)+(S3-5); (I-244)+(S3-6); (I-244)+(S3-7); (I-244)+(S3-8); (I-244)+(S3-9); (I-244)+(S3-10); (I-244)+(S3-11); (I-244)+(S4-1); (I-244)+(S4-2); (I-244)+(S4-3); (I-244)+(S4-4); (I-244)+(S4-5); (I-244)+(S7-1); (I-244)+(S11-1); (I-244)+(S11-2); (I-244)+(S11-3); (I-244)+(S12-1); (I-244)+(S13-1); (I-244)+(S13-2); (I-244)+(S13-3); (I-244)+(S13-4): (I-244)+(S13-5); (I-244)+(S13-6); (I-244)+(S13-7); (I-244)+(S13-8); (I-244)+(S13-9); (I-244)+(S14-1)
(I-245)+(S1-1); (I-245)+(S1-2); (I-245)+(S1-3); (I-245)+(S1-4); (I-245)+(S1-5); (I-245)+(S1-6); (I-245)+(S1-7); (I-245)+(S1-8); (I-245)+(S1-9); (I-245)+(S1-10); (I-245)+(S1-11); (I-245)+(S1-12); (I-245)+(S1-13); (I-245)+(S2-1); (I-245)+(S2-2); (I-245)+(S2-3); (I-245)+(S2-4); (I-245)+(S2-5); (I-245)+(S2-6); (I-245)+(S2-7); (I-245)+(S2-8); (I-245)+(S2-9); (I-245)+(S2-10); (I-245)+(S3-1); (I-245)+(S3-2); (I-245)+(S3-3); (I-245)+(S3-4); (I-245)+(S3-5); (I-245)+(S3-6); (I-245)+(S3-7); (I-245)+(S3-8); (I-245)+(S3-9); (I-245)+(S3-10); (I-245)+(S3-11); (I-245)+(S4-1); (I-245)+(S4-2); (I-245)+(S4-3); (I-245)+(S4-4); (I-245)+(S4-5); (I-245)+(S7-1); (I-245)+(S11-1); (I-245)+(S11-2); (I-245)+(S11-3); (I-245)+(S12-1); (I-245)+(S13-1); (I-245)+(S13-2); (I-245)+(S13-3); (I-245)+(S13-4): (I-245)+(S13-5); (I-245)+(S13-6); (I-245)+(S13-7); (I-245)+(S13-8); (I-245)+(S13-9); (I-245)+(S14-1)
(I-246)+(S1-1); (I-246)+(S1-2); (I-246)+(S1-3); (I-246)+(S1-4); (I-246)+(S1-5); (I-246)+(S1-6); (I-246)+(S1-7); (I-246)+(S1-8); (I-246)+(S1-9); (I-246)+(S1-10); (I-246)+(S1-11); (I-246)+(S1-12); (I-246)+(S1-13); (I-246)+(S2-1); (I-246)+(S2-2); (I-246)+(S2-3); (I-246)+(S2-4); (I-246)+(S2-5); (I-246)+(S2-6); (I-246)+(S2-7); (I-246)+(S2-8); (I-246)+(S2-9); (I-246)+(S2-10); (I-246)+(S3-1); (I-246)+(S3-2); (I-246)+(S3-3); (I-246)+(S3-4); (I-246)+(S3-5); (I-246)+(S3-6); (I-246)+(S3-7); (I-246)+(S3-8); (I-246)+(S3-9); (I-246)+(S3-10); (I-246)+(S3-11); (I-246)+(S4-1); (I-246)+(S4-2); (I-246)+(S4-3); (I-246)+(S4-4); (I-246)+(S4-5); (I-246)+(S7-1); (I-246)+(S11-1); (I-246)+(S11-2); (I-246)+(S11-3); (I-246)+(S12-1); (I-246)+(S13-1); (I-246)+(S13-2); (I-246)+(S13-3); (I-246)+(S13-4): (I-246)+(S13-5); (I-246)+(S13-6); (I-246)+(S13-7); (I-246)+(S13-8); (I-246)+(S13-9); (I-246)+(S14-1)
(I-247)+(S1-1); (I-247)+(S1-2); (I-247)+(S1-3); (I-247)+(S1-4); (I-247)+(S1-5); (I-247)+(S1-6); (I-247)+(S1-7); (I-247)+(S1-8); (I-247)+(S1-9); (I-247)+(S1-10); (I-247)+(S1-11); (I-247)+(S1-12); (I-247)+(S1-13); (I-247)+(S2-1); (I-247)+(S2-2); (I-247)+(S2-3); (I-247)+(S2-4); (I-247)+(S2-5); (I-247)+(S2-6); (I-247)+(S2-7); (I-247)+(S2-8); (I-247)+(S2-9); (I-247)+(S2-10); (I-247)+(S3-1); (I-247)+(S3-2); (I-247)+(S3-3); (I-247)+(S3-4); (I-247)+(S3-5); (I-247)+(S3-6); (I-247)+(S3-7); (I-247)+(S3-8); (I-247)+(S3-9); (I-247)+(S3-10); (I-247)+(S3-11); (I-247)+(S4-1); (I-247)+(S4-2); (I-247)+(S4-3); (I-247)+(S4-4); (I-247)+(S4-5); (I-247)+(S7-1); (I-247)+(S11-1); (I-247)+(S11-2); (I-247)+(S11-3); (I-247)+(S12-1); (I-247)+(S13-1); (I-247)+(S13-2); (I-247)+(S13-3); (I-247)+(S13-4): (I-247)+(S13-5); (I-247)+(S13-6); (I-247)+(S13-7); (I-247)+(S13-8); (I-247)+(S13-9); (I-247)+(S14-1)
(I-248)+(S1-1); (I-248)+(S1-2); (I-248)+(S1-3); (I-248)+(S1-4); (I-248)+(S1-5); (I-248)+(S1-6); (I-248)+(S1-7); (I-248)+(S1-8); (I-248)+(S1-9); (I-248)+(S1-10); (I-248)+(S1-11); (I-248)+(S1-12); (I-248)+(S1-13); (I-248)+(S2-1); (I-248)+(S2-2); (I-248)+(S2-3); (I-248)+(S2-4); (I-248)+(S2-5); (I-248)+(S2-6); (I-248)+(S2-7); (I-248)+(S2-8); (I-248)+(S2-9); (I-248)+(S2-10); (I-248)+(S3-1); (I-248)+(S3-2); (I-248)+(S3-3); (I-248)+(S3-4); (I-248)+(S3-5); (I-248)+(S3-6); (I-248)+(S3-7); (I-248)+(S3-8); (I-248)+(S3-9); (I-248)+(S3-10); (I-248)+(S3-11); (I-248)+(S4-1); (I-248)+(S4-2); (I-248)+(S4-3); (I-248)+(S4-4); (I-248)+(S4-5); (I-248)+(S7-1); (I-248)+(S11-1); (I-248)+(S11-2); (I-248)+(S11-3); (I-248)+(S12-1); (I-248)+(S13-1); (I-248)+(S13-2); (I-248)+(S13-3); (I-248)+(S13-4): (I-248)+(S13-5); (I-248)+(S13-6); (I-248)+(S13-7); (I-248)+(S13-8); (I-248)+(S13-9); (I-248)+(S14-1)
(I-249)+(S1-1); (I-249)+(S1-2); (I-249)+(S1-3); (I-249)+(S1-4); (I-249)+(S1-5); (I-249)+(S1-6); (I-249)+(S1-7); (I-249)+(S1-8); (I-249)+(S1-9); (I-249)+(S1-10); (I-249)+(S1-11); (I-249)+(S1-12); (I-249)+(S1-13); (I-249)+(S2-1); (I-249)+(S2-2); (I-249)+(S2-3); (I-249)+(S2-4); (I-249)+(S2-5); (I-249)+(S2-6); (I-249)+(S2-7); (I-249)+(S2-8); (I-249)+(S2-9); (I-249)+(S2-10); (I-249)+(S3-1); (I-249)+(S3-2); (I-249)+(S3-3); (I-249)+(S3-4); (I-249)+(S3-5); (I-249)+(S3-6); (I-249)+(S3-7); (I-249)+(S3-8); (I-249)+(S3-9); (I-249)+(S3-10); (I-249)+(S3-11); (I-249)+(S4-1); (I-249)+(S4-2); (I-249)+(S4-3); (I-249)+(S4-4); (I-249)+(S4-5); (I-249)+(S7-1); (I-249)+(S11-1); (I-249)+(S11-2); (I-249)+(S11-3); (I-249)+(S12-1); (I-249)+(S13-1); (I-249)+(S13-2); (I-249)+(S13-3); (I-249)+(S13-4): (I-249)+(S13-5); (I-249)+(S13-6); (I-249)+(S13-7); (I-249)+(S13-8); (I-249)+(S13-9); (I-249)+(S14-1)
(I-250)+(S1-1); (I-250)+(S1-2); (I-250)+(S1-3); (I-250)+(S1-4); (I-250)+(S1-5); (I-250)+(S1-6); (I-250)+(S1-7); (I-250)+(S1-8); (I-250)+(S1-9); (I-250)+(S1-10); (I-250)+(S1-11); (I-250)+(S1-12); (I-250)+(S1-13); (I-250)+(S2-1); (I-250)+(S2-2); (I-250)+(S2-3); (I-250)+(S2-4); (I-250)+(S2-5); (I-250)+(S2-6); (I-250)+(S2-7); (I-250)+(S2-8); (I-250)+(S2-9); (I-250)+(S2-10); (I-250)+(S3-1); (I-250)+(S3-2); (I-250)+(S3-3); (I-250)+(S3-4); (I-250)+(S3-5); (I-250)+(S3-6); (I-250)+(S3-7); (I-250)+(S3-8); (I-250)+(S3-9); (I-250)+(S3-10); (I-250)+(S3-11); (I-250)+(S4-1); (I-250)+(S4-2); (I-250)+(S4-3); (I-250)+(S4-4); (I-250)+(S4-5); (I-250)+(S7-1); (I-250)+(S11-1); (I-250)+(S11-2); (I-250)+(S11-3); (I-250)+(S12-1); (I-250)+(S13-1); (I-250)+(S13-2); (I-250)+(S13-3); (I-250)+(S13-4): (I-250)+(S13-5); (I-250)+(S13-6); (I-250)+(S13-7); (I-250)+(S13-8); (I-250)+(S13-9); (I-250)+(S14-1)
(I-251)+(S1-1); (I-251)+(S1-2); (I-251)+(S1-3); (I-251)+(S1-4); (I-251)+(S1-5); (I-251)+(S1-6); (I-251)+(S1-7); (I-251)+(S1-8); (I-251)+(S1-9); (I-251)+(S1-10); (I-251)+(S1-11); (I-251)+(S1-12); (I-251)+(S1-13); (I-251)+(S2-1); (I-251)+(S2-2); (I-251)+(S2-3); (I-251)+(S2-4); (I-251)+(S2-5); (I-251)+(S2-6); (I-251)+(S2-7); (I-251)+(S2-8); (I-251)+(S2-9); (I-251)+(S2-10); (I-251)+(S3-1); (I-251)+(S3-2); (I-251)+(S3-3); (I-251)+(S3-4); (I-251)+(S3-5); (I-251)+(S3-6); (I-251)+(S3-7); (I-251)+(S3-8); (I-251)+(S3-9); (I-251)+(S3-10); (I-251)+(S3-11); (I-251)+(S4-1); (I-251)+(S4-2); (I-251)+(S4-3); (I-251)+(S4-4); (I-251)+(S4-5); (I-251)+(S7-1); (I-251)+(S11-1); (I-251)+(S11-2); (I-251)+(S11-3); (I-251)+(S12-1); (I-251)+(S13-1); (I-251)+(S13-2); (I-251)+(S13-3); (I-251)+(S13-4): (I-251)+(S13-5); (I-251)+(S13-6); (I-251)+(S13-7); (I-251)+(S13-8); (I-251)+(S13-9); (I-251)+(S14-1)
(I-252)+(S1-1); (I-252)+(S1-2); (I-252)+(S1-3); (I-252)+(S1-4); (I-252)+(S1-5); (I-252)+(S1-6); (I-252)+(S1-7); (I-252)+(S1-8); (I-252)+(S1-9); (I-252)+(S1-10); (I-252)+(S1-11); (I-252)+(S1-12); (I-252)+(S1-13); (I-252)+(S2-1); (I-252)+(S2-2); (I-252)+(S2-3); (I-252)+(S2-4); (I-252)+(S2-5); (I-252)+(S2-6); (I-252)+(S2-7); (I-252)+(S2-8); (I-252)+(S2-9); (I-252)+(S2-10); (I-252)+(S3-1); (I-252)+(S3-2); (I-252)+(S3-3); (I-252)+(S3-4); (I-252)+(S3-5); (I-252)+(S3-6); (I-252)+(S3-7); (I-252)+(S3-8); (I-252)+(S3-9); (I-252)+(S3-10); (I-252)+(S3-11); (I-252)+(S4-1); (I-252)+(S4-2); (I-252)+(S4-3); (I-252)+(S4-4); (I-252)+(S4-5); (I-252)+(S7-1); (I-252)+(S11-1); (I-252)+(S11-2); (I-252)+(S11-3); (I-252)+(S12-1); (I-252)+(S13-1); (I-252)+(S13-2); (I-252)+(S13-3); (I-252)+(S13-4): (I-252)+(S13-5); (I-252)+(S13-6); (I-252)+(S13-7); (I-252)+(S13-8); (I-252)+(S13-9); (I-252)+(S14-1)
(I-253)+(S1-1); (I-253)+(S1-2); (I-253)+(S1-3); (I-253)+(S1-4); (I-253)+(S1-5); (I-253)+(S1-6); (I-253)+(S1-7); (I-253)+(S1-8); (I-253)+(S1-9); (I-253)+(S1-10); (I-253)+(S1-11); (I-253)+(S1-12); (I-253)+(S1-13); (I-253)+(S2-1); (I-253)+(S2-2); (I-253)+(S2-3); (I-253)+(S2-4); (I-253)+(S2-5); (I-253)+(S2-6); (I-253)+(S2-7); (I-253)+(S2-8); (I-253)+(S2-9); (I-253)+(S2-10); (I-253)+(S3-1); (I-253)+(S3-2); (I-253)+(S3-3); (I-253)+(S3-4); (I-253)+(S3-5); (I-253)+(S3-6); (I-253)+(S3-7); (I-253)+(S3-8); (I-253)+(S3-9); (I-253)+(S3-10); (I-253)+(S3-11); (I-253)+(S4-1); (I-253)+(S4-2); (I-253)+(S4-3); (I-253)+(S4-4); (I-253)+(S4-5); (I-253)+(S7-1); (I-253)+(S11-1); (I-253)+(S11-2); (I-253)+(S11-3); (I-253)+(S12-1); (I-253)+(S13-1); (I-253)+(S13-2); (I-253)+(S13-3); (I-253)+(S13-4): (I-253)+(S13-5); (I-253)+(S13-6); (I-253)+(S13-7); (I-253)+(S13-8); (I-253)+(S13-9); (I-253)+(S14-1)
(I-254)+(S1-1); (I-254)+(S1-2); (I-254)+(S1-3); (I-254)+(S1-4); (I-254)+(S1-5); (I-254)+(S1-6); (I-254)+(S1-7); (I-254)+(S1-8); (I-254)+(S1-9); (I-254)+(S1-10); (I-254)+(S1-11); (I-254)+(S1-12); (I-254)+(S1-13); (I-254)+(S2-1); (I-254)+(S2-2); (I-254)+(S2-3); (I-254)+(S2-4); (I-254)+(S2-5); (I-254)+(S2-6); (I-254)+(S2-7); (I-254)+(S2-8); (I-254)+(S2-9); (I-254)+(S2-10); (I-254)+(S3-1); (I-254)+(S3-2); (I-254)+(S3-3); (I-254)+(S3-4); (I-254)+(S3-5); (I-254)+(S3-6); (I-254)+(S3-7); (I-254)+(S3-8); (I-254)+(S3-9); (I-254)+(S3-10); (I-254)+(S3-11); (I-254)+(S4-1); (I-254)+(S4-2); (I-254)+(S4-3); (I-254)+(S4-4); (I-254)+(S4-5); (I-254)+(S7-1); (I-254)+(S11-1); (I-254)+(S11-2); (I-254)+(S11-3); (I-254)+(S12-1); (I-254)+(S13-1); (I-254)+(S13-2); (I-254)+(S13-3); (I-254)+(S13-4): (I-254)+(S13-5); (I-254)+(S13-6); (I-254)+(S13-7); (I-254)+(S13-8); (I-254)+(S13-9); (I-254)+(S14-1)
(I-255)+(S1-1); (I-255)+(S1-2); (I-255)+(S1-3); (I-255)+(S1-4); (I-255)+(S1-5); (I-255)+(S1-6); (I-255)+(S1-7); (I-255)+(S1-8); (I-255)+(S1-9); (I-255)+(S1-10); (I-255)+(S1-11); (I-255)+(S1-12); (I-255)+(S1-13); (I-255)+(S2-1); (I-255)+(S2-2); (I-255)+(S2-3); (I-255)+(S2-4); (I-255)+(S2-5); (I-255)+(S2-6); (I-255)+(S2-7); (I-255)+(S2-8); (I-255)+(S2-9); (I-255)+(S2-10); (I-255)+(S3-1); (I-255)+(S3-2); (I-255)+(S3-3); (I-255)+(S3-4); (I-255)+(S3-5); (I-255)+(S3-6); (I-255)+(S3-7); (I-255)+(S3-8); (I-255)+(S3-9); (I-255)+(S3-10); (I-255)+(S3-11); (I-255)+(S4-1); (I-255)+(S4-2); (I-255)+(S4-3); (I-255)+(S4-4); (I-255)+(S4-5); (I-255)+(S7-1); (I-255)+(S11-1); (I-255)+(S11-2); (I-255)+(S11-3); (I-255)+(S12-1); (I-255)+(S13-1); (I-255)+(S13-2); (I-255)+(S13-3); (I-255)+(S13-4): (I-255)+(S13-5); (I-255)+(S13-6); (I-255)+(S13-7); (I-255)+(S13-8); (I-255)+(S13-9); (I-255)+(S14-1)
(I-256)+(S1-1); (I-256)+(S1-2); (I-256)+(S1-3); (I-256)+(S1-4); (I-256)+(S1-5); (I-256)+(S1-6); (I-256)+(S1-7); (I-256)+(S1-8); (I-256)+(S1-9); (I-256)+(S1-10); (I-256)+(S1-11); (I-256)+(S1-12); (I-256)+(S1-13); (I-256)+(S2-1); (I-256)+(S2-2); (I-256)+(S2-3); (I-256)+(S2-4); (I-256)+(S2-5); (I-256)+(S2-6); (I-256)+(S2-7); (I-256)+(S2-8); (I-256)+(S2-9); (I-256)+(S2-10); (I-256)+(S3-1); (I-256)+(S3-2); (I-256)+(S3-3); (I-256)+(S3-4); (I-256)+(S3-5); (I-256)+(S3-6); (I-256)+(S3-7); (I-256)+(S3-8); (I-256)+(S3-9); (I-256)+(S3-10); (I-256)+(S3-11); (I-256)+(S4-1); (I-256)+(S4-2); (I-256)+(S4-3); (I-256)+(S4-4); (I-256)+(S4-5); (I-256)+(S7-1); (I-256)+(S11-1); (I-256)+(S11-2); (I-256)+(S11-3); (I-256)+(S12-1); (I-256)+(S13-1); (I-256)+(S13-2); (I-256)+(S13-3); (I-256)+(S13-4): (I-256)+(S13-5); (I-256)+(S13-6); (I-256)+(S13-7); (I-256)+(S13-8); (I-256)+(S13-9); (I-256)+(S14-1)
(I-257)+(S1-1); (I-257)+(S1-2); (I-257)+(S1-3); (I-257)+(S1-4); (I-257)+(S1-5); (I-257)+(S1-6); (I-257)+(S1-7); (I-257)+(S1-8); (I-257)+(S1-9); (I-257)+(S1-10); (I-257)+(S1-11); (I-257)+(S1-12); (I-257)+(S1-13); (I-257)+(S2-1); (I-257)+(S2-2); (I-257)+(S2-3); (I-257)+(S2-4); (I-257)+(S2-5); (I-257)+(S2-6); (I-257)+(S2-7); (I-257)+(S2-8); (I-257)+(S2-9); (I-257)+(S2-10); (I-257)+(S3-1); (I-257)+(S3-2); (I-257)+(S3-3); (I-257)+(S3-4); (I-257)+(S3-5); (I-257)+(S3-6); (I-257)+(S3-7); (I-257)+(S3-8); (I-257)+(S3-9); (I-257)+(S3-10); (I-257)+(S3-11); (I-257)+(S4-1); (I-257)+(S4-2); (I-257)+(S4-3); (I-257)+(S4-4); (I-257)+(S4-5); (I-257)+(S7-1); (I-257)+(S11-1); (I-257)+(S11-2); (I-257)+(S11-3); (I-257)+(S12-1); (I-257)+(S13-1); (I-257)+(S13-2); (I-257)+(S13-3); (I-257)+(S13-4): (I-257)+(S13-5); (I-257)+(S13-6); (I-257)+(S13-7); (I-257)+(S13-8); (I-257)+(S13-9); (I-257)+(S14-1)
(I-258)+(S1-1); (I-258)+(S1-2); (I-258)+(S1-3); (I-258)+(S1-4); (I-258)+(S1-5); (I-258)+(S1-6); (I-258)+(S1-7); (I-258)+(S1-8); (I-258)+(S1-9); (I-258)+(S1-10); (I-258)+(S1-11); (I-258)+(S1-12); (I-258)+(S1-13); (I-258)+(S2-1); (I-258)+(S2-2); (I-258)+(S2-3); (I-258)+(S2-4); (I-258)+(S2-5); (I-258)+(S2-6); (I-258)+(S2-7); (I-258)+(S2-8); (I-258)+(S2-9); (I-258)+(S2-10); (I-258)+(S3-1); (I-258)+(S3-2); (I-258)+(S3-3); (I-258)+(S3-4); (I-258)+(S3-5); (I-258)+(S3-6); (I-258)+(S3-7); (I-258)+(S3-8); (I-258)+(S3-9); (I-258)+(S3-10); (I-258)+(S3-11); (I-258)+(S4-1); (I-258)+(S4-2); (I-258)+(S4-3); (I-258)+(S4-4); (I-258)+(S4-5); (I-258)+(S7-1); (I-258)+(S11-1); (I-258)+(S11-2); (I-258)+(S11-3); (I-258)+(S12-1); (I-258)+(S13-1); (I-258)+(S13-2); (I-258)+(S13-3); (I-258)+(S13-4): (I-258)+(S13-5); (I-258)+(S13-6); (I-258)+(S13-7); (I-258)+(S13-8); (I-258)+(S13-9); (I-258)+(S14-1)
(I-259)+(S1-1); (I-259)+(S1-2); (I-259)+(S1-3); (I-259)+(S1-4); (I-259)+(S1-5); (I-259)+(S1-6); (I-259)+(S1-7); (I-259)+(S1-8); (I-259)+(S1-9); (I-259)+(S1-10); (I-259)+(S1-11); (I-259)+(S1-12); (I-259)+(S1-13); (I-259)+(S2-1); (I-259)+(S2-2); (I-259)+(S2-3); (I-259)+(S2-4); (I-259)+(S2-5); (I-259)+(S2-6); (I-259)+(S2-7); (I-259)+(S2-8); (I-259)+(S2-9); (I-259)+(S2-10); (I-259)+(S3-1); (I-259)+(S3-2); (I-259)+(S3-3); (I-259)+(S3-4); (I-259)+(S3-5); (I-259)+(S3-6); (I-259)+(S3-7); (I-259)+(S3-8); (I-259)+(S3-9); (I-259)+(S3-10); (I-259)+(S3-11); (I-259)+(S4-1); (I-259)+(S4-2); (I-259)+(S4-3); (I-259)+(S4-4); (I-259)+(S4-5); (I-259)+(S7-1); (I-259)+(S11-1); (I-259)+(S11-2); (I-259)+(S11-3); (I-259)+(S12-1); (I-259)+(S13-1); (I-259)+(S13-2); (I-259)+(S13-3); (I-259)+(S13-4): (I-259)+(S13-5); (I-259)+(S13-6); (I-259)+(S13-7); (I-259)+(S13-8); (I-259)+(S13-9); (I-259)+(S14-1)
(I-260)+(S1-1); (I-260)+(S1-2); (I-260)+(S1-3); (I-260)+(S1-4); (I-260)+(S1-5); (I-260)+(S1-6); (I-260)+(S1-7); (I-260)+(S1-8); (I-260)+(S1-9); (I-260)+(S1-10); (I-260)+(S1-11); (I-260)+(S1-12); (I-260)+(S1-13); (I-260)+(S2-1); (I-260)+(S2-2); (I-260)+(S2-3); (I-260)+(S2-4); (I-260)+(S2-5); (I-260)+(S2-6); (I-260)+(S2-7); (I-260)+(S2-8); (I-260)+(S2-9); (I-260)+(S2-10); (I-260)+(S3-1); (I-260)+(S3-2); (I-260)+(S3-3); (I-260)+(S3-4); (I-260)+(S3-5); (I-260)+(S3-6); (I-260)+(S3-7); (I-260)+(S3-8); (I-260)+(S3-9); (I-260)+(S3-10); (I-260)+(S3-11); (I-260)+(S4-1); (I-260)+(S4-2); (I-260)+(S4-3); (I-260)+(S4-4); (I-260)+(S4-5); (I-260)+(S7-1); (I-260)+(S11-1); (I-260)+(S11-2); (I-260)+(S11-3); (I-260)+(S12-1); (I-260)+(S13-1); (I-260)+(S13-2); (I-260)+(S13-3); (I-260)+(S13-4): (I-260)+(S13-5); (I-260)+(S13-6); (I-260)+(S13-7); (I-260)+(S13-8); (I-260)+(S13-9); (I-260)+(S14-1)
(I-261)+(S1-1); (I-261)+(S1-2); (I-261)+(S1-3); (I-261)+(S1-4); (I-261)+(S1-5); (I-261)+(S1-6); (I-261)+(S1-7); (I-261)+(S1-8); (I-261)+(S1-9); (I-261)+(S1-10); (I-261)+(S1-11); (I-261)+(S1-12); (I-261)+(S1-13); (I-261)+(S2-1); (I-261)+(S2-2); (I-261)+(S2-3); (I-261)+(S2-4); (I-261)+(S2-5); (I-261)+(S2-6); (I-261)+(S2-7); (I-261)+(S2-8); (I-261)+(S2-9); (I-261)+(S2-10); (I-261)+(S3-1); (I-261)+(S3-2); (I-261)+(S3-3); (I-261)+(S3-4); (I-261)+(S3-5); (I-261)+(S3-6); (I-261)+(S3-7); (I-261)+(S3-8); (I-261)+(S3-9); (I-261)+(S3-10); (I-261)+(S3-11); (I-261)+(S4-1); (I-261)+(S4-2); (I-261)+(S4-3); (I-261)+(S4-4); (I-261)+(S4-5); (I-261)+(S7-1); (I-261)+(S11-1); (I-261)+(S11-2); (I-261)+(S11-3); (I-261)+(S12-1); (I-261)+(S13-1); (I-261)+(S13-2); (I-261)+(S13-3); (I-261)+(S13-4): (I-261)+(S13-5); (I-261)+(S13-6); (I-261)+(S13-7); (I-261)+(S13-8); (I-261)+(S13-9); (I-261)+(S14-1)
(I-262)+(S1-1); (I-262)+(S1-2); (I-262)+(S1-3); (I-262)+(S1-4); (I-262)+(S1-5); (I-262)+(S1-6); (I-262)+(S1-7); (I-262)+(S1-8); (I-262)+(S1-9); (I-262)+(S1-10); (I-262)+(S1-11); (I-262)+(S1-12); (I-262)+(S1-13); (I-262)+(S2-1); (I-262)+(S2-2); (I-262)+(S2-3); (I-262)+(S2-4); (I-262)+(S2-5); (I-262)+(S2-6); (I-262)+(S2-7); (I-262)+(S2-8); (I-262)+(S2-9); (I-262)+(S2-10); (I-262)+(S3-1); (I-262)+(S3-2); (I-262)+(S3-3); (I-262)+(S3-4); (I-262)+(S3-5); (I-262)+(S3-6); (I-262)+(S3-7); (I-262)+(S3-8); (I-262)+(S3-9); (I-262)+(S3-10); (I-262)+(S3-11); (I-262)+(S4-1); (I-262)+(S4-2); (I-262)+(S4-3); (I-262)+(S4-4); (I-262)+(S4-5); (I-262)+(S7-1); (I-262)+(S11-1); (I-262)+(S11-2); (I-262)+(S11-3); (I-262)+(S12-1); (I-262)+(S13-1); (I-262)+(S13-2); (I-262)+(S13-3); (I-262)+(S13-4): (I-262)+(S13-5); (I-262)+(S13-6); (I-262)+(S13-7); (I-262)+(S13-8); (I-262)+(S13-9); (I-262)+(S14-1)
(I-263)+(S1-1); (I-263)+(S1-2); (I-263)+(S1-3); (I-263)+(S1-4); (I-263)+(S1-5); (I-263)+(S1-6); (I-263)+(S1-7); (I-263)+(S1-8); (I-263)+(S1-9); (I-263)+(S1-10); (I-263)+(S1-11); (I-263)+(S1-12); (I-263)+(S1-13); (I-263)+(S2-1); (I-263)+(S2-2); (I-263)+(S2-3); (I-263)+(S2-4); (I-263)+(S2-5); (I-263)+(S2-6); (I-263)+(S2-7); (I-263)+(S2-8); (I-263)+(S2-9); (I-263)+(S2-10); (I-263)+(S3-1); (I-263)+(S3-2); (I-263)+(S3-3); (I-263)+(S3-4); (I-263)+(S3-5); (I-263)+(S3-6); (I-263)+(S3-7); (I-263)+(S3-8); (I-263)+(S3-9); (I-263)+(S3-10); (I-263)+(S3-11); (I-263)+(S4-1); (I-263)+(S4-2); (I-263)+(S4-3); (I-263)+(S4-4); (I-263)+(S4-5); (I-263)+(S7-1); (I-263)+(S11-1); (I-263)+(S11-2); (I-263)+(S11-3); (I-263)+(S12-1); (I-263)+(S13-1); (I-263)+(S13-2); (I-263)+(S13-3); (I-263)+(S13-4): (I-263)+(S13-5); (I-263)+(S13-6); (I-263)+(S13-7); (I-263)+(S13-8); (I-263)+(S13-9); (I-263)+(S14-1)
(I-264)+(S1-1); (I-264)+(S1-2); (I-264)+(S1-3); (I-264)+(S1-4); (I-264)+(S1-5); (I-264)+(S1-6); (I-264)+(S1-7); (I-264)+(S1-8); (I-264)+(S1-9); (I-264)+(S1-10); (I-264)+(S1-11); (I-264)+(S1-12); (I-264)+(S1-13); (I-264)+(S2-1); (I-264)+(S2-2); (I-264)+(S2-3); (I-264)+(S2-4); (I-264)+(S2-5); (I-264)+(S2-6); (I-264)+(S2-7); (I-264)+(S2-8); (I-264)+(S2-9); (I-264)+(S2-10); (I-264)+(S3-1); (I-264)+(S3-2); (I-264)+(S3-3); (I-264)+(S3-4); (I-264)+(S3-5); (I-264)+(S3-6); (I-264)+(S3-7); (I-264)+(S3-8); (I-264)+(S3-9); (I-264)+(S3-10); (I-264)+(S3-11); (I-264)+(S4-1); (I-264)+(S4-2); (I-264)+(S4-3); (I-264)+(S4-4); (I-264)+(S4-5); (I-264)+(S7-1); (I-264)+(S11-1); (I-264)+(S11-2); (I-264)+(S11-3); (I-264)+(S12-1); (I-264)+(S13-1); (I-264)+(S13-2); (I-264)+(S13-3); (I-264)+(S13-4): (I-264)+(S13-5); (I-264)+(S13-6); (I-264)+(S13-7); (I-264)+(S13-8); (I-264)+(S13-9); (I-264)+(S14-1)

Within the context of the present invention, in particular combinations of the compounds of the formula (I) with the following safeners are preferred: daimuron (S14-1), benoxacor (S3-4), furilazole [(S3-10) or (S3-11)], fluxofenim (S11-2), fenchlorazole(-ethyl) (S1-7), mefenpyr-diethyl (S1-1), cloquintocet-mexyl (S2-1), isoxadifen-ethyl (S1-11), cyprosulfamide (S4-1), flurazole (S13-3), oxabetrinil (S11-1), dichlormid (S3-1) and dietholate (S13-8).

Within the context of the present invention, even more preferred combinations of the compounds of the formula (I) with the following safeners are: mefenpyr-diethyl (S1-1), isoxadifen-ethyl (S1-11), cyprosulfamide (S4-1), fenchlorazole-ethyl (S1-7), benoxacor (S3-4), cloquintocet-mexyl (S2-1), fluxofenim (S11-2) and furilazole [(S3-10) or (S3-11)].

Within the context of the present invention, preference is given in particular to combinations which comprise, as component (A), a compound of the formula (I) selected from methyl 4-amino-3,5-dichloro-6-cyclopropyl-2-pyridinecarboxylate, 4-amino-3,5-dichloro-6-cyclopropyl-2-pyridinecarboxylic acid, methyl 4-amino-3-chloro-6-cyclopropyl-2-pyridinecarboxylate, 4-amino-3-chloro-6-cyclopropyl-2-pyridinecarboxylic acid, methyl 4-amino-3-chloro-6-cyclopropyl-5-fluoro-2-pyridinecarboxylate and 4-amino-3-chloro-6-cyclopropyl-5-fluoro-2-pyridinecarboxylic acid and, as component (B), a safener selected from mefenpyr-diethyl (S1-1), isoxadifen-ethyl (S1-11), cyprosulfamide (S4-1), fenchlorazole-ethyl (S1-7), benoxacor (S3-4), cloquintocet-mexyl (S2-1), fluxofenim (S11-2) and furilazole [(S3-10) or (S3-11)].

Preference is given to herbicide/safener combinations comprising (A) a herbicidally effective amount of one or more compounds of the formula (I) or their salts, and (B) an antidotically effective amount of one or more safeners.

Within the context of the invention, herbicidally effective amount means an amount of one or more herbicides which is suitable for adversely affecting plant growth. Antidotically effective amount within the context of the invention means an amount of one or more safeners which is suitable for reducing the phytotoxic effect of crop protection composition active ingredients (e.g. of herbicides) on crop plants.

The safeners (B) are suitable for reducing phytotoxic effects which may occur when herbicides of the formula (I) are used in crops of useful plants without substantially impairing the effectiveness of these herbicidal active ingredients against harmful plants.

As a result, it is possible to extend quite considerably the field of use of conventional crop protection compositions, for example to crops in which it has hitherto only been possible to use the herbicides to a limited extent, if at all.

Depending on indication and herbicidal active ingredient used, the required application rates of the safeners can vary within wide limits and are generally in the range from 0.001 to 5 kg, preferably 0.005 to 2.5 kg of active ingredient per hectare.

The herbicidal active ingredients (A) of the formula (I) and the safeners (B) can be applied together (e.g. as a ready mix or in the tank mix method) or sequentially in any desired order, for example by atomizing, pouring or spraying, or by scattering granules. The weight ratio of herbicide of the formula (I) (A): safener (B) can vary within wide limits and is preferably in the range from 1:10 000 to 10 000:1, in particular from 1:1000 to 1000:1. The optimum amounts in each case of the formula (I) (A) and safener (B) are dependent on the type of herbicide used and the type of safener used and also on the nature and the development stage of the plant stock to be treated and can be determined from case to case by simple routine preliminary experiments.

Depending on their properties, the safeners (B) contained in the herbicide/safener combination according to the invention can be used for pretreating the seed material of the crop plant (for example for seed dressing) or introduced into the seed furrows prior to sowing or be used together with the herbicide before or after the emergence of the plants. Pre-emergence treatment includes not only the treatment of the area under cultivation (including, if appropriate, water present on the area under cultivation, for example in the case of rice applications) before sowing, but also the treatment of the sown areas of cultivation which do not yet sustain any growth. Joint application with the herbicide is preferred. For this purpose, it is possible to use tank mixes or ready mixes.

In a preferred embodiment, the seed material (e.g. grains, seeds or vegetative propagation organs, such as tubers or shoot parts with buds) or seedlings are pretreated with the safeners (B), if appropriate in combination with other agrochemical active ingredients. For the pretreatment of the seed material, the active ingredients can be applied to the seed material, for example, by dressing, or the active ingredients and the seed material can be introduced into water or other solvents, and the active ingredients are taken up, for example, by adduct formation or diffusion in a dip process or by swelling or pregermination. For the pretreatment of seedlings, the young plants can be brought into contact with the safeners, if appropriate in combination with other agrochemical active ingredients, for example by spraying, dipping or watering, and then be transplanted and, if appropriate, be subjected to a post-treatment with the herbicides (A).

The treatment of the seed material or seedlings can be carried out using the safeners (B) alone or together with other agrochemical active ingredients—such as fungicides, insecticides or agents for fortifying the plant, for fertilizing or for increasing the rate of the swelling and germination processes. Here, the safeners may, after the pretreatment application, be applied again before, after or together with one or more herbicides of the formula (I), possibly also in combination with other known herbicides. By pretreating the seed material or the seedlings, it is possible to achieve an improved long-term effect of the safeners.

Accordingly, the present invention further provides a method for controlling undesired plants in plant crops, which method comprises applying the components (A) and (B) of the herbicide/safener combination according to the invention to the plants (for example harmful plants, such as monocotyledonous or dicotyledonous weeds or undesired crop plants), the seed material (e.g. grains, seeds or vegetative propagation organs, such as tubers or shoot parts with buds) or the area on which the plants grow (e.g. the area under cultivation), for example together or separately. Here, it is possible to apply one or more safeners (B), preferably one or more, in particular one, compound of groups (S1) to (S14) before, after or at the same time as the herbicide(s) of the formula (I) (A) to the plants, the seed material or the area on which the plants grow (for example the area under cultivation). In a preferred embodiment, the safeners (B) are used for treating the seed material.

Undesired plants are to be understood as meaning all plants which grow where they are not wanted. These may be, for example, harmful plants (for example monocotyledonous or dicotyledonous weeds or undesired crop plants), including, for example, those which are resistant to certain herbicidal active ingredients, such as glyphosate, atrazin, glufosinate or imidazolinone herbicides.

Monocotyledonous weeds originate, for example, from the genera Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Ischaemum, Sphenoclea, Dactyloctenium, Agrostis, Alopecurus, Apera. Dicotyledonous weeds originate, for example, from the genera Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum, Euphorbia.

In the method according to the invention, preferably an effective amount of components (A) and (B) is used for controlling harmful plants in plant crops, for example in economically important arable crops, for example monocotyledonous arable crops such as cereals (for example wheat, barley, rye, oats), rice, corn, millet, or dicotyledonous arable crops such as sugar beet, rapeseed, cotton, sunflowers and leguminous plants, for example of the genera Glycine (for example Glycine max., such as non-transgenic Glycine max. (for example conventional cultivars, such as STS cultivars) or transgenic Glycine max. (for example RR-soybean or LL soybean) and hybrids thereof), Phaseolus, Pisum, Vicia and Arachis, or vegetable crops of various botanical groups, such as potato, leek, cabbage, carrot, tomato, onion, and also permanent crops and plantation crops, such as pip and stone fruit, berry fruit, grapevine, Hevea, bananas, sugar cane, coffee, tea, citrus fruits, nut plantations, lawns, palm crops and forest plantations.

The invention also provides the use of the herbicide/safener combinations according to the invention for controlling undesired plant growth, preferably in plant crops.

The herbicide/safener combinations according to the invention can be prepared by known processes, for example as mix formulations of the individual components, if appropriate with further active ingredients, additives and/or customary formulation auxiliaries, which are then applied in a customary manner diluted with water, or they can be prepared as tank mixes by jointly diluting the individual components, formulated separately or partially formulated separately, with water. It is likewise possible to apply the individual components, formulated separately or partially formulated separately, at different times (splitting). It is also possible to apply the individual components or the herbicide/safener combinations in several portions (sequential application), for example pre-emergence applications, followed by post-emergence applications or early post-emergence applications, followed by medium or late post-emergence applications. Preference is given here to the joint or almost simultaneous application of the active ingredients of the combination in question.

The herbicide/safener combination according to the invention can also be used for controlling harmful plants in crops of known or still developing genetically modified plants.

The transgenic plants are usually characterized by particularly advantageous properties, for example by resistances to certain pesticides, primarily certain herbicides, resistances to plant diseases or pathogens of plant diseases such as certain insects or microorganisms such as fungi, bacteria or viruses. Other particular properties relate, for example, to the harvest material with regard to amount, quality, storability, composition and special ingredients. For example, transgenic plants with increased starch content or modified quality of the starch or those with a different fatty acid composition of the harvest material are known. Further particular properties may lie in a tolerance or resistance to abiotic stressors, for example heat, cold, dryness, salt and ultraviolet radiation.

Preferably, the application of the herbicide/safener combinations according to the invention, or salts thereof, is in economically important transgenic crops of useful plants and ornamental plants, e.g. of cereals such as wheat, barley, rye, oats, millet, rice, manioc and corn or else crops of sugar beet, cotton, soybean, rapeseed, potatoes, tomatoes, peas and other vegetable crops.

The compounds of the formula (I) can preferably be used as herbicides in crops of useful plants which are resistant to the phytotoxic effects of the herbicides and/or have been rendered resistant by means of genetic engineering.

Conventional methods for producing new plants which have modified properties compared to existing plants consist, for example, in classical cultivation methods and the production of mutants. Alternatively, new plants with modified properties can be produced using genetic engineering methods (see e.g. EP-A-0221044, EP-A-0131624). For example, in several cases the following have been described:
genetic modifications of crop plants for the purpose of modifying the starch synthesized in the plants (e.g. WO 92/11376, WO 92/14827, WO 91/19806),
transgenic crop plants which are resistant to certain herbicides of the glufosinate type (c.f. e.g. EP-A-0242236, EP-A-242246) or glyphosate type (WO 92/00377) or the sulfonylurea type (EP-A-0257993, U.S. Pat. No. 5,013,659),
transgenic crop plants, for example cotton, with the ability to produce Bacillus thuringiensis toxins (Bt toxins) which make the plants resistant to certain pests (EP-A-0142924, EP-A-0193259).
transgenic crop plants with a modified fatty acid composition (WO 91/13972).
genetically modified crop plants with new ingredients or secondary substances, for example new phytoalexins, which bring about an increased disease resistance (EPA 309862, EPA0464461)
genetically modified plants with reduced photorespiration which have higher yields and higher stress tolerance (EPA 0305398).
transgenic crop plants which produce pharmaceutically or diagnostically important proteins (“molecular pharming”)
transgenic crop plants which are characterized by higher yields or better quality
transgenic crop plants which are characterized by a combination e.g. of the aforementioned new properties (“gene stacking”).

Numerous molecular-biological techniques by means of which novel transgenic plants with modified properties can be produced are known in principle; see, for example, I. Potrykus and G. Spangenberg (eds.) Gene Transfer to Plants, Springer Lab Manual (1995), Springer Verlag Berlin, Heidelberg, or Christou, “Trends in Plant Science” 1 (1996) 423-431.

For genetic manipulations of this type, nucleic acid molecules can be introduced into plasmids which permit a mutagenesis or a sequence modification through recombination of DNA sequences. With the help of standard methods it is possible, for example, to undertake base exchanges, remove part sequences or add natural or synthetic sequences. For joining the DNA fragments with one another, adapters or linkers can be attached to the fragments, see e.g. Sambrook et al., 1989, Molecular Cloning, A Laboratory Manual, 2nd edition, Cold Spring Harbor Laboratory Press, Cold Spring Harbor, N.Y.; or Winnacker “Gene and Klone [Genes and Clones]”, VCH Weinheim 2nd edition 1996.

The production of plant cells with reduced activity of a gene product can be achieved, for example, through the expression of at least one corresponding antisense-RNA, of a sense-RNA for achieving a cosuppression effect or the expression of at least one correspondingly constructed ribozyme which cleaves specifically transcripts of the aforementioned gene product.

For this, firstly DNA molecules can be used which include the entire coding sequence for a gene product including any flanking sequences present, and also DNA molecules which only include parts of the coding sequence, in which case it is necessary for these parts to be long enough to bring about an antisense effect in the cells. It is also possible to use DNA sequences which have a high degree of homology to the coding sequences of a gene product, but are not completely identical.

During the expression of nucleic acid molecules in plants, the synthesized protein can be localized in any desired compartment of the plant cell. However, in order to achieve localization in a specific compartment, the coding region can, for example, be linked to DNA sequences which ensure localization in a specific compartment. Sequences of this type are known to the person skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106). The expression of the nucleic acid molecules can also take place in the organelles of the plant cells.

The transgenic plant cells can be regenerated by known techniques to give whole plants. The transgenic plants may in principle be plants of any desired plant species, i.e. both monocotyledonous and also dicotyledonous plants.

Thus, transgenic plants are obtainable which have modified properties through overexpression, suppression or inhibition of homologous (=natural) genes or gene sequences or expression of heterologous (=foreign) genes or gene sequences.

Preferably, the herbicide/safener combinations according to the invention can be used in transgenic crops which are resistant to growth regulators such as, for example, dicamba or to herbicides which inhibit essential plant enzymes, for example acetolactate synthases (ALS), EPSP synthases, glutamine synthases (GS) or hydroxyphenylpyruvate dioxygenases (HPPD), or to herbicides from the group of sulfonylureas, glyphosate, glufosinate or benzoylisoxazoles and analogous active ingredients.

When using the herbicide/safener combinations according to the invention in transgenic crops, besides the effects against harmful plants that are observed in other crops, effects often arise which are specific to the application in the particular transgenic crop, for example a modified or specifically expanded weed spectrum which can be controlled, modified application rates which can be used for the application, preferably good combinability with the herbicides against which the transgenic crop is resistant, and also influencing of growth and yield of the transgenic crop plants.

The invention therefore also provides the use of the herbicide/safener combinations according to the invention for controlling harmful plants in transgenic crop plants.

Preferably, the use of the combinations according to the invention is in economically important transgenic crops of useful plants and ornamental plants, e.g. of cereals (e.g. wheat, barley, rye, oats), millet, rice, manioc and corn or else crops of sugar beet, cotton, soybean, rapeseed, potatoes, tomatoes, peas and other vegetable crops.

The invention therefore also provides the use of the herbicide/safener combinations according to the invention for controlling harmful plants in transgenic crop plants or crop plants which are tolerant owing to selective cultivation.

The herbicides (A) and the safeners (B) can be converted jointly or separately into customary formulations, for example for application by atomization, pouring, spraying and seed dressing, such as solutions, emulsions, suspensions, powders, foams, pastes, granules, aerosols, natural and synthetic materials impregnated with active ingredient, and microencapsulations in polymeric substances. The formulations may comprise the customary auxiliaries and additives.

These formulations are produced in a known manner, for example by mixing the active ingredients with extenders, that is liquid solvents, liquefied gases under pressure, and/or solid carriers, optionally with the use of surface-active agents, that is emulsifiers and/or dispersants and/or foam formers.

If the extender used is water, it is also possible to use, for example, organic solvents as auxiliary solvents. Essentially, suitable liquid solvents are: aromatics such as xylene, toluene, or alkylnaphthalenes, chlorinated aromatics or chlorinated aliphatic hydrocarbons such as chlorobenzenes, chloroethylenes, or methylene chloride, aliphatic hydrocarbons such as cyclohexane or paraffins, e.g. mineral oil fractions, mineral and vegetable oils, alcohols, such as butanol or glycol and ethers and esters thereof, ketones, such as acetone, methyl ethyl ketone, methyl isobutyl ketone or cyclohexanone, strongly polar solvents such as dimethylformamide or dimethyl sulfoxide, and water.

Suitable solid carriers are: for example ammonium salts and ground natural minerals such as kaolins, clay earths, talc, chalk, quartz, attapulgite, montmorillonite or diatomaceous earth, and ground synthetic materials such as highly-dispersed silica, alumina and silicates; suitable solid carriers for granules are: for example crushed and fractionated natural rocks such as calcite, marble, pummis, sepiolite and dolomite, and also synthetic granules of inorganic and organic meals, and granules of organic material such as sawdust, coconut shells, corn cobs and tobacco stalks; suitable emulsifiers and/or foam formers are: for example nonionogenic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates and protein hydrolysates; suitable dispersants are: for example lignosulfite waste liquors and methylcellulose.

Tackifiers such as carboxymethylcellulose, natural and synthetic polymers in the form of powders, granules or lattices, such as gum Arabic, polyvinyl alcohol and polyvinyl acetate, and also natural phospholipids, such as cephalins and lecithins, and synthetic phospholipids can be used in the formulations. Further additives may be mineral and vegetable oils.

Dyes such as inorganic pigments, for example iron oxide, titanium oxide, ferrocyan blue, and organic dyes such as alizarin dyes, azo dyes and metalophthalocyanine dyes and trace nutrients such as salts of iron, manganese, boron, copper, cobalt, molybdenum and zinc can be used.

The formulations comprise generally between 0.1 and 95% by weight of active ingredient, preferably between 0.5 and 90% by weight.

The herbicides (A) and the safeners (B) can be used as such or in their formulations also in a mixture with other agrochemical active ingredients, such as known herbicides, for controlling undesired plant growth, for example for controlling weeds or for controlling undesired crop plants, where, for example, ready mixes or tank mixes are possible.

Mixtures with other known active ingredients such as fungicides, insecticides, acaricides, nematicides, bird repellants, plant nutrients and soil structure improvers are also possible, likewise with additives and formulation auxiliaries customary in crop protection.

The herbicides (A) and the safeners (B) can be applied as such, in the form of their formulations or the application forms provided therefrom by further dilution, such as ready-to-use solutions, suspensions, emulsions, powders, pastes and granules. The application takes place in the customary manner, for example by pouring, atomizing, spraying, scattering.

The active ingredients can be applied to the plants, plant parts, the seed material or the area under cultivation (arable soil), preferably to the seed material or the green plants and plant parts and, if appropriate, additionally to the arable soil. One possible application is the joint application of the active ingredients in the form of tank mixes, where the optimally formulated concentrated formulations of the individual active ingredients are mixed together in the tank with water and the resulting spray liquor is applied.

A joint formulation of the combination according to the invention of active ingredients (A) and (B) has the advantage of easier application because the amounts of the components can already be adjusted in an optimal ratio relative to one another. Moreover, the auxiliaries in the formulation can be optimally matched to one another.

Combination partners which can be used for the herbicide/safener combination according to the invention in mixture formulations or in the tank mix are, for example, known, preferably herbicidal, active ingredients which are based on an inhibition of, for example, acetolactate synthase, acetyl-coenzyme-A-carboxylase, PS I, PS II, HPPD, phytoene desaturase, protoporphyrinogene oxidase, glutamine synthetase, cellulose biosynthesis, 5-enolpyruvylshikimate-3-phosphate synthetase. Such compounds and also other compounds that can be used, some of which have an unknown action mechanism or a different action mechanism, are described, for example, in Weed Research 26, 441-445 (1986), or in the handbook “The Pesticide Manual”, 12th edition 2000, or 13th edition 2003 or 14th edition 2006/2007, or in the corresponding “e-Pesticide Manual”, version 4.1 (2007-08), each published by the British Crop Protection Council (also referred to for short below as “PM”), and literature cited therein. Lists of “Common names” are also available in “The Compendium of Pesticide Common Names” on the internet. Herbicides known in the literature which can be combined with the mixtures according to the invention are, for example, the following active ingredients (note: the compounds are designated either with the “common name” in accordance with the International Organization for Standardization (ISO) or with the chemical name, optionally together with a customary code number, and always include all of the application forms such as acids, salts, esters and isomers such as stereoisomers and optical isomers. Here, one, and sometimes also more, application forms are specified):

2,4-D, acetochlor, acifluorfen, acifluorfen-sodium, aclonifen, alachlor, alloxydim, alloxydim-sodium, ametryn, amicarbazone, amidosulfuron, aminocyclopyrachlor, aminopyralid, amitrole, anilofos, asulam, atrazine, azafenidin, azimsulfuron, beflubutamid, benazolin, benazolin-ethyl, benfuresate, bensulfuron-methyl, bentazone, benzfendizone, benzobicyclon, benzofenap, bicyclopyrone, bifenox, bilanafos, bispyribac-sodium, bromacil, bromobutide, bromofenoxim, bromoxynil, butachlor, butafenacil, butenachlor, butralin, butroxydim, butylate, cafenstrole, carbetamide, carfentrazone-ethyl, chloamthoxyfen, chloridazon, chlorimuron-ethyl, chlornitrofen, chlorotoluron, chlorsulfuron, cinidon-ethyl, cinmethylin, cinosulfuron, clefoxydim, clethodim, clodinafop-propargyl, clomazone, cloamprop, clopyralid, cloransulam-methyl, cumyluron, cyanazine, cyclosulfamuron, cycloxydim, cyhalofop-butyl, desmedipham, dicamba, dichlobenil, dichlorprop, dichlorprop-P, diclofop-methyl, diclosulam, difenzoquat, diflufenican, diflufenzopyr, dikegulac-sodium, dimefuron, dimepiperate, dimethachlor, dimethametryn, dimethenamid, triaziflam, diquat-dibromide, dithiopyr, diuron, dymron, EPTC, esprocarb, ethalfluralin, ethametsulfuron-methyl, ethofumesate, ethoxyfen, ethoxysulfuron, etobenzanid, fenoxaprop-ethyl, fenoxaprop-P-ethyl, fenoxasulfone, fentrazamide, flamprop-M-isopropyl, flamprop-M-methyl, flazasulfuron, florasulam, fluazifop, fluazifop-butyl, fluazifop-P-butyl, fluazolate, flucarbazone-sodium, flucetosulfuron, fluchloralin, flufenacet, flufenpyr, flumetsulam, flumiclorac-pentyl, flumioxazin, fluometuron, fluorochloridone, fluoroglycofen-ethyl, flupoxam, flupyrsulfuron-methyl-sodium, fluridone, fluoroxypyr, fluoroxypyr-butoxypropyl, fluoroxypyr-meptyl, flurprimidol, flurtamone, fluthiacet-methyl, fomesafen, foramsulfuron, glufosinate, glufosinate-P, glufosinate-ammonium, glufosinate-P-ammonium, glufosinate-P-sodium, glyphosate, halosulfuron-methyl, haloxyfop, haloxyfop-ethoxyethyl, haloxyfop-methyl, haloxyfop-P-methyl, hexazinone, imazamethabenz-methyl, imazamox, imazapic, imazapyr, imazaquin, imazethapyr, imazosulfuron, indanofan, indaziflam, iodosulfuron-methyl-sodium, ioxynil, isoproturon, isouron, isoxaben, isoxachlortole, isoxaflutole, ketospiradox, lactofen, lenacil, linuron, MCPA, mecoprop, mecoprop-P, mefenacet, mesosulfuron-methyl, mesotrione, metamifop, metamitron, metazachlor, metazosulfuron, methabenzthiazuron, methiozolin, methyldymron, metobromuron, metolachlor, metosulam, metoxuron, metribuzin, metsulfuron-methyl, molinate, monolinuron, naproanilide, napropamide, neburon, nicosulfuron, norflurazon, orbencarb, oryzalin, oxadiargyl, oxadiazon, oxasulfuron, oxazicloamfone, oxyfluorfen, paraquat, pelargonic acid, pendimethalin, pendralin, penoxsulam, pentoxazone, pethoxamid, phenmedipham, picloram, picolinafen, pinoxaden, piperophos, pretilachlor, primisulfuron-methyl, profluazol, profoxydim, prometryn, propachlor, propanil, propaquizafop, propisochlor, propoxycarbazone-sodium, propyrisulfuron, propyzamide, prosulfocarb, prosulfuron, pyraclonil, pyraflufen-ethyl, pyrazolate, pyrazosulfuron-ethyl, pyrazoxyfen, pyribenzoxim, pyributicarb, pyridafol, pyridate, pyriftalid, pyriminobac-methyl, pyrithiobac-sodium, quinclorac, quinmerac, quinoclamine, quizalofop-ethyl, quizalofop-P-ethyl, quizalofop-P-tefuryl, rimsulfuron, saflufenacil, sethoxydim, simazine, simetryn, S-metolachlor, sulcotrione, sulfentrazone, sulfometuron-methyl, sulfosate, sulfosulfuron, tebuthiuron, tepraloxydim, terbuthylazine, terbutryn, thenylchlor, thiazopyr, thifensulfuron-methyl, thiobencarb, tiocarbazil, tralkoxydim, triallate, triasulfuron, tribenuron-methyl, triclopyr, tridiphane, trifloxysulfuron, trifluralin, triflusulfuron-methyl and tritosulfuron.

Further possible mixing partners are

pyroxasulfone, pyroxsulam, orthosulfamuron, pyrimisulfan, prohexadione-calcium, bencarbazone, SYN-523, IDH-100, SYP-249, monosulfuron, ipfencarbazone (HOK-201), pyribambenz-isopropyl, tefuryltrione, bencarbazone, tembotrione, pyrasulfotole, thiencarbazone-methyl, methyl 4-amino-3-chloro-6-(4-chloro-2-fluoro-3-methoxyphenyl)pyridine-2-carboxylate and 4-amino-3-chloro-6-(4-chloro-2-fluoro-3-methoxyphenyl)pyridine-2-carboxylic acid.

For use, the formulations, which are present in a commercially available form, are, if appropriate, diluted in the customary manner, for example in the case of wettable powders, emulsifiable concentrates, dispersions and water-dispersible granules, by means of water. Preparations in the form of dusts, soil granules, granules for scattering, and sprayable solutions are usually not diluted further with other inert substances prior to use.

### BIOLOGICAL EXAMPLES

### Post-Emergence Herbicidal Effect and Safener Effect

Seeds or rhizome pieces of mono- and dicotyledonous harmful plants and of crop plants are planted in peat pots in sandy loam, covered with earth and grown in a greenhouse under good growth conditions. Alternatively to this, harmful plants occurring in the paddy rice cultivation are cultivated in pots in which water stands up to 2 cm above the soil surface. 10 to 20 days after sowing, the test plants are treated in the one to three-leaf stage. The herbicide/safener active ingredient combinations according to the invention, formulated as water-soluble powders or suspensions, and, in parallel experiments, the correspondingly formulated individual active ingredients are sprayed onto the green plant parts in various dosages using an application rate of 300 l of water/ha (converted) and, after the test plants have remained in the greenhouse under optimum growth conditions for 2-3 weeks, the effect of the preparations is scored visually in comparison with untreated controls. In the case of rice or in the case of harmful plants which occur in the rice cultivation, the active ingredients are also placed directly into the irrigation water (application analogous to the so-called granules application) or sprayed onto plants and into the irrigation water.

### Pre-Emergence Herbicidal Effect and Safener Effect

Seeds or rhizome pieces of mono- and dicotyledonous weed plants and crop plants were planted in peat pots in sandy loam and covered with earth. The herbicide/safener active ingredient combinations according to the invention, formulated as water-soluble powders or suspensions, and, in parallel experiments, the correspondingly formulated individual active ingredients were then applied to the surface of the covering earth at an application rate of 600 to 800 l of water/ha (converted) in a variety of dosages.

Wheat (Triso)

| | | Herbicide | % effect | | Safener | % effect | |
|---|---|---|---|---|---|---|---|
| | | dosage | (without | | dosage | (with | % |
| Administration | Herbicide | g (a.i./ha) | safener) | Safener (SA) | g a.i./ha | safener) | Reduction |
| Pre-emergence | I-2 | 20 | 30 | Mefenpyr-diethyl | 50 | 20 | 33 |
| Pre-emergence | I-2 | 20 | 30 | Isoxadifen-ethyl | 50 | 10 | 67 |
| Pre-emergence | I-2 | 20 | 30 | Furilazole | 50 | 10 | 67 |
| Pre-emergence | I-2 | 20 | 30 | Fluxofenim | 50 | 20 | 33 |
| Pre-emergence | I-2 | 20 | 30 | Fenchlorazole | 50 | 10 | 67 |
| Pre-emergence | I-2 | 80 | 30 | Cyprosulfamide | 200 | 20 | 33 |
| Pre-emergence | I-2 | 80 | 30 | Cloquintocet-mexyl | 200 | 20 | 33 |
| Post-emergence | I-2 | 20 | 20 | Mefenpyr-diethyl | 50 | 0 | 100 |
| Post-emergence | I-2 | 20 | 20 | Isoxadifen-ethyl | 50 | 0 | 100 |

Barley (Adonis)

| | | Herbicide | % effect | | Safener | % effect | |
|---|---|---|---|---|---|---|---|
| | | dosage | (without | | dosage | (with | % |
| Administration | Herbicide | g (a.i./ha) | safener) | Safener (SA) | g a.i./ha | safener) | Reduction |
| Post-emergence | I-2 | 20 | 20 | Mefenpyr-diethyl | 50 | 10 | 50 |
| Post-emergence | I-2 | 20 | 20 | Isoxadifen-ethyl | 50 | 0 | 100 |

Rice (Ballila)

| | | Herbicide | % effect | | Safener | % effect | |
|---|---|---|---|---|---|---|---|
| | | dosage | (without | | dosage | (with | % |
| Administration | Herbicide | g (a.i./ha) | safener) | Safener (SA) | g a.i./ha | safener) | Reduction |
| Post-emergence | I-2 | 80 | 30 | Isoxadifen-ethyl | 200 | 20 | 33 |
| Post-emergence | I-2 | 80 | 30 | Cloquintocet-mexyl | 200 | 10 | 67 |

Corn (Aventura)

| | | Herbicide | % effect | | Safener | % effect | |
|---|---|---|---|---|---|---|---|
| | | dosage | (without | | dosage | (with | % |
| Administration | Herbicide | g (a.i./ha) | safener) | Safener (SA) | g a.i./ha | safener) | Reduction |
| Pre-emergence | I-2 | 80 | 35 | Mefenpyr-diethyl | 200 | 20 | 43 |
| Pre-emergence | I-2 | 80 | 35 | Isoxadifen-ethyl | 200 | 25 | 29 |
| Pre-emergence | I-2 | 80 | 35 | Cyprosulfamide | 200 | 20 | 43 |
| Post-emergence | I-2 | 20 | 40 | Mefenpyr-diethyl | 50 | 20 | 50 |
| Post-emergence | I-2 | 80 | 40 | Isoxadifen-ethyl | 200 | 20 | 50 |
| Post-emergence | I-2 | 80 | 40 | Cyprosulfamide | 200 | 20 | 50 |
| Post-emergence | I-2 | 20 | 40 | Cloquintocet-mexyl | 50 | 20 | 50 |
| Post-emergence | I-2 | 80 | 40 | Benoxacor | 200 | 10 | 75 |
| Post-emergence | I-2 | 20 | 40 | Furilazole | 50 | 20 | 50 |

1. A composition comprising
(A) one or more compounds of the formula (I), their N-oxides or their salts, 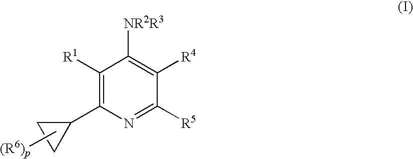
in which
R¹ is hydrogen, fluorine or chlorine;
R² is hydrogen, C₁-C₄-alkyl optionally substituted by one to two radicals R⁷, C₂-C₄-alkenyl optionally substituted by one to two radicals R⁸, C₂-C₄-alkynyl optionally substituted by one to two radicals R⁹, C(═O)R¹⁹, nitro, OR¹¹, SO₂R¹², NR¹³R¹⁴ or N═CR¹⁵R¹⁶;
R³ is hydrogen, C₁-C₄-alkyl optionally substituted by one to two radicals R¹⁷ or C(═O)R¹⁰; or
R² and R³ together are —(CH₂)₄—, —(CH₂)₅—, —CH₂CH═CHCH₂— or —(CH₂)₂O(CH₂)₂—, where each of these four last-mentioned radicals is optionally substituted by one to two radicals R¹⁸; or
R² and R³ together are ═C(R¹⁹)NR²⁰R²¹ or ═C(R²²)OR²³;
R⁴ is halogen;
R⁵ is COOH or a herbicide-active derivative of COOH;
R⁶ independently of the others is halogen, C₁-C₆-alkyl, C₁-C₆-haloalkyl, C₂-C₆-alkenyl, C₂-C₆-haloalkenyl, C₁-C₃-alkoxy, C₁-C₂-haloalkoxy, C₁-C₃-alkylthio or C₁-C₂-haloalkylthio;
R⁷, R⁸ and R⁹ in each case independently of one another are halogen, C₁-C₃-alkoxy, C₁-C₃-haloalkoxy, C₁-C₃-alkylthio, C₁-C₃-haloalkylthio, amino, C₁-C₃-alkylamino, C₂-C₄-dialkylamino or C₂-C₄-alkoxycarbonyl;
R¹⁰ independently of the others is hydrogen, C₁-C₁₄-alkyl, C₁-C₃-haloalkyl, C₁-C₄-alkoxy, phenyl, phenoxy or benzyloxy;
R¹¹ is hydrogen, C₁-C₄-alkyl, C₁-C₃-haloalkyl or CHR²⁴C(O)OR²⁵;
R¹² is C₁-C₄-alkyl or C₁-C₃-haloalkyl;
R¹³ is hydrogen, C₁-C₄-alkyl or C(═O)R²⁶;
R¹⁴ is hydrogen or C₁-C₄-alkyl;
R¹⁵ is hydrogen, C₁-C₄-alkyl or phenyl optionally substituted by one to three radicals R²⁷;
R¹⁶ is hydrogen or C₁-C₄-alkyl; or
R¹⁵ and R¹⁶ together are —(CH₂)₄— or —(CH₂)₅—;
R¹⁷ independently of one another are halogen, C₁-C₃-alkoxy, C₁-C₃-haloalkoxy, C₁-C₃-alkylthio, C₁-C₃-haloalkylthio, amino, C₁-C₃-alkylamino, C₂-C₄-dialkylamino or C₂-C₄-alkoxycarbonyl;
R¹⁸ independently of one another are halogen, C₁-C₃-alkyl, C₁-C₃-alkoxy, C₁-C₃-haloalkoxy, C₁-C₃-alkylthio, C₁-C₃-haloalkylthio, amino, C₁-C₃-alkylamino, C₂-C₄-dialkylamino or C₂-C₄-alkoxycarbonyl;
R¹⁹ is hydrogen or C₁-C₄-alkyl;
R²⁰ and R²¹ independently of one another are hydrogen or C₁-C₄-alkyl; or
R²⁰ and R²¹ together are —(CH₂)₄—, —(CH₂)₅—, —CH₂CH═CHCH₂— or —(CH₂)₂O(CH₂)₂—;
R²² is hydrogen or C₁-C₄-alkyl;
R²³ is C₁-C₄-alkyl;
R²⁴ is hydrogen, C₁-C₄-alkyl or C₁-C₄-alkoxy;
R²⁵ is hydrogen, C₁-C₄-alkyl or benzyl;
R²⁶ is hydrogen, C₁-C₁₄-alkyl, C₁-C₃-haloalkyl, C₁-C₄-alkoxy, phenyl, phenoxy or benzyloxy;
R²⁷ independently of the others is methyl, chloro or methoxy;
p is 0, 1, 2, 3, 4 or 5;
and
(B) one or more safeners selected from the group consisting of
S1) compounds from the group of heterocyclic carboxylic acid derivatives,
which consists of:
S1^{a}) compounds of the dichlorophenylpyrazoline-3-carboxylic acid type (S1^{a}),
S1^{b}) derivatives of dichlorophenylpyrazolecarboxylic acid (S1^{b}),
S1^{c}) derivates of 1,5-diphenylpyrazole-3-carboxylic acid (S1^{c}),
S1^{d}) compounds of the triazolecarboxylic acid type (S1^{d}),
S1^{e}) compounds of the 5-benzyl- or 5-phenyl-2-isoxazoline-3-carboxylic acid type, or of the 5,5-diphenyl-2-isoxazoline-3-carboxylic acid type (S1^{e}),
S4) compounds from the class of acylsulfonamides (S4), which consists of:
S4^{a}) N-acylsulfonamides of the formula (S4^{a}) and salts thereof 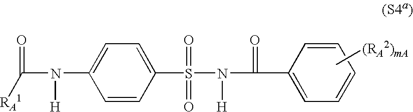
in which
R_{A}¹ is (C₁-C₆)alkyl, (C₃-C₆)cycloalkyl, where the 2 last-mentioned radicals are substituted by v_{A} substituents from the group consisting of halogen, (C₁-C₄)alkoxy, (C₁-C₆)haloalkoxy and (C₁-C₄)alkylthio and, in the case of cyclic radicals, also by (C₁-C₄)alkyl and (C₁-C₄)haloalkyl;
R_{A}² is halogen, (C₁-C₄)alkyl, (C₁-C₄)alkoxy, CF₃;
m_{A} is 1 or 2;
v_{A} is 0, 1, 2 or 3;
S4^{b}) compounds of the 4-(benzoylsulfamoyl)benzamide type of the formula (S4^{b}) and salts thereof, 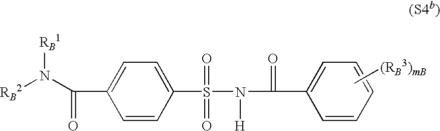
in which
R_{B}¹, R_{B}² independently of one another are hydrogen, (C₁-C₆)alkyl, (C₃-C₆)cycloalkyl, (C₃-C₆)alkenyl, (C₃-C₆)alkynyl,
R_{B}³ is halogen, (C₁-C₄)alkyl, (C₁-C₄)haloalkyl or (C₁-C₄)alkoxy and
m_{B} is 1 or 2,
S4^{c}) compounds from the benzoylsulfamoylphenylurea class of the formula (S4^{c}), 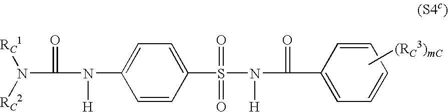
in which
R_{C}¹, R_{C}² independently of one another are hydrogen, (C₁-C₈)-alkyl, (C₃-C₈)-cycloalkyl, (C₃-C₆)-alkenyl, (C₃-C₆)-alkynyl,
R_{C}³ is halogen, (C₁-C₄)alkyl, (C₁-C₄)alkoxy, CF₃
m_{C} is 1 or 2;
S2) compounds from the group of the 8-quinolinyloxy derivates (S2), which consists of:
S2^{a}) compounds of the 8-quinolinoxyacetic acid type (S2^{a}),
S2^{b}) compounds of the (5-chloro-8-quinolinoxy)malonic acid type (S2^{b}),
S3) active ingredients of the dichloroacetamide type (S3),
S5) active ingredients from the class of hydroxyaromatics and the aromatic-aliphatic carboxylic acid derivatives (S5),
S6) active ingredients from the class of 1,2-dihydroquinoxalin-2-ones (S6),
S7) compounds from the class of diphenylmethoxyacetic acid derivatives (S7),
S8) compounds of the formula (S8), 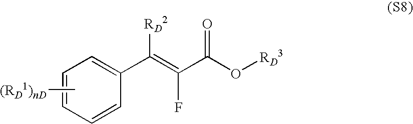
in which the symbols and the indices have the following meanings:
R_{D}¹ is halogen, (C₁-C₄)alkyl, (C₁-C₄)haloalkyl, (C₁-C₄)alkoxy, (C₁-C₄)haloalkoxy,
R_{D}² is hydrogen or (C₁-C₄)alkyl
R_{D}³ is hydrogen, (C₁-C₈)alkyl, (C₂-C₄)alkenyl, (C₂-C₄)alkynyl, or aryl, where each of the aforementioned C-containing radicals is unsubstituted or substituted by one or more identical or different radicals from the group consisting of halogen and alkoxy; or salts thereof
n_{D} is an integer from 0 to 2,
S9) active ingredients from the class of 3-(5-tetrazolylcarbonyl)-2-quinolones (S9),
S10) compounds of the formulae (S10^{a}) or (S10^{b}) 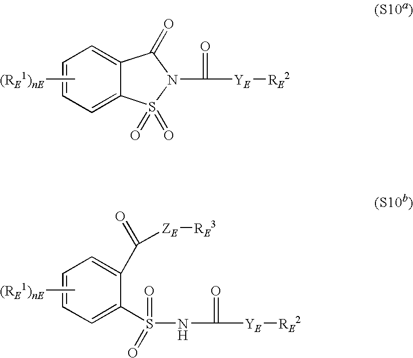
in which
R_{E}¹ is halogen, (C₁-C₄)alkyl, methoxy, nitro, cyano, CF₃, OCF₃
Y_{E}, Z_{E} independently of one another are O or S,
n_{E} is an integer from 0 to 4,
R_{E}² is (C₁-C₁₆)alkyl, (C₂-C₆)alkenyl, (C₃-C₆)cycloalkyl, aryl; benzyl, halobenzyl,
R_{E}³ is hydrogen or (C₁-C₆)alkyl,
S11) active ingredients of the oxyimino compound type (S11), which are known as seed dressings,
S12) active ingredients from the class of isothiochromanones (S12),
S13) one or more compounds from group (S13):
“naphthalic anhydride” (1,8-naphthalenedicarboxylic anhydride) (S13-1),
“fenclorim” (4,6-dichloro-2-phenylpyrimidine) (S13-2), “flurazole” (benzyl 2-chloro-4-trifluoromethyl-1,3-thiazole-5-carboxylate) (S13-3),
“CL 304415” (CAS Reg. No. 31541-57-8) (4-carboxy-3,4-dihydro-2H-1-benzopyran-4-acetic acid) (S13-4),
“MG 191” (CAS Reg. No. 96420-72-3) (2-dichloromethyl-2-methyl-1,3-dioxolane) (S13-5),
“MG-838” (CAS-Reg. No. 133993-74-5) (2-propenyl 1-oxa-4-azaspiro[4.5]decane-4-carbodithioate) (S13-6),
“disulfoton” (O,O-diethyl S-2-ethylthioethyl phosphorodithioate) (S13-7),
“dietholate” (O,O-diethyl O-phenylphosphorothioate) (S13-8),
“mephenate” (4-chlorophenyl methylcarbamate) (S13-9),
S14) active ingredients which, besides a herbicidal effect against harmful plants, also have a safener effect on crop plants such as rice, such as, for example,
“dimepiperate” or “MY-93” (S-1-methyl-1-phenylethyl piperidine-1-carbothioate),
“daimuron” or “SK 23” (1-(1-methyl-1-phenylethyl)-3-p-tolylurea), (S14-1),
“cumyluron”=“JC-940” (3-(2-chlorophenylmethyl)-1-(1-methyl-1-phenylethyl)urea),
“methoxyphenone” or “NK 049” (3,3′-dimethyl-4-methoxybenzo-phenone),
“CSB” (1-bromo-4-(chloromethylsulfonyl)benzene) (CAS Reg. No. 54091-06-4).

2. The composition as claimed in claim 1, wherein, in the compound of the formula (I)
R⁵ is CO₂R²⁹, CH₂OR³⁰, CH(OR³¹)(OR³²), CHO, C(═NOR³³)H, C(═NNR³⁴R³⁵)H,
C(═O)N(R³⁶)R³⁷, C(═S)OR³⁸, C(═O)SR³⁹, C(═S)SR⁴⁰ or C(═NR⁴¹)YR⁴²;
R²⁹ is hydrogen, —CH[C(O)O(CH₂)ₘ], —N═C(R⁴³)R⁴⁴ or a radical which is selected from the group consisting of C₁-C₁₄-alkyl, C₃-C₁₂-cycloalkyl, C₄-C₁₂-alkylcycloalkyl, C₄-C₁₂-cycloalkylalkyl, C₂-C₁₄-alkenyl, C₂-C₁₄-alkynyl and phenyl, where each radical may be optionally substituted by 1 to 3 radicals R⁴⁵; or
R²⁹ is a divalent radical which joins the carboxylate function CO₂R²⁹ of two pyridine ring systems of the formula (I), and the divalent radical is selected from the group consisting of —CH₂—, —(CH₂)₂—, —(CH₂)₃— and —CH(CH₃)CH₂—;
R³⁹ is hydrogen; C₁-C₁₀-alkyl, which may be optionally substituted by 1 to 3 radicals R⁴⁶; or is benzyl;
R³¹ and R³² independently of one another are C₁-C₄-alkyl or C₁-C₃-haloalkyl; or
R³¹ and R³² together are —CH₂CH₂—, —CH₂CH(CH₃)— or —(CH₂)₃—;
R³³ is hydrogen, C₁-C₄-alkyl, C₁-C₄-haloalkyl or benzyl;
R³⁴ is hydrogen, C₁-C₄-alkyl, C₁-C₄-haloalkyl, C₂-C₄-alkylcarbonyl, C₂-C₄-alkoxycarbonyl or benzyl;
R³⁵ is hydrogen, C₁-C₄-alkyl or C₁-C₄-haloalkyl;
R³⁶ is hydrogen, C₁-C₄-alkyl, hydroxy, C₁-C₄-alkoxy or S(O)₂R⁴⁷;
R³⁷ is hydrogen or C₁-C₄-alkyl;
R³⁸, R³⁹ and R⁴⁰ are hydrogen or a radical which is selected from the group consisting of C₁-C₁₄-alkyl, C₃-C₁₂-cycloalkyl, C₄-C₁₂-alkylcycloalkyl, C₄-C₁₂-cycloalkylalkyl, C₂-C₁₄-alkenyl and C₂-C₁₄-alkynyl, where each radical may be optionally substituted by 1 to 3 radicals R⁴⁵;
Y is O, S or NR⁴⁸;
R⁴¹ is hydrogen, C₁-C₃-alkyl, C₁-C₃-haloalkyl, C₂-C₄-alkoxyalkyl, OH or C₁-C₃-alkoxy;
R⁴² is C₁-C₃-alkyl, C₁-C₃-haloalkyl or C₂-C₄-alkoxyalkyl; or
R⁴¹ and R⁴² together form —(CH₂)₂—, —CH₂CH(CH₃)— or —(CH₂)₃—;
R⁴³ and R⁴⁴ independently of one another are selected from the group consisting of C₁-C₄-alkyl;
each R⁴⁵ independently of the others is selected from the group consisting of halogen, cyano, hydroxycarbonyl, C₂-C₄-alkoxycarbonyl, hydroxy, C₁-C₄-alkoxy, C₁-C₄-haloalkoxy, C₁-C₄-alkylthio, C₁-C₄-haloalkylthio, amino, C₁-C₄-alkylamino, C₂-C₄-dialkylamino, —CH[O(CH₂)ₙ—] and phenyl, which may be optionally substituted by 1 to 3 radicals R⁴⁹; or
two R⁴⁵ together form —OC(O)O— or —O(C(R⁵⁰)(R⁵⁰))₁₋₂O—; or
two R⁴⁵ form an oxygen atom in order to form a carbonyl radical with the carbon atom to which they are bonded;
each R⁴⁶ independently of the others is selected from the group consisting of halogen, C₁-C₄-alkoxy, C₁-C₄-haloalkoxy, C₁-C₄-alkylthio, C₁-C₄-haloalkylthio, amino, C₁-C₄-alkylamino and C₂-C₄-dialkylamino; or
two R⁴⁶ form an oxygen atom in order to form a carbonyl radical with the carbon atom to which they are bonded;
R⁴⁷ is C₁-C₄-alkyl, C₁-C₃-haloalkyl or NR⁵¹R⁵²;
R⁴⁸ is hydrogen, C₁-C₃-alkyl, C₁-C₃-haloalkyl or C₂-C₄-alkoxyalkyl;
each R⁴⁹ independently of the others is selected from the group consisting of halogen, C₁-C₄-alkyl, C₁-C₃-haloalkyl, hydroxy, C₁-C₄-alkoxy, C₁-C₃-haloalkoxy, C₁-C₃-alkylthio, C₁-C₃-haloalkylthio, amino, C₁-C₃-alkylamino, C₂-C₄-dialkylamino and nitro;
each R⁵⁰ independently of the others is selected from the group consisting of hydrogen and C₁-C₄-alkyl;
R⁵¹ and R⁵² independently of one another are hydrogen or C₁-C₄-alkyl;
m is an integer from 2 to 3; and
n is an integer from 1 to 4.

3. The composition as claimed in claim 1, wherein, in the compound of the formula (I),
p is 0.

4. The composition as claimed in claim 1, wherein, in the compound of the formula (I),
R⁵ is CO₂R²⁹, CH₂OR³⁰ or CHO.

5. The composition as claimed in claim 1, wherein, in the compound of the formula (I),
R² is hydrogen, CH₃ or C(O)R¹⁰;
R³ is hydrogen or CH₃; or
R² and R³ together form ═C(R¹⁹)N(R²⁰)R²¹; and
R¹⁰, R¹⁹, R²⁰ and R²¹ in each case independently of one another are hydrogen or CH₃.

6. The composition as claimed in claim 1, wherein, in the compound of the formula (I),
R⁵ is CO₂R²⁹; and
R² and R³ are hydrogen.

7. The composition as claimed claim 2, wherein, in the compound of the formula (I),
R²⁹ is hydrogen, C₁-C₄-alkyl or benzyl.

8. The composition as claimed in claim 1, wherein the safener is selected from the group consisting of mefenpyr-diethyl (S1-1), isoxadifen-ethyl (S1-11), cyprosulfamide (S4-1), fenchlorazole-ethyl (S1-7), benoxacor (S3-4), cloquintocet-mexyl (S2-1), fluxofenim (S11-2) and furilazole [(S3-10) or (S3-11)].

9. The composition as claimed in claim 1, comprising, as component (A), a compound of the formula (I) selected from methyl 4-amino-3,5-dichloro-6-cyclopropyl-2-pyridinecarboxylate, 4-amino-3,5-dichloro-6-cyclopropyl-2-pyridinecarboxylic acid, methyl 4-amino-3-chloro-6-cyclopropyl-2-pyridinecarboxylate, 4-amino-3-chloro-6-cyclopropyl-2-pyridinecarboxylic acid, methyl 4-amino-3-chloro-6-cyclopropyl-5-fluoro-2-pyridinecarboxylate and 4-amino-3-chloro-6-cyclopropyl-5-fluoro-2-pyridinecarboxylic acid and, as component (B), a safener selected from mefenpyr-diethyl, isoxadifen-ethyl, cyprosulfamide, fenchlorazoleethyl, benoxacor, cloquintocet-mexyl, fluxofenim and furilazole.

10. A method for controlling undesired plants, in which the compound of the formula (I) and at least one compound from group (B) as claimed in any of claims 1 to 9 are applied together or separately.

11. A method as claimed in claim 10 for controlling undesired plants in plant crops from the group of the arable crops, vegetable crops or permanent crops and plantation crops.

12. The method as claimed in claim 11, wherein the plant crops are transgenic or are tolerant owing to selective cultivation.
